(19) United States
(12) Patent Application Publication
(10) Pub. No.: US 2025/0208392 A1
(43) Pub. Date: Jun. 26, 2025

(54) ZOOM LENS AND IMAGING APPARATUS

(71) Applicant: FUJIFILM Corporation, Tokyo (JP)

(72) Inventors: Masaru AMANO, Saitama-shi (JP); Taiga NODA, Saitama-shi (JP); Yasutaka SHIMADA, Saitama-shi (JP); Yuya HIRAKAWA, Saitama-shi (JP)

(73) Assignee: FUJIFILM Corporation, Tokyo (JP)

(21) Appl. No.: 19/077,032

(22) Filed: Mar. 11, 2025

Related U.S. Application Data
(63) Continuation of application No. PCT/JP2023/027399, filed on Jul. 26, 2023.

(30) Foreign Application Priority Data
Sep. 13, 2022 (JP) 2022-145620
Jun. 29, 2023 (JP) 2023-107553

(51) Int. Cl. G02B 15/20; G02B 15/14

(52) U.S. Cl. CPC G02B 15/20; G02B 15/145523

(57) ABSTRACT

A zoom lens consists of, in order from an object side, a first lens group having a negative refractive power, and a subsequent group. The subsequent group includes at least three lens groups. One of the at least three lens groups of the subsequent group has a positive refractive power. During zooming, a spacing between the first lens group and the subsequent group changes, and all spacings between adjacent lens groups in the subsequent group change. The zoom lens satisfies a predetermined conditional expression.

### CROSS-REFERENCE TO RELATED APPLICATIONS

This application is a continuation application of International Application No. PCT/JP2023/027399, filed on Jul. 26, 2023, which claims priority from Japanese Patent Application No. 2023-107553, filed on Jun. 29, 2023, and Japanese Patent Application No. 2022-145620, filed on Sep. 13, 2022. The entire disclosure of each of the above applications is incorporated herein by reference.

### BACKGROUND

### Technical Field

The disclosed technology relates to a zoom lens and an imaging apparatus.

### Related Art

In the related art, a zoom lens according to JP2021-124673A has been known as a zoom lens usable in an imaging apparatus such as a digital camera.

### SUMMARY

There is a demand for a zoom lens that has favorable optical performance while being configured to be reduced in size. A level of such a demand is increasing every year.

An object of the present disclosure is to provide a zoom lens that is reduced in size and that has favorable optical performance, and an imaging apparatus comprising the zoom lens.

According to an aspect of the present disclosure, there is provided a zoom lens consisting of, in order from an object side to an image side, a first lens group having a negative refractive power, and a subsequent group, in which the subsequent group includes at least three lens groups, one of the at least three lens groups is a P lens group having a positive refractive power, during zooming, a spacing between the first lens group and the subsequent group changes, and all spacings between adjacent lens groups in the subsequent group change, and in a case where a focal length of an entire system in a state where an infinite distance object is in focus at a wide angle end is denoted by fw, a focal length of the entire system in a state where the infinite distance object is in focus at a telephoto end is denoted by ft, a back focus of the entire system as an air conversion distance in the state where the infinite distance object is in focus at the wide angle end is denoted by Bfw, and a maximum half angle of view in the state where the infinite distance object is in focus at the wide angle end is denoted by ww, Conditional Expressions (1) and (2) are satisfied, which are represented by

$$1.5 < ft / fw < 6 and \qquad ( 1 )$$

$$0.4 < Bfw / ( fw \times tan ω w ) < 2. \qquad ( 2 )$$

The P lens group preferably has a largest moving amount to the object side during zooming from the wide angle end to the telephoto end among the lens groups in the subsequent group.

In a case where a moving amount of the P lens group during zooming from the wide angle end to the telephoto end is denoted by ΔP, and a sign of the moving amount during zooming is negative for movement to the object side and is positive for movement to the image side, the zoom lens of the aspect preferably satisfies Conditional Expression (3) represented by

$$0.9 < ( - Δ P ) / fw < 6. \qquad ( 3 )$$

It is preferable that an N lens group having a negative refractive power is disposed on the image side with respect to the P lens group.

It is preferable that a final lens group positioned closest to the image side in the zoom lens is disposed on the image side with respect to the N lens group.

At least a part of the N lens group is preferably a focus group that moves along an optical axis during focusing.

In a case where a focal length of the N lens group is denoted by fN, the zoom lens of the aspect preferably satisfies Conditional Expression (4) represented by

$$0.5 < ( - fN ) / fw < 7. \qquad ( 4 )$$

In a case where an open F-number in the state where the infinite distance object is in focus at the telephoto end is denoted by Fnot, the zoom lens of the aspect preferably satisfies Conditional Expression (5) represented by

$$1.2 < Fnot < 5.8 . \qquad ( 5 )$$

In a case where an open F-number in the state where the infinite distance object is in focus at the telephoto end is denoted by Fnot, and an open F-number in the state where the infinite distance object is in focus at the wide angle end is denoted by Fnow, the zoom lens of the aspect preferably satisfies Conditional Expression (6) represented by

$$0.95 < Fnot / Fnow < 1.8 . \qquad ( 6 )$$

In a case where a focal length of the P lens group is denoted by fP, the zoom lens of the aspect preferably satisfies Conditional Expression (7) represented by

$$0.5 < fP / fw < 6. \qquad ( 7 )$$

The zoom lens of the aspect preferably satisfies Conditional Expression (8) represented by

$$35 < ω w < 54. \qquad ( 8 )$$

The final lens group preferably has a positive refractive power.

It is preferable that an M lens group is disposed between the P lens group and the N lens group.

It is preferable that the P lens group has a largest moving amount to the object side during zooming from the wide angle end to the telephoto end among the lens groups in the subsequent group, an N lens group having a negative refractive power is provided on the image side with respect to the P lens group, an M lens group is provided between the P lens group and the N lens group, and in a case where a moving amount of the P lens group during zooming from the wide angle end to the telephoto end is denoted by ΔP, and a sign of the moving amount during zooming is negative for movement to the object side and is positive for movement to the image side, the zoom lens of the aspect satisfies Conditional Expression (3) represented by

$$0.9 < ( - Δ P ) / fw < 6. \qquad ( 3 )$$

The M lens group preferably has a positive refractive power.

In a case where a focal length of the M lens group is denoted by fM, the zoom lens of the aspect preferably satisfies Conditional Expression (9) represented by

$$0.01 < fw / fM < 0.35 . \qquad ( 9 )$$

In a case where a refractive index with respect to a d line for a positive lens closest to the image side among positive lenses in the M lens group is denoted by NMp, and an Abbe number based on the d line for the positive lens closest to the image side among the positive lenses in the M lens group is denoted by vMp, the zoom lens of the aspect preferably satisfies Conditional Expressions (10) and (11) represented by

$$1.73 < NMp < 2.5 and \qquad ( 10 )$$

$$10 < vMp < 50. \qquad ( 11 )$$

It is preferable that an aperture stop is disposed closest to the object side in the M lens group.

The first lens group preferably includes a negative meniscus lens having a concave surface facing the image side, closest to the object side.

In a case where a focal length of the first lens group is denoted by f1, the zoom lens of the aspect preferably satisfies Conditional Expression (12) represented by

$$1 < ( - fl ) / fw < 2.5 . \qquad ( 12 )$$

In a case where a distance on an optical axis from a lens surface of the first lens group closest to the object side to a lens surface of the first lens group closest to the image side is denoted by DG1, the zoom lens of the aspect preferably satisfies Conditional Expression (13) represented by

$$0.71 < DGl / ( fw \times tan ω w ) < 2.5 . \qquad ( 13 )$$

In a case where a distance on an optical axis from a lens surface of the P lens group closest to the object side to a lens surface of the P lens group closest to the image side is denoted by DGP, the zoom lens of the aspect preferably satisfies Conditional Expression (14) represented by

$$0.35 < DGP / ( fw \times tan ω w ) < 2.5 . \qquad ( 14 )$$

In a case where a distance on an optical axis from a lens surface of the first lens group closest to the object side to a paraxial entrance pupil position in the state where the infinite distance object is in focus at the wide angle end is denoted by Denw, the zoom lens of the aspect preferably satisfies Conditional Expression (15) represented by

$$1 < Denw / fw < 2.2 . \qquad ( 15 )$$

In a case where an average specific gravity of all lenses of the first lens group is denoted by G1ave, the zoom lens of the aspect preferably satisfies Conditional Expression (16) represented by

$$1 < Glave < 5. \qquad ( 16 )$$

In a case where an average specific gravity of all lenses of the P lens group is denoted by GPave, the zoom lens of the aspect preferably satisfies Conditional Expression (17) represented by

$$1 < GPave < 5. \qquad ( 17 )$$

In a case where an average specific gravity of all lenses of the focus group is denoted by Gfave, a distance on the optical axis from a lens surface of the focus group closest to the object side to a lens surface of the focus group closest to the image side is denoted by DGfoc, and a focal length of the focus group is denoted by ffoc, the zoom lens of the aspect preferably satisfies Conditional Expression (18) represented by

$$0.03 < GFave \times DGfoc / \vert ffoc \vert < 0.9 . \qquad ( 18 )$$

In a case where a focal length of the first lens group is denoted by f1, and a focal length of the P lens group is denoted by fP, the zoom lens of the aspect preferably satisfies Conditional Expression (19) represented by

$$0.3 < ( - fl ) / fP < 1.5 . \qquad ( 19 )$$

In a case where a focal length of the first lens group is denoted by f1, and a focal length of the M lens group is denoted by fM, the zoom lens of the aspect preferably satisfies Conditional Expression (20) represented by

$$0 < ( - fl ) / fM < 0.7 . \qquad ( 20 )$$

In a case where a focal length of the P lens group is denoted by fP, and a focal length of the M lens group is denoted by fM, the zoom lens of the aspect preferably satisfies Conditional Expression (21) represented by

$$0 < fP / fM < 2. \qquad ( 21 )$$

In a case where a focal length of the focus group is denoted by ffoc, the zoom lens of the aspect preferably satisfies Conditional Expression (22) represented by

$$1.2 < ( - ffoc ) / ( fw \times tan ω w ) < 5.5 . \qquad ( 22 )$$

It is preferable that the first lens group includes at least one aspherical lens, and in a case where a paraxial curvature radius of a surface, on the object side, of the aspherical lens of the first lens group is denoted by Rolf, a paraxial curvature radius of a surface, on the image side, of the aspherical lens of the first lens group is denoted by Rc1r, a curvature radius of the surface, on the object side, of the aspherical lens of the first lens group at a position of a maximum effective diameter is denoted by Ry1f, and a curvature radius of the surface, on the image side, of the aspherical lens of the first lens group at a position of a maximum effective diameter is denoted by Ry1r, the zoom lens of the aspect satisfies Conditional Expression (23) represented by

$$1.05 < ( 1 / Rclf - 1 / Rclr ) / ( 1 / Rylf - 1 / Rylr ) < 8. \qquad ( 23 )$$

It is preferable that the P lens group includes at least one aspherical lens, and in a case where a paraxial curvature radius of a surface, on the object side, of the aspherical lens of the P lens group is denoted by RcPf, a curvature radius of the surface, on the object side, of the aspherical lens of the P lens group at a position of a maximum effective diameter is denoted by RyPf, a refractive index with respect to a d line for the aspherical lens of the P lens group is denoted by NP, and a focal length of the P lens group is denoted by fP, the zoom lens of the aspect satisfies Conditional Expression (24) represented by

$$0.01 < ( 1 / RcPf - 1 / RyPf ) \times NP \times fP < 5. \qquad ( 24 )$$

It is preferable that the N lens group includes at least one aspherical lens, and in a case where a paraxial curvature radius of a surface, on the object side, of the aspherical lens of the N lens group is denoted by RcNf, a paraxial curvature radius of a surface, on the image side, of the aspherical lens of the N lens group is denoted by RcNr, a curvature radius of the surface, on the object side, of the aspherical lens of the N lens group at a position of a maximum effective diameter is denoted by RyNf, and a curvature radius of the surface, on the image side, of the aspherical lens of the N lens group at a position of a maximum effective diameter is RyNr, the zoom lens of the aspect satisfies Conditional Expression (25) represented by

$$0.7 < ( 1 / RcNf - 1 / RcNr ) / ( 1 / RyNf - 1 / RyNr ) < 0.996 . \qquad ( 25 )$$

It is preferable that the final lens group includes at least one aspherical lens, and in a case where a paraxial curvature radius of a surface, on the object side, of the aspherical lens of the final lens group is denoted by RcEf, a paraxial curvature radius of a surface, on the image side, of the aspherical lens of the final lens group is denoted by RcEr, a curvature radius of the surface, on the object side, of the aspherical lens of the final lens group at a position of a maximum effective diameter is denoted by RyEf, and a curvature radius of the surface, on the image side, of the aspherical lens of the final lens group at a position of a maximum effective diameter is denoted by RyEr, the zoom lens of the aspect satisfies Conditional Expression (26) represented by

$$1.01 < ( 1 / RcEf - 1 / RcEr ) / ( 1 / RyEf - 1 / RyEr ) < 2. \qquad ( 26 )$$

It is preferable that the first lens group includes at least one negative lens, and in a case where an Abbe number based on a d line for the negative lens of the first lens group is denoted by ν1n, and a partial dispersion ratio between a g line and an F line for the negative lens of the first lens group is denoted by θgF1n, the zoom lens of the aspect satisfies Conditional Expressions (27) and (28) represented by

$$55 < vln < 110 and \qquad ( 27 )$$

$$0.003 < θ gFln - ( 0.6438 - 0.001682 \times vln ) < 0 \text{.05} . \qquad ( 28 )$$

It is preferable that the P lens group includes at least one negative lens, and in a case where an Abbe number based on a d line for the negative lens of the P lens group is denoted by νPn, and a partial dispersion ratio between a g line and an F line for the negative lens of the P lens group is denoted by θgFPn, the zoom lens of the aspect satisfies Conditional Expressions (29) and (30) represented by

$$55 < vPn < 110 and \qquad ( 29 )$$

$$0.003 < θ gFPn - ( 0.6 \; 438 - 0.001682 \times vPn ) < 0.05 . \qquad ( 30 )$$

It is preferable that the N lens group includes at least one negative lens, and in a case where an Abbe number based on a d line for the negative lens of the N lens group is denoted by νNn, and a partial dispersion ratio between a g line and an F line for the negative lens of the N lens group is denoted by θgFNn, the zoom lens of the aspect satisfies Conditional Expressions (31) and (32) represented by

$$55 < vNn < 110 and \qquad ( 31 )$$

$$0.003 < θ gFNn - ( 0.6 \; 438 - 0.001682 \times vNn ) < 0.05 . \qquad ( 32 )$$

It is preferable that the M lens group includes at least one negative lens, and in a case where an Abbe number based on a d line for the negative lens of the M lens group is denoted by νMn, and a partial dispersion ratio between a g line and an F line for the negative lens of the M lens group is denoted by θgFMn, the zoom lens of the aspect satisfies Conditional Expressions (33) and (34) represented by

$$55 < vMn < 110 and \qquad ( 33 )$$

$$0.003 < θ gFMn - ( 0.6 \; 438 - 0.001682 \times vMn ) < 0.06 . \qquad ( 34 )$$

It is preferable that the final lens group includes at least one positive lens, and in a case where an Abbe number based on a d line for the positive lens of the final lens group is denoted by νEp, and a partial dispersion ratio between a g line and an F line for the positive lens of the final lens group is denoted by θgFEp, the zoom lens of the aspect satisfies Conditional Expressions (35) and (36) represented by

$$55 < vEp < 110 and \qquad ( 35 )$$

$$0.003 < θ gFEp - ( 0.6 \; 438 - 0.001682 \times vEp ) < 0.05 . \qquad ( 36 )$$

It is preferable that the first lens group includes at least one positive lens, and in a case where a refractive index with respect to a d line for the positive lens of the first lens group is denoted by N1p, and an Abbe number based on the d line for the positive lens of the first lens group is denoted by ν1p, the zoom lens of the aspect satisfies Conditional Expressions (37) and (38) represented by

$$1.8 < Nlp < 2.3 and \qquad ( 37 )$$

$$10 < vlp < 45. \qquad ( 38 )$$

The final lens group may be configured to be fixed with respect to an image plane during zooming.

The first lens group may be configured to include a biconcave lens disposed on the image side with respect to the negative meniscus lens, and a positive lens disposed on the image side with respect to the biconcave lens.

The first lens group at the telephoto end may be configured to be positioned on the image side with respect to the first lens group at the wide angle end. Alternatively, the first lens group at the telephoto end may be configured to be positioned on the object side with respect to the first lens group at the wide angle end.

It is preferable that the subsequent group includes an aperture stop, at least one negative lens having a concave surface facing the object side is disposed on the image side with respect to the aperture stop, and in a case where a distance on an optical axis between the aperture stop and the negative lens having the concave surface facing the object side in the state where the infinite distance object is in focus at the wide angle end is denoted by DSInw, and a sum of a distance on the optical axis from a lens surface of the first lens group closest to the object side to a lens surface of the subsequent group closest to the image side and the back focus of the entire system as the air conversion distance in the state where the infinite distance object is in focus at the wide angle end is denoted by TLw, the zoom lens of the aspect satisfies Conditional Expression (39) represented by

$$0.001 < DSInw / TLw < 0.12 . \qquad ( 39 )$$

It is preferable that the subsequent group includes an aperture stop, at least one negative lens having a concave surface facing the image side is disposed on the object side with respect to the aperture stop, and in a case where a distance on an optical axis between the aperture stop and the negative lens having the concave surface facing the image side in the state where the infinite distance object is in focus at the wide angle end is denoted by DSOnw, and a sum of a distance on the optical axis from a lens surface of the first lens group closest to the object side to a lens surface of the subsequent group closest to the image side and the back focus of the entire system as the air conversion distance in the state where the infinite distance object is in focus at the wide angle end is denoted by TLw, the zoom lens of the aspect satisfies Conditional Expression (40) represented by

$$0.001 < DSOnw / TLw < 0.18 . \qquad ( 40 )$$

It is preferable that the subsequent group includes an aperture stop, at least one cemented lens is disposed on the image side with respect to the aperture stop, and in a case where a distance on an optical axis between the aperture stop and a bonding surface of the cemented lens on the image side with respect to the aperture stop in the state where the infinite distance object is in focus at the wide angle end is denoted by DSIcew, and a sum of a distance on the optical axis from a lens surface of the first lens group closest to the object side to a lens surface of the subsequent group closest to the image side and the back focus of the entire system as the air conversion distance in the state where the infinite distance object is in focus at the wide angle end is denoted by TLw, the zoom lens of the aspect satisfies Conditional Expression (41) represented by

$$0.001 < DSIcew / TLw < 0.12 . \qquad ( 41 )$$

It is preferable that the subsequent group includes an aperture stop, at least one cemented lens is disposed on the object side with respect to the aperture stop, and in a case where a distance on an optical axis between the aperture stop and a bonding surface of the cemented lens on the object side with respect to the aperture stop in the state where the infinite distance object is in focus at the wide angle end is denoted by DSOcew, and a sum of a distance on the optical axis from a lens surface of the first lens group closest to the object side to a lens surface of the subsequent group closest to the image side and the back focus of the entire system as the air conversion distance in the state where the infinite distance object is in focus at the wide angle end is denoted by TLw, the zoom lens of the aspect satisfies Conditional Expression (42) represented by

$$0.001 < DSOcew / TLw < 0.18 . \qquad ( 42 )$$

In a case where a moving amount of the N lens group during zooming from the wide angle end to the telephoto end is denoted by AN, a moving amount of the P lens group during zooming from the wide angle end to the telephoto end is denoted by ΔP, and a sign of the moving amount during zooming is negative for movement to the object side and is positive for movement to the image side, the zoom lens of the aspect preferably satisfies Conditional Expression (43) represented by

$$0.1 < Δ N / Δ P < 0.75 . \qquad ( 43 )$$

In a case where a sum of a distance on an optical axis from a paraxial exit pupil position to a lens surface of the subsequent group closest to the image side and the back focus of the entire system as the air conversion distance in the state where the infinite distance object is in focus at the wide angle end is denoted by Dexw, the zoom lens of the aspect preferably satisfies Conditional Expression (44) represented by

$$1.5 < Dexw / ( fw \times tan ω w ) < 5. \qquad ( 44 )$$

In a case where an open F-number in the state where the infinite distance object is in focus at the telephoto end is denoted by Fnot, and a distance on an optical axis from a lens surface of the P lens group closest to the object side to a lens surface of the P lens group closest to the image side is denoted by DGP, the zoom lens of the aspect preferably satisfies Conditional Expression (45) represented by

$$0.4 < Fnot \times DGP / ft < 4. \qquad ( 45 )$$

In a case where an open F-number in the state where the infinite distance object is in focus at the telephoto end is denoted by Fnot, a distance on an optical axis from a lens surface of the P lens group closest to the object side to a lens surface of the P lens group closest to the image side is denoted by DGP, and a distance on the optical axis from a lens surface of the M lens group closest to the object side to a lens surface of the M lens group closest to the image side is denoted by DGM, the zoom lens of the aspect preferably satisfies Conditional Expression (46) represented by

$$4 < Fnot \times ( DGP + GGM ) / ft < 4. \qquad ( 46 )$$

One lens group may be configured to be provided between the first lens group and the P lens group.

In a case where a sum of a distance on an optical axis from a lens surface of the first lens group closest to the object side to a lens surface of the subsequent group closest to the image side and the back focus of the entire system as the air conversion distance in the state where the infinite distance object is in focus at the telephoto end is denoted by TLt, the zoom lens of the aspect preferably satisfies Conditional Expression (47) represented by

$$1.2 < TLt / ft < 5. \qquad ( 47 )$$

In a case where a focal length of the final lens group is denoted by fE, the zoom lens of the aspect preferably satisfies Conditional Expression (48) represented by

$$0.1 < fw / fE < 0.7 . \qquad ( 48 )$$

In a case where a lateral magnification of the focus group in the state where the infinite distance object is in focus at the wide angle end is denoted by βfw, and a combined lateral magnification of all lenses on the image side with respect to the focus group in the state where the infinite distance object is in focus at the wide angle end is denoted by βfRw, the zoom lens of the aspect preferably satisfies Conditional Expression (49) represented by

$$0.3 < \vert ( 1 - β {fw}^{2} ) \times β {fRw}^{2} \vert < 3. \qquad ( 49 )$$

In a case where a lateral magnification of the focus group in the state where the infinite distance object is in focus at the telephoto end is denoted by βft, and a combined lateral magnification of all lenses on the image side with respect to the focus group in the state where the infinite distance object is in focus at the telephoto end is denoted by βfRt, the zoom lens of the aspect preferably satisfies Conditional Expression (50) represented by

$$0.5 < \vert ( 1 - β {ft}^{2} ) \times β {fRt}^{2} \vert < 4. \qquad ( 50 )$$

In a case where a focal length of the focus group is denoted by ffoc, a combined focal length of all lenses on the image side with respect to the focus group in the state where the infinite distance object is in focus at the wide angle end is denoted by ffRw, a sum of a distance on an optical axis from a paraxial exit pupil position to a lens surface of the subsequent group closest to the image side and the back focus of the entire system as the air conversion distance in the state where the infinite distance object is in focus at the wide angle end is denoted by Dexw, and

$$γ w = ( 1 - β {fw}^{2} ) \times β {fRw}^{2} and$$

$$BRw = \{ β fw / ( ffoc \times γ w ) - 1 / ( β fRw \times ffRw ) - ( 1 / Dexw ) \}$$

are established, the zoom lens of the aspect preferably satisfies Conditional Expression (51) represented by

$$0 < ( - BRw ) \times ( fw \times tan ω w ) < 0.7 . \qquad ( 51 )$$

In a case where a focal length of the focus group is denoted by ffoc, a combined focal length of all lenses on the image side with respect to the focus group in the state where the infinite distance object is in focus at the telephoto end is denoted by ffRt, a sum of a distance on an optical axis from a paraxial exit pupil position to a lens surface of the subsequent group closest to the image side and the back focus of the entire system as the air conversion distance in the state where the infinite distance object is in focus at the telephoto end is denoted by Dext, the maximum half angle of view in the state where the infinite distance object is in focus at the telephoto end is denoted by ωt, and

$$γ t = ( 1 - β {ft}^{2} ) \times β {fRt}^{2} and$$

$$BRt = \{ β ft / ( ffoc \times γ t ) - 1 / ( β fRt \times ffRt ) - ( 1 / Dext ) \}$$

are established, the zoom lens of the aspect preferably satisfies Conditional Expression (52) represented by

$$0 < ( - BRt ) \times ( ft \times tan ω t ) < 0.5 . \qquad ( 52 )$$

The zoom lens of the aspect preferably comprises an aperture stop, and at least three lenses are provided between the first lens group and the aperture stop.

The zoom lens of the aspect preferably comprises an aperture stop, and at least three positive lenses are provided between the first lens group and the aperture stop.

The zoom lens of the aspect preferably comprises an aperture stop, and at least three lenses are provided between the aperture stop and the N lens group.

The zoom lens of the aspect preferably comprises an aperture stop, and at least two positive lenses are provided between the aperture stop and the N lens group.

The number of lenses included in the focus group is preferably two or less.

The number of lenses included in the final lens group is preferably two or less.

A lens surface of the first lens group closest to the image side is preferably a concave surface.

The number of moving paths different from each other among moving paths of each lens group that moves during zooming from the wide angle end to the telephoto end may be configured to be five, may be configured to be four, or may be configured to be three.

It is preferable that at least one of a lens closest to the object side or a second lens from the object side is a negative lens, and in a case where a refractive index with respect to a d line for the negative lens of at least one of the lens closest to the object side or the second lens from the object side is denoted by Nobn, the zoom lens of the aspect satisfies Conditional Expression (53) represented by

$$1.7 < Nobn < 2.2 . \qquad ( 53 )$$

It is preferable that the lens closest to the object side is a negative lens and satisfies Conditional Expression (53).

According to another aspect of the present disclosure, there is provided an imaging apparatus comprising the zoom lens according to the aspect of the present disclosure.

In the present specification, the expressions “consists of” and “consisting of” indicate that a lens substantially not having a refractive power, an optical element other than a lens, such as a stop, a filter, and a cover glass, a mechanism part such as a lens flange, a lens barrel, an imaging element, and a camera shake correction mechanism may be included in addition to the illustrated constituents.

The term “group having a positive refractive power” and the expression “a group has a positive refractive power” in the present specification mean that the entire group has a positive refractive power. Similarly, the term “group having a negative refractive power” and the expression “a group has a negative refractive power” mean that the entire group has a negative refractive power. The terms “first lens group”, “lens group”, “P lens group”, “N lens group”, “final lens group”, “focus lens group”, and “M lens group” in the present specification are not limited to a configuration consisting of a plurality of lenses and may mean a configuration consisting of only one lens.

A compound aspherical lens (a lens functioning as one aspherical lens as a whole, in which a spherical lens and a film of an aspherical shape formed on the spherical lens are configured to be integrated with each other) is not regarded as a cemented lens and is handled as one lens. Unless otherwise specified, a sign of a refractive power and a surface shape related to a lens including an aspherical surface in a paraxial region are used. A sign of a paraxial curvature radius of a surface having a convex shape facing the object side is positive, and a sign of a paraxial curvature radius of a surface having a convex shape facing the image side is negative.

In the present specification, the term “entire system” means the zoom lens. The term “focal length” used in the conditional expressions means a paraxial focal length. Unless otherwise specified, the term “distance on the optical axis” used in the conditional expressions means a geometrical distance. Unless otherwise specified, values used in the conditional expressions are values based on the d line in the state where the infinite distance object is in focus.

The terms “d line”, “C line”, “F line”, and “g line” according to the present specification mean bright lines. A wavelength of the d line is 587.56 nanometers (nm). A wavelength of the C line is 656.27 nanometers (nm). A wavelength of the F line is 486.13 nanometers (nm). A wavelength of the g line is 435.84 nanometers (nm).

According to the present disclosure, a zoom lens that is reduced in size and that has favorable optical performance, and an imaging apparatus comprising the zoom lens can be provided.

### BRIEF DESCRIPTION OF THE DRAWINGS

FIG. 1 is a diagram that illustrates a configuration and a moving path of a zoom lens according to one embodiment and that corresponds to a zoom lens of Example 1.

FIG. 2 is a diagram for describing symbols of conditional expressions.

FIG. 3 is a diagram for describing positions of an effective diameter and a maximum effective diameter.

FIG. 4 is each aberration diagram of the zoom lens of Example 1.

FIG. 5 is a diagram illustrating a configuration and a moving path of a zoom lens of Example 2.

FIG. 6 is each aberration diagram of the zoom lens of Example 2.

FIG. 7 is a diagram illustrating a configuration and a moving path of a zoom lens of Example 3.

FIG. 8 is each aberration diagram of the zoom lens of Example 3.

FIG. 9 is a diagram illustrating a configuration and a moving path of a zoom lens of Example 4.

FIG. 10 is each aberration diagram of the zoom lens of Example 4.

FIG. 11 is a diagram illustrating a configuration and a moving path of a zoom lens of Example 5.

FIG. 12 is each aberration diagram of the zoom lens of Example 5.

FIG. 13 is a diagram illustrating a configuration and a moving path of a zoom lens of Example 6.

FIG. 14 is each aberration diagram of the zoom lens of Example 6.

FIG. 15 is a diagram illustrating a configuration and a moving path of a zoom lens of Example 7.

FIG. 16 is each aberration diagram of the zoom lens of Example 7.

FIG. 17 is a diagram illustrating a configuration and a moving path of a zoom lens of Example 8.

FIG. 18 is each aberration diagram of the zoom lens of Example 8.

FIG. 19 is a diagram illustrating a configuration and a moving path of a zoom lens of Example 9.

FIG. 20 is each aberration diagram of the zoom lens of Example 9.

FIG. 21 is a diagram illustrating a configuration and a moving path of a zoom lens of Example 10.

FIG. 22 is each aberration diagram of the zoom lens of Example 10.

FIG. 23 is a diagram illustrating a configuration and a moving path of a zoom lens of Example 11.

FIG. 24 is each aberration diagram of the zoom lens of Example 11.

FIG. 25 is a diagram illustrating a configuration and a moving path of a zoom lens of Example 12.

FIG. 26 is each aberration diagram of the zoom lens of Example 12.

FIG. 27 is a diagram illustrating a configuration and a moving path of a zoom lens of Example 13.

FIG. 28 is each aberration diagram of the zoom lens of Example 13.

FIG. 29 is a diagram illustrating a configuration and a moving path of a zoom lens of Example 14.

FIG. 30 is each aberration diagram of the zoom lens of Example 14.

FIG. 31 is a diagram illustrating a configuration and a moving path of a zoom lens of Example 15.

FIG. 32 is each aberration diagram of the zoom lens of Example 15.

FIG. 33 is a diagram illustrating a configuration and a moving path of a zoom lens of Example 16.

FIG. 34 is each aberration diagram of the zoom lens of Example 16.

FIG. 35 is a diagram illustrating a configuration and a moving path of a zoom lens of Example 17.

FIG. 36 is each aberration diagram of the zoom lens of Example 17.

FIG. 37 is a diagram illustrating a configuration and a moving path of a zoom lens of Example 18.

FIG. 38 is each aberration diagram of the zoom lens of Example 18.

FIG. 39 is a diagram illustrating a configuration and a moving path of a zoom lens of Example 19.

FIG. 40 is each aberration diagram of the zoom lens of Example 19.

FIG. 41 is a perspective view of a front surface side of an imaging apparatus according to one embodiment.

FIG. 42 is a perspective view of a rear surface side of the imaging apparatus according to one embodiment.

### DETAILED DESCRIPTION

Hereinafter, an embodiment of the present disclosure will be described with reference to the drawings.

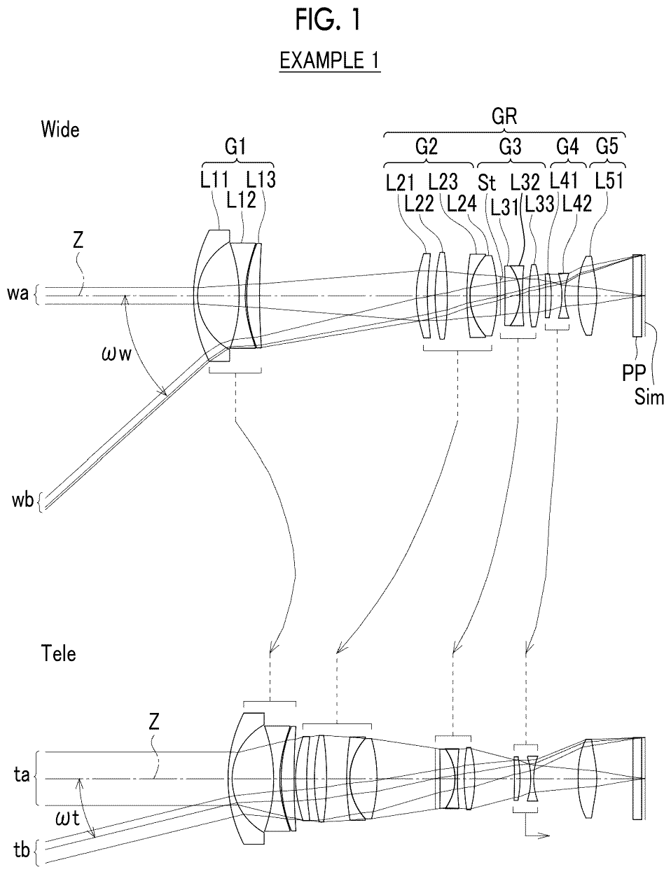

FIG. 1 illustrates a cross-sectional view and a moving path of a configuration of a zoom lens according to one embodiment of the present disclosure. In FIG. 1, a wide angle end state is illustrated in an upper part labeled “Wide”, and a telephoto end state is illustrated in a lower part labeled “Tele”. The example illustrated in FIG. 1 corresponds to a zoom lens of Example 1 described later. FIG. 1 illustrates a state where an infinite distance object is in focus, in which a left side is an object side and a right side is an image side. FIG. 1 also illustrates an on-axis luminous flux wa and a luminous flux wb of a maximum half angle of view ww at a wide angle end and an on-axis luminous flux ta and a luminous flux tb of a maximum half angle of view ωt at a telephoto end.

FIG. 1 illustrates an example in which an optical member PP having a shape of a parallel flat plate is disposed between the zoom lens and an image plane Sim, assuming that the zoom lens is applied to an imaging apparatus. The optical member PP is a member that is assumed to be various filters and/or a cover glass or the like. The various filters include a low-pass filter, an infrared cut filter, and/or a filter or the like that cuts a specific wavelength range. The optical member PP is a member not having a refractive power. The imaging apparatus can also be configured without the optical member PP.

The zoom lens of the present disclosure consists of, in order from the object side to the image side along an optical axis Z, a first lens group G1 having a negative refractive power, and a subsequent group GR. Providing the first lens group G1 closest to the object side with a negative refractive power facilitates diameter reduction of a lens closest to the object side and thus, achieves an advantage in size reduction.

During zooming, a spacing between the first lens group G1 and the subsequent group GR changes, and all spacings between adjacent lens groups in the subsequent group GR change. The terms “first lens group G1” and “lens groups” included in the subsequent group GR in the present specification mean parts that are constituents of the zoom lens and that include at least one lens separated by air spacings which change during zooming. During zooming, each lens group is moved or fixed in lens group units, and a mutual spacing between lenses in each lens group does not change. That is, in the present specification, one lens group is a group in which, during zooming, a spacing with respect to an adjacent group changes, and all spacings between adjacent lenses in the group do not change.

For example, the zoom lens in FIG. 1 includes, in order from the object side to the image side, the first lens group G1 having a negative refractive power, a second lens group G2 having a positive refractive power, a third lens group G3 having a positive refractive power, a fourth lens group G4 having a negative refractive power, and a fifth lens group G5 having a positive refractive power.

In the example in FIG. 1, the subsequent group GR consists of the second lens group G2, the third lens group G3, the fourth lens group G4, and the fifth lens group G5.

For example, each lens group in FIG. 1 is composed of lenses described below. The first lens group G1 consists of, in order from the object side to the image side, three lenses including lenses L11 to L13. The second lens group G2 consists of, in order from the object side to the image side, four lenses including lenses L21 to L24. The third lens group G3 consists of, in order from the object side to the image side, an aperture stop St and three lenses including lenses L31 to L33. The fourth lens group G4 consists of, in order from the object side to the image side, two lenses including lenses L41 and L42. The fifth lens group G5 consists of one lens that is a lens L51. The aperture stop St in FIG. 1 does not indicate a shape and a size and indicates a position in an optical axis direction.

In the example in FIG. 1, during zooming, the first lens group G1, the second lens group G2, the third lens group G3, and the fourth lens group G4 move along the optical axis Z by changing spacings with respect to adjacent lens groups, and the fifth lens group G5 is fixed with respect to the image plane Sim. In FIG. 1, for lens groups that move, an arrow between the upper part and the lower part indicates a schematic moving path of each lens group during zooming from the wide angle end to the telephoto end.

The zoom lens of the present disclosure preferably includes the aperture stop St, and at least three lenses between the first lens group G1 and the aperture stop St. Doing so achieves an advantage in correcting a spherical aberration while reducing an F-number.

The zoom lens of the present disclosure preferably includes the aperture stop St, and at least three positive lenses between the first lens group G1 and the aperture stop St. Doing so achieves an advantage in correcting an axial chromatic aberration while reducing the F-number.

The first lens group G1 preferably includes a negative meniscus lens having a concave surface facing the image side, closest to the object side. Doing so achieves an advantage in correcting a distortion. In the present specification, the term “negative meniscus lens” means a meniscus lens having a negative refractive power.

In a case where the first lens group G1 includes the negative meniscus lens having the concave surface facing the image side, closest to the object side, the first lens group G1 preferably includes a biconcave lens disposed on the image side with respect to the negative meniscus lens, and a positive lens disposed on the image side with respect to the biconcave lens. Doing so achieves an advantage in suppressing a lateral chromatic aberration and an astigmatism.

A lens surface of the first lens group G1 closest to the image side is preferably a concave surface. Doing so achieves an advantage in suppressing fluctuation of the astigmatism during zooming.

As in the example in FIG. 1, the first lens group G1 at the telephoto end may be configured to be positioned on the image side with respect to the first lens group G1 at the wide angle end. Doing so achieves an advantage in reduction of a total length of a lens system. Unlike the example in FIG. 1, in a case where the first lens group G1 at the telephoto end is configured to be positioned on the object side with respect to the first lens group G1 at the wide angle end, this achieves an advantage in achieving a high zoom ratio.

At least one of the lens closest to the object side in the zoom lens or the second lens from the object side in the zoom lens is preferably a negative lens. Doing so achieves an advantage in achieving a wide angle.

The subsequent group GR is configured to include at least three lens groups. By doing so, the three lens groups can perform a main zooming action, an image forming action, and a correction action of an image plane position during zooming, respectively.

One of the at least three lens groups of the subsequent group GR is a P lens group having a positive refractive power. The P lens group can perform the main zooming action.

The P lens group can be configured to be a lens group having the largest moving amount to the object side during zooming from the wide angle end to the telephoto end among the lens groups in the subsequent group GR. Doing so makes the P lens group suitable as a lens group that performs the main zooming action. For example, in the example in FIG. 1, the second lens group G2 is the lens group having the largest moving amount to the object side during zooming from the wide angle end to the telephoto end among the lens groups in the subsequent group GR.

The zoom lens of the present disclosure preferably includes an N lens group having a negative refractive power, on the image side with respect to the P lens group. By doing so, the N lens group can perform the correction action of the image plane position during zooming. In the example in FIG. 1, in a case where the second lens group G2 is associated with the P lens group, the fourth lens group G4 corresponds to the N lens group.

At least a part of the N lens group is preferably a focus group that moves along the optical axis Z during focusing. The N lens group is present at a position where both of a diameter of an on-axis luminous flux at the telephoto end and a height of an off-axis ray at the wide angle end from the optical axis Z are reduced. Forming at least a part of the N lens group as the focus group can reduce a lens diameter of the focus group and achieve size reduction as a group and thus, achieves an advantage in performing autofocus.

In the present specification, the focus group refers to a group that moves along the optical axis Z during focusing. Focusing is performed by moving the focus group. In the example in FIG. 1, the focus group consists of the fourth lens group G4. A bracket and a rightward arrow under the fourth lens group G4 in FIG. 1 indicate that the fourth lens group G4 is the focus group that moves to the image side during focusing from the infinite distance object to a nearest object. While the fourth lens group G4 functions as the focus group in the entire magnification range, the bracket and the arrow indicating the focus group are provided in only the lower part of FIG. 1 in order to avoid complication of the drawing.

The number of lenses included in the focus group is preferably two or less. Doing so achieves an advantage in weight reduction of the focus group.

The zoom lens of the present disclosure preferably includes the aperture stop St, and at least three lenses between the aperture stop St and the N lens group. Doing so achieves an advantage in suppressing fluctuation of the spherical aberration during zooming.

The zoom lens of the present disclosure preferably includes the aperture stop St, and at least two positive lenses between the aperture stop St and the N lens group. Doing so achieves an advantage in suppressing fluctuation of the axial chromatic aberration during zooming.

The zoom lens of the present disclosure preferably includes a final lens group positioned closest to the image side in the zoom lens, on the image side with respect to the N lens group. Disposing a lens group at a position close to an image forming position achieves an advantage in correcting aberrations related to an off-axis luminous flux, such as the distortion and the lateral chromatic aberration. In the example in FIG. 1, the fifth lens group G5 corresponds to the final lens group.

The final lens group preferably has a positive refractive power. Doing so can reduce an incidence angle of a ray on the image plane Sim at the wide angle end and achieves an advantage in suppressing the distortion and the lateral chromatic aberration at the wide angle end.

The number of lenses included in the final lens group is preferably two or less. Doing so achieves an advantage in reduction of the total length of the lens system.

The final lens group may be configured to be fixed with respect to the image plane Sim during zooming. Doing so achieves an advantage in suppressing fluctuation of a field curvature during zooming. This can also contribute to simplification of the apparatus.

The zoom lens of the present disclosure may be configured to include an M lens group between the P lens group and the N lens group. Doing so achieves an advantage in suppressing fluctuation of the spherical aberration during zooming. In the example in FIG. 1, in a case where the second lens group G2 is associated with the P lens group and the fourth lens group G4 is associated with the N lens group, the third lens group G3 corresponds to the M lens group.

The M lens group may be configured to have a positive refractive power. Doing so can distribute a positive refractive power between the M lens group and the P lens group and thus, can suppress sensitivity of the P lens group to error on a telephoto side, which is likely to pose a problem in achieving a large diameter. This can contribute to implementation of the zoom lens having favorable optical performance.

The zoom lens of the present disclosure may be configured to include the aperture stop St closest to the object side in the M lens group. Disposing the aperture stop St on the image side with respect to the P lens group, which performs the zooming action, can reduce changes caused by zooming while reducing an opening diameter of the aperture stop St.

Next, preferable configurations and available configurations related to conditional expressions of the zoom lens of the present disclosure will be described. In the following description related to the conditional expressions, in order to avoid redundant description, the same symbol will be used for the same definition to partially omit duplicate descriptions of the symbol. Hereinafter, the “zoom lens of the present disclosure” will be simply referred to as the “zoom lens” in order to avoid redundant description.

In a case where a focal length of the entire system in a state where the infinite distance object is in focus at the wide angle end is denoted by fw, and a focal length of the entire system in a state where the infinite distance object is in focus at the telephoto end is denoted by ft, the zoom lens preferably satisfies Conditional Expression (1). Ensuring that a corresponding value of Conditional Expression (1) is not less than or equal to its lower limit can implement a high zoom ratio. Ensuring that the corresponding value of Conditional Expression (1) is not greater than or equal to its upper limit can reduce a moving amount of each lens group during zooming and thus, achieves an advantage in size reduction. In order to obtain more favorable characteristics, the zoom lens more preferably satisfies Conditional Expression (1-1), further preferably satisfies Conditional Expression (1-2), and still more preferably satisfies Conditional Expression (1-3).

$$1.5 < ft / fw < 6 \qquad ( 1 )$$

$$1.9 < ft / fw < 5 \qquad ( 1 - 1 )$$

$$2.1 < ft / fw < 4.5 \qquad ( 1 - 2 )$$

$$2.8 < ft / fw < 4.2 \qquad ( 1 - 3 )$$

The zoom lens preferably satisfies Conditional Expression (2). A back focus of the entire system as an air conversion distance in the state where the infinite distance object is in focus at the wide angle end is denoted by Bfw. A maximum half angle of view in the state where the infinite distance object is in focus at the wide angle end is denoted by ow. Here, tan denotes a tangent. Ensuring that a corresponding value of Conditional Expression (2) is not less than or equal to its lower limit achieves an advantage in securing an edge part light quantity. Doing so can also separate the lens group closest to the image side away from the image plane Sim and thus, achieves an advantage in suppressing ghost or flare caused by reflection from the image plane Sim. Ensuring that the corresponding value of Conditional Expression (2) is not greater than or equal to its upper limit can secure a space for a lens group that moves during zooming while maintaining the total length of the lens system, and thus, achieves an advantage in implementing a high zoom ratio while achieving size reduction.

In order to obtain more favorable characteristics, the zoom lens more preferably satisfies Conditional Expression (2-1) and further preferably satisfies Conditional Expression (2-2).

$$0.4 < Bfw / ( fw \times tan ω w ) < 2 \qquad ( 2 )$$

$$0.65 < Bfw / ( fw \times tan ω w ) < 1.7 \qquad ( 2 - 1 )$$

$$0.84 < Bfw / ( fw \times tan ω w ) < 1.48 \qquad ( 2 - 2 )$$

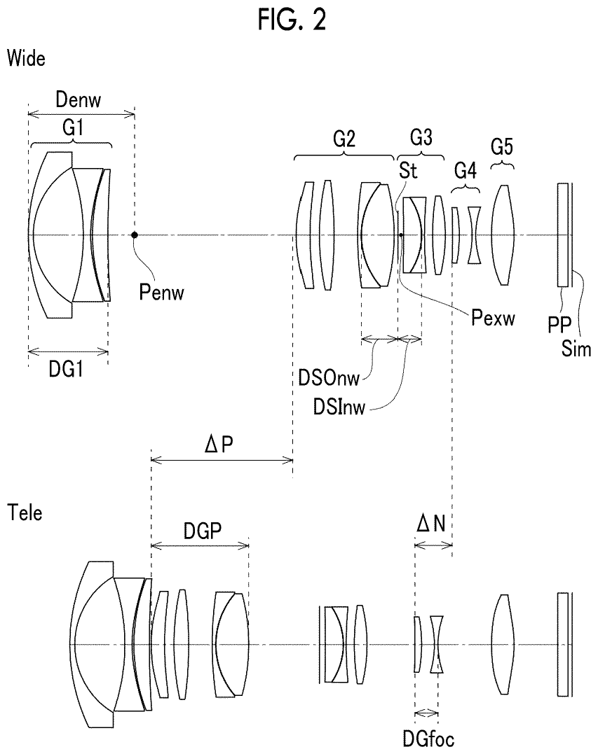

In a case where a moving amount of the P lens group during zooming from the wide angle end to the telephoto end is denoted by ΔP, the zoom lens preferably satisfies Conditional Expression (3). A sign of the moving amount during zooming is negative for movement to the object side and is positive for movement to the image side. For example, FIG. 2 illustrates the moving amount ΔP in a case where the second lens group G2 corresponds to the P lens group. Ensuring that a corresponding value of Conditional Expression (3) is not less than or equal to its lower limit prevents an excessively small moving amount of the P lens group and thus, facilitates securing of a desired zoom ratio. In a case where the desired zoom ratio is to be secured with a small moving amount of the P lens group, the refractive power of the P lens group has to be increased, and consequently, it is difficult to correct the spherical aberration and the axial chromatic aberration on the telephoto side. Ensuring that the corresponding value of Conditional Expression (3) is not less than or equal to its lower limit can avoid such a problem. Ensuring that the corresponding value of Conditional Expression (3) is not greater than or equal to its upper limit prevents an excessively large moving amount of the P lens group and thus, can avoid an increase in a diameter of the first lens group G1 caused by an increase in the total length of the lens system. This facilitates size reduction. In order to obtain more favorable characteristics, the zoom lens more preferably satisfies Conditional Expression (3-1) and further preferably satisfies Conditional Expression (3-2).

$$0.9 < ( - Δ P ) / fw < 6 \qquad ( 3 )$$

$$1.2 < ( - Δ P ) / fw < 5 \qquad ( 3 - 1 )$$

$$1.75 < ( - Δ P ) / fw < 3.5 \qquad ( 3 - 2 )$$

In a case where a focal length of the N lens group is denoted by fN, the zoom lens preferably satisfies Conditional Expression (4). Ensuring that a corresponding value of Conditional Expression (4) is not less than or equal to its lower limit prevents an excessively strong refractive power of the N lens group and thus, can suppress fluctuation of various aberrations caused by zooming. Particularly, fluctuation of the field curvature can be suppressed. This achieves an advantage in achieving both of a large diameter and a high zoom ratio. Ensuring that the corresponding value of Conditional Expression (4) is not greater than or equal to its upper limit prevents an excessively weak refractive power of the N lens group and thus, facilitates avoiding an increase in the total length of the lens system caused by an increase in a moving amount of the N lens group during zooming. In order to obtain more favorable characteristics, the zoom lens more preferably satisfies Conditional Expression (4-1) and further preferably satisfies Conditional Expression (4-2).

$$0.5 < ( - fN ) / fw < 7 \qquad ( 4 )$$

$$1. 2 < ( - fN ) / fw < 5.8 \qquad ( 4 - 1 )$$

$$1. 63 < ( - fN ) / fw < 4 \text{.88} \qquad ( 4 - 2 )$$

In a case where an open F-number in the state where the infinite distance object is in focus at the telephoto end is denoted by Fnot, the zoom lens preferably satisfies Conditional Expression (5). Ensuring that a corresponding value of Conditional Expression (5) is not less than or equal to its lower limit can narrow the on-axis luminous flux at the telephoto end and thus, achieves an advantage in size reduction and weight reduction of the lens. Ensuring that the corresponding value of Conditional Expression (5) is not greater than or equal to its upper limit can obtain a brighter optical image at the telephoto end. The effect of each configuration of the present disclosure is generally suitable for a zoom lens having a small F-number. Thus, ensuring that the corresponding value of Conditional Expression (5) is not greater than or equal to its upper limit can provide a more suitable zoom lens. In order to obtain more favorable characteristics, the zoom lens more preferably satisfies Conditional Expression (5-1) and further preferably satisfies Conditional Expression (5-2).

$$1.2 < Fnot < 5.8 \qquad ( 5 )$$

$$2 < Fnot < 4.2 \qquad ( 5 - 1 )$$

$$2.73 < Fnot < 3.7 \qquad ( 5 - 2 )$$

In a case where an open F-number in the state where the infinite distance object is in focus at the wide angle end is denoted by Fnow, the zoom lens preferably satisfies Conditional Expression (6). Ensuring that a corresponding value of Conditional Expression (6) is not less than or equal to its lower limit can narrow the on-axis luminous flux at the telephoto end and thus, achieves an advantage in size reduction and weight reduction of the lens. Ensuring that the corresponding value of Conditional Expression (6) is not greater than or equal to its upper limit can suppress fluctuation of brightness of the optical image during zooming. In order to obtain more favorable characteristics, the zoom lens more preferably satisfies Conditional Expression (6-1) and further preferably satisfies Conditional Expression (6-2).

$$0.95 < Fnot / Fnow < 1.8 \qquad ( 6 )$$

$$0.95 < Fnot / Fnow < 1.46 \qquad ( 6 - 1 )$$

$$0.95 < Fnot / Fnow < 1.1 \qquad ( 6 - 2 )$$

In a case where a focal length of the P lens group is denoted by fP, the zoom lens preferably satisfies Conditional Expression (7). Ensuring that a corresponding value of Conditional Expression (7) is not less than or equal to its lower limit prevents an excessively strong refractive power of the P lens group and thus, facilitates correction of the spherical aberration on the telephoto side. Ensuring that the corresponding value of Conditional Expression (7) is not greater than or equal to its upper limit prevents an excessively weak refractive power of the P lens group and thus, facilitates a high zooming action of the P lens group. In order to obtain more favorable characteristics, the zoom lens more preferably satisfies Conditional Expression (7-1) and further preferably satisfies Conditional Expression (7-2).

$$0.5 < fP / fw < 6 \qquad ( 7 )$$

$$1 < fP / fw < 4 \qquad ( 7 - 1 )$$

$$1.26 < fP / fw < 2.97 \qquad ( 7 - 2 )$$

In a case where the maximum half angle of view in the state where the infinite distance object is in focus at the wide angle end is denoted by ow, the zoom lens preferably satisfies Conditional Expression (8). Ensuring that a corresponding value of Conditional Expression (8) is not less than or equal to its lower limit achieves an advantage in achieving a wide angle. Ensuring that the corresponding value of Conditional Expression (8) is not greater than or equal to its upper limit can further reduce a height of a ray passing through the first lens group G1 and thus, achieves an advantage in achieving diameter reduction. In order to obtain more favorable characteristics, the zoom lens more preferably satisfies Conditional Expression (8-1) and the zoom lens further preferably satisfies Conditional Expression (8-2).

$$35 < ω w < 54 \qquad ( 8 )$$

$$38 < ω w < 50 \qquad ( 8 - 1 )$$

$$41 < ω w < 47 \qquad ( 8 - 2 )$$

In a case where a focal length of the M lens group is denoted by fM, the zoom lens preferably satisfies Conditional Expression (9). Ensuring that a corresponding value of Conditional Expression (9) is not less than or equal to its lower limit prevents an excessively weak refractive power of the M lens group and thus, can suppress the sensitivity of the P lens group to error on the telephoto side, which is likely to pose a problem in achieving a large diameter. This can contribute to implementation of the zoom lens having favorable optical performance. Ensuring that the corresponding value of Conditional Expression (9) is not greater than or equal to its upper limit prevents an excessively strong refractive power of the M lens group and thus, can increase the refractive power of the P lens group. This can strengthen the zooming action of the P lens group and thus, facilitates reduction of the total length of the lens system and securing of the desired zoom ratio. In order to obtain more favorable characteristics, the zoom lens more preferably satisfies Conditional Expression (9-1) and further preferably satisfies Conditional Expression (9-2).

$$0.01 < fw / fM < 0 \text{.35} \qquad ( 9 )$$

$$0.015 < fw / fM < 0.3 \qquad ( 9 - 1 )$$

$$0.019 < fw / fM < 0.26 \qquad ( 9 - 2 )$$

In a case where a refractive index with respect to a d line for a positive lens closest to the image side among positive lenses in the M lens group is denoted by NMp, the zoom lens preferably satisfies Conditional Expression (10). Generally, an Abbe number of an optical material tends to decrease as a refractive index of the optical material increases.

Ensuring that a corresponding value of Conditional Expression (10) is not less than or equal to its lower limit enables selection of a material having a smaller Abbe number and thus, facilitates correction of a chromatic aberration including the axial chromatic aberration caused by zooming. Ensuring that the corresponding value of Conditional Expression (10) is not greater than or equal to its upper limit prevents an excessively high refractive index and thus, can suppress overcorrection of the chromatic aberration. In order to obtain more favorable characteristics, the zoom lens more preferably satisfies Conditional Expression (10-1) and further preferably satisfies Conditional Expression (10-2).

$$1.73 < NMp < 2.5 \qquad ( 10 )$$

$$1.85 < NMp < 2.3 \qquad ( 10 - 1 )$$

$$1.9 < NMp < 2.1 \qquad ( 10 - 2 )$$

In a case where an Abbe number based on the d line for the positive lens closest to the image side among the positive lenses in the M lens group is denoted by vMp, the zoom lens preferably satisfies Conditional Expression (11). Ensuring that a corresponding value of Conditional Expression (11) is not less than or equal to its lower limit prevents an excessively small Abbe number and thus, can suppress overcorrection of the chromatic aberration. Ensuring that the corresponding value of Conditional Expression (11) is not greater than or equal to its upper limit prevents an excessively large Abbe number facilitates correction of the chromatic aberration including the axial chromatic aberration caused by zooming. In order to obtain more favorable characteristics, the zoom lens more preferably satisfies Conditional Expression (11-1) and further preferably satisfies Conditional Expression (11-2).

$$10 < vMp < 50 \qquad ( 11 )$$

$$15 < vMp < 41 \qquad ( 11 - 1 )$$

$$17 < vMp < 37 \qquad ( 11 - 2 )$$

The zoom lens preferably satisfies Conditional Expressions (10) and (11). The zoom lens more preferably satisfies Conditional Expressions (10) and (11) and at least one of Conditional Expression (10-1), (10-2), (11-1), or (11-2).

In a case where a focal length of the first lens group G1 is denoted by f1, the zoom lens preferably satisfies Conditional Expression (12). Ensuring that a corresponding value of Conditional Expression (12) is not less than or equal to its lower limit prevents an excessively strong refractive power of the first lens group G1 and thus, eliminates need for disposing a large number of lenses in the first lens group G1 to reduce the distortion and the lateral chromatic aberration and can reduce a diameter of a lens closest to the object side in the first lens group G1. Ensuring that the corresponding value of Conditional Expression (12) is not greater than or equal to its upper limit prevents an excessively weak refractive power of the first lens group G1 and thus, facilitates securing of a suitable focal length of the zoom lens at the wide angle end. In order to obtain more favorable characteristics, the zoom lens more preferably satisfies Conditional Expression (12-1) and further preferably satisfies Conditional Expression (12-2).

$$1 < ( - f 1 ) / fw < 2.5 \qquad ( 12 )$$

$$1.15 < ( - f 1 ) / fw < 2.3 \qquad ( 12 - 1 )$$

$$1.22 < ( - f 1 ) / fw < 2.19 \qquad ( 12 - 2 )$$

In a case where a distance on the optical axis from a lens surface of the first lens group G1 closest to the object side to the lens surface of the first lens group G1 closest to the image side is denoted by DG1, the zoom lens preferably satisfies Conditional Expression (13). For example, FIG. 2 illustrates the distance DG1. Ensuring that a corresponding value of Conditional Expression (13) is not less than or equal to its lower limit increases a space in which a lens can be disposed in the first lens group G1, and thus, achieves an advantage in reducing the distortion and the lateral chromatic aberration. Ensuring that the corresponding value of Conditional Expression (13) is not greater than or equal to its upper limit can reduce a total thickness of the first lens group G1 and thus, can reduce a weight of a lens on the object side in the zoom lens. In order to obtain more favorable characteristics, the zoom lens more preferably satisfies Conditional Expression (13-1) and further preferably satisfies Conditional Expression (13-2).

$$0.71 < DG 1 / ( fw \times tan ω w ) < 2.5 \qquad ( 13 )$$

$$0.8 < DG 1 / ( fw \times tan ω w ) < 2.2 \qquad ( 13 - 1 )$$

$$0.97 < DG 1 / ( fw \times tan ω w ) < 1.94 \qquad ( 13 - 2 )$$

In a case where a distance on the optical axis from a lens surface of the P lens group closest to the object side to a lens surface of the P lens group closest to the image side is denoted by DGP, the zoom lens preferably satisfies Conditional Expression (14). For example, FIG. 2 illustrates the distance DGP in a case where the second lens group G2 corresponds to the P lens group. Ensuring that a corresponding value of Conditional Expression (14) is not less than or equal to its lower limit increases a space in which a lens can be disposed in the P lens group, and thus, achieves an advantage in suppressing fluctuation of the axial chromatic aberration and the spherical aberration during zooming. Ensuring that the corresponding value of Conditional Expression (14) is not greater than or equal to its upper limit can reduce a total thickness of the P lens group and thus, can achieve a high zoom ratio and a large diameter while reducing a weight of the lens. In order to obtain more favorable characteristics, the zoom lens more preferably satisfies Conditional Expression (14-1) and further preferably satisfies Conditional Expression (14-2).

$$0.35 < DGP / ( fw \times tan ω w ) < 2.5 \qquad ( 14 )$$

$$0.8 < DGP / ( fw \times tan ω w ) < 2.1 \qquad ( 14 - 1 )$$

$$1.4 < DGP / ( fw \times tan ω w ) < 1.9 \qquad ( 14 - 2 )$$

In a case where a distance on the optical axis from the lens surface of the first lens group G1 closest to the object side to a paraxial entrance pupil position Penw in the state where the infinite distance object is in focus at the wide angle end is denoted by Denw, the zoom lens preferably satisfies Conditional Expression (15). For example, FIG. 2 illustrates the distance Denw and the paraxial entrance pupil position Penw. Ensuring that a corresponding value of Conditional Expression (15) is not less than or equal to its lower limit can suitably separate the on-axis luminous flux wa and the off-axis luminous flux passing through the first lens group G1 from each other and thus, achieves an advantage in correcting the lateral chromatic aberration. Ensuring that the corresponding value of Conditional Expression (15) is not greater than or equal to its upper limit positions the paraxial entrance pupil position Penw closer to the object side and thus, can reduce a height, from the optical axis Z, of the off-axis ray passing through the first lens group G1. This achieves an advantage in diameter reduction and weight reduction. In order to obtain more favorable characteristics, the zoom lens more preferably satisfies Conditional Expression (15-1) and further preferably satisfies Conditional Expression (15-2).

$$1 < Denw / fw < 2.2 \qquad ( 15 )$$

$$1.2 < Denw / fw < 1.9 \qquad ( 15 - 1 )$$

$$1.28 < Denw / fw < 1.82 \qquad ( 15 - 2 )$$

In a case where an average specific gravity of all lenses of the first lens group G1 is denoted by G1ave, the zoom lens preferably satisfies Conditional Expression (16). Ensuring that a corresponding value of Conditional Expression (16) is not less than or equal to its lower limit enables selection of a high-refractive index material and a small-Abbe number material having a relatively high relative density and thus, achieves an advantage in correcting the lateral chromatic aberration in the first lens group G1. Ensuring that the corresponding value of Conditional Expression (16) is not greater than or equal to its upper limit can reduce a weight of the first lens group G1 and thus, can position a centroid of an optical system closer to the image side. In order to obtain more favorable characteristics, the zoom lens more preferably satisfies Conditional Expression (16-1) and further preferably satisfies Conditional Expression (16-2).

$$1 < G 1 ave < 5 \qquad ( 16 )$$

$$2.4 < G 1 ave < 4.5 \qquad ( 16 - 1 )$$

$$3 < G 1 ave < 4.15 \qquad ( 16 - 2 )$$

In a case where an average specific gravity of all lenses of the P lens group is denoted by GPave, the zoom lens preferably satisfies Conditional Expression (17). Ensuring that a corresponding value of Conditional Expression (17) is not less than or equal to its lower limit enables selection of a high-refractive index material and a small-Abbe number material having a relatively high relative density and thus, achieves an advantage in correcting the axial chromatic aberration in the P lens group. Ensuring that the corresponding value of Conditional Expression (17) is not greater than or equal to its upper limit can reduce a weight of the P lens group and thus, achieves an advantage in suppressing movement of the centroid during zooming.

In order to obtain more favorable characteristics, the zoom lens more preferably satisfies Conditional Expression (17-1) and further preferably satisfies Conditional Expression (17-2).

$$1 < GPave < 5 \qquad ( 17 )$$

$$2.4 < GPave < 4.5 \qquad ( 17 - 1 )$$

$$3 < GPave < 4.3 \qquad ( 17 - 2 )$$

The zoom lens preferably satisfies Conditional Expression (18). An average specific gravity of all lenses of the focus group is denoted by Gfave. A distance on the optical axis from a lens surface of the focus group closest to the object side to a lens surface of the focus group closest to the image side is denoted by DGfoc. A focal length of the focus group is denoted by ffoc. For example, FIG. 2 illustrates the distance DGfoc. Ensuring that a corresponding value of Conditional Expression (18) is not less than or equal to its lower limit can increase a refractive power of the focus group and thus, can reduce a moving amount of the focus group during focusing. This achieves an advantage in reduction of the total length of the lens system. Ensuring that the corresponding value of Conditional Expression (18) is not greater than or equal to its upper limit can reduce a weight of the focus group and thus, achieves an advantage in achieving high-speed and quiet autofocus. In order to obtain more favorable characteristics, the zoom lens more preferably satisfies Conditional Expression (18-1) and further preferably satisfies Conditional Expression (18-2).

$$0.03 < Gfave \times DGfoc / \vert ffoc \vert < 0.9 \qquad ( 18 )$$

$$0.04 < Gfave \times DGfoc / \vert ffoc \vert < 0.52 \qquad ( 18 - 1 )$$

$$0.045 < Gfave \times DGfoc / \vert ffoc \vert < 0.15 \qquad ( 18 - 2 )$$

The zoom lens preferably satisfies Conditional Expression (19). Ensuring that a corresponding value of Conditional Expression (19) is not less than or equal to its lower limit achieves an advantage in suppressing fluctuation of the spherical aberration during zooming. Ensuring that the corresponding value of Conditional Expression (19) is not greater than or equal to its upper limit achieves an advantage in suppressing fluctuation of the distortion during zooming. In order to obtain more favorable characteristics, the zoom lens more preferably satisfies Conditional Expression (19-1) and further preferably satisfies Conditional Expression (19-2).

$$0.3 < ( - f 1 ) / fP < 1.5 \qquad ( 19 )$$

$$0.35 < ( - f 1 ) / fP < 1.31 \qquad ( 19 - 1 )$$

$$0.48 < ( - f 1 ) / fP < 1.07 \qquad ( 19 - 2 )$$

The zoom lens preferably satisfies Conditional Expression (20). Ensuring that a corresponding value of Conditional Expression (20) is not less than or equal to its lower limit can increase a refractive power of the M lens group while reducing the refractive power of the first lens group G1 and thus, can suppress the sensitivity of the P lens group to error between the first lens group G1 and the M lens group. This can contribute to implementation of the zoom lens having favorable optical performance. Ensuring that the corresponding value of Conditional Expression (20) is not greater than or equal to its upper limit can increase the refractive power of the first lens group G1 while reducing the refractive power of the M lens group and thus, can strengthen the zooming action of the P lens group between the first lens group G1 and the M lens group. This facilitates securing of the desired zoom ratio. In order to obtain more favorable characteristics, the zoom lens more preferably satisfies Conditional Expression (20-1) and further preferably satisfies Conditional Expression (20-2).

$$0 < ( - f 1 ) / fM < 0.7 \qquad ( 20 )$$

$$0.05 < ( - f 1 ) / fM < 0.6 \qquad ( 20 - 1 )$$

$$0.2 < ( - f 1 ) / fM < 0.7 \qquad ( 20 - 2 )$$

The zoom lens preferably satisfies Conditional Expression (21). Conditional Expression (21) is an expression defining a balance between the refractive power of the P lens group and the refractive power of the M lens group. Ensuring that a corresponding value of Conditional Expression (21) is not less than or equal to its lower limit can reduce the refractive power of the P lens group and thus, can suppress the sensitivity of the P lens group to error. This can contribute to implementation of the zoom lens having favorable optical performance.

Ensuring that the corresponding value of Conditional Expression (21) is not greater than or equal to its upper limit can reduce the refractive power of the M lens group and thus, can suppress sensitivity of the M lens group to error. This can contribute to implementation of the zoom lens having favorable optical performance. In order to obtain more favorable characteristics, the zoom lens more preferably satisfies Conditional Expression (21-1) and further preferably satisfies Conditional Expression (21-2).

$$0 < fP / fM < 2 \qquad ( 21 )$$

$$0.05 < fP / fM < 1.2 \qquad ( 21 - 1 )$$

$$2 < fP / fM < 0.59 \qquad ( 21 - 2 )$$

The zoom lens preferably satisfies Conditional Expression (22). Ensuring that a corresponding value of Conditional Expression (22) is not less than or equal to its lower limit can reduce the refractive power of the focus group and thus, can suppress fluctuation of the aberrations during focusing. Ensuring that the corresponding value of Conditional Expression (22) is not greater than or equal to its upper limit can increase the refractive power of the focus group and thus, can reduce the moving amount of the focus group during focusing. This achieves an advantage in reduction of the total length of the lens system. In order to obtain more favorable characteristics, the zoom lens more preferably satisfies Conditional Expression (22-1) and further preferably satisfies Conditional Expression (22-2).

$$1.2 < ( - ffoc ) / ( fw \times tan ω w ) < 5.5 \qquad ( 22 )$$

$$1.4 < ( - ffoc ) / ( fw \times tan ω w ) < 5 \qquad ( 22 - 1 )$$

$$1.7 < ( - ffoc ) / ( fw \times tan ω w ) < 4.7 \qquad ( 22 - 2 )$$

The first lens group G1 preferably includes at least one aspherical lens satisfying Conditional Expression (23). A paraxial curvature radius of a surface, on the object side, of the aspherical lens of the first lens group G1 is denoted by Rc1f. A paraxial curvature radius of a surface, on the image side, of the aspherical lens of the first lens group G1 is denoted by Rc1r. A curvature radius of the surface, on the object side, of the aspherical lens of the first lens group G1 at a position of a maximum effective diameter is denoted by Ry1f. A curvature radius of the surface, on the image side, of the aspherical lens of the first lens group G1 at the position of the maximum effective diameter is denoted by Ry1r. Ensuring that a corresponding value of Conditional Expression (23) is not less than or equal to its lower limit reduces a refractive power on an edge part side of the lens and thus, achieves an advantage in correcting the distortion. Ensuring that the corresponding value of Conditional Expression (23) is not greater than or equal to its upper limit increases the refractive power on the edge part side of the lens and thus, achieves an advantage in suppressing the astigmatism of the off-axis ray generated on the edge part side of the lens. Disposing the aspherical lens satisfying Conditional Expression (23) at a position of the first lens group G1 in which the on-axis ray and the off-axis ray are separated from each other achieves an advantage in correcting the distortion and the astigmatism. In order to obtain more favorable characteristics, the at least one aspherical lens of the first lens group G1 more preferably satisfies Conditional Expression (23-1) and further preferably satisfies Conditional Expression (23-2).

$$1.05 < ( 1 / Rc 1 f - 1 / Rc 1 r ) / ( 1 / Ry 1 f - 1 / Ry 1 r ) < 8 \qquad ( 23 )$$

$$1.1 < ( 1 / Rc 1 f - 1 / Rc 1 r ) / ( 1 / Ry 1 f - 1 / Ry 1 r ) < 6 \qquad ( 23 - 1 )$$

$$1.15 < ( 1 / Rc 1 f - 1 / Rc 1 r ) / ( 1 / Ry 1 f - 1 / Ry 1 r ) < 4.7 \qquad ( 23 - 2 )$$

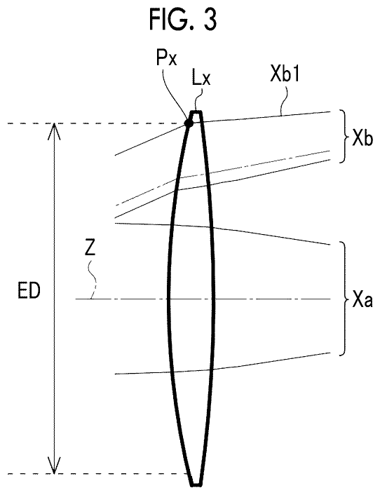

FIG. 3 illustrates an example of a position Px of the maximum effective diameter as a diagram for description. In FIG. 3, a left side is the object side, and a right side is the image side. FIG. 3 illustrates an on-axis luminous flux Xa and an off-axis luminous flux Xb passing through a lens Lx. In the example in FIG. 3, a ray Xb1 that is an upper ray of the off-axis luminous flux Xb is a ray passing through a most outer side. In the present specification, twice a distance from an intersection between the ray passing through the most outer side and a lens surface to the optical axis Z among rays that are incident on the lens surface from the object side and that exit to the image side will be referred to as an “effective diameter” of the lens surface. The term “outer side” means an outer side in a diameter direction centered on the optical axis Z, that is, a side away from the optical axis Z. In the example in FIG. 3, twice a distance from an intersection between a surface of the lens Lx on the object side and the ray Xb1 to the optical axis Z is an effective diameter ED of the surface of the lens Lx on the object side.

A position of the intersection between the ray passing through the most outer side and the lens surface is the position Px of the maximum effective diameter. While the upper ray of the off-axis luminous flux Xb is the ray passing through the most outer side in the example in FIG. 3, which ray is the ray passing through the most outer side varies depending on the optical system. The ray passing through the most outer side is determined by considering the entire magnification range.

The P lens group preferably includes at least one aspherical lens satisfying Conditional Expression (24). A paraxial curvature radius of a surface, on the object side, of the aspherical lens of the P lens group is denoted by RcPf. A curvature radius of the surface, on the object side, of the aspherical lens of the P lens group at the position of the maximum effective diameter is denoted by RyPf. A refractive index with respect to a d line for the aspherical lens of the P lens group is denoted by NP. Ensuring that a corresponding value of Conditional Expression (24) is not less than or equal to its lower limit enables the refractive power on the edge part side of the surface, on the object side, of the aspherical lens of the P lens group to change to a negative side and thus, achieves an advantage in suppressing fluctuation of the spherical aberration during zooming. Ensuring that the corresponding value of Conditional Expression (24) is not greater than or equal to its upper limit can suppress changing of the refractive power on the edge part side of the surface, on the object side, of the aspherical lens of the P lens group to the negative side and thus, achieves an advantage in suppressing the sensitivity of the P lens group to error. Disposing the aspherical lens satisfying Conditional Expression (24) in the P lens group performing the zooming action achieves an advantage in suppressing fluctuation of the spherical aberration during zooming while reducing the sensitivity of the P lens group to error. In order to obtain more favorable characteristics, the at least one aspherical lens of the P lens group more preferably satisfies Conditional Expression (24-1) and further preferably satisfies Conditional Expression (24-2).

$$0.01 < ( 1 / RcPf - 1 / RyPf ) \times NP \times fP < 5 \qquad ( 24 )$$

$$0.075 < ( 1 / RcPf - 1 / RyPf ) \times NP \times fP < 2.5 \qquad ( 24 - 1 )$$

$$0.2 < ( 1 / RcPf - 1 / RyPf ) \times NP \times fP < 1.3 \qquad ( 24 - 2 )$$

The N lens group preferably includes at least one aspherical lens satisfying Conditional Expression (25). A paraxial curvature radius of a surface, on the object side, of the aspherical lens of the N lens group is denoted by RcNf. A paraxial curvature radius of a surface, on the image side, of the aspherical lens of the N lens group is denoted by RcNr. A curvature radius of the surface, on the object side, of the aspherical lens of the N lens group at the position of the maximum effective diameter is denoted by RyNf. A curvature radius of the surface, on the image side, of the aspherical lens of the N lens group at the position of the maximum effective diameter is denoted by RyNr. Ensuring that a corresponding value of Conditional Expression (25) is not less than or equal to its lower limit reduces the refractive power on the edge part side of the lens and thus, achieves an advantage in suppressing sensitivity of the N lens group to error. Ensuring that the corresponding value of Conditional Expression (25) is not greater than or equal to its upper limit reduces a difference between the refractive power on the edge part side of the lens and a refractive power near the optical axis of the lens and thus, achieves an advantage in suppressing fluctuation of the astigmatism during zooming. Disposing the aspherical lens satisfying Conditional Expression (25) in the N lens group achieves an advantage in suppressing fluctuation of the astigmatism during zooming while reducing the sensitivity of the N lens group to error. In order to obtain more favorable characteristics, the at least one aspherical lens of the N lens group more preferably satisfies Conditional Expression (25-1) and further preferably satisfies Conditional Expression (25-2).

$$0.7 < ( 1 / RcNf - 1 / RcNr ) / ( 1 / RyNf - 1 / RyNr ) < 0.996 \qquad ( 25 )$$

$$0.8 < ( 1 / RcNf - 1 / RcNr ) / ( 1 / RyNf - 1 / RyNr ) < 0.99 \qquad ( 25 - 1 )$$

$$0.85 < ( 1 / RcNf - 1 / RcNr ) / ( 1 / RyNf - 1 / RyNr ) < 0.98 \qquad ( 25 - 2 )$$

The final lens group preferably includes at least one aspherical lens satisfying Conditional Expression (26). A paraxial curvature radius of a surface, on the object side, of the aspherical lens of the final lens group is denoted by RcEf. A paraxial curvature radius of a surface, on the image side, of the aspherical lens of the final lens group is denoted by RcEr. A curvature radius of the surface, on the object side, of the aspherical lens of the final lens group at the position of the maximum effective diameter is denoted by RyEf. A curvature radius of the surface, on the image side, of the aspherical lens of the final lens group at the position of the maximum effective diameter is denoted by RyEr.

Ensuring that a corresponding value of Conditional Expression (26) is not less than or equal to its lower limit reduces the refractive power on the edge part side of the lens below the refractive power near the optical axis of the lens and thus, achieves an advantage in correcting the field curvature. Ensuring that the corresponding value of Conditional Expression (26) is not greater than or equal to its upper limit increases the refractive power on the edge part side of the lens and thus, can suppress overcorrection of the field curvature. Disposing the aspherical lens satisfying Conditional Expression (26) in the final lens group achieves an advantage in correcting the field curvature. In order to obtain more favorable characteristics, the at least one aspherical lens of the final lens group more preferably satisfies Conditional Expression (26-1) and further preferably satisfies Conditional Expression (26-2).

$$1.01 < ( 1 / RcEf - 1 / RcEr ) / ( 1 / RyEf - 1 / RyEr ) < 2 \qquad ( 26 )$$

$$1.05 < ( 1 / RcEf - 1 / RcEr ) / ( 1 / RyEf - 1 / RyEr ) < 1.5 \qquad ( 26 - 1 )$$

$$1.15 < ( 1 / RcEf - 1 / RcEr ) / ( 1 / RyEf - 1 / RyEr ) < 1.3 \qquad ( 26 - 2 )$$

The first lens group G1 preferably includes at least one negative lens satisfying Conditional Expression (27). An Abbe number based on a d line for the negative lens of the first lens group G1 is denoted by ν1n. Ensuring that a corresponding value of Conditional Expression (27) is not less than or equal to its lower limit achieves an advantage in correcting the lateral chromatic aberration. Ensuring that the corresponding value of Conditional Expression (27) is not greater than or equal to its upper limit can suppress overcorrection of the lateral chromatic aberration. In order to obtain more favorable characteristics, the at least one negative lens of the first lens group G1 more preferably satisfies Conditional Expression (27-1) and further preferably satisfies Conditional Expression (27-2).

$$55 < v 1 n < 110 \qquad ( 27 )$$

$$57 < v 1 n < 95 \qquad ( 27 - 1 )$$

$$60 < v 1 n < 85 \qquad ( 27 - 2 )$$

The first lens group G1 preferably includes at least one negative lens satisfying Conditional Expression (28). A partial dispersion ratio between a g line and an F line for the negative lens of the first lens group G1 is denoted by θgF1n. Ensuring that a corresponding value of Conditional Expression (28) is not less than or equal to its lower limit achieves an advantage in correcting a secondary lateral chromatic aberration. Ensuring that the corresponding value of Conditional Expression (28) is not greater than or equal to its upper limit can suppress overcorrection of the secondary lateral chromatic aberration. In order to obtain more favorable characteristics, the at least one negative lens of the first lens group G1 more preferably satisfies Conditional Expression (28-1) and further preferably satisfies Conditional Expression (28-2).

$$0.003 < θ gF 1 n - ( 06 \; 438 - 0.001682 \times v 1 n ) < 0 \text{.05} \qquad ( 28 )$$

$$0.005 < θ gF 1 n - ( 06 \; 438 - 0.001682 \times v 1 n ) < 0 \text{.04} \qquad ( 28 - 1 )$$

$$0.015 < θ gF 1 n - ( 06 \; 438 - 0.001682 \times v 1 n ) < 0.0 \; 33 \qquad ( 28 - 2 )$$

In a case where refractive indices with respect to a g line, an F line, and a C line for a lens are denoted by Ng, NF, and NC, respectively, and a partial dispersion ratio between the g line and the F line for the lens is denoted by θgF, θgF is defined by the following expression.

$$θ gF = ( Ng - NF ) / ( NF - NC )$$

The at least one negative lens of the first lens group G1 preferably satisfies Conditional Expressions (27) and (28). The at least one negative lens of the first lens group G1 more preferably satisfies Conditional Expressions (27) and (28) and at least one of Conditional Expression (27-1), (27-2), (28-1), or (28-2).

The P lens group preferably includes at least one negative lens satisfying Conditional Expression (29). An Abbe number based on a d line for the negative lens of the P lens group is denoted by νPn. Ensuring that a corresponding value of Conditional Expression (29) is not less than or equal to its lower limit achieves an advantage in correcting the axial chromatic aberration. Ensuring that the corresponding value of Conditional Expression (29) is not greater than or equal to its upper limit can suppress overcorrection of the axial chromatic aberration. In order to obtain more favorable characteristics, the at least one negative lens of the P lens group more preferably satisfies Conditional Expression (29-1) and further preferably satisfies Conditional Expression (29-2).

$$55 < vPn < 110 \qquad ( 29 )$$

$$57 < vPn < 95 \qquad ( 29 - 1 )$$

$$60 < vPn < 85 \qquad ( 29 - 2 )$$

The P lens group preferably includes at least one negative lens satisfying Conditional Expression (30). A partial dispersion ratio between a g line and an F line for the negative lens of the P lens group is denoted by θgFPn. Ensuring that a corresponding value of Conditional Expression (30) is not less than or equal to its lower limit achieves an advantage in correcting a secondary axial chromatic aberration. Ensuring that the corresponding value of Conditional Expression (30) is not greater than or equal to its upper limit can suppress overcorrection of the secondary axial chromatic aberration. In order to obtain more favorable characteristics, the at least one negative lens of the P lens group more preferably satisfies Conditional Expression (30-1) and further preferably satisfies Conditional Expression (30-2).

$$0.003 < θ gFPn - ( 0.6438 - 0.001682 \times vPn ) < 0 \text{.05} \qquad ( 30 )$$

$$0.005 < θ gFPn - ( 0.6438 - 0.001682 \times vPn ) < 0 \text{.04} \qquad ( 30 - 1 )$$

$$0.015 < θ gFPn - ( 0.6438 - 0.001682 \times vPn ) < 0.0 \; 33 \qquad ( 30 - 2 )$$

The at least one negative lens of the P lens group preferably satisfies Conditional Expressions (29) and (30). The at least one negative lens of the P lens group more preferably satisfies Conditional Expressions (29) and (30) and at least one of Conditional Expression (29-1), (29-2), (30-1), or (30-2).

The N lens group preferably includes at least one negative lens satisfying Conditional Expression (31). An Abbe number based on a d line for the negative lens of the N lens group is denoted by νNn. Ensuring that a corresponding value of Conditional Expression (31) is not less than or equal to its lower limit achieves an advantage in correcting the lateral chromatic aberration. Ensuring that the corresponding value of Conditional Expression (31) is not greater than or equal to its upper limit can suppress overcorrection of the lateral chromatic aberration. In order to obtain more favorable characteristics, the at least one negative lens of the N lens group more preferably satisfies Conditional Expression (31-1) and further preferably satisfies Conditional Expression (31-2).

$$55 < vNn < 110 \qquad ( 31 )$$

$$57 < vNn < 95 \qquad ( 31 - 1 )$$

$$60 < vNn < 85 \qquad ( 31 - 2 )$$

The N lens group preferably includes at least one negative lens satisfying Conditional Expression (32). A partial dispersion ratio between a g line and an F line for the negative lens of the N lens group is denoted by θgFNn. Ensuring that a corresponding value of Conditional Expression (32) is not less than or equal to its lower limit achieves an advantage in correcting the secondary lateral chromatic aberration. Ensuring that the corresponding value of Conditional Expression (32) is not greater than or equal to its upper limit can suppress overcorrection of the secondary lateral chromatic aberration. In order to obtain more favorable characteristics, the at least one negative lens of the N lens group more preferably satisfies Conditional Expression (32-1) and further preferably satisfies Conditional Expression (32-2).

$$0.003 < θ gFNn - ( 0.6438 - 0.001682 \times vNn ) < 0 \text{.05} \qquad ( 32 )$$

$$0.005 < θ gFNn - ( 0.6438 - 0.001682 \times vNn ) < 0 \text{.04} \qquad ( 32 - 1 )$$

$$0.015 < θ gFNn - ( 0.6438 - 0.001682 \times vNn ) < 0.0 \; 33 \qquad ( 32 - 2 )$$

The at least one negative lens of the N lens group preferably satisfies Conditional Expressions (31) and (32). The at least one negative lens of the N lens group more preferably satisfies Conditional Expressions (31) and (32) and at least one of Conditional Expression (31-1), (31-2), (32-1), or (32-2).

The M lens group preferably includes at least one negative lens satisfying Conditional Expression (33). An Abbe number based on a d line for the negative lens of the M lens group is denoted by νMn. Ensuring that a corresponding value of Conditional Expression (33) is not less than or equal to its lower limit achieves an advantage in correcting the axial chromatic aberration. Ensuring that the corresponding value of Conditional Expression (33) is not greater than or equal to its upper limit can suppress overcorrection of the axial chromatic aberration. In order to obtain more favorable characteristics, the at least one negative lens of the M lens group more preferably satisfies Conditional Expression (33-1) and further preferably satisfies Conditional Expression (33-2).

$$55 < vMn < 110 \qquad ( 33 )$$

$$57 < vMn < 95 \qquad ( 33 - 1 )$$

$$60 < vMn < 91 \qquad ( 33 - 2 )$$

The M lens group preferably includes at least one negative lens satisfying Conditional Expression (34). A partial dispersion ratio between a g line and an F line for the negative lens of the M lens group is denoted by θgFMn. Ensuring that a corresponding value of Conditional Expression (34) is not less than or equal to its lower limit achieves an advantage in correcting the secondary axial chromatic aberration. Ensuring that the corresponding value of Conditional Expression (34) is not greater than or equal to its upper limit can suppress overcorrection of the secondary axial chromatic aberration. In order to obtain more favorable characteristics, the at least one negative lens of the M lens group more preferably satisfies Conditional Expression (34-1) and further preferably satisfies Conditional Expression (34-2).

$$0.003 < θ gFMn - ( 0.6 \; 438 - 0.001682 \times ν Mn ) < 0 \text{.06} \qquad ( 34 )$$

$$0.005 < θ gFMn - ( 0.6 \; 438 - 0.001682 \times ν Mn ) < 0 \text{.05} \qquad ( 34 - 1 )$$

$$0.015 < θ gFMn - ( 0.6438 - 0.001682 \times ν Mn ) < 0 \text{.045} \qquad ( 34 - 2 )$$

The at least one negative lens of the M lens group preferably satisfies Conditional Expressions (33) and (34). The at least one negative lens of the M lens group more preferably satisfies Conditional Expressions (33) and (34) and at least one of Conditional Expression (33-1), (33-2), (34-1), or (34-2).

The final lens group preferably includes at least one positive lens satisfying Conditional Expression (35). An Abbe number based on a d line for the positive lens of the final lens group is denoted by νEp. Ensuring that a corresponding value of Conditional Expression (35) is not less than or equal to its lower limit achieves an advantage in correcting the lateral chromatic aberration. Ensuring that the corresponding value of Conditional Expression (35) is not greater than or equal to its upper limit can suppress overcorrection of the lateral chromatic aberration. In order to obtain more favorable characteristics, the at least one positive lens of the final lens group more preferably satisfies Conditional Expression (35-1) and further preferably satisfies Conditional Expression (35-2).

$$55 < ν Ep < 110 \qquad ( 35 )$$

$$57 < ν Ep < 95 \qquad ( 35 - 1 )$$

$$60 < ν Ep < 85 \qquad ( 35 - 2 )$$

The final lens group preferably includes at least one positive lens satisfying Conditional Expression (36). A partial dispersion ratio between a g line and an F line for the positive lens of the final lens group is denoted by θgFEp. Ensuring that a corresponding value of Conditional Expression (36) is not less than or equal to its lower limit achieves an advantage in correcting the secondary lateral chromatic aberration. Ensuring that the corresponding value of Conditional Expression (36) is not greater than or equal to its upper limit can suppress overcorrection of the secondary lateral chromatic aberration. In order to obtain more favorable characteristics, the at least one positive lens of the final lens group more preferably satisfies Conditional Expression (36-1) and further preferably satisfies Conditional Expression (36-2).

$$0.003 < θ gFEp - ( 0.6438 - 0.001682 \times ν Ep ) < 0 \text{.05} \qquad ( 36 )$$

$$0.005 < θ gFEp - ( 0.6 \; 438 - 0.001682 \times ν Ep ) < 0 \text{.04} \qquad ( 36 - 1 )$$

$$0.015 < θ gFEp - ( 0.6 \; 438 - 0.001682 \times ν Ep ) < 0 \text{.033} \qquad ( 36 - 2 )$$

The at least one positive lens of the final lens group preferably satisfies Conditional Expressions (35) and (36). The at least one positive lens of the final lens group more preferably satisfies Conditional Expressions (35) and (36) and at least one of Conditional Expression (35-1), (35-2), (36-1), or (36-2).

The first lens group G1 preferably includes at least one positive lens satisfying Conditional Expression (37). A refractive index with respect to a d line for the positive lens of the first lens group G1 is denoted by N1p. Ensuring that a corresponding value of Conditional Expression (37) is not less than or equal to its lower limit achieves an advantage in correcting the field curvature. Ensuring that the corresponding value of Conditional Expression (37) is not greater than or equal to its upper limit can suppress overcorrection of the field curvature. In order to obtain more favorable characteristics, the at least one positive lens of the first lens group G1 more preferably satisfies Conditional Expression (37-1) and further preferably satisfies Conditional Expression (37-2).

$$1.8 < N 1 p < 2.3 \qquad ( 37 )$$

$$1.89 < N 1 p < 2.2 \qquad ( 37 - 1 )$$

$$1.92 < N 1 p < 2.15 \qquad ( 37 - 2 )$$

The first lens group G1 preferably includes at least one positive lens satisfying Conditional Expression (38). An Abbe number based on a d line for the positive lens of the first lens group G1 is denoted by ν1p. Ensuring that a corresponding value of Conditional Expression (38) is not less than or equal to its lower limit achieves an advantage in correcting the lateral chromatic aberration. Ensuring that the corresponding value of Conditional Expression (38) is not greater than or equal to its upper limit can suppress overcorrection of the lateral chromatic aberration. In order to obtain more favorable characteristics, the at least one positive lens of the first lens group G1 more preferably satisfies Conditional Expression (38-1) and further preferably satisfies Conditional Expression (38-2).

$$10 < ν 1 p < 45 \qquad ( 38 )$$

$$13 < ν 1 p < 35 \qquad ( 38 - 1 )$$

$$16 < ν 1 p < 25 \qquad ( 38 - 2 )$$

The at least one positive lens of the first lens group G1 preferably satisfies Conditional Expressions (37) and (38). The at least one positive lens of the first lens group G1 more preferably satisfies Conditional Expressions (37) and (38) and at least one of Conditional Expression (37-1), (37-2), (38-1), or (38-2).

The subsequent group GR preferably includes the aperture stop St, and at least one negative lens having a concave surface facing the object side is preferably disposed at a position where the at least one negative lens is on the image side with respect to the aperture stop St and satisfies Conditional Expression (39). A distance on the optical axis between the aperture stop St in the state where the infinite distance object is in focus at the wide angle end and the negative lens having the concave surface facing the object side is denoted by DSInw. A sum of a distance on the optical axis from the lens surface of the first lens group G1 closest to the object side to a lens surface of the subsequent group GR closest to the image side and the back focus of the entire system as the air conversion distance in the state where the infinite distance object is in focus at the wide angle end is denoted by TLw. For example, FIG. 2 illustrates the distance DSInw. Ensuring that a corresponding value of Conditional Expression (39) is not less than or equal to its lower limit achieves an advantage in securing a space for disposing a stop mechanism. Ensuring that the corresponding value of Conditional Expression (39) is not greater than or equal to its upper limit enables the negative lens having the concave surface facing the object side to be disposed at a position close to the aperture stop St and thus, achieves an advantage in correcting the spherical aberration and the axial chromatic aberration. In order to obtain more favorable characteristics, the zoom lens more preferably satisfies Conditional Expression (39-1) and further preferably satisfies Conditional Expression (39-2).

$$0.001 < DSInw / TLw < 0 \text{.12} \qquad ( 39 )$$

$$0.005 < DSInw / TLw < 0.0 \; 85 \qquad ( 39 - 1 )$$

$$0.01 < DSInw / TLw < 0.0 \; 75 \qquad ( 39 - 2 )$$

The subsequent group GR preferably includes the aperture stop St, and at least one negative lens having a concave surface facing the image side is preferably disposed at a position where the at least one negative lens is on the object side with respect to the aperture stop St and satisfies Conditional Expression (40). A distance on the optical axis between the aperture stop St in the state where the infinite distance object is in focus at the wide angle end and the negative lens having the concave surface facing the image side is denoted by DSOnw. For example, FIG. 2 illustrates the distance DSOnw. Ensuring that a corresponding value of Conditional Expression (40) is not less than or equal to its lower limit achieves an advantage in securing the space for disposing the stop mechanism. Ensuring that the corresponding value of Conditional Expression (40) is not greater than or equal to its upper limit enables the negative lens having the concave surface facing the image side to be disposed at a position close to the aperture stop St and thus, achieves an advantage in correcting the spherical aberration and the axial chromatic aberration. In order to obtain more favorable characteristics, the zoom lens more preferably satisfies Conditional Expression (40-1) and further preferably satisfies Conditional Expression (40-2).

$$0.001 < DSOnw / TLw < 0 \text{.18} \qquad ( 40 )$$

$$0.01 < DSOnw / TLw < 0.0 \; 85 \qquad ( 40 - 1 )$$

$$0.03 < DSOnw / TLw < 0.0 \; 75 \qquad ( 40 - 2 )$$

The subsequent group GR preferably includes the aperture stop St, at least one cemented lens is preferably disposed on the image side with respect to the aperture stop St, and the cemented lens preferably satisfies Conditional Expression (41). A distance on the optical axis between the aperture stop St and a bonding surface of the cemented lens on the image side with respect to the aperture stop St in the state where the infinite distance object is in focus at the wide angle end is denoted by DSIcew. In a case where the cemented lens has a plurality of bonding surfaces, at least one bonding surface preferably satisfies Conditional Expression (41). Ensuring that a corresponding value of Conditional Expression (41) is not less than or equal to its lower limit achieves an advantage in securing the space for disposing the stop mechanism. Ensuring that the corresponding value of Conditional Expression (41) is not greater than or equal to its upper limit enables the bonding surface to be disposed at a position close to the aperture stop St and thus, achieves an advantage in correcting the spherical aberration and the axial chromatic aberration. In order to obtain more favorable characteristics, the zoom lens more preferably satisfies Conditional Expression (41-1) and further preferably satisfies Conditional Expression (41-2).

$$0.001 < DSIcew / TLw < 0 \text{.12} \qquad ( 41 )$$

$$0.005 < DSIcew / TLw < 0.0 \; 85 \qquad ( 41 - 1 )$$

$$0.01 < DSIcew / TLw < 0 \text{.075} \qquad ( 41 - 2 )$$

The subsequent group GR preferably includes the aperture stop St, at least one cemented lens is preferably disposed on the object side with respect to the aperture stop St, and the cemented lens preferably satisfies Conditional Expression (42).

A distance on the optical axis between the aperture stop St and a bonding surface of the cemented lens on the object side with respect to the aperture stop St in the state where the infinite distance object is in focus at the wide angle end is denoted by DSOcew. In a case where the cemented lens has a plurality of bonding surfaces, at least one bonding surface preferably satisfies Conditional Expression (42). Ensuring that a corresponding value of Conditional Expression (42) is not less than or equal to its lower limit achieves an advantage in securing the space for disposing the stop mechanism. Ensuring that the corresponding value of Conditional Expression (42) is not greater than or equal to its upper limit enables the bonding surface to be disposed at a position close to the aperture stop St and thus, achieves an advantage in correcting the spherical aberration and the axial chromatic aberration. In order to obtain more favorable characteristics, the zoom lens more preferably satisfies Conditional Expression (42-1) and further preferably satisfies Conditional Expression (42-2).

$$0.001 < DSOcew / TLw < 0.18 \qquad ( 42 )$$

$$0.01 < DSOcew / TLw < 0.085 \qquad ( 42 - 1 )$$

$$0.03 < DSOcew / TLw < 0.075 \qquad ( 42 - 2 )$$

The zoom lens preferably satisfies Conditional Expression (43). The moving amount of the N lens group during zooming from the wide angle end to the telephoto end is denoted by AN. The moving amount of the P lens group during zooming from the wide angle end to the telephoto end is denoted by AP. A sign of each moving amount during zooming is negative for movement to the object side and is positive for movement to the image side. For example, FIG. 2 illustrates the moving amount ΔN in a case where the fourth lens group G4 corresponds to the N lens group. Ensuring that a corresponding value of Conditional Expression (43) is not less than or equal to its lower limit causes the N lens group to move at a position close to the P lens group near the telephoto end and thus, achieves an advantage in suppressing fluctuation of the spherical aberration near the telephoto end. Ensuring that the corresponding value of Conditional Expression (43) is not greater than or equal to its upper limit causes the N lens group to move at a position away from the P lens group near the telephoto end and thus, achieves an advantage in suppressing fluctuation of the field curvature near the telephoto end. In order to obtain more favorable characteristics, the zoom lens more preferably satisfies Conditional Expression (43-1) and further preferably satisfies Conditional Expression (43-2).

$$0.1 < Δ N / Δ P < 0 \text{.75} \qquad ( 43 )$$

$$0.13 < Δ N / Δ P < 0.5 \qquad ( 43 - 1 )$$

$$0.25 < Δ N / Δ P < 0 \text{.37} \qquad ( 43 - 2 )$$

The zoom lens preferably satisfies Conditional Expression (44). A sum of a distance on the optical axis from a paraxial exit pupil position Pexw to the lens surface of the subsequent group GR closest to the image side and the back focus of the entire system as the air conversion distance in the state where the infinite distance object is in focus at the wide angle end is denoted by Dexw. For example, FIG. 2 illustrates the paraxial exit pupil position Pexw in the state where the infinite distance object is in focus at the wide angle end. Ensuring that a corresponding value of Conditional Expression (44) is not less than or equal to its lower limit can bring a paraxial exit pupil close to the object side and thus, achieves an advantage in securing the edge part light quantity. Ensuring that the corresponding value of Conditional Expression (44) is not greater than or equal to its upper limit can bring the paraxial exit pupil close to the image side and thus, achieves an advantage in achieving size reduction. In order to obtain more favorable characteristics, the zoom lens more preferably satisfies Conditional Expression (44-1) and further preferably satisfies Conditional Expression (44-2).

$$1.5 < Dexw / ( fw \times tan ω w ) < 5 \qquad ( 44 )$$

$$1.8 < Dexw / ( fw \times tan ω w ) < 4.5 \qquad ( 44 - 1 )$$

$$2.2 < Dexw / ( fw \times tan ω w ) < 3.6 \qquad ( 44 - 2 )$$

The zoom lens preferably satisfies Conditional Expression (45). The open F-number in the state where the infinite distance object is in focus at the telephoto end is denoted by Fnot. The distance on the optical axis from the lens surface of the P lens group closest to the object side to the lens surface of the P lens group closest to the image side is denoted by DGP. Ensuring that a corresponding value of Conditional Expression (45) is not less than or equal to its lower limit can secure a sufficient space for disposing a plurality of lenses in the P lens group and thus, achieves an advantage in correcting the axial chromatic aberration. Ensuring that the corresponding value of Conditional Expression (45) is not greater than or equal to its upper limit can reduce the thickness of the P lens group and thus, achieves an advantage in reduction of the total length of the lens system.

In order to obtain more favorable characteristics, the zoom lens more preferably satisfies Conditional Expression (45-1) and further preferably satisfies Conditional Expression (45-2).

$$0.4 < Fnot \times DGP / ft < 4 \qquad ( 45 )$$

$$0.8 < Fnot \times DGP / ft < 3.4 \qquad ( 45 - 1 )$$

$$1.2 < Fnot \times DGP / ft < 2 \qquad ( 45 - 2 )$$

The zoom lens preferably satisfies Conditional Expression (46). The open F-number in the state where the infinite distance object is in focus at the telephoto end is denoted by Fnot. The distance on the optical axis from the lens surface of the P lens group closest to the object side to the lens surface of the P lens group closest to the image side is denoted by DGP. A distance on the optical axis from a lens surface of the M lens group closest to the object side to a lens surface of the M lens group closest to the image side is denoted by DGM. Ensuring that a corresponding value of Conditional Expression (46) is not less than or equal to its lower limit can secure a sufficient space for disposing a plurality of lenses in the P lens group and the M lens group and thus, achieves an advantage in correcting the axial chromatic aberration. Ensuring that the corresponding value of Conditional Expression (46) is not greater than or equal to its upper limit can reduce thicknesses of the P lens group and the M lens group and thus, achieves an advantage in reduction of the total length of the lens system. In order to obtain more favorable characteristics, the zoom lens more preferably satisfies Conditional Expression (46-1) and further preferably satisfies Conditional Expression (46-2).

$$0.4 < Fnot \times ( DGP + DGM ) / ft < 4 \qquad ( 46 )$$

$$0.8 < Fnot \times ( DGP + DGM ) / ft < 3.4 \qquad ( 46 - 1 )$$

$$1.2 < Fnot \times ( DGP + DGM ) / ft < 2 \text{.93} \qquad ( 46 - 2 )$$

The zoom lens preferably satisfies Conditional Expression (47). A sum of the distance on the optical axis from the lens surface of the first lens group G1 closest to the object side to the lens surface of the subsequent group GR closest to the image side and the back focus of the entire system as the air conversion distance in the state where the infinite distance object is in focus at the telephoto end is denoted by TLt. Ensuring that the corresponding value of Conditional Expression (47) is not less than or equal to its lower limit can secure a space for movement of each lens group during zooming and thus, achieves an advantage in achieving a high zoom ratio. Ensuring that the corresponding value of Conditional Expression (47) is not greater than or equal to its upper limit can reduce the total length of the lens system and thus, achieves an advantage in size reduction. In order to obtain more favorable characteristics, the zoom lens more preferably satisfies Conditional Expression (47-1) and further preferably satisfies Conditional Expression (47-2).

$$1.2 < TLt / ft < 5 \qquad ( 47 )$$

$$1.4 < TLt / ft < 4 \qquad ( 47 - 1 )$$

$$1.66 < TLt / ft < 3.02 \qquad ( 47 - 2 )$$

In a case where a focal length of the final lens group is denoted by fE, the zoom lens preferably satisfies Conditional Expression (48). Ensuring that a corresponding value of Conditional Expression (48) is not less than or equal to its lower limit achieves an advantage in securing the back focus. Ensuring that the corresponding value of Conditional Expression (48) is not greater than or equal to its upper limit achieves an advantage in reduction of the total length of the lens system. In order to obtain more favorable characteristics, the zoom lens more preferably satisfies Conditional Expression (48-1) and further preferably satisfies Conditional Expression (48-2).

$$0.1 < fw / fE < 0.7 \qquad ( 48 )$$

$$0.17 < fw / fE < 0.5 \qquad ( 48 - 1 )$$

$$0.25 < fw / fE < 0 \text{.42} \qquad ( 48 - 2 )$$

The zoom lens preferably satisfies Conditional Expression (49). A lateral magnification of the focus group in the state where the infinite distance object is in focus at the wide angle end is denoted by βfw. A combined lateral magnification of all lenses on the image side with respect to the focus group in the state where the infinite distance object is in focus at the wide angle end is denoted by βfRw. Ensuring that a corresponding value of Conditional Expression (49) is not less than or equal to its lower limit can reduce the moving amount of the focus group during focusing and thus, achieves an advantage in reduction of the total length of the lens system.

Ensuring that the corresponding value of Conditional Expression (49) is not greater than or equal to its upper limit achieves an advantage in suppressing sensitivity of the focus group to error. In order to obtain more favorable characteristics, the zoom lens more preferably satisfies Conditional Expression (49-1) and further preferably satisfies Conditional Expression (49-2).

$$0.3 < \vert ( 1 - β {fw}^{2} ) \times β {fRw}^{2} \vert < 3 \qquad ( 49 )$$

$$0.4 < \vert ( 1 - β {fw}^{2} ) \times β {fRw}^{2} \vert < 2.5 \qquad ( 49 - 1 )$$

$$0.5 < \vert ( 1 - β {fw}^{2} ) \times β {fRw}^{2} \vert < 1.56 \qquad ( 49 - 2 )$$

The zoom lens preferably satisfies Conditional Expression (50). A lateral magnification of the focus group in the state where the infinite distance object is in focus at the telephoto end is denoted by βft. A combined lateral magnification of all lenses on the image side with respect to the focus group in the state where the infinite distance object is in focus at the telephoto end is denoted by βfRt. Ensuring that a corresponding value of Conditional Expression (50) is not less than or equal to its lower limit can reduce the moving amount of the focus group during focusing and thus, achieves an advantage in reduction of the total length of the lens system. Ensuring that the corresponding value of Conditional Expression (50) is not greater than or equal to its upper limit achieves an advantage in suppressing the sensitivity of the focus group to error. In order to obtain more favorable characteristics, the zoom lens more preferably satisfies Conditional Expression (50-1) and further preferably satisfies Conditional Expression (50-2).

$$0.5 < \vert ( 1 - β {ft}^{2} ) \times β {fRt}^{2} \vert < 4 \qquad ( 50 )$$

$$0.7 < \vert ( 1 - β {ft}^{2} ) \times β {fRt}^{2} \vert < 3 \qquad ( 50 - 1 )$$

$$1.2 < \vert ( 1 - β {ft}^{2} ) \times β {fRt}^{2} \vert < 2.7 \qquad ( 50 - 2 )$$

The zoom lens preferably satisfies Conditional Expression (51). The lateral magnification of the focus group in the state where the infinite distance object is in focus at the wide angle end is denoted by βfw. The combined lateral magnification of all lenses on the image side with respect to the focus group in the state where the infinite distance object is in focus at the wide angle end is denoted by βfRw. The focal length of the focus group is denoted by ffoc. A combined focal length of all lenses on the image side with respect to the focus group in the state where the infinite distance object is in focus at the wide angle end is denoted by ffRw. The sum of the distance on the optical axis from the paraxial exit pupil position Pexw to the lens surface of the subsequent group closest to the image side and the back focus of the entire system as the air conversion distance in the state where the infinite distance object is in focus at the wide angle end is denoted by Dexw. The above symbols are used to define γw and BRw as follows.

$$γ w = ( 1 - β {fw}^{2} ) \times β {fRw}^{2}$$

$$BRw = \{ β fw / ( ffoc \times γ w ) - 1 / ( β fRw \times ffRw ) - ( 1 / Dexw ) \}$$

Ensuring that a corresponding value of Conditional Expression (51) is not less than or equal to its lower limit achieves an advantage in size reduction.

Ensuring that the corresponding value of Conditional Expression (51) is not greater than or equal to its upper limit can suppress fluctuation of an angle of view during focusing at the wide angle end. In order to obtain more favorable characteristics, the zoom lens more preferably satisfies Conditional Expression (51-1) and further preferably satisfies Conditional Expression (51-2).

$$0 < ( - BRw ) \times ( fw \times tan ω w ) < 0.7 \qquad ( 51 )$$

$$0 < ( - BRw ) \times ( fw \times tan ω w ) < 0.4 \qquad ( 51 - 1 )$$

$$0 < ( - BRw ) \times ( fw \times tan ω w ) < 0.24 \qquad ( 51 - 2 )$$

The zoom lens preferably satisfies Conditional Expression (52). The lateral magnification of the focus group in the state where the infinite distance object is in focus at the telephoto end is denoted by βft. The combined lateral magnification of all lenses on the image side with respect to the focus group in the state where the infinite distance object is in focus at the telephoto end is denoted by βfRt. The focal length of the focus group is denoted by ffoc. A combined focal length of all lenses on the image side with respect to the focus group in the state where the infinite distance object is in focus at the telephoto end is denoted by ffRt. A sum of the distance on the optical axis from the paraxial exit pupil position to the lens surface of the subsequent group closest to the image side and the back focus of the entire system as the air conversion distance in the state where the infinite distance object is in focus at the telephoto end is denoted by Dext. A maximum half angle of view in the state where the infinite distance object is in focus at the telephoto end is denoted by ωt.

The above symbols are used to define γt and BRt as follows.

$$γ t = ( 1 - β {ft}^{2} ) \times β {fRt}^{2}$$

$$BRt = \{ β ft / ( ffoc \times γ t ) - 1 / ( β fRt \times ffRt ) - ( 1 / Dext ) \}$$

Ensuring that a corresponding value of Conditional Expression (52) is not less than or equal to its lower limit achieves an advantage in size reduction.

Ensuring that the corresponding value of Conditional Expression (52) is not greater than or equal to its upper limit can suppress fluctuation of the angle of view during focusing at the telephoto end. In order to obtain more favorable characteristics, the zoom lens more preferably satisfies Conditional Expression (52-1) and further preferably satisfies Conditional Expression (52-2).

$$0 < ( - BRt ) \times ( ft \times tan ω t ) < 0.5 \qquad ( 52 )$$

$$0 < ( - BRt ) \times ( ft \times tan ω t ) < 0.3 \qquad ( 52 - 1 )$$

$$0 < ( - BRt ) \times ( ft \times tan ω t ) < 0 \text{.13} \qquad ( 52 - 2 )$$

In the configuration in which at least one of the lens closest to the object side in the zoom lens or the second lens from the object side in the zoom lens is a negative lens, in a case where a refractive index with respect to a d line for the negative lens is denoted by Nobn, the zoom lens preferably satisfies Conditional Expression (53). Particularly, it is preferable that the lens closest to the object side in the zoom lens is a negative lens and satisfies Conditional Expression (53). Ensuring that a corresponding value of Conditional Expression (53) is not less than or equal to its lower limit achieves an advantage in suppressing the distortion and the field curvature. Ensuring that the corresponding value of Conditional Expression (53) is not greater than or equal to its upper limit achieves an advantage in suppressing the lateral chromatic aberration. In order to obtain more favorable characteristics, the zoom lens more preferably satisfies Conditional Expression (53-1) and further preferably satisfies Conditional Expression (53-2).

$$1.7 < Nobn < 2.2 \qquad ( 53 )$$

$$1.76 < Nobn < 2 \qquad ( 53 - 1 )$$

$$1.81 < Nobn < 1.9 \qquad ( 53 - 2 )$$

The number of moving paths different from each other among the moving paths of each lens group that moves during zooming from the wide angle end to the telephoto end may be configured to be five. In other words, the moving paths of each lens group that moves during zooming may be configured to include five types. Doing so achieves an advantage in obtaining a high zoom ratio while simplifying a drive mechanism.

Alternatively, the number of moving paths different from each other among the moving paths of each lens group that moves during zooming from the wide angle end to the telephoto end may be configured to be four or may be configured to be three. Doing so achieves an advantage in simplification and weight reduction of the drive mechanism.

As in the examples described later, in a case where there are a plurality of lens groups that move on the same moving path during zooming from the wide angle end to the telephoto end, the number of types of moving paths of the plurality of lens groups is counted as one. In the disclosed technology, in a case where moving paths are different from each other in a partial magnification range in the entire magnification range, the moving paths are considered to be different from each other during zooming from the wide angle end to the telephoto end even in a case where the moving paths are the same in the rest of the magnification range. Naturally, the term “moving path” is related to a lens group that moves during zooming, and is not related to a lens group that is fixed during zooming.

The zoom lens may be configured to include a plurality of lens groups that move on the same moving path during zooming from the wide angle end to the telephoto end. Doing so enables the lens groups moving on the same moving path to be driven by one cam and thus, can simplify the drive mechanism for the lens groups. The term “same moving path during zooming from the wide angle end to the telephoto end” means the same moving path in the entire magnification range from the wide angle end to the telephoto end.

The example illustrated in FIG. 1 is merely an example and can be subjected to various modifications without departing from the gist of the disclosed technology. For example, the number of lens groups included in the subsequent group GR and the number of lenses included in each lens group may be different from the numbers in the example in FIG. 1.

For example, the subsequent group GR may be configured to consist of three lens groups or may be configured to consist of five lens groups. The focus group may be configured to consist of one lens.

For example, one lens group may be configured to be provided between the first lens group G1 and the P lens group. Doing so achieves an advantage in suppressing fluctuation of the distortion during zooming.

The first lens group G1 may be configured to consist of, in order from the object side to the image side, a negative lens, a negative lens, and a positive lens. The first lens group G1 may be configured to consist of, in order from the object side to the image side, a negative lens, a negative lens, a negative lens, and a positive lens. The first lens group G1 may be configured to consist of, in order from the object side to the image side, a negative lens and a negative lens.

The focus group preferably has a negative refractive power. Doing so can reduce the moving amount of the focus group during focusing and thus, achieves an advantage in size reduction and weight reduction of the entire system. The focus group preferably includes at least one negative lens. Doing so achieves an advantage in suppressing fluctuation of the chromatic aberration during focusing.

The focus group may be configured to consist of one negative lens. Doing so achieves an advantage in size reduction. Alternatively, the focus group may be configured to consist of a positive lens and a negative lens. Doing so achieves an advantage in suppressing fluctuation of the chromatic aberration during focusing.

The number of lenses included in the final lens group may be configured to be two or less. Doing so achieves an advantage in size reduction.

The above preferable configurations and available configurations can be combined with each other in any manner and are preferably selectively adopted, as appropriate, in accordance with required specifications. Conditional expressions preferably satisfied by the zoom lens of the present disclosure are not limited to the conditional expressions described in the form of an expression and include all conditional expressions obtained by any combination of lower limits and upper limits from the preferable, more preferable, and further preferable conditional expressions.

For example, according to a first preferable aspect of the present disclosure, a zoom lens consists of, in order from the object side to the image side, the first lens group G1 having a negative refractive power, and the subsequent group GR, in which the subsequent group GR includes at least three lens groups, one of the at least three lens groups is the P lens group having a positive refractive power, during zooming, the spacing between the first lens group G1 and the subsequent group GR changes, and all spacings between adjacent lens groups in the subsequent group GR change, and Conditional Expressions (1) and (2) are satisfied.

According to a second preferable aspect of the present disclosure, in the zoom lens of the first aspect, the P lens group has the largest moving amount to the object side during zooming from the wide angle end to the telephoto end among the lens groups in the subsequent group GR, the zoom lens includes the N lens group having a negative refractive power, on the image side with respect to the P lens group, the zoom lens includes the M lens group between the P lens group and the N lens group, and Conditional Expression (3) is satisfied.

Next, examples of the zoom lens of the present disclosure will be described with reference to the drawings. Reference numerals provided to the lenses in the cross-sectional view of each example are independently used for each example in order to avoid complication of description and the drawings caused by an increasing number of digits of the reference numerals. Accordingly, a common reference numeral provided in the drawings of different examples does not necessarily indicate a common configuration.

### Example 1

A configuration and a moving path of the zoom lens of Example 1 are illustrated in FIG. 1, and its illustration method and configuration are described above. Thus, duplicate descriptions will be partially omitted. The zoom lens of Example 1 consists of, in order from the object side to the image side, the first lens group G1 having a negative refractive power, the second lens group G2 having a positive refractive power, the third lens group G3 having a positive refractive power, the fourth lens group G4 having a negative refractive power, and the fifth lens group G5 having a positive refractive power. The subsequent group GR consists of the second lens group G2, the third lens group G3, the fourth lens group G4, and the fifth lens group G5. During zooming from the wide angle end to the telephoto end, the first lens group G1, the second lens group G2, the third lens group G3, and the fourth lens group G4 move along the optical axis Z by changing spacings with respect to adjacent lens groups, and the fifth lens group G5 is fixed with respect to the image plane Sim. The focus group consists of the fourth lens group G4, and the focus group moves to the image side during focusing from the infinite distance object to the nearest object.

For the zoom lens of Example 1, Table 1 shows basic lens data, Table 2 shows specifications and a variable surface spacing, and Table 3 shows aspherical coefficients.

The table of the basic lens data is described as follows. A column of Sn shows a surface number in a case where the number is increased by one for each surface from a surface closest to the object side as a first surface to the image side. A column of R shows a curvature radius of each surface. A column of D shows a surface spacing on the optical axis between each surface and its adjacent surface on the image side. A column of Nd shows a refractive index with respect to a d line for each constituent. A column of νd shows an Abbe number based on the d line for each constituent. A column of θgF shows a partial dispersion ratio between a g line and an F line for each constituent. A column of ED shows an effective diameter of each surface. A column of SG shows a relative density of each constituent.

In the table of the basic lens data, a sign of the curvature radius of the surface having a convex shape facing the object side is positive, and a sign of the curvature radius of the surface having a convex shape facing the image side is negative. Table 1 also shows the aperture stop St and the optical member PP. A field of the surface number of the surface corresponding to the aperture stop St has the surface number and a text (St). A value in a lowermost field of the column of the surface spacing in the table indicates a spacing between a surface closest to the image side in the table and the image plane Sim. A symbol DD[ ] is used for the variable surface spacing. A surface number on the object side of the spacing is shown in [ ] in the column of the surface spacing.

Table 2 shows a zoom ratio Zr, a focal length f, a back focus Bf as an air conversion distance, an open F-number Fno., a maximum full angle of view 2ω, and the variable surface spacing based on the d line. The zoom ratio is synonymous with a zoom magnification. In a field of 2ω, [°] indicates a degree unit. In Table 2, each value in the wide angle end state is shown in a column labeled “Wide”, each value in a middle focal length state is shown in a column labeled “Middle”, and each value in the telephoto end state is shown in a column labeled “Tele”.

In the basic lens data, a surface number of an aspherical surface is marked with *, and a value of a paraxial curvature radius is shown in a field of the curvature radius of the aspherical surface. In Table 3, the column of Sn shows the surface number of the aspherical surface, and columns of KA and Am show a numerical value of the aspherical coefficient for each aspherical surface. Here, m of Am is an integer greater than or equal to 3 and varies depending on the surface. For example, for the third surface of Example 1, m=3, 4, 5, . . . , 16 is established. In the numerical value of the aspherical coefficient in Table 3, “E±n” (n: integer) means “×10^{±n}”. KA and Am are aspherical coefficients in an aspheric equation represented by the following expression.

$$Zd = C \times {h}^{2} / \{ 1 + {( 1 - KA \times {C}^{2} \times {h}^{2} )}^{1 / 2} \} + \sum Am \times {h}^{m}$$

where
Zd: a depth of the aspherical surface (a length of a perpendicular line drawn from a point on the aspherical surface at a height h to a plane that is in contact with an aspherical surface apex and that is perpendicular to the optical axis Z)
h: a height (a distance from the optical axis Z to the lens surface)
C: a reciprocal of the paraxial curvature radius
KA and Am: aspherical coefficients
Σ in the aspheric equation means a sum total related to m.

In the data of each table, a degree unit is used for angles, and a millimeter unit is used for lengths. However, since the optical system can also be proportionally enlarged or proportionally reduced to be used, other appropriate units can also be used. Each table below shows numerical values rounded to predetermined digits.

TABLE 1
Example 1

| Sn | R | D | Nd | νd | θgF | ED | SG |
|---|---|---|---|---|---|---|---|
| 1 | 51.9122 | 1.3490 | 1.85883 | 30.00 | 0.59793 | 45.455 | 3.750 |
| 2 | 21.7472 | 13.7320 | | | | 36.714 | |
| *3 | −56.6037 | 2.0000 | 1.49710 | 81.56 | 0.53848 | 36.444 | 3.640 |
| *4 | 40.3824 | 0.5021 | | | | 35.995 | |
| 5 | 50.1527 | 4.2315 | 1.92286 | 20.88 | 0.63900 | 36.100 | 3.940 |
| 6 | 261.1609 | DD[6] | | | | 35.838 | |
| *7 | 38.7201 | 3.6766 | 1.69350 | 53.20 | 0.54661 | 28.800 | 3.520 |
| *8 | 91.2297 | 2.5661 | | | | 29.106 | |
| 9 | 70.8600 | 4.0317 | 1.58144 | 40.75 | 0.57757 | 30.002 | 2.590 |
| 10 | −112.6633 | 6.4581 | | | | 30.021 | |
| 11 | 96.2082 | 1.0007 | 1.74000 | 28.30 | 0.60790 | 28.861 | 3.110 |
| 12 | 21.2881 | 9.0091 | 1.53775 | 74.70 | 0.53936 | 27.812 | 3.640 |
| 13 | 53.8511 | DD[13] | | | | 27.782 | |
| 14 (St) | ∞ | 1.5815 | | | | 21.058 | |
| 15 | −488.5995 | 4.9324 | 1.45860 | 90.19 | 0.53516 | 20.593 | 3.630 |
| 16 | −18.1749 | 0.7998 | 1.72047 | 34.71 | 0.58350 | 20.319 | 3.190 |
| 17 | 112.0659 | 2.2302 | | | | 20.725 | |
| 18 | 70.4709 | 3.4797 | 1.91082 | 35.25 | 0.58224 | 21.493 | 4.970 |
| 19 | −45.1514 | DD[19] | | | | 21.500 | |
| 20 | −185.2592 | 1.8392 | 1.94595 | 17.98 | 0.65460 | 15.165 | 3.510 |
| 21 | −42.0151 | 3.5049 | | | | 15.000 | |
| *22 | −32.7463 | 1.0003 | 1.68948 | 31.02 | 0.59874 | 14.838 | 2.880 |
| *23 | 19.7460 | DD[23] | | | | 15.515 | |
| *24 | 58.7210 | 6.1611 | 1.49710 | 81.56 | 0.53848 | 27.000 | 3.640 |
| *25 | −30.3132 | 11.9988 | | | | 27.249 | |
| 26 | ∞ | 2.8500 | 1.51680 | 64.20 | 0.53430 | 28.207 | 2.520 |
| 27 | ∞ | 1.1099 | | | | 28.338 | |

TABLE 2
Example 1

| | Wide | Middle | Tele |
|---|---|---|---|
| Zr | 1.00 | 1.92 | 3.24 |
| f | 16.49 | 31.67 | 53.42 |
| Bf | 14.99 | 14.99 | 14.99 |
| Fno. | 2.88 | 2.88 | 2.88 |
| 2ω [°] | 86.6 | 47.0 | 28.8 |
| DD[6] | 51.6174 | 16.0969 | 0.5002 |
| DD[13] | 1.0009 | 9.6899 | 19.2758 |
| DD[19] | 2.0000 | 6.4820 | 13.1251 |
| DD[23] | 4.3588 | 7.5436 | 14.6990 |

TABLE 3
Example 1

| Sn | 3 | 4 | 7 | 8 |
|---|---|---|---|---|
| KA | 1.0000000000E+00 | 1.0000000000E+00 | 1.0000000000E+00 | 1.0000000000E+00 |
| A3 | 0.0000000000E+00 | 0.0000000000E+00 | 0.0000000000E+00 | 0.0000000000E+00 |
| A4 | 8.6659553179E−06 | 4.8078948118E−07 | −3.7818901449E−06 | 7.7274194746E−07 |
| A5 | −1.8667295238E−06 | −1.7248151094E−06 | −7.2054269739E−07 | −4.5425139006E−07 |
| A6 | 9.1676445081E−08 | 7.2688600005E−08 | 1.5173000412E−07 | 1.7231155076E−07 |
| A7 | 3.3537007157E−09 | 4.1010949365E−09 | −1.3946593295E−08 | −3.5879648114E−08 |
| A8 | −6.4358842425E−10 | −4.1056088512E−10 | 3.0759382138E−10 | 4.7020489650E−09 |
| A9 | 5.8416211163E−11 | 2.0875832346E−11 | 2.9213931908E−11 | −3.8187120258E−10 |
| A10 | −3.8305280611E−12 | −8.2186106061E−13 | −3.0438336918E−12 | 1.0155371948E−11 |
| A11 | 1.2362709954E−13 | −5.5339927760E−14 | 1.1012637494E−13 | 1.0518981227E−12 |
| A12 | 2.4772850800E−15 | 1.0900203368E−14 | 4.0746057924E−15 | −9.6414127389E−14 |
| A13 | −4.4370539929E−16 | −7.5719838077E−16 | −1.0209131814E−15 | 3.3102998113E−16 |
| A14 | 1.9933947646E−17 | 2.8960436945E−17 | 6.7234788784E−17 | 2.9441726812E−16 |
| A15 | −4.2966172979E−19 | −6.0399543649E−19 | −2.0944611615E−18 | −1.4437252259E−17 |
| A16 | 3.7854426026E−21 | 5.3917429277E−21 | 2.6298146923E−20 | 2.2447726248E−19 |
| Sn | 22 | 23 | 24 | 25 |
| KA | 1.0000000000E+00 | 1.0000000000E+00 | 1.0000000000E+00 | 1.0000000000E+00 |
| A3 | 0.0000000000E+00 | 0.0000000000E+00 | 0.0000000000E+00 | 0.0000000000E+00 |
| A4 | −3.4537929877E−04 | −3.9414923539E−04 | 6.7430567568E−05 | 7.6117406809E−05 |
| A5 | 2.7572880860E−05 | 5.0832605361E−05 | −4.8856987280E−06 | −1.5391570982E−06 |
| A6 | 8.6587534325E−06 | 5.0351226840E−06 | 9.9261042599E−08 | −1.9843470357E−07 |
| A7 | −7.9622208920E−07 | −1.3069451619E−06 | 7.1367850088E−09 | 1.2857138390E−08 |
| A8 | −2.1426293495E−07 | 4.6375819313E−08 | 4.3258740319E−10 | −3.9211796788E−10 |
| A9 | 4.0646772921E−08 | 1.2990217104E−08 | −3.4204630161E−11 | 3.8842140381E−11 |
| A10 | −3.0173725101E−10 | −3.8522695362E−09 | −9.8759483275E−12 | 3.0365160051E−13 |
| A11 | −6.3996230580E−10 | 6.0549268251E−10 | 1.2416299273E−12 | −4.1716601365E−13 |
| A12 | 4.8231530197E−11 | −2.9121108875E−11 | −1.5155770235E−14 | 1.8693006137E−14 |
| A13 | 1.0008734852E−11 | −5.6879382526E−12 | −7.6789103909E−15 | 1.5596255313E−15 |
| A14 | −2.2033434122E−12 | 1.0589068209E−12 | 7.0200816200E−16 | −2.0154491755E−16 |
| A15 | 1.6492732793E−13 | −7.0857231279E−14 | −2.6223236789E−17 | 8.3215975002E−18 |
| A16 | −4.5542713936E−15 | 1.7863494683E−15 | 3.7698967219E−19 | −1.2559987534E−19 |

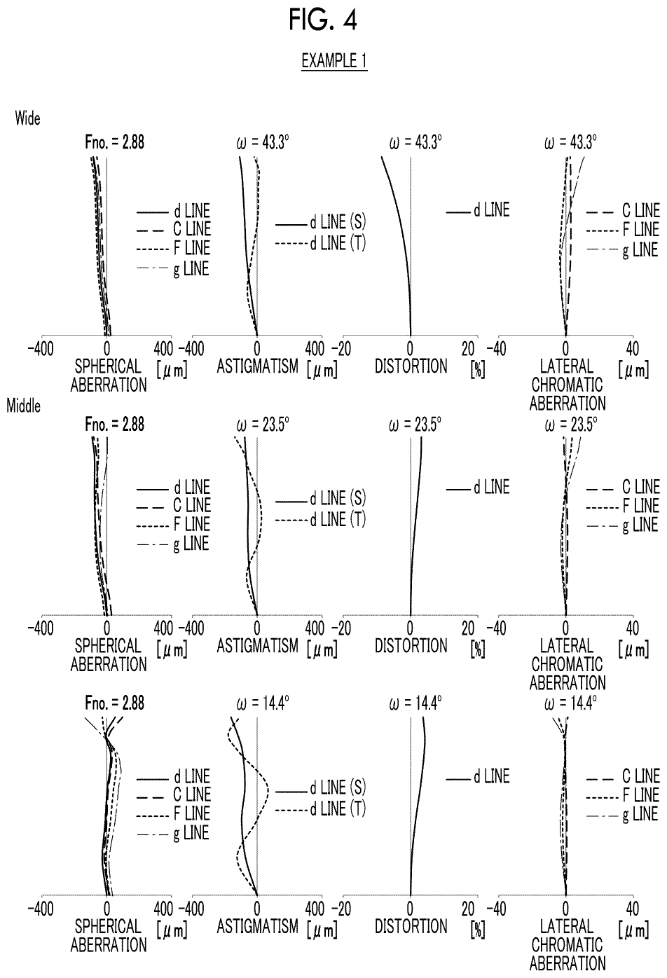

FIG. 4 illustrates each aberration diagram of the zoom lens of Example 1 in the state where the infinite distance object is in focus. In FIG. 4, the spherical aberration, the astigmatism, the distortion, and the lateral chromatic aberration are illustrated in this order from the left. In FIG. 4, the aberrations in the wide angle end state are illustrated in an upper part labeled “Wide”, the aberrations in the middle focal length state are illustrated in a middle part labeled “Middle”, and the aberrations in the telephoto end state are illustrated in a lower part labeled “Tele”. In the spherical aberration diagram, the aberrations on the d line, the C line, the F line, and the g line are illustrated by a solid line, a long broken line, a short broken line, and a dot-dashed line, respectively. In the astigmatism diagram, the aberration on the d line in a sagittal direction is illustrated by a solid line, and the aberration on the d line in a tangential direction is illustrated by a short broken line. In the distortion diagram, the aberration on the d line is illustrated by a solid line. In the lateral chromatic aberration diagram, the aberrations on the C line, the F line, and the g line are illustrated by a long broken line, a short broken line, and a dot-dashed line, respectively. In the spherical aberration diagram, a value of the open F-number is shown after “Fno.=”. In other aberration diagrams, a value of the maximum half angle of view is shown after ω=.

Symbols, meanings, description methods, and illustration methods of each data related to Example 1 are basically the same for the following examples unless otherwise specified. Thus, duplicate descriptions will be omitted below.

### Example 2

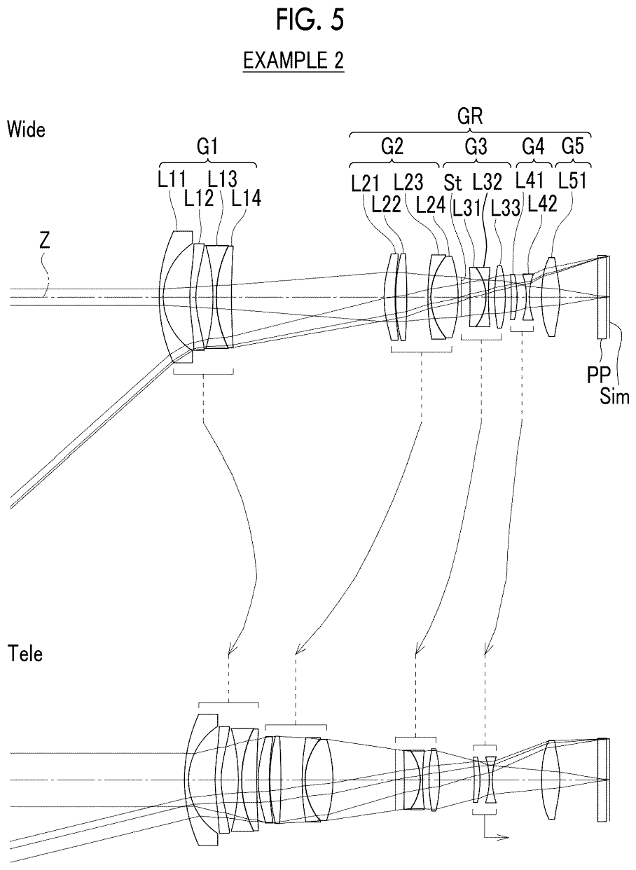

FIG. 5 illustrates a configuration and a moving path of a zoom lens of Example 2. The zoom lens of Example 2 consists of, in order from the object side to the image side, the first lens group G1 having a negative refractive power, the second lens group G2 having a positive refractive power, the third lens group G3 having a positive refractive power, the fourth lens group G4 having a negative refractive power, and the fifth lens group G5 having a positive refractive power.

The subsequent group GR consists of the second lens group G2, the third lens group G3, the fourth lens group G4, and the fifth lens group G5. During zooming from the wide angle end to the telephoto end, the first lens group G1, the second lens group G2, the third lens group G3, and the fourth lens group G4 move along the optical axis Z by changing spacings with respect to adjacent lens groups, and the fifth lens group G5 is fixed with respect to the image plane Sim. The focus group consists of the fourth lens group G4, and the focus group moves to the image side during focusing from the infinite distance object to the nearest object.

The first lens group G1 consists of, in order from the object side to the image side, four lenses including lenses L11 to L14. The second lens group G2 consists of, in order from the object side to the image side, four lenses including the lenses L21 to L24. The third lens group G3 consists of, in order from the object side to the image side, the aperture stop St and three lenses including the lenses L31 to L33. The fourth lens group G4 consists of, in order from the object side to the image side, two lenses including the lenses L41 and L42. The fifth lens group G5 consists of one lens that is the lens L51.

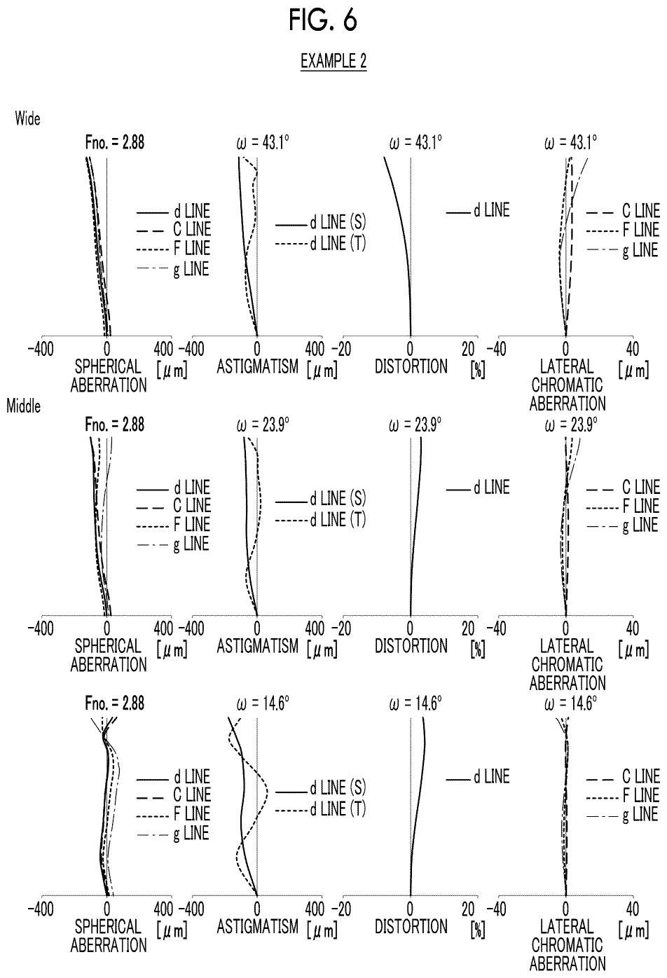

For the zoom lens of Example 2, Table 4 shows basic lens data, Table 5 shows specifications and a variable surface spacing, Table 6 shows aspherical coefficients, and FIG. 6 illustrates each aberration diagram.

TABLE 4
Example 2

| Sn | R | D | Nd | νd | θgF | ED | SG |
|---|---|---|---|---|---|---|---|
| 1 | 56.8390 | 1.3499 | 1.85883 | 30.00 | 0.59793 | 45.533 | 3.750 |
| 2 | 22.6435 | 8.7886 | | | | 37.112 | |
| *3 | 51.9482 | 1.9991 | 1.51633 | 64.06 | 0.53345 | 36.888 | 2.380 |
| *4 | 31.9284 | 5.6543 | | | | 35.841 | |
| 5 | −68.5857 | 1.1096 | 1.48749 | 70.44 | 0.53062 | 35.640 | 2.450 |
| 6 | 41.3331 | 4.9934 | 1.92119 | 23.96 | 0.62025 | 35.206 | 3.840 |
| 7 | 276.7851 | DD[7] | | | | 34.800 | |
| *8 | 39.2575 | 3.6402 | 1.69350 | 53.20 | 0.54661 | 29.400 | 3.520 |
| *9 | 80.3771 | 0.2015 | | | | 29.799 | |
| 10 | 63.3714 | 3.6404 | 1.67270 | 32.10 | 0.59891 | 30.095 | 2.910 |
| 11 | −260.4744 | 6.9991 | | | | 30.070 | |
| 12 | 84.5802 | 0.9974 | 1.80518 | 25.42 | 0.61616 | 29.126 | 3.370 |
| 13 | 22.6229 | 9.0117 | 1.53775 | 74.70 | 0.53936 | 28.129 | 3.640 |
| 14 | −48.4802 | DD[14] | | | | 28.159 | |
| 15 (St) | ∞ | 2.9146 | | | | 21.096 | |
| 16 | −470.5170 | 5.2673 | 1.49700 | 81.61 | 0.53887 | 20.496 | 3.700 |
| 17 | −17.3282 | 0.7972 | 1.72047 | 34.71 | 0.58350 | 20.226 | 3.190 |
| 18 | 93.2266 | 2.0917 | | | | 20.583 | |
| 19 | 61.2163 | 3.5028 | 1.91082 | 35.25 | 0.58224 | 21.316 | 4.970 |
| 20 | −47.0517 | DD[20] | | | | 21.295 | |
| 21 | −118.0060 | 1.8834 | 1.94595 | 17.98 | 0.65460 | 15.649 | 3.510 |
| 22 | −36.8433 | 3.0660 | | | | 15.500 | |
| *23 | −31.1957 | 0.9987 | 1.68948 | 31.02 | 0.59874 | 15.260 | 2.880 |
| *24 | 21.3427 | DD[24] | | | | 15.938 | |
| *25 | 68.5032 | 6.0050 | 1.49710 | 81.56 | 0.53848 | 27.000 | 3.640 |
| *26 | −30.0585 | 12.5138 | | | | 27.265 | |
| 27 | ∞ | 2.8500 | 1.51680 | 64.20 | 0.53430 | 28.667 | 2.520 |
| 28 | ∞ | 1.1102 | | | | 28.851 | |

TABLE 5
Example 2

| | Wide | Middle | Tele |
|---|---|---|---|
| Zr | 1.00 | 1.92 | 3.24 |
| f | 16.49 | 31.67 | 53.42 |
| Bf | 15.50 | 15.50 | 15.50 |
| Fno. | 2.88 | 2.88 | 2.88 |
| 2ω [°] | 86.2 | 47.8 | 29.2 |
| DD[7] | 50.2498 | 16.1562 | 0.4991 |
| DD[14] | 0.9999 | 9.9347 | 20.6699 |
| DD[20] | 1.9995 | 5.6384 | 11.4528 |
| DD[24] | 4.0871 | 8.8326 | 16.3817 |

TABLE 6
Example 2

| Sn | 3 | 4 | 8 | 9 |
|---|---|---|---|---|
| KA | 1.0000000000E+00 | 1.0000000000E+00 | 1.0000000000E+00 | 1.0000000000E+00 |
| A3 | 0.0000000000E+00 | 0.0000000000E+00 | 0.0000000000E+00 | 0.0000000000E+00 |
| A4 | −2.2842644388E−05 | −3.1309457353E−05 | −6.3367182412E−06 | −2.3133507889E−06 |
| A5 | −1.1828440159E−06 | −1.0922780755E−06 | −2.2355686919E−07 | 1.7799985938E−07 |
| A6 | 1.1732537236E−07 | 8.7320774847E−08 | 8.3785390290E−08 | 2.7296616172E−08 |
| A7 | −9.6905035028E−10 | 1.4426022388E−09 | −9.5903580960E−09 | −7.1076912193E−09 |
| A8 | −1.9982651053E−10 | −6.4761038731E−11 | 1.0803427787E−10 | 2.2108919872E−10 |
| A9 | 2.1983120619E−11 | −6.3480007966E−12 | 2.6440120668E−11 | 2.6878388575E−12 |
| A10 | −1.1970664577E−12 | 7.4754240103E−13 | −9.5933470716E−13 | 3.1713741337E−12 |
| A11 | 2.7128115737E−14 | −7.0570103852E−14 | 2.6301569729E−15 | −5.6809500563E−13 |
| A12 | −2.4386016946E−16 | 3.5781998297E−15 | −1.2325359063E−14 | 2.7786319663E−14 |
| A13 | 2.4355584660E−17 | −9.0477795049E−17 | 1.7215702462E−15 | 6.0547574744E−16 |
| A14 | −2.5701070202E−18 | 1.9630194804E−19 | −1.0647191999E−16 | −1.2151637996E−16 |
| A15 | 9.1462172142E−20 | 4.3012679227E−20 | 3.2676415542E−18 | 4.9357409965E−18 |
| A16 | −1.1341325853E−21 | −7.0619442647E−22 | −4.0700253630E−20 | −7.0024626665E−20 |
| Sn | 23 | 24 | 25 | 26 |
| KA | 1.0000000000E+00 | 1.0000000000E+00 | 1.0000000000E+00 | 1.0000000000E+00 |
| A3 | 0.0000000000E+00 | 0.0000000000E+00 | 0.0000000000E+00 | 0.0000000000E+00 |
| A4 | −3.0791858120E−04 | −3.3541131248E−04 | 7.0565665074E−05 | 7.2976744592E−05 |
| A5 | 2.4035066371E−05 | 4.0863754638E−05 | −5.3396577864E−06 | −5.8949440516E−07 |
| A6 | 9.9502024179E−06 | 4.4540570828E−06 | 1.2845253298E−07 | −2.1147263808E−07 |
| A7 | −2.8611330404E−06 | −1.0267839071E−06 | −5.7428448267E−09 | −2.9538586037E−08 |
| A8 | 6.4622470803E−07 | 4.2904541378E−08 | 3.2416785465E−09 | 8.1646145819E−09 |
| A9 | −1.3754281677E−07 | −3.4520801664E−09 | −3.4730426449E−10 | −7.6178957740E−10 |
| A10 | 1.8145502794E−08 | 2.1887299579E−09 | 9.1584333594E−12 | 2.8489795881E−11 |
| A11 | −8.0004880528E−10 | −5.2668577839E−10 | 1.0841433424E−12 | 1.2401063293E−12 |
| A12 | −1.2244202771E−10 | 8.0702888795E−11 | −8.1453228390E−14 | −1.2886272575E−13 |
| A13 | 2.1678687471E−11 | −8.5694019308E−12 | −2.9265705348E−15 | −5.3156459470E−15 |
| A14 | −1.3401896453E−12 | 5.9809241498E−13 | 5.7851287994E−16 | 1.0448061924E−15 |
| A15 | 2.8091924722E−14 | −2.4643319415E−14 | −2.6083784310E−17 | −4.7646431888E−17 |
| A16 | 2.0630358195E−16 | 4.5376276294E−16 | 4.1092449401E−19 | 7.5636485521E−19 |

### Example 3

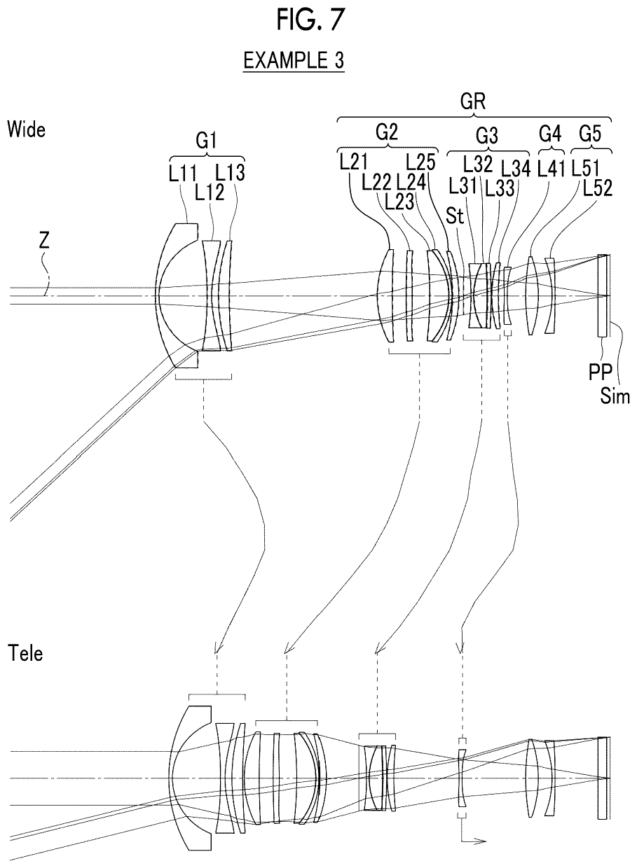

FIG. 7 illustrates a configuration and a moving path of a zoom lens of Example 3. The zoom lens of Example 3 consists of, in order from the object side to the image side, the first lens group G1 having a negative refractive power, the second lens group G2 having a positive refractive power, the third lens group G3 having a negative refractive power, the fourth lens group G4 having a negative refractive power, and the fifth lens group G5 having a positive refractive power. The subsequent group GR consists of the second lens group G2, the third lens group G3, the fourth lens group G4, and the fifth lens group G5. During zooming from to the image plane Sim.

The focus group consists of the fourth lens group G4, and the focus group moves to the image side during focusing from the infinite distance object to the nearest object.

The first lens group G1 consists of, in order from the object side to the image side, three lenses including the lenses L11 to L13. The second lens group G2 consists of, in order from the object side to the image side, five lenses including lenses L21 to L25. The third lens group G3 consists of, in order from the object side to the image side, the aperture stop St and four lenses including lenses L31 to L34. The fourth lens group G4 consists of one lens that is the lens L41. The fifth lens group G5 consists of, in order from the object side to the image side, two lenses including lenses L51 and L52.

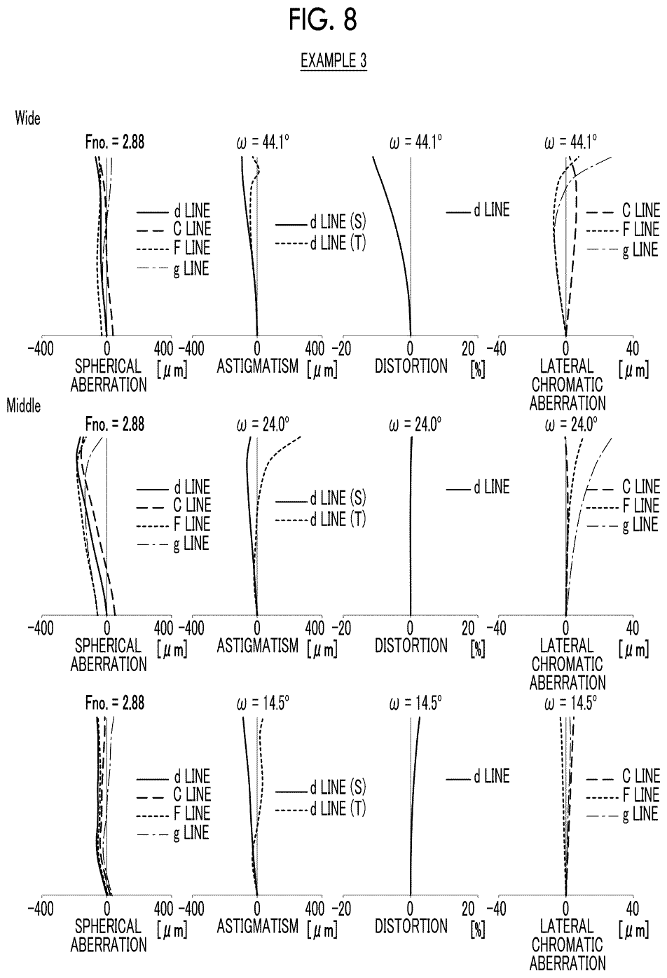

For the zoom lens of Example 3, Table 7 shows basic lens data, Table 8 shows specifications and a variable surface spacing, Table 9 shows aspherical coefficients, and FIG. 8 illustrates each aberration diagram.

TABLE 7
Example 3

| Sn | R | D | Nd | νd | θgF | ED | SG |
|---|---|---|---|---|---|---|---|
| 1 | 50.0118 | 1.1991 | 1.74694 | 53.31 | 0.54634 | 49.893 | 4.189 |
| 2 | 20.8333 | 15.8836 | | | | 38.443 | |
| *3 | −262.3854 | 1.5005 | 1.58313 | 59.38 | 0.54237 | 38.002 | 3.050 |
| *4 | 35.9120 | 2.2689 | | | | 37.874 | |
| 5 | 63.6396 | 3.5732 | 1.95489 | 23.02 | 0.62840 | 38.002 | 4.208 |
| 6 | 221.3263 | DD[6] | | | | 37.600 | |
| 7 | 35.3793 | 4.9475 | 1.68591 | 57.20 | 0.54264 | 32.000 | 3.985 |
| 8 | 298.6922 | 4.5938 | | | | 31.804 | |
| *9 | 248.9735 | 2.0023 | 1.69304 | 52.93 | 0.54673 | 31.171 | 3.660 |
| *10 | −225.9032 | 5.7856 | | | | 31.020 | |
| 11 | −140.4419 | 6.3220 | 1.43700 | 95.10 | 0.53364 | 31.039 | 3.530 |
| 12 | −24.8842 | 1.0008 | 1.90218 | 20.17 | 0.64101 | 31.160 | 3.591 |
| 13 | −28.8032 | 0.1991 | | | | 31.864 | |
| 14 | −61.9435 | 2.1039 | 1.73734 | 54.27 | 0.54496 | 30.657 | 4.145 |
| 15 | −43.4002 | DD[15] | | | | 30.663 | |
| 16 (St) | ∞ | 2.4991 | | | | 22.798 | |
| 17 | −85.8210 | 0.9001 | 1.82454 | 23.77 | 0.62003 | 22.213 | 3.611 |
| 18 | 24.8538 | 4.3686 | 1.49700 | 81.61 | 0.53887 | 22.002 | 3.700 |
| 19 | −226.2626 | 0.1999 | | | | 22.240 | |
| *20 | −138.8726 | 1.2008 | 1.68948 | 31.02 | 0.59874 | 22.267 | 2.880 |
| *21 | −147.5639 | 0.1991 | | | | 22.403 | |
| 22 | 43.6307 | 2.1713 | 1.99999 | 17.79 | 0.66021 | 22.791 | 3.948 |
| 23 | 111.3533 | DD[23] | | | | 22.575 | |
| *24 | −53.1574 | 1.0009 | 1.49710 | 81.56 | 0.53848 | 19.757 | 3.640 |
| *25 | 135.4479 | DD[25] | | | | 19.500 | |
| 26 | 82.1018 | 4.1528 | 1.88219 | 39.78 | 0.57106 | 26.970 | 4.995 |
| 27 | −43.0789 | 4.5414 | | | | 27.000 | |
| 28 | −35.5532 | 0.9991 | 1.70613 | 29.69 | 0.59901 | 25.583 | 3.026 |
| 29 | −219.1590 | 14.1919 | | | | 25.986 | |
| 30 | ∞ | 2.8500 | 1.51680 | 64.20 | 0.53430 | 28.108 | 2.520 |
| 31 | ∞ | 1.1192 | | | | 28.412 | |

TABLE 8
Example 3

| | Wide | Middle | Tele |
|---|---|---|---|
| Zr | 1.00 | 1.92 | 3.24 |
| f | 16.50 | 31.69 | 53.46 |
| Bf | 17.19 | 17.19 | 17.19 |
| Fno. | 2.88 | 2.88 | 2.88 |
| 2ω [°] | 88.2 | 48.0 | 29.0 |
| DD[6] | 48.7103 | 12.9103 | 0.5006 |
| DD[15] | 1.4991 | 6.4991 | 10.7433 |
| DD[23] | 1.9991 | 14.3625 | 21.5530 |
| DD[25] | 6.0695 | 4.3058 | 21.0115 |

TABLE 9
Example 3

| Sn | 3 | 4 | 9 | 10 |
|---|---|---|---|---|
| KA | 1.0000000000E+00 | 1.0000000000E+00 | 1.0000000000E+00 | 1.0000000000E+00 |
| A3 | 0.0000000000E+00 | 0.0000000000E+00 | 0.0000000000E+00 | 0.0000000000E+00 |
| A4 | −4.9501645631E−05 | −5.8001964704E−05 | −1.1995804434E−05 | −2.4071291342E−06 |
| A5 | 3.9193981972E−06 | 3.3711915220E−06 | 7.8396688496E−07 | 2.9126184535E−06 |
| A6 | −6.5228461696E−08 | 1.2925395646E−07 | 4.2131198364E−07 | −6.0034668232E−07 |
| A7 | 1.7332478551E−08 | −2.1512617805E−08 | −1.9537756457E−07 | 9.2747847620E−08 |
| A8 | −4.0918755500E−09 | 6.4459426655E−10 | 3.8603427393E−08 | −1.0485093287E−08 |
| A9 | 3.5515830622E−10 | 2.6376294073E−12 | −4.2096459394E−09 | 9.1013771065E−10 |
| A10 | −1.3973473282E−11 | −1.0571863307E−12 | 2.6247187043E−10 | −4.1251154113E−11 |
| A11 | 6.5280616184E−14 | 1.1832342625E−13 | −8.1080020659E−12 | −8.9208313959E−13 |
| A12 | 1.2827178141E−14 | −6.3379864594E−15 | 6.9982026309E−14 | 2.0637278934E−13 |
| A13 | 6.9509802481E−17 | 6.3764175175E−17 | −7.2341351067E−15 | −8.7252139179E−15 |
| A14 | −4.1174878896E−17 | 6.6793106456E−18 | 1.0557399758E−15 | 2.9941603438E−17 |
| A15 | 1.5311882599E−18 | −2.7438142659E−19 | −4.6101146159E−17 | 7.2710994330E−18 |
| A16 | −1.8364801353E−20 | 3.3259542174E−21 | 6.8487398624E−19 | −1.4979223488E−19 |
| Sn | 20 | 21 | 24 | 25 |
| KA | 1.0000000000E+00 | 1.0000000000E+00 | 1.0000000000E+00 | 1.0000000000E+00 |
| A3 | 0.0000000000E+00 | 0.0000000000E+00 | 0.0000000000E+00 | 0.0000000000E+00 |
| A4 | −6.7573204849E−06 | −8.1034358884E−06 | 2.9930980704E−04 | 2.9546654901E−04 |
| A5 | −3.6289353224E−07 | 1.6051345598E−07 | −2.7574410853E−05 | −2.4658065244E−05 |
| A6 | 1.8776579432E−07 | 6.5872383755E−08 | −2.1679664090E−06 | −4.6603904472E−07 |
| A7 | −1.2240976130E−09 | 2.0095131262E−08 | 1.1890684879E−06 | 1.2639004619E−07 |
| A8 | −4.6878633265E−10 | −4.3525471596E−09 | −2.5190977967E−07 | 5.3988269424E−09 |
| A9 | 8.1108047766E−11 | 5.8237857114E−10 | 2.8138495897E−08 | −1.7789124826E−09 |
| A10 | −1.2195123842E−11 | −4.3541255312E−11 | −4.5761845562E−10 | 2.2806937975E−10 |
| A11 | 9.2495875686E−13 | 6.6703022390E−13 | −2.2829747195E−10 | −4.6446723390E−11 |
| A12 | 1.0648727186E−14 | 1.3320929266E−13 | 9.1401727067E−12 | 9.3360595180E−12 |
| A13 | −9.0765101840E−15 | −5.1949363818E−15 | 3.3785393688E−12 | −1.2155796142E−12 |
| A14 | 8.3482117297E−16 | −5.4424298019E−16 | −4.8475637269E−13 | 9.4286048490E−14 |
| A15 | −3.4727150634E−17 | 4.7546663164E−17 | 2.6357850246E−14 | −4.0031099544E−15 |
| A16 | 5.7560917383E−19 | −1.0772187202E−18 | −5.3839240747E−16 | 7.1958740892E−17 |

### Example 4

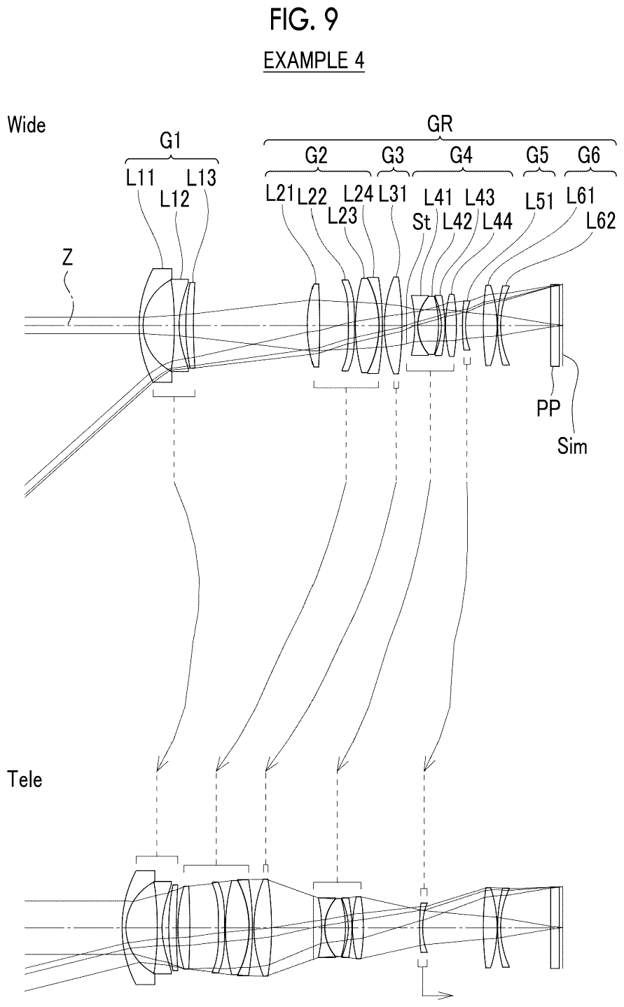

FIG. 9 illustrates a configuration and a moving path of a zoom lens of Example 4. The zoom lens of Example 4 consists of, in order from the object side to the image side, the first lens group G1 having a negative refractive power, the second lens group G2 having a positive refractive power, the third lens group G3 having a positive refractive power, the fourth lens group G4 having a positive refractive power, the fifth lens group G5 having a negative refractive power, and a sixth lens group G6 having a positive refractive power. The subsequent group GR consists of the second lens group G2, the third lens group G3, the fourth lens group G4, the fifth lens group G5, and the sixth lens group G6. During zooming from the wide angle end to the telephoto end, the first lens group G1, the second lens group G2, the third lens group G3, the fourth lens group G4, and the fifth lens group G5 move along the optical axis Z by changing spacings with respect to adjacent lens groups, and the sixth lens group G6 is fixed with respect to the image plane Sim.

The focus group consists of the fifth lens group G5, and the focus group moves to the image side during focusing from the infinite distance object to the nearest object.

The first lens group G1 consists of, in order from the object side to the image side, three lenses including the lenses L11 to L13. The second lens group G2 consists of, in order from the object side to the image side, four lenses including the lenses L21 to L24. The third lens group G3 consists of one lens that is the lens L31. The fourth lens group G4 consists of, in order from the object side to the image side, the aperture stop St and four lenses including lenses L41 to L44. The fifth lens group G5 consists of one lens that is the lens L51. The sixth lens group G6 consists of, in order from the object side to the image side, two lenses including lenses L61 and L62.

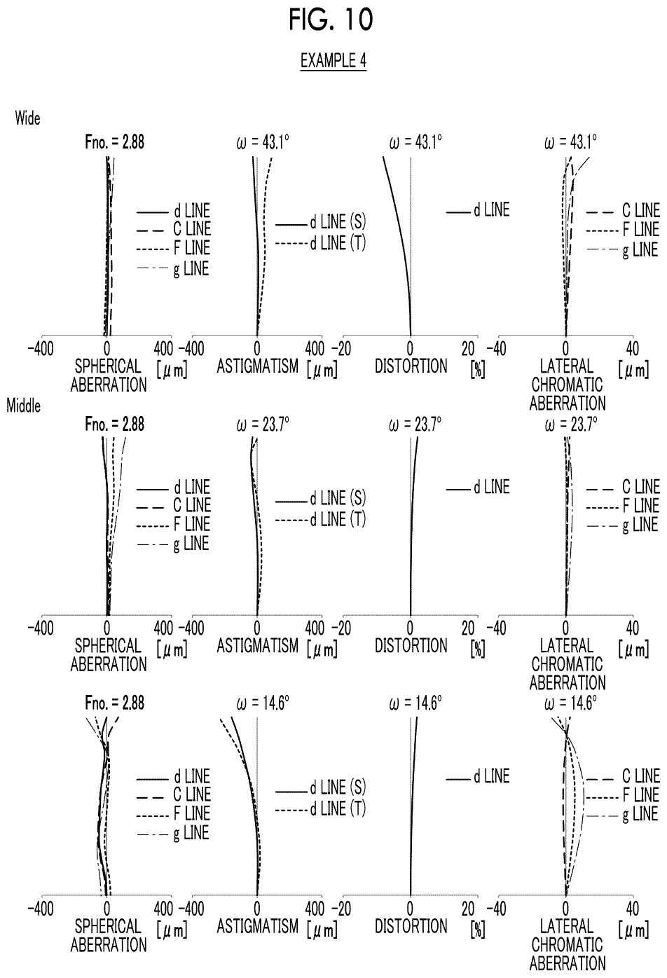

For the zoom lens of Example 4, Table 10 shows basic lens data, Table 11 shows specifications and a variable surface spacing, Table 12 shows aspherical coefficients, and FIG. 10 illustrates each aberration diagram.

TABLE 10
Example 4

| Sn | R | D | Nd | νd | θgF | ED | SG |
|---|---|---|---|---|---|---|---|
| 1 | 44.2049 | 1.2991 | 1.69680 | 55.53 | 0.54341 | 39.427 | 3.700 |
| 2 | 18.1578 | 10.3505 | | | | 31.260 | |
| *3 | −204.3649 | 1.6005 | 1.61881 | 63.85 | 0.54182 | 31.019 | 3.570 |
| *4 | 28.6350 | 2.2063 | | | | 29.704 | |
| 5 | 78.6745 | 2.5350 | 1.94595 | 17.98 | 0.65460 | 29.700 | 3.510 |
| 6 | 227.3937 | DD[6] | | | | 29.528 | |
| 7 | 51.8333 | 3.9337 | 1.90366 | 31.31 | 0.59481 | 28.460 | 4.510 |
| 8 | −315.9962 | 9.5020 | | | | 28.730 | |
| *9 | −323.3870 | 2.0036 | 1.68948 | 31.02 | 0.59874 | 30.580 | 2.880 |
| *10 | −519.6372 | 0.3310 | | | | 31.503 | |
| 11 | 65.4387 | 7.8022 | 1.49700 | 81.61 | 0.53887 | 32.624 | 3.700 |
| 12 | −37.0450 | 1.1121 | 1.84666 | 23.78 | 0.62054 | 32.609 | 3.540 |
| 13 | −107.5732 | DD[13] | | | | 33.247 | |
| 14 | 46.7660 | 5.8168 | 1.72916 | 54.68 | 0.54451 | 33.564 | 4.180 |
| 15 | −118.3219 | DD[15] | | | | 33.130 | |
| 16 (St) | ∞ | 2.7051 | | | | 21.971 | |
| 17 | −48.5320 | 1.0197 | 1.84666 | 23.78 | 0.62054 | 20.785 | 3.540 |
| 18 | 15.7573 | 6.8536 | 1.49700 | 81.61 | 0.53887 | 19.844 | 3.700 |
| 19 | −37.0682 | 0.9573 | | | | 20.178 | |
| *20 | −20.0856 | 1.2009 | 1.73077 | 40.50 | 0.57149 | 20.173 | 3.220 |
| *21 | −34.2424 | 0.2000 | | | | 20.802 | |
| 22 | 46.1426 | 3.5831 | 1.92286 | 18.90 | 0.64960 | 21.526 | 3.580 |
| 23 | −70.8871 | DD[23] | | | | 21.400 | |
| *24 | 114.5357 | 1.0232 | 1.80139 | 45.45 | 0.55814 | 17.000 | 4.840 |
| *25 | 28.5126 | DD[25] | | | | 17.069 | |
| 26 | 112.6342 | 4.5452 | 1.80400 | 46.53 | 0.55775 | 27.447 | 4.460 |
| 27 | −46.2503 | 0.1997 | | | | 27.800 | |
| 28 | 56.6299 | 1.0007 | 1.48749 | 70.24 | 0.53007 | 27.413 | 2.460 |
| 29 | 33.3334 | 16.5743 | | | | 26.924 | |
| 30 | ∞ | 2.8500 | 1.51680 | 64.20 | 0.53430 | 28.129 | 2.520 |
| 31 | ∞ | 1.1102 | | | | 28.294 | |

TABLE 11
Example 4

| | Wide | Middle | Tele |
|---|---|---|---|
| Zr | 1.00 | 1.92 | 3.24 |
| f | 16.49 | 31.68 | 53.43 |
| Bf | 19.56 | 19.56 | 19.56 |
| Fno. | 2.88 | 2.88 | 2.88 |
| 2ω [°] | 86.2 | 47.4 | 29.2 |
| DD[6] | 37.6591 | 11.4676 | 0.5010 |
| DD[13] | 0.6772 | 2.2424 | 0.4991 |
| DD[15] | 1.5003 | 6.1155 | 13.6986 |
| DD[23] | 2.0007 | 11.4914 | 18.5625 |
| DD[25] | 5.8678 | 10.1653 | 20.1607 |

TABLE 12
Example 4

| Sn | 3 | 4 | 9 | 10 |
|---|---|---|---|---|
| KA | 1.0000000000E+00 | 1.0000000000E+00 | 1.0000000000E+00 | 1.0000000000E+00 |
| A3 | 0.0000000000E+00 | 0.0000000000E+00 | 0.0000000000E+00 | 0.0000000000E+00 |
| A4 | −4.2607096563E−05 | −5.5665585041E−05 | −4.7145673669E−05 | −4.7989751832E−05 |
| A5 | 3.7240227128E−06 | 3.9351845355E−06 | 3.0795186582E−06 | 2.7801112663E−06 |
| A6 | 3.3904354385E−08 | 1.5300934868E−08 | −4.8890417559E−07 | −3.7256089425E−07 |
| A7 | −1.4110893254E−08 | −1.4708914673E−08 | 4.8485695020E−08 | 2.7997657944E−08 |
| A8 | −3.7782889095E−10 | −3.7962553883E−10 | −3.1916387392E−09 | −3.9086863643E−10 |
| A9 | 1.3943088655E−10 | 1.5064582746E−10 | 2.6410030472E−10 | −3.7561240636E−11 |
| A10 | −1.2412125471E−11 | −1.2146260945E−11 | −2.3365482553E−11 | 4.1043617871E−13 |
| A11 | 8.2199729514E−13 | 3.3638892181E−13 | 1.3904248465E−12 | 2.0119967383E−14 |
| A12 | −4.4052415789E−14 | 3.8186246243E−14 | −6.4474239131E−14 | 6.6875049607E−15 |
| A13 | 1.7760098924E−15 | −5.2455312924E−15 | 3.4689910772E−15 | −5.6185762337E−16 |
| A14 | −5.2204103286E−17 | 2.8879459019E−16 | −1.6988933252E−16 | 2.1609535843E−17 |
| A15 | 1.0008614453E−18 | −8.0105506595E−18 | 5.0547734718E−18 | −4.1944279067E−19 |
| A16 | −9.2391052610E−21 | 9.1893481310E−20 | −6.3518230875E−20 | 3.2551866752E−21 |
| Sn | 20 | 21 | 24 | 25 |
| KA | 1.0000000000E+00 | 1.0000000000E+00 | 1.0000000000E+00 | 1.0000000000E+00 |
| A3 | 0.0000000000E+00 | 0.0000000000E+00 | 0.0000000000E+00 | 0.0000000000E+00 |
| A4 | 6.7547084582E−05 | 6.2110092408E−05 | 6.4776963628E−05 | 7.9615562386E−05 |
| A5 | 6.8827314754E−07 | 2.2213255620E−06 | 6.2322447638E−07 | −4.5191751054E−07 |
| A6 | 1.5817640217E−06 | −4.0701689177E−07 | −1.5685492937E−06 | −1.9115584494E−06 |
| A7 | −9.2533707668E−07 | −2.0275192644E−08 | 1.2695441104E−07 | 4.0047485458E−07 |
| A8 | 2.2709693011E−07 | 1.0161278786E−08 | 9.9605603036E−09 | −6.8107190243E−08 |
| A9 | −2.9087161639E−08 | −3.2917887997E−09 | −3.0041681509E−09 | 7.2239077169E−09 |
| A10 | 9.7507899663E−10 | 8.2957393827E−10 | 4.1927691674E−10 | 3.1616926108E−10 |
| A11 | 2.6890835297E−10 | −1.4115108962E−10 | −4.1840623808E−11 | −1.9249471007E−10 |
| A12 | −4.2382633696E−11 | 1.6386252979E−11 | 8.8677618141E−13 | 1.6017872704E−11 |
| A13 | 2.3328535953E−12 | −1.2938671218E−12 | 4.0424287230E−13 | 1.1451983056E−12 |
| A14 | −3.3458432505E−15 | 6.6621479723E−14 | −5.5136658114E−14 | −2.9743438591E−13 |
| A15 | −4.7746264128E−15 | −2.0209508378E−15 | 3.0738811550E−15 | 2.0432054626E−14 |
| A16 | 1.4326759960E−16 | 2.7425811665E−17 | −6.6599910375E−17 | −5.0109273994E−16 |

### Example 5

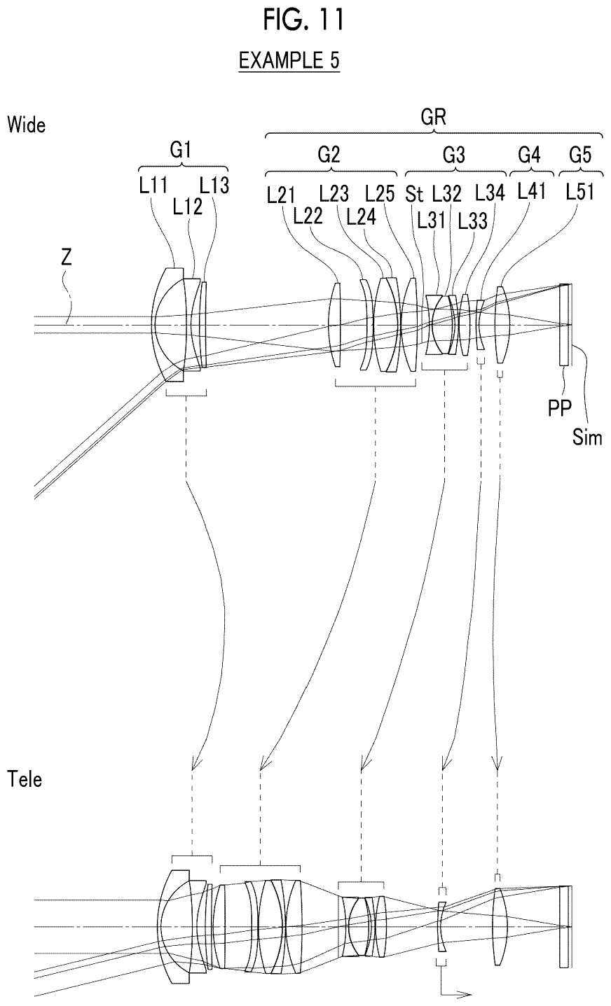

FIG. 11 illustrates a configuration and a moving path of a zoom lens of Example 5. The zoom lens of Example 5 consists of, in order from the object side to the image side, the first lens group G1 having a negative refractive power, the second lens group G2 having a positive refractive power, the third lens group G3 having a positive refractive power, the fourth lens group G4 having a negative refractive power, and the fifth lens group G5 having a positive refractive power. The subsequent group GR consists of the second lens group G2, the third lens group G3, the fourth lens group G4, and the fifth lens group G5.

During zooming from the wide angle end to the telephoto end, the first lens group G1, the second lens group G2, the third lens group G3, the fourth lens group G4, and the fifth lens group G5 move along the optical axis Z by changing spacings with respect to adjacent lens groups. The focus group consists of the fourth lens group G4, and the focus group moves to the image side during focusing from the infinite distance object to the nearest object.

The first lens group G1 consists of, in order from the object side to the image side, three lenses including the lenses L11 to L13. The second lens group G2 consists of, in order from the object side to the image side, five lenses including the lenses L21 to L25. The third lens group G3 consists of, in order from the object side to the image side, the aperture stop St and four lenses including the lenses L31 to L34. The fourth lens group G4 consists of one lens that is the lens L41. The fifth lens group G5 consists of one lens that is the lens L51.

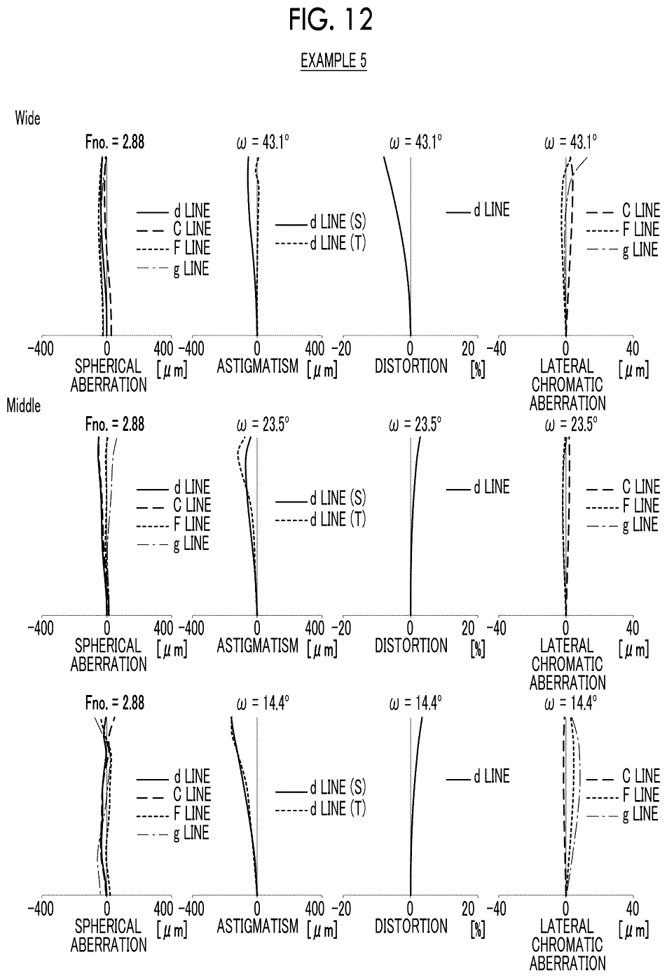

For the zoom lens of Example 5, Table 13 shows basic lens data, Table 14 shows specifications and a variable surface spacing, Table 15 shows aspherical coefficients, and FIG. 12 illustrates each aberration diagram.

TABLE 13
Example 5

| Sn | R | D | Nd | νd | θgF | ED | SG |
|---|---|---|---|---|---|---|---|
| 1 | 42.3657 | 1.2000 | 1.69680 | 55.46 | 0.54260 | 39.268 | 3.670 |
| 2 | 18.2781 | 10.3780 | | | | 31.394 | |
| *3 | −232.4961 | 1.5000 | 1.59201 | 67.02 | 0.53589 | 31.057 | 3.140 |
| *4 | 28.8393 | 2.8006 | | | | 29.559 | |
| 5 | 120.3141 | 2.0172 | 1.98613 | 16.48 | 0.66558 | 29.500 | 3.540 |
| 6 | 413.9655 | DD[6] | | | | 29.435 | |
| 7 | 46.2679 | 3.9189 | 1.90366 | 31.31 | 0.59481 | 28.800 | 4.510 |
| 8 | −855.2208 | 8.8424 | | | | 28.983 | |
| *9 | −184.1931 | 2.0000 | 1.68948 | 31.02 | 0.59874 | 30.356 | 2.880 |
| *10 | −256.5610 | 0.2292 | | | | 31.289 | |
| 11 | 56.0759 | 7.9117 | 1.49700 | 81.61 | 0.53887 | 32.283 | 3.700 |
| 12 | −36.2870 | 1.0000 | 1.84666 | 23.78 | 0.62054 | 32.166 | 3.540 |
| 13 | −91.2345 | 0.2009 | | | | 32.603 | |
| 14 | 42.0311 | 5.3024 | 1.72916 | 54.67 | 0.54534 | 32.300 | 4.050 |
| 15 | −224.6624 | DD[15] | | | | 31.726 | |
| 16 (St) | ∞ | 2.5084 | | | | 21.666 | |
| 17 | −44.3269 | 0.8991 | 1.84666 | 23.78 | 0.62054 | 20.614 | 3.540 |
| 18 | 16.1266 | 6.6821 | 1.49700 | 81.61 | 0.53887 | 19.675 | 3.700 |
| 19 | −36.7518 | 0.8636 | | | | 19.958 | |
| *20 | −19.8192 | 1.2000 | 1.68948 | 31.02 | 0.59874 | 19.945 | 2.880 |
| *21 | −34.2802 | 0.2009 | | | | 20.476 | |
| 22 | 43.1032 | 3.5928 | 1.92286 | 18.90 | 0.64960 | 21.109 | 3.580 |
| 23 | −67.8003 | DD[23] | | | | 21.000 | |
| *24 | 49.3212 | 1.0003 | 1.80139 | 45.45 | 0.55814 | 17.000 | 4.840 |
| *25 | 17.4008 | DD[25] | | | | 17.089 | |
| 26 | 99.3998 | 4.9168 | 1.58144 | 40.75 | 0.57757 | 26.096 | 2.590 |
| 27 | −36.8725 | DD[27] | | | | 26.500 | |
| 28 | ∞ | 2.8500 | 1.51680 | 64.20 | 0.53430 | 28.151 | 2.520 |
| 29 | ∞ | 1.1132 | | | | 28.320 | |

TABLE 14
Example 5

| | Wide | Middle | Tele |
|---|---|---|---|
| Zr | 1.00 | 1.92 | 3.24 |
| f | 16.49 | 31.68 | 53.42 |
| Bf | 19.51 | 21.79 | 20.28 |
| Fno. | 2.88 | 2.88 | 2.88 |
| 2ω [°] | 86.2 | 47.0 | 28.8 |
| DD[6] | 40.4763 | 11.6433 | 0.5888 |
| DD[15] | 1.5009 | 5.2849 | 11.8094 |
| DD[23] | 2.0008 | 10.1468 | 16.9040 |
| DD[25] | 5.2676 | 7.3234 | 17.2581 |
| DD[27] | 16.5206 | 18.7991 | 17.2842 |

TABLE 15
Example 5

| Sn | 3 | 4 | 9 | 10 |
|---|---|---|---|---|
| KA | 1.0000000000E+00 | 1.0000000000E+00 | 1.0000000000E+00 | 1.0000000000E+00 |
| A3 | 0.0000000000E+00 | 0.0000000000E+00 | 0.0000000000E+00 | 0.0000000000E+00 |
| A4 | −4.1255361576E−05 | −5.3321366167E−05 | −3.7965934433E−05 | −3.9482814266E−05 |
| A5 | 3.7279574126E−06 | 3.8745022973E−06 | 1.5636838996E−06 | 1.2872576007E−06 |
| A6 | 1.3560226497E−08 | −1.7662393806E−09 | −3.0746049946E−07 | −2.0285302955E−07 |
| A7 | −1.1872010926E−08 | −1.3590490407E−08 | 3.3376637049E−08 | 1.3923788603E−08 |
| A8 | −2.3916883713E−10 | −1.3448412018E−10 | −2.2903272534E−09 | 8.5641427727E−10 |
| A9 | 5.0509222565E−11 | 8.8992398633E−11 | 2.6807189526E−10 | −1.7008839529E−10 |
| A10 | 2.2809515648E−12 | −5.4559813075E−12 | −3.6361083002E−11 | 1.0166016514E−11 |
| A11 | −4.9363941779E−13 | 4.3402646401E−14 | 3.2240617192E−12 | −3.4313693370E−13 |
| A12 | 1.9723522755E−14 | 1.8987084934E−14 | −1.8951120289E−13 | 1.0178629909E−14 |
| A13 | 1.7258106807E−16 | −1.6848590214E−15 | 7.7409649429E−15 | −5.5318796668E−16 |
| A14 | −1.0484042232E−16 | 6.9755374579E−17 | −2.1187376066E−16 | 3.6564223462E−17 |
| A15 | 3.8707473183E−18 | −1.4791835259E−18 | 3.5529999279E−18 | −1.2841738130E−18 |
| A16 | −5.1401652312E−20 | 1.2812359841E−20 | −2.8106246654E−20 | 1.7397975920E−20 |
| Sn | 20 | 21 | 24 | 25 |
| KA | 1.0000000000E+00 | 1.0000000000E+00 | 1.0000000000E+00 | 1.0000000000E+00 |
| A3 | 0.0000000000E+00 | 0.0000000000E+00 | 0.0000000000E+00 | 0.0000000000E+00 |
| A4 | 6.9219069821E−05 | 6.6071405521E−05 | −2.0203403945E−04 | −2.2425480023E−04 |
| A5 | 4.2817439177E−06 | 3.5481642706E−06 | 1.8424337807E−05 | 2.4278963950E−05 |
| A6 | −8.8064731823E−07 | −4.4316202378E−07 | 2.8280836371E−06 | −4.4226232492E−07 |
| A7 | 7.7135452514E−08 | −9.4926074484E−08 | −1.6066112517E−06 | −1.1035941564E−07 |
| A8 | −1.3358755871E−08 | 2.5726393297E−08 | 4.4080142740E−07 | 1.2467207242E−08 |
| A9 | 2.4710355564E−09 | −2.7369008151E−09 | −6.8381589831E−08 | −7.7192463910E−10 |
| A10 | −2.7186863305E−10 | 8.0391091950E−11 | 3.5330374769E−09 | −2.4457998523E−10 |
| A11 | 1.9583369875E−11 | 6.9301788296E−12 | 6.2540778204E−10 | 1.1624380740E−10 |
| A12 | −1.3580066810E−12 | 1.5308363106E−12 | −1.2033127112E−10 | −2.3369488528E−11 |
| A13 | 1.3812924607E−13 | −5.2276471404E−13 | 5.9225694389E−12 | 2.7399213993E−12 |
| A14 | −1.2277778695E−14 | 5.4353001060E−14 | 3.0819195701E−13 | −1.9457021495E−13 |
| A15 | 6.0539303523E−16 | −2.6004278048E−15 | −4.3515494048E−14 | 7.7925405177E−15 |
| A16 | −1.2118206846E−17 | 4.9045637852E−17 | 1.3119839374E−15 | −1.3564809945E−16 |

### Example 6

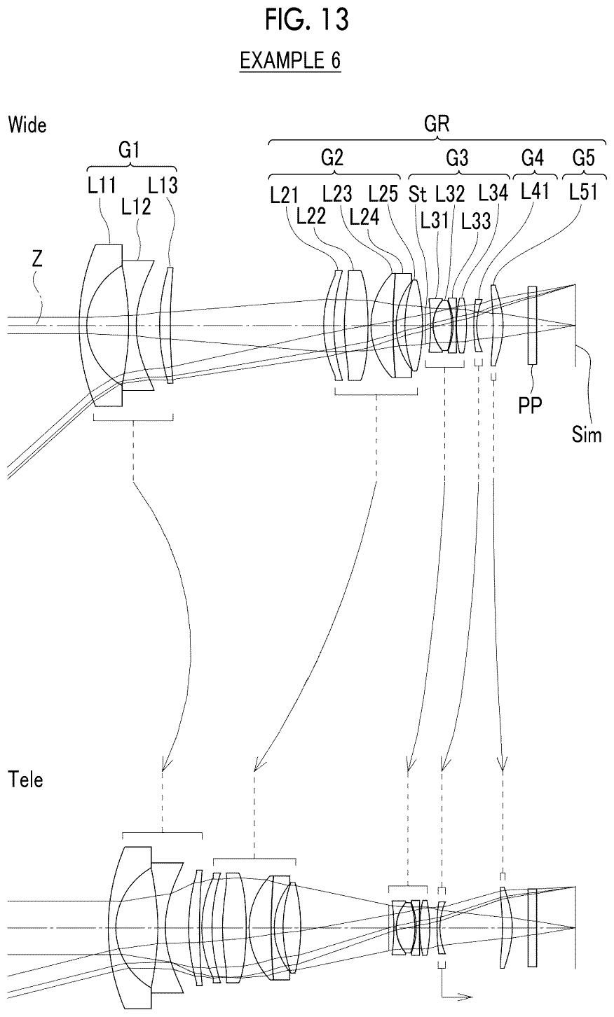

FIG. 13 illustrates a configuration and a moving path of a zoom lens of Example 6. The zoom lens of Example 6 consists of, in order from the object side to the image side, the first lens group G1 having a negative refractive power, the second lens group G2 having a positive refractive power, the third lens group G3 having a positive refractive power, the fourth lens group G4 having a negative refractive power, and the fifth lens group G5 having a positive refractive power. The subsequent group GR consists of the second lens group G2, the third lens group G3, the fourth lens group G4, and the fifth lens group G5.

During zooming from the wide angle end to the telephoto end, the first lens group G1, the second lens group G2, the third lens group G3, the fourth lens group G4, and the fifth lens group G5 move along the optical axis Z by changing spacings with respect to adjacent lens groups. The focus group consists of the fourth lens group G4, and the focus group moves to the image side during focusing from the infinite distance object to the nearest object.

The first lens group G1 consists of, in order from the object side to the image side, three lenses including the lenses L11 to L13. The second lens group G2 consists of, in order from the object side to the image side, five lenses including the lenses L21 to L25. The third lens group G3 consists of, in order from the object side to the image side, the aperture stop St and four lenses including the lenses L31 to L34. The fourth lens group G4 consists of one lens that is the lens L41. The fifth lens group G5 consists of one lens that is the lens L51.

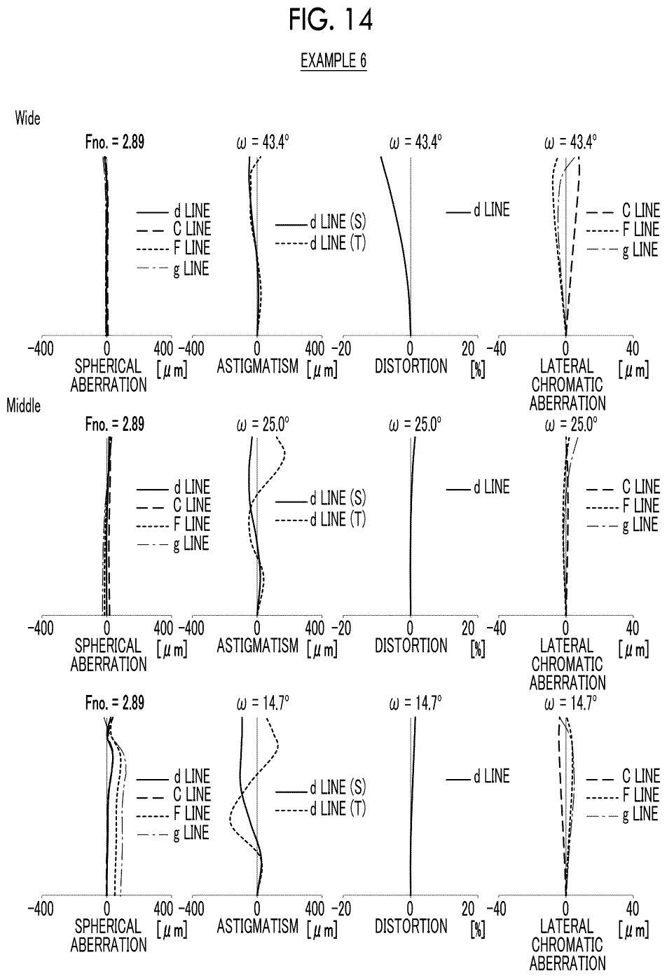

For the zoom lens of Example 6, Table 16 shows basic lens data, Table 17 shows specifications and a variable surface spacing, Table 18 shows aspherical coefficients, and FIG. 14 illustrates each aberration diagram.

TABLE 16
Example 6

| Sn | R | D | Nd | νd | θgF | ED | SG |
|---|---|---|---|---|---|---|---|
| 1 | 75.0109 | 2.5000 | 1.58913 | 61.13 | 0.54067 | 52.780 | 3.310 |
| 2 | 24.3292 | 13.8799 | | | | 40.717 | |
| *3 | −85.7865 | 2.5002 | 1.58313 | 59.38 | 0.54237 | 40.127 | 3.050 |
| *4 | 37.1614 | 7.7384 | | | | 37.579 | |
| 5 | 70.5617 | 3.5387 | 1.92286 | 20.88 | 0.63900 | 37.800 | 3.940 |
| 6 | 219.6188 | DD[6] | | | | 37.567 | |
| 7 | 41.9834 | 3.3656 | 1.92286 | 20.88 | 0.63900 | 34.800 | 3.940 |
| 8 | 64.8972 | 3.4804 | | | | 34.488 | |
| *9 | 69.3107 | 7.8253 | 1.58313 | 59.38 | 0.54237 | 34.981 | 3.050 |
| *10 | −109.6813 | 0.9612 | | | | 35.540 | |
| 11 | 26.8224 | 7.3171 | 1.49700 | 81.61 | 0.53887 | 33.875 | 3.700 |
| 12 | 213.3920 | 1.0000 | 1.85896 | 22.73 | 0.62844 | 32.678 | 3.710 |
| 13 | 25.1680 | 2.9247 | | | | 29.888 | |
| 14 | 49.2307 | 5.8162 | 1.61800 | 63.33 | 0.54414 | 29.971 | 3.670 |
| 15 | −66.9253 | DD[15] | | | | 29.794 | |
| 16 (St) | ∞ | 1.6899 | | | | 15.817 | |
| 17 | −74.6872 | 0.8000 | 1.67270 | 32.17 | 0.59633 | 15.677 | 2.900 |
| 18 | 13.7898 | 6.1427 | 1.49700 | 81.61 | 0.53887 | 15.750 | 3.700 |
| 19 | −28.1550 | 0.4579 | | | | 16.225 | |
| 20 | −24.2695 | 1.0000 | 1.62004 | 36.30 | 0.58729 | 16.223 | 2.670 |
| 21 | 290.4566 | 0.1500 | | | | 16.884 | |
| 22 | 44.2907 | 3.3113 | 1.92286 | 20.88 | 0.63900 | 17.298 | 3.940 |
| 23 | −48.1830 | DD[23] | | | | 17.368 | |
| *24 | 56.7843 | 1.0000 | 1.85135 | 40.10 | 0.56954 | 14.800 | 5.250 |
| *25 | 22.4502 | DD[25] | | | | 14.897 | |
| *26 | −82.0631 | 3.2467 | 1.85135 | 40.10 | 0.56954 | 25.489 | 5.250 |
| *27 | −32.9021 | DD[27] | | | | 26.000 | |
| 28 | ∞ | 2.8000 | 1.51680 | 64.20 | 0.53430 | 28.078 | 2.520 |
| 29 | ∞ | 1.1000 | | | | 28.276 | |

TABLE 17
Example 6

| | Wide | Middle | Tele |
|---|---|---|---|
| Zr | 1.00 | 1.83 | 3.24 |
| f | 16.49 | 30.11 | 53.37 |
| Bf | 23.03 | 22.31 | 19.93 |
| Fno. | 2.89 | 2.89 | 2.89 |
| 2ω [°] | 86.8 | 50.0 | 29.4 |
| DD[6] | 50.5402 | 16.4951 | 0.7998 |
| DD[15] | 0.9998 | 12.0513 | 28.9381 |
| DD[23] | 2.3997 | 3.4536 | 2.3994 |
| DD[25] | 5.4193 | 9.3382 | 20.7109 |
| DD[27] | 20.0804 | 19.3604 | 16.9813 |

TABLE 18
Example 6

| Sn | 3 | 4 | 9 | 10 |
|---|---|---|---|---|
| KA | 1.0000000000E+00 | 1.0000000000E+00 | 1.0000000000E+00 | 1.0000000000E+00 |
| A3 | 0.0000000000E+00 | 0.0000000000E+00 | 0.0000000000E+00 | 0.0000000000E+00 |
| A4 | 4.5547400309E−06 | −6.1298362567E−07 | −1.4607829245E−05 | −9.8172496673E−06 |
| A5 | −7.3984509034E−07 | −1.0978025671E−06 | 2.0303728933E−06 | 1.9912568445E−06 |
| A6 | 7.0364585677E−08 | 1.0581018808E−07 | −2.2637318827E−07 | −2.1851861462E−07 |
| A7 | −7.6418352230E−10 | −1.8915150020E−09 | 1.1272064022E−08 | 1.0169919178E−08 |
| A8 | −2.2848297378E−10 | −2.8168332780E−10 | −2.0825688962E−10 | −1.0577174748E−10 |
| A9 | 1.2253828245E−11 | 1.6504354730E−11 | −2.3340751917E−12 | −7.5697988206E−12 |
| A10 | −1.9523353598E−13 | −2.7797245920E−13 | 5.6670672811E−14 | 1.6931275178E−13 |
| Sn | 24 | 25 | 26 | 27 |
| KA | 1.0000000000E+00 | 1.0000000000E+00 | 1.0000000000E+00 | 1.0000000000E+00 |
| A3 | 0.0000000000E+00 | 0.0000000000E+00 | 0.0000000000E+00 | 0.0000000000E+00 |
| A4 | −5.2927188801E−05 | −6.0566804870E−05 | 9.9226193091E−06 | 6.8755548175E−06 |
| A5 | −1.1192129902E−05 | −7.5913836594E−06 | −1.1271875622E−06 | −1.6831067301E−07 |
| A6 | 5.0096573732E−06 | 4.7480926666E−06 | 8.1316242235E−08 | −5.1043375406E−08 |
| A7 | −4.4942453483E−07 | −5.1286667859E−07 | 9.0591557252E−09 | 1.1550122800E−08 |
| A8 | −3.1530104945E−08 | −1.8402991874E−08 | −5.0905223129E−10 | −2.8600168136E−11 |
| A9 | 7.8139483138E−09 | 6.9659910274E−09 | −1.2761653321E−11 | −3.7623556845E−11 |
| A10 | −3.7130945435E−10 | −3.5516731948E−10 | 7.5346047419E−13 | 1.0364915973E−12 |

### Example 7

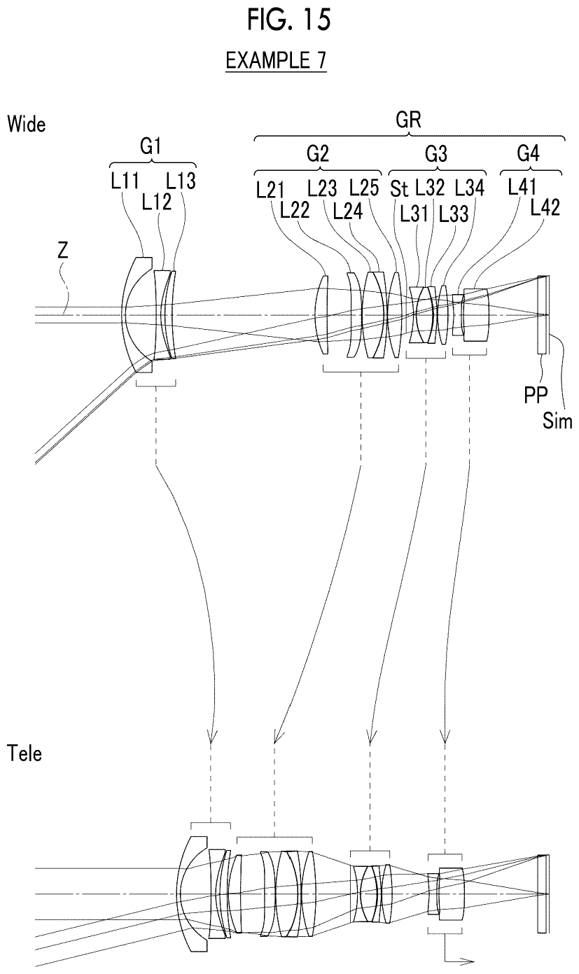

FIG. 15 illustrates a configuration and a moving path of a zoom lens of Example 7. The zoom lens of Example 7 consists of, in order from the object side to the image side, the first lens group G1 having a negative refractive power, the second lens group G2 having a positive refractive power, the third lens group G3 having a positive refractive power, and the fourth lens group G4 having a negative refractive power. The subsequent group GR consists of the second lens group G2, the third lens group G3, and the fourth lens group G4. During zooming from the wide angle end to the telephoto end, the first lens group G1, the second lens group G2, the third lens group G3, and the fourth lens group G4 move along the optical axis Z by changing spacings with respect to adjacent lens groups. The focus group consists of the fourth lens group G4, and the focus group moves to the image side during focusing from the infinite distance object to the nearest object.

The first lens group G1 consists of, in order from the object side to the image side, three lenses including the lenses L11 to L13. The second lens group G2 consists of, in order from the object side to the image side, five lenses including the lenses L21 to L25. The third lens group G3 consists of, in order from the object side to the image side, the aperture stop St and four lenses including the lenses L31 to L34. The fourth lens group G4 consists of, in order from the object side to the image side, two lenses including the lenses L41 and L42.

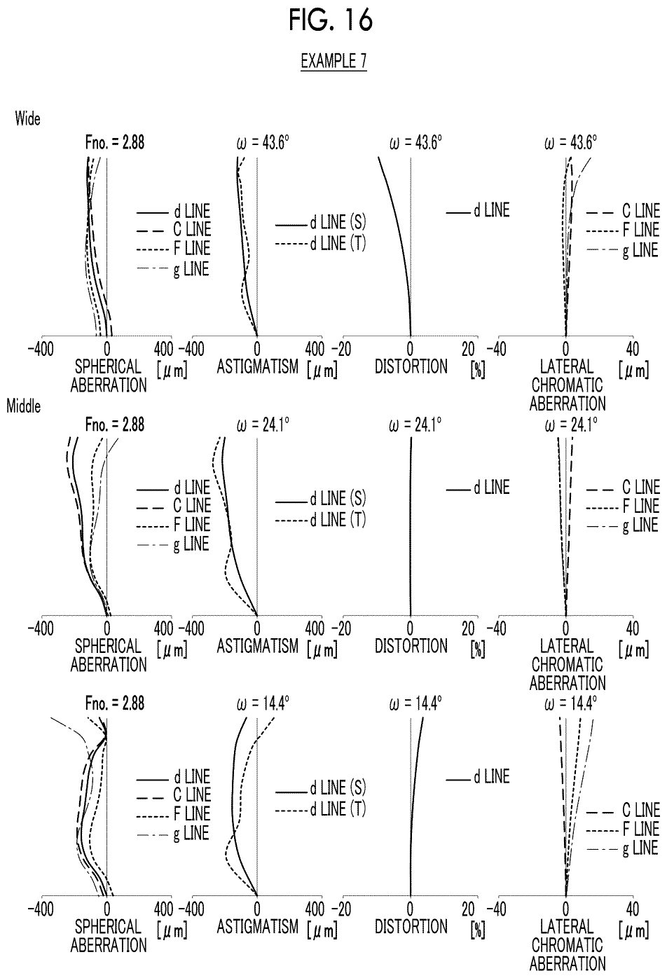

For the zoom lens of Example 7, Table 19 shows basic lens data, Table 20 shows specifications and a variable surface spacing, Table 21 shows aspherical coefficients, and FIG. 16 illustrates each aberration diagram.

TABLE 19
Example 7

| Sn | R | D | Nd | νd | θgF | ED | SG |
|---|---|---|---|---|---|---|---|
| 1 | 45.5338 | 1.3006 | 1.77250 | 49.60 | 0.55212 | 41.432 | 4.230 |
| 2 | 19.6801 | 10.5895 | | | | 33.323 | |
| *3 | −439.0131 | 1.5995 | 1.61881 | 63.85 | 0.54182 | 32.981 | 3.570 |
| *4 | 28.3977 | 1.4187 | | | | 31.497 | |
| 5 | 52.6918 | 2.4779 | 1.94595 | 17.98 | 0.65460 | 31.500 | 3.510 |
| 6 | 100.3299 | DD[6] | | | | 31.223 | |
| 7 | 35.9366 | 4.1632 | 1.69895 | 30.13 | 0.60298 | 28.000 | 2.960 |
| 8 | 333.9621 | 8.2470 | | | | 28.116 | |
| *9 | 300.0660 | 3.6509 | 1.51633 | 64.06 | 0.53345 | 29.420 | 2.380 |
| *10 | −136.5028 | 0.2005 | | | | 30.442 | |
| 11 | 59.9705 | 7.4526 | 1.49700 | 81.61 | 0.53887 | 30.853 | 3.700 |
| 12 | −33.5618 | 1.0991 | 1.84666 | 23.78 | 0.62054 | 30.647 | 3.540 |
| 13 | −97.3449 | 0.1991 | | | | 31.000 | |
| 14 | 47.3243 | 4.8848 | 1.59349 | 67.00 | 0.53667 | 30.645 | 3.140 |
| 15 | −96.9841 | DD[15] | | | | 30.294 | |
| 16 (St) | ∞ | 2.5003 | | | | 20.871 | |
| 17 | −36.1509 | 0.9991 | 1.84666 | 23.78 | 0.62054 | 20.108 | 3.540 |
| 18 | 20.8622 | 5.6321 | 1.49700 | 81.61 | 0.53887 | 19.730 | 3.700 |
| 19 | −29.2787 | 0.3079 | | | | 19.956 | |
| *20 | −22.0763 | 1.1991 | 1.68948 | 31.02 | 0.59874 | 19.942 | 2.880 |
| *21 | −44.1556 | 0.1991 | | | | 20.374 | |
| 22 | 37.9136 | 3.5597 | 1.92286 | 18.90 | 0.64960 | 21.138 | 3.580 |
| 23 | −67.0214 | DD[23] | | | | 21.000 | |
| *24 | −20.7835 | 2.5962 | 1.82080 | 42.71 | 0.56428 | 14.500 | 5.010 |
| *25 | 423.2496 | 0.7497 | | | | 14.675 | |
| *26 | 42.5006 | 8.7817 | 1.68948 | 31.02 | 0.59874 | 14.751 | 2.880 |
| *27 | −153.6224 | DD[27] | | | | 18.765 | |
| 28 | ∞ | 2.8500 | 1.51680 | 64.20 | 0.53430 | 27.400 | 2.520 |
| 29 | ∞ | 1.1165 | | | | 28.078 | |

TABLE 20
Example 7

| | Wide | Middle | Tele |
|---|---|---|---|
| Zr | 1.00 | 1.92 | 3.24 |
| f | 16.50 | 31.69 | 53.45 |
| Bf | 19.77 | 26.75 | 28.30 |
| Fno. | 2.88 | 2.88 | 2.88 |
| 2ω [°] | 87.2 | 48.2 | 28.8 |
| DD[6] | 49.0046 | 16.4332 | 0.5009 |
| DD[15] | 1.5000 | 4.0799 | 11.8474 |
| DD[23] | 1.9991 | 6.5374 | 12.7435 |
| DD[27] | 16.7798 | 23.7562 | 25.3056 |

TABLE 21
Example 7

| Sn | 3 | 4 | 9 | 10 |
|---|---|---|---|---|
| KA | 1.0000000000E+00 | 1.0000000000E+00 | 1.0000000000E+00 | 1.0000000000E+00 |
| A3 | 0.0000000000E+00 | 0.0000000000E+00 | 0.0000000000E+00 | 0.0000000000E+00 |
| A4 | −2.6394553634E−05 | −3.9567191344E−05 | −4.5306373175E−05 | −3.7991987008E−05 |
| A5 | 2.0040760372E−06 | 2.7747547000E−06 | 8.3891431708E−06 | 4.1742483726E−06 |
| A6 | 3.6181219244E−09 | −9.1821403564E−08 | −2.2656451129E−06 | −7.3381584737E−07 |
| A7 | −7.5003839233E−09 | −2.8985871679E−09 | 4.0582222896E−07 | 4.9419675601E−08 |
| A8 | 5.7200471094E−10 | 1.1697827700E−10 | −5.2800805183E−08 | −7.8183576061E−10 |
| A9 | −9.2669452771E−11 | 3.1047139332E−11 | 4.0042315265E−09 | 4.9982966055E−11 |
| A10 | 1.2940970355E−11 | −5.1958988967E−12 | −2.4400454952E−11 | −2.1895248466E−11 |
| A11 | −8.6298254750E−13 | 4.5391908101E−13 | −2.5539642751E−11 | 2.3135383119E−12 |
| A12 | 7.8367921708E−15 | −2.5847627085E−14 | 2.2104292248E−12 | −1.2874018887E−13 |
| A13 | 2.8085172356E−15 | 9.4288037972E−16 | −5.9726359251E−14 | 4.2520432138E−15 |
| A14 | −2.0083354563E−16 | −1.9719108447E−17 | −1.5809138306E−15 | −6.1701239799E−17 |
| A15 | 5.9426159851E−18 | 1.7058947222E−19 | 1.3093648209E−16 | −4.1321332149E−19 |
| A16 | −6.8260161628E−20 | 3.0225470891E−22 | −2.2573862429E−18 | 1.8333461924E−20 |
| Sn | 20 | 21 | 24 | 25 |
| KA | 1.0000000000E+00 | 1.0000000000E+00 | 1.0000000000E+00 | 1.0000000000E+00 |
| A3 | 0.0000000000E+00 | 0.0000000000E+00 | 0.0000000000E+00 | 0.0000000000E+00 |
| A4 | 2.0753700701E−05 | 2.2735582381E−05 | 6.7717591743E−04 | 6.3743331415E−04 |
| A5 | −1.0782212128E−07 | 5.2637806443E−07 | −5.1208644188E−05 | −7.4844991041E−05 |
| A6 | 6.2379297889E−10 | 3.8500426637E−07 | −2.0273963593E−06 | 1.0366084302E−06 |
| A7 | 3.3224942453E−07 | 1.8818189151E−08 | 2.5877697700E−08 | −9.6775642641E−08 |
| A8 | −1.0942015347E−07 | −7.3547102005E−09 | 2.0944427297E−07 | 3.7065286411E−07 |
| A9 | 2.2076518387E−08 | 2.5623498879E−10 | −4.6799142469E−08 | −7.9763154947E−08 |
| A10 | −3.2308389986E−09 | 2.0714163290E−12 | 3.5922473373E−09 | 2.6052684948E−09 |
| A11 | 3.2727333666E−10 | 8.9335761126E−13 | 9.7269229588E−11 | 1.1547172199E−09 |
| A12 | −2.1650571444E−11 | −2.3099657778E−13 | 1.5745930333E−11 | −1.2531609657E−10 |
| A13 | 8.5527652471E−13 | 4.2411402073E−14 | −1.7202585038E−11 | −1.3506043202E−11 |
| A14 | −1.4374715585E−14 | −3.8987615805E−15 | 2.9200086426E−12 | 3.8238068004E−12 |
| A15 | −1.6683785724E−16 | 1.7950231447E−16 | −2.1119668630E−13 | −3.0495173740E−13 |
| A16 | 7.5709355255E−18 | −3.3438843538E−18 | 5.8614384775E−15 | 8.7114290859E−15 |

| Sn | 26 | 27 |
|---|---|---|
| KA | 1.0000000000E+00 | 1.0000000000E+00 |
| A3 | 0.0000000000E+00 | 0.0000000000E+00 |
| A4 | 5.0362639314E−05 | −7.6362726060E−05 |
| A5 | −9.6401031184E−05 | 6.2023305827E−06 |
| A6 | 1.8572167248E−05 | −1.4940292075E−06 |
| A7 | −1.8576621863E−06 | 1.3527794793E−07 |
| A8 | 1.3517195110E−07 | 6.9430935800E−09 |
| A9 | 1.7856657914E−09 | −2.1931690480E−09 |
| A10 | −7.1521980982E−09 | 1.8871330662E−10 |
| A11 | 1.8328126655E−09 | −1.3603445390E−11 |
| A12 | −1.6540185518E−10 | −7.4544173167E−13 |
| A13 | −8.5503558672E−12 | 4.0372712938E−13 |
| A14 | 3.0303924521E−12 | −4.6209322623E−14 |
| A15 | −2.4114357973E−13 | 2.3963615933E−15 |
| A16 | 6.7773086654E−15 | −4.9002386470E−17 |

### Example 8

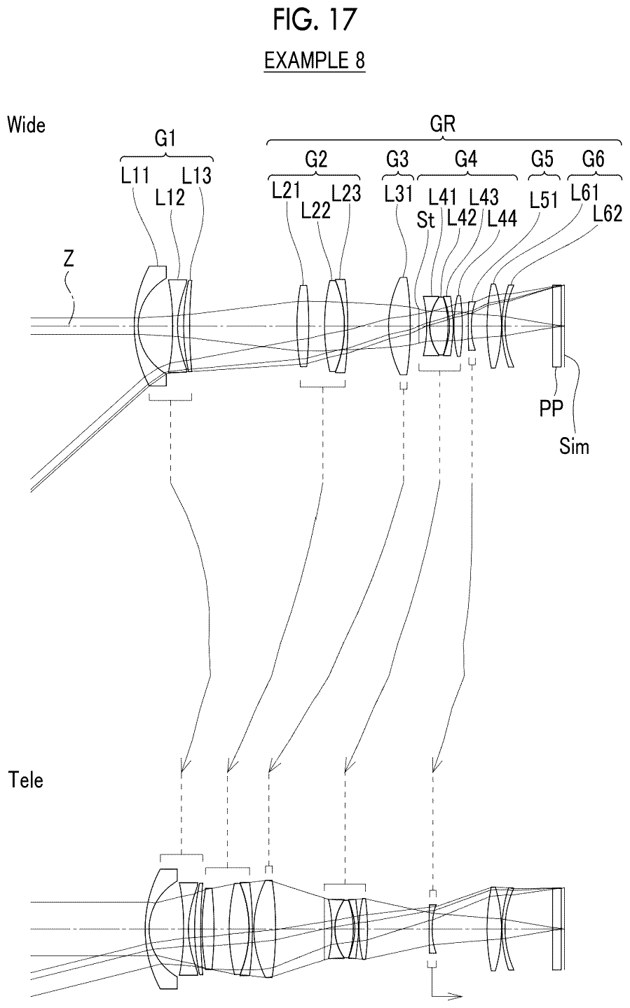

FIG. 17 illustrates a configuration and a moving path of a zoom lens of Example 8. The zoom lens of Example 8 consists of, in order from the object side to the image side, the first lens group G1 having a negative refractive power, the second lens group G2 having a positive refractive power, the third lens group G3 having a positive refractive power, the fourth lens group G4 having a positive refractive power, the fifth lens group G5 having a negative refractive power, and the sixth lens group G6 having a positive refractive power.

The subsequent group GR consists of the second lens group G2, the third lens group G3, the fourth lens group G4, the fifth lens group G5, and the sixth lens group G6. During zooming from the wide angle end to the telephoto end, the first lens group G1, the second lens group G2, the third lens group G3, the fourth lens group G4, and the fifth lens group G5 move along the optical axis Z by changing spacings with respect to adjacent lens groups, and the sixth lens group G6 is fixed with respect to the image plane Sim. During zooming from the wide angle end to the telephoto end, the second lens group G2 and the fourth lens group G4 move along the optical axis Z on the same moving path. The focus group consists of the fifth lens group G5, and the focus group moves to the image side during focusing from the infinite distance object to the nearest object.

The first lens group G1 consists of, in order from the object side to the image side, three lenses including the lenses L11 to L13. The second lens group G2 consists of, in order from the object side to the image side, three lenses including the lenses L21 to L23. The third lens group G3 consists of one lens that is the lens L31. The fourth lens group G4 consists of, in order from the object side to the image side, the aperture stop St and four lenses including the lenses L41 to L44. The fifth lens group G5 consists of one lens that is the lens L51. The sixth lens group G6 consists of, in order from the object side to the image side, two lenses including the lenses L61 and L62.

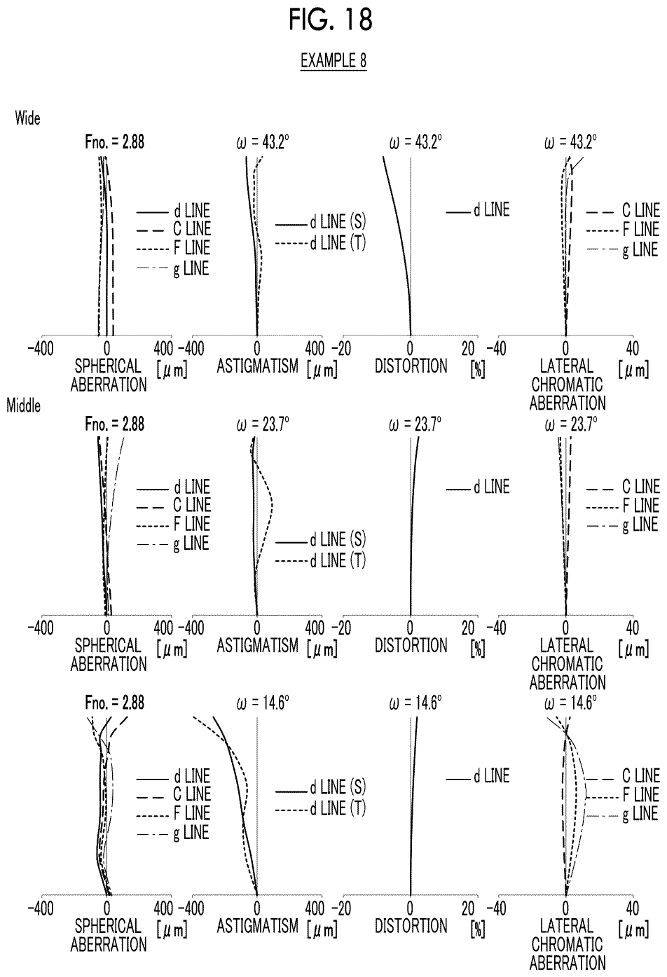

For the zoom lens of Example 8, Table 22 shows basic lens data, Table 23 shows specifications and a variable surface spacing, Table 24 shows aspherical coefficients, and FIG. 18 illustrates each aberration diagram.

TABLE 22
Example 8

| Sn | R | D | Nd | νd | θgF | ED | SG |
|---|---|---|---|---|---|---|---|
| 1 | 45.6420 | 1.2991 | 1.72916 | 54.68 | 0.54451 | 41.450 | 4.180 |
| 2 | 19.4042 | 11.3992 | | | | 33.163 | |
| *3 | −200.0766 | 1.6009 | 1.61881 | 63.85 | 0.54182 | 32.792 | 3.570 |
| *4 | 28.3271 | 2.0458 | | | | 31.568 | |
| 5 | 76.5422 | 1.9923 | 1.89286 | 20.36 | 0.63944 | 31.600 | 3.610 |
| 6 | 178.7017 | DD[6] | | | | 31.436 | |
| 7 | 85.0222 | 3.9168 | 1.90110 | 27.06 | 0.60718 | 27.500 | 3.830 |
| 8 | −149.9510 | 5.0304 | | | | 28.147 | |
| 9 | 71.4147 | 6.5890 | 1.49700 | 81.61 | 0.53887 | 31.279 | 3.700 |
| 10 | −43.2424 | 1.0991 | 1.84666 | 23.78 | 0.62054 | 31.512 | 3.540 |
| 11 | −138.2105 | DD[11] | | | | 32.280 | |
| *12 | 38.2314 | 7.1591 | 1.72903 | 54.04 | 0.54474 | 33.621 | 4.280 |
| *13 | −146.5404 | DD[13] | | | | 33.062 | |
| 14 (St) | ∞ | 2.4991 | | | | 21.517 | |
| 15 | −48.5983 | 0.9991 | 1.84666 | 23.78 | 0.62054 | 20.575 | 3.540 |
| 16 | 17.8258 | 6.0764 | 1.49700 | 81.61 | 0.53887 | 19.880 | 3.700 |
| 17 | −31.9791 | 0.5224 | | | | 20.090 | |
| *18 | −20.1600 | 1.2000 | 1.68948 | 31.02 | 0.59874 | 20.073 | 2.880 |
| *19 | −34.6768 | 0.2000 | | | | 20.518 | |
| 20 | 47.6744 | 2.7869 | 1.92286 | 18.90 | 0.64960 | 21.054 | 3.580 |
| 21 | −82.3730 | DD[21] | | | | 21.000 | |
| *22 | −362.9465 | 0.9991 | 1.73077 | 40.51 | 0.57279 | 16.500 | 3.240 |
| *23 | 33.1875 | DD[23] | | | | 16.784 | |
| 24 | 75.7142 | 4.7453 | 1.83400 | 37.16 | 0.57759 | 28.752 | 4.430 |
| 25 | −52.8912 | 0.1991 | | | | 29.000 | |
| 26 | 47.4881 | 1.0006 | 1.80518 | 25.42 | 0.61616 | 28.409 | 3.370 |
| 27 | 35.7509 | 15.7265 | | | | 27.832 | |
| 28 | ∞ | 2.8500 | 1.51680 | 64.20 | 0.53430 | 28.275 | 2.520 |
| 29 | ∞ | 1.1222 | | | | 28.340 | |

TABLE 23
Example 8

| | Wide | Middle | Tele |
|---|---|---|---|
| Zr | 1.00 | 1.92 | 3.24 |
| f | 16.49 | 31.67 | 53.41 |
| Bf | 18.73 | 18.73 | 18.73 |
| Fno. | 2.88 | 2.88 | 2.88 |
| 2ω [°] | 86.4 | 47.4 | 29.2 |
| DD[6] | 35.4790 | 8.9063 | 0.4991 |
| DD[11] | 13.5179 | 7.4099 | 0.5002 |
| DD[13] | 2.9205 | 9.0285 | 15.9382 |
| DD[21] | 1.9994 | 13.0047 | 20.3576 |
| DD[23] | 5.1990 | 8.1041 | 18.2808 |

TABLE 24
Example 8

| Sn | 3 | 4 | 12 | 13 |
|---|---|---|---|---|
| KA | 1.0000000000E+00 | 1.0000000000E+00 | 1.0000000000E+00 | 1.0000000000E+00 |
| A3 | 0.0000000000E+00 | 0.0000000000E+00 | 0.0000000000E+00 | 0.0000000000E+00 |
| A4 | −7.7122469085E−05 | −9.1046912225E−05 | 1.0594156931E−07 | −3.7179100545E−06 |
| A5 | 6.6835117653E−06 | 7.6414025258E−06 | −2.5690965064E−07 | 2.0872292080E−08 |
| A6 | 6.1589695195E−08 | −1.0872864342E−08 | 3.1608805291E−08 | 9.4470330791E−09 |
| A7 | −2.5152013987E−08 | −3.2637553988E−08 | −2.0709256703E−09 | −6.8698894959E−10 |
| A8 | 2.9838392045E−11 | 2.0802434335E−09 | 1.1880412017E−10 | 1.7105787515E−11 |
| A9 | 1.0010771156E−10 | −1.2648976549E−10 | −1.3470075108E−11 | −1.2139833857E−12 |
| A10 | −5.4366233564E−12 | 7.7547438626E−12 | 1.0604590780E−12 | 2.1686318487E−13 |
| A11 | 1.7468278277E−13 | 1.1117812912E−13 | −3.3922519212E−14 | −9.9220546289E−15 |
| A12 | −8.1579827241E−15 | −6.4548228607E−14 | −1.1678024488E−15 | −4.2011425149E−16 |
| A13 | 6.1183477944E−16 | 5.3595393536E−15 | 1.8350581121E−16 | 8.3082216462E−17 |
| A14 | −3.5735533817E−17 | −2.2875516402E−16 | −8.8725531861E−18 | −4.7839116292E−18 |
| A15 | 1.1017506870E−18 | 5.2087516884E−18 | 2.1040421418E−19 | 1.3129131401E−19 |
| A16 | −1.3620634083E−20 | −5.0268396416E−20 | −2.0562603209E−21 | −1.4538247322E−21 |
| Sn | 18 | 19 | 22 | 23 |
| KA | 1.0000000000E+00 | 1.0000000000E+00 | 1.0000000000E+00 | 1.0000000000E+00 |
| A3 | 0.0000000000E+00 | 0.0000000000E+00 | 0.0000000000E+00 | 0.0000000000E+00 |
| A4 | 8.9002643497E−05 | 8.9119167797E−05 | 9.8510305686E−05 | 1.0898730796E−04 |
| A5 | 7.6019765075E−08 | −2.2628949195E−06 | −4.1599265760E−06 | −3.9388797519E−06 |
| A6 | −8.4521943425E−07 | −1.0557461777E−07 | −5.1379006028E−07 | −3.7869851667E−07 |
| A7 | 2.1734753071E−07 | 3.9897625102E−09 | 4.8164260004E−08 | −7.9318173357E−08 |
| A8 | −4.3174641795E−08 | 4.9833230903E−10 | −9.7117043434E−09 | 2.5530697114E−08 |
| A9 | 4.7029839006E−09 | −1.0703845236E−10 | 2.3191077345E−09 | −2.5941697177E−09 |
| A10 | −1.1050820344E−10 | 1.5594367193E−11 | −2.6014376990E−10 | −1.3281573857E−10 |
| A11 | −9.1165617506E−12 | −9.1829129105E−13 | 9.4725051384E−12 | 8.6488419187E−11 |
| A12 | −5.7596923408E−12 | −9.2128139648E−14 | 1.1585786578E−12 | −1.1460546773E−11 |
| A13 | 1.5088703620E−12 | 2.3323538586E−14 | −1.4920633019E−13 | 4.8736444162E−13 |
| A14 | −1.5041887560E−13 | −2.0442017786E−15 | 3.8186229904E−15 | 2.9324457516E−14 |
| A15 | 7.1655061299E−15 | 8.7799009031E−17 | 2.5149952732E−16 | −3.7893111103E−15 |
| A16 | −1.3634548619E−16 | −1.5394820566E−18 | −1.2643726430E−17 | 1.1217070846E−16 |

### Example 9

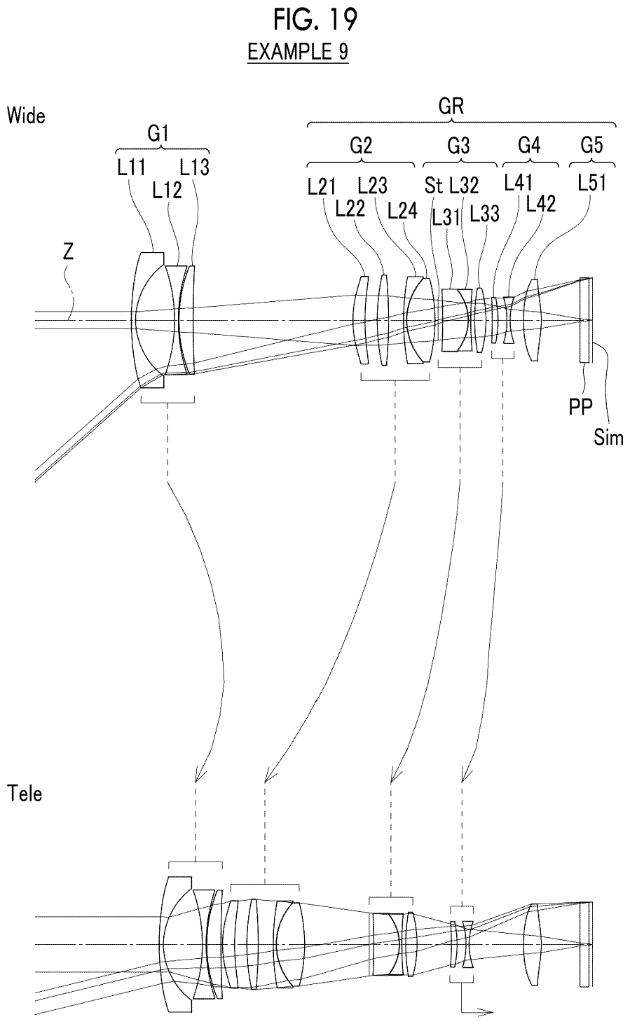

FIG. 19 illustrates a configuration and a moving path of a zoom lens of Example 9. The zoom lens of Example 9 consists of, in order from the object side to the image side, the first lens group G1 having a negative refractive power, the second lens group G2 having a positive refractive power, the third lens group G3 having a positive refractive power, the fourth lens group G4 having a negative refractive power, and the fifth lens group G5 having a positive refractive power. The subsequent group GR consists of the second lens group G2, the third lens group G3, the fourth lens group G4, and the fifth lens group G5.

During zooming from the wide angle end to the telephoto end, the first lens group G1, the second lens group G2, the third lens group G3, and the fourth lens group G4 move along the optical axis Z by changing spacings with respect to adjacent lens groups, and the fifth lens group G5 is fixed with respect to the image plane Sim. The focus group consists of the fourth lens group G4, and the focus group moves to the image side during focusing from the infinite distance object to the nearest object.

The first lens group G1 consists of, in order from the object side to the image side, three lenses including the lenses L11 to L13. The second lens group G2 consists of, in order from the object side to the image side, four lenses including the lenses L21 to L24. The third lens group G3 consists of, in order from the object side to the image side, the aperture stop St and three lenses including the lenses L31 to L33. The fourth lens group G4 consists of, in order from the object side to the image side, two lenses including the lenses L41 and L42. The fifth lens group G5 consists of one lens that is the lens L51.

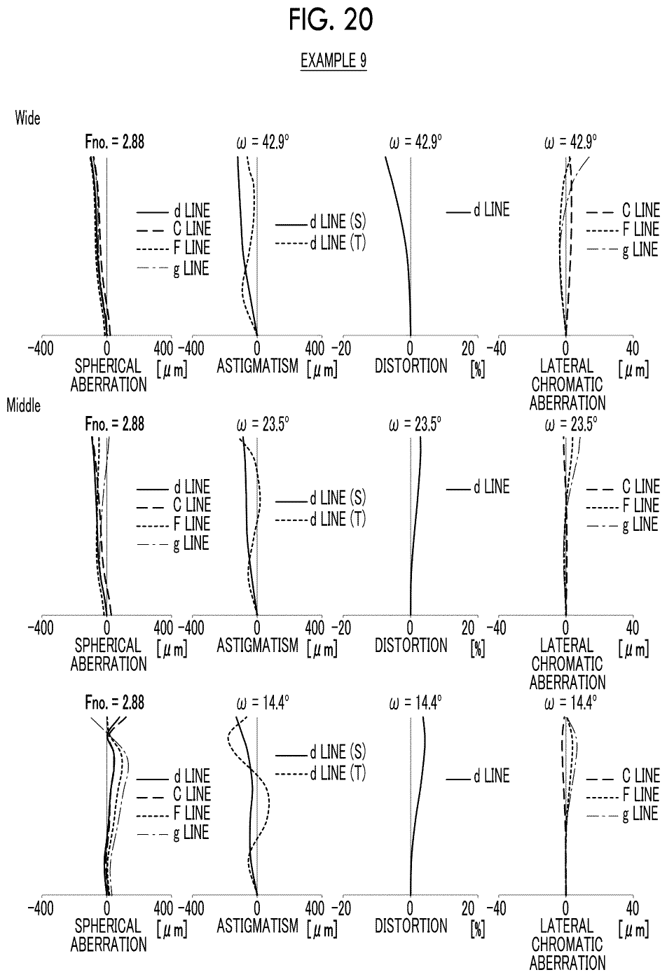

For the zoom lens of Example 9, Table 25 shows basic lens data, Table 26 shows specifications and a variable surface spacing, Table 27 shows aspherical coefficients, and FIG. 20 illustrates each aberration diagram.

TABLE 25
Example 9

| Sn | R | D | Nd | νd | θgF | ED | SG |
|---|---|---|---|---|---|---|---|
| *1 | 84.9210 | 1.3502 | 1.83441 | 37.28 | 0.57732 | 45.273 | 4.390 |
| *2 | 22.4639 | 12.4456 | | | | 36.750 | |
| 3 | −56.6794 | 1.2010 | 1.52841 | 76.45 | 0.53954 | 36.379 | 3.760 |
| 4 | 59.6247 | 0.2009 | | | | 35.993 | |
| 5 | 50.1082 | 4.5337 | 1.92119 | 23.96 | 0.62025 | 36.200 | 3.840 |
| 6 | 406.8010 | DD[6] | | | | 35.943 | |
| *7 | 36.3922 | 3.8600 | 1.75501 | 51.16 | 0.54856 | 29.000 | 4.410 |
| *8 | 78.7565 | 3.9071 | | | | 29.219 | |
| 9 | 74.5198 | 3.6369 | 1.61340 | 44.27 | 0.56340 | 30.191 | 2.930 |
| 10 | −158.1899 | 4.7657 | | | | 30.161 | |
| 11 | 83.6788 | 1.0000 | 1.77047 | 29.74 | 0.59514 | 29.126 | 3.340 |
| 12 | 21.1015 | 8.9950 | 1.53775 | 74.70 | 0.53936 | 27.928 | 3.640 |
| 13 | −58.0141 | DD[13] | | | | 27.887 | |
| 14 (St) | ∞ | 1.4995 | | | | 21.149 | |
| 15 | −199.6195 | 8.1507 | 1.49700 | 81.61 | 0.53887 | 20.779 | 3.700 |
| 16 | −16.5654 | 0.7992 | 1.72047 | 34.71 | 0.58350 | 20.050 | 3.190 |
| 17 | 125.4603 | 1.2263 | | | | 20.561 | |
| 18 | 65.1953 | 3.6142 | 1.91082 | 35.25 | 0.58224 | 21.084 | 4.970 |
| 19 | −42.6676 | DD[19] | | | | 21.091 | |
| 20 | −160.9403 | 1.8456 | 1.94595 | 17.98 | 0.65460 | 15.253 | 3.510 |
| 21 | −38.7462 | 2.8451 | | | | 15.000 | |
| *22 | −39.9289 | 1.0010 | 1.68948 | 31.02 | 0.59874 | 14.829 | 2.880 |
| *23 | 18.2865 | DD[23] | | | | 15.481 | |
| *24 | 63.3337 | 5.6529 | 1.49710 | 81.56 | 0.53848 | 27.000 | 3.640 |
| *25 | −33.8988 | 12.3559 | | | | 27.157 | |
| 26 | ∞ | 2.8500 | 1.51680 | 64.20 | 0.53430 | 28.187 | 2.520 |
| 27 | ∞ | 1.1089 | | | | 28.329 | |

TABLE 26
Example 9

| | Wide | Middle | Tele |
|---|---|---|---|
| Zr | 1.00 | 1.92 | 3.24 |
| f | 16.49 | 31.67 | 53.42 |
| Bf | 15.34 | 15.34 | 15.34 |
| Fno. | 2.88 | 2.88 | 2.88 |
| 2ω [°] | 85.8 | 47.0 | 28.8 |
| DD[6] | 50.7939 | 16.1285 | 0.5010 |
| DD[13] | 1.0005 | 10.4486 | 20.4249 |
| DD[19] | 2.0009 | 5.4368 | 10.9124 |
| DD[23] | 4.3210 | 8.7485 | 17.4280 |

TABLE 27
Example 9

| Sn | 1 | 2 | 7 | 8 |
|---|---|---|---|---|
| KA | 1.0000000000E+00 | 1.0000000000E+00 | 1.0000000000E+00 | 1.0000000000E+00 |
| A3 | 0.0000000000E+00 | 0.0000000000E+00 | 0.0000000000E+00 | 0.0000000000E+00 |
| A4 | −1.0192024105E−05 | −1.0524621869E−05 | −6.0499576933E−06 | −2.3814521055E−06 |
| A5 | 3.1750128723E−07 | −1.5325746773E−06 | −2.5967544398E−07 | 2.9054301002E−07 |
| A6 | 2.1340403074E−08 | 3.0321915055E−07 | 1.3613040380E−07 | 4.1328753154E−08 |
| A7 | −2.9734165912E−10 | −2.6998925057E−08 | −2.4975633681E−08 | −1.6964754107E−08 |
| A8 | −2.9553379988E−11 | 1.8053237540E−09 | 2.6359198469E−09 | 2.1227456741E−09 |
| A9 | 1.4769488939E−13 | −9.6459260886E−11 | −2.1315067181E−10 | −1.6797623189E−10 |
| A10 | 4.9981785159E−14 | 2.3866598266E−12 | 1.0250025861E−11 | 6.7626334185E−12 |
| A11 | −3.4046148681E−15 | 1.3133938842E−13 | −8.6150013261E−14 | 1.0824423477E−13 |
| A12 | 1.4029001541E−16 | −9.1436200106E−15 | −5.7125658616E−15 | −2.9557304675E−14 |
| A13 | −2.5044039759E−18 | −2.2830952232E−16 | −1.8221987969E−15 | 1.1089490642E−15 |
| A14 | −1.4743866608E−20 | 3.6127211950E−17 | 2.0653889923E−16 | 1.7126070924E−17 |
| A15 | 1.3082011028E−21 | −1.2273257005E−18 | −8.2285537828E−18 | −2.0970435745E−18 |
| A16 | −1.5058065126E−23 | 1.4437831499E−20 | 1.1958177959E−19 | 3.9483720618E−20 |
| Sn | 22 | 23 | 24 | 25 |
| KA | 1.0000000000E+00 | 1.0000000000E+00 | 1.0000000000E+00 | 1.0000000000E+00 |
| A3 | 0.0000000000E+00 | 0.0000000000E+00 | 0.0000000000E+00 | 0.0000000000E+00 |
| A4 | −5.4534558080E−04 | −6.1667602422E−04 | 8.7813135853E−05 | 9.0671741597E−05 |
| A5 | 5.1099144226E−05 | 8.5712011191E−05 | −7.9602474782E−06 | −1.9550924087E−06 |
| A6 | 1.2672289455E−05 | 5.2652601232E−06 | 2.1259435157E−07 | −3.6126126302E−07 |
| A7 | −2.3975142749E−06 | −1.8385541553E−06 | 1.8489799814E−08 | 1.8857395859E−08 |
| A8 | 8.5748345490E−08 | 1.4999704265E−07 | −1.2752470655E−09 | 5.8839047481E−10 |
| A9 | 7.6610723384E−09 | −2.7548493078E−08 | 2.6242789639E−11 | −4.3851345654E−11 |
| A10 | −2.8253568104E−09 | 7.4376458184E−09 | 4.8971500911E−12 | 3.4811031247E−12 |
| A11 | 9.2747879458E−10 | −8.9071594504E−10 | −8.8590608885E−13 | −5.0959774291E−13 |
| A12 | −1.5776131026E−10 | −3.1829093610E−12 | 4.6964894724E−14 | 2.8909875196E−14 |
| A13 | 1.3720645201E−11 | 1.5008061405E−11 | 9.5280648853E−16 | −2.6874571884E−16 |
| A14 | −5.2849699832E−13 | −2.0013409545E−12 | −2.2691259221E−16 | −5.8457820974E−17 |
| A15 | −1.8410077271E−15 | 1.1803011130E−13 | 1.0113255330E−17 | 3.0810337475E−18 |
| A16 | 5.4274768350E−16 | −2.7586777996E−15 | −1.5681170883E−19 | −5.0232934232E−20 |

### Example 10

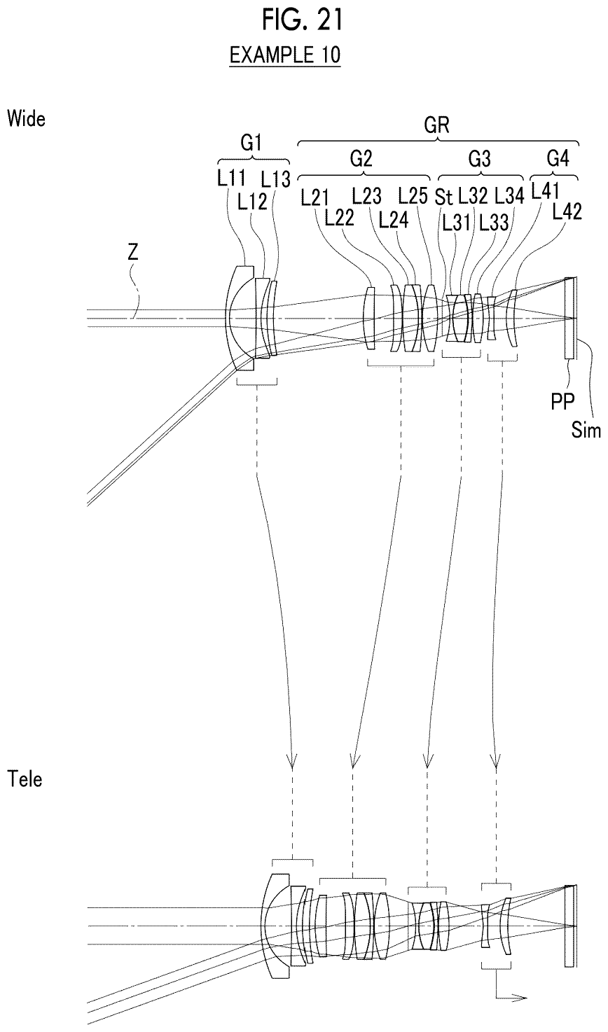

FIG. 21 illustrates a configuration and a moving path of a zoom lens of Example 10. The zoom lens of Example 10 consists of, in order from the object side to the image side, the first lens group G1 having a negative refractive power, the second lens group G2 having a positive refractive power, the third lens group G3 having a positive refractive power, and the fourth lens group G4 having a negative refractive power. The subsequent group GR consists of the second lens group G2, the third lens group G3, and the fourth lens group G4. During zooming from the wide angle end to the telephoto end, the first lens group G1, the second lens group G2, the third lens group G3, and the fourth lens group G4 move along the optical axis Z by changing spacings with respect to adjacent lens groups.

The focus group consists of the fourth lens group G4, and the focus group moves to the image side during focusing from the infinite distance object to the nearest object.

The first lens group G1 consists of, in order from the object side to the image side, three lenses including the lenses L11 to L13. The second lens group G2 consists of, in order from the object side to the image side, five lenses including the lenses L21 to L25. The third lens group G3 consists of, in order from the object side to the image side, the aperture stop St and four lenses including the lenses L31 to L34. The fourth lens group G4 consists of, in order from the object side to the image side, two lenses including the lenses L41 and L42.

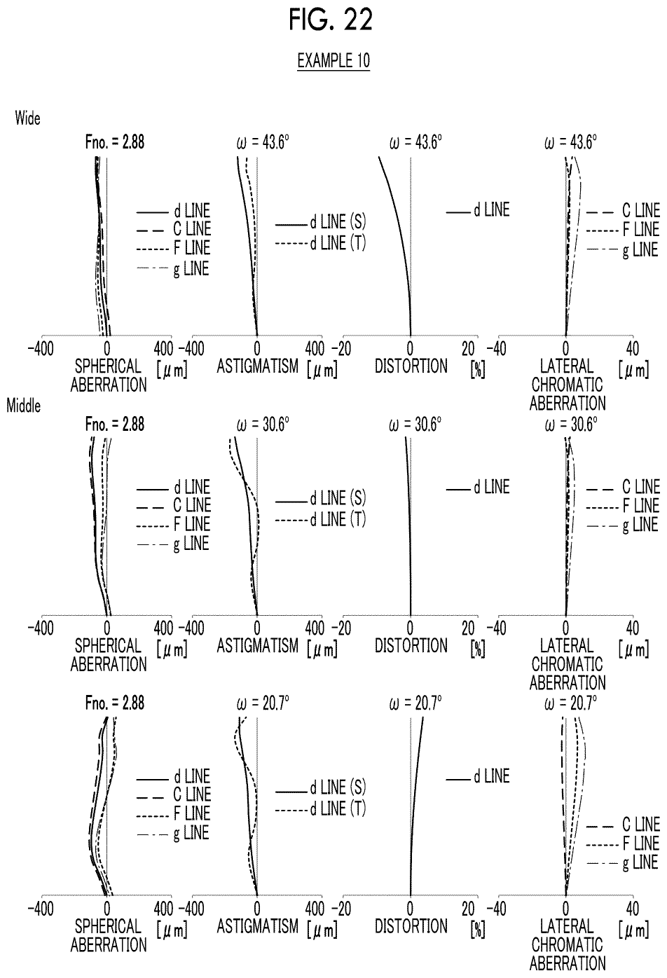

For the zoom lens of Example 10, Table 28 shows basic lens data, Table 29 shows specifications and a variable surface spacing, Table 30 shows aspherical coefficients, and FIG. 22 illustrates each aberration diagram.

TABLE 28
Example 10

| Sn | R | D | Nd | νd | θgF | ED | SG |
|---|---|---|---|---|---|---|---|
| 1 | 44.9189 | 1.3005 | 1.62041 | 60.29 | 0.54266 | 35.764 | 3.590 |
| 2 | 16.1045 | 8.7399 | | | | 27.188 | |
| *3 | −242.7817 | 1.6008 | 1.59201 | 67.02 | 0.53589 | 27.403 | 3.140 |
| *4 | 27.9435 | 1.9730 | | | | 25.613 | |
| 5 | 52.0966 | 2.1023 | 1.94595 | 17.18 | 0.65460 | 25.500 | 3.510 |
| 6 | 70.2271 | DD[6] | | | | 25.066 | |
| 7 | 37.8872 | 3.5908 | 1.80518 | 25.42 | 0.61616 | 21.000 | 3.370 |
| 8 | 507.2094 | 6.3357 | | | | 21.162 | |
| *9 | 690.5370 | 2.8065 | 1.51633 | 64.06 | 0.53345 | 22.053 | 2.380 |
| *10 | −94.2104 | 0.2000 | | | | 22.783 | |
| 11 | 76.8191 | 5.1665 | 1.49700 | 81.61 | 0.53887 | 22.861 | 3.700 |
| 12 | −31.7482 | 1.1008 | 1.84666 | 23.18 | 0.62054 | 22.682 | 3.540 |
| 13 | −111.7634 | 0.2008 | | | | 22.888 | |
| 14 | 34.0591 | 4.9780 | 1.60300 | 65.44 | 0.54022 | 22.811 | 3.510 |
| 15 | −50.9927 | DD[15] | | | | 22.312 | |
| 16 (St) | ∞ | 2.5008 | | | | 16.736 | |
| 17 | −26.4688 | 1.0008 | 1.84666 | 23.78 | 0.62054 | 15.868 | 3.540 |
| 18 | 20.6228 | 4.8583 | 1.49700 | 81.61 | 0.53887 | 15.718 | 3.700 |
| 19 | −26.4609 | 0.2405 | | | | 16.021 | |
| *20 | −21.4498 | 1.1994 | 1.68948 | 31.02 | 0.59874 | 16.000 | 2.880 |
| *21 | −46.3457 | 0.2009 | | | | 16.340 | |
| 22 | 44.4462 | 3.4168 | 1.92286 | 18.90 | 0.64960 | 16.693 | 3.580 |
| 23 | −38.4475 | DD[23] | | | | 16.600 | |
| *24 | −17.5972 | 1.5547 | 1.85135 | 40.10 | 0.56954 | 14.500 | 5.250 |
| *25 | −53.6969 | 4.0374 | | | | 14.687 | |
| 26 | 24.5098 | 2.5209 | 1.58913 | 61.13 | 0.54067 | 19.174 | 3.310 |
| 27 | 46.6225 | DD[27] | | | | 19.382 | |
| 28 | ∞ | 2.8500 | 1.51680 | 64.20 | 0.53430 | 27.106 | 2.520 |
| 29 | ∞ | 1.1101 | | | | 27.922 | |

TABLE 29
Example 10

| | Wide | Middle | Tele |
|---|---|---|---|
| Zr | 1.00 | 1.48 | 2.20 |
| f | 16.48 | 24.39 | 36.26 |
| Bf | 19.69 | 22.49 | 21.75 |
| Fno. | 2.88 | 2.88 | 2.88 |
| 2ω [°] | 87.2 | 61.2 | 41.4 |
| DD[6] | 29.2786 | 13.5848 | 1.8766 |
| DD[15] | 1.5009 | 2.5372 | 6.1030 |
| DD[23] | 2.0000 | 5.4143 | 11.1288 |
| DD[27] | 16.6995 | 19.5058 | 18.7638 |

TABLE 30
Example 10

| Sn | 3 | 4 | 9 | 10 |
|---|---|---|---|---|
| KA | 1.0000000000E+00 | 1.0000000000E+00 | 1.0000000000E+00 | 1.0000000000E+00 |
| A3 | 0.0000000000E+00 | 0.0000000000E+00 | 0.0000000000E+00 | 0.0000000000E+00 |
| A4 | 3.7155362308E−05 | 2.2813373817E−05 | −5.8705862226E−05 | −6.0824015225E−05 |
| A5 | −4.3270871358E−06 | −2.8835024418E−06 | 4.2013555586E−06 | 4.4344624557E−06 |
| A6 | 1.2634137033E−07 | −1.1514755279E−07 | −6.1949881652E−07 | −1.7139683803E−07 |
| A7 | 2.4278884389E−09 | 1.2398422011E−08 | 9.5743452171E−09 | −2.0442014957E−07 |
| A8 | 3.4753838842E−10 | 8.6140093956E−10 | 1.3037482313E−09 | 4.4816564934E−08 |
| A9 | −9.2372548919E−11 | −1.1324250420E−10 | −3.5330391592E−11 | −3.5322151165E−09 |
| A10 | 1.0176180115E−11 | 1.4240936846E−12 | 1.6134164831E−11 | −1.3580596203E−10 |
| A11 | −4.0922862838E−13 | 6.1013995827E−13 | −4.6881864972E−12 | 4.2734876772E−11 |
| A12 | −5.2159670978E−14 | −6.8427751312E−14 | 5.3134284272E−13 | −5.2757108228E−13 |
| A13 | 8.7165262001E−15 | 2.6893086418E−15 | −3.4712757037E−14 | −4.9881835320E−13 |
| A14 | −5.6400374383E−16 | 1.7260097796E−17 | 1.2670639309E−15 | 5.5082796673E−14 |
| A15 | 1.8098603920E−17 | −4.4419771405E−18 | −2.1164068948E−17 | −2.4876373250E−15 |
| A16 | −2.3761354494E−19 | 9.7771762573E−20 | 5.6316035965E−20 | 4.3065027466E−17 |
| Sn | 20 | 21 | 24 | 25 |
| KA | 1.0000000000E+00 | 1.0000000000E+00 | 1.0000000000E+00 | 1.0000000000E+00 |
| A3 | 0.0000000000E+00 | 0.0000000000E+00 | 0.0000000000E+00 | 0.0000000000E+00 |
| A4 | 5.9982137531E−05 | 5.9356819910E−05 | 7.3232821933E−04 | 6.6042584138E−04 |
| A5 | 6.2420797074E−06 | 8.3909229630E−06 | −9.0802000216E−06 | 3.7334036884E−06 |
| A6 | −9.4870652687E−07 | −9.1042434582E−07 | −1.0494363005E−05 | −1.1670205780E−05 |
| A7 | 2.7501141414E−08 | −2.5548840254E−07 | 6.7331978670E−07 | 1.8025684452E−06 |
| A8 | −6.3454566443E−09 | 9.3372809530E−08 | 2.1628125306E−08 | −3.2538955313E−07 |
| A9 | 3.2806694396E−09 | −1.2126226905E−08 | −9.7454962292E−09 | −1.9644347611E−09 |
| A10 | −5.0431118193E−10 | 3.1698813897E−10 | 3.3922237515E−09 | 2.3762378525E−08 |
| A11 | 2.6869094593E−11 | 1.4145068810E−11 | −3.7159970784E−10 | −6.2080563015E−09 |
| A12 | 3.2535464233E−12 | 3.3089991401E−11 | −6.9309774645E−11 | 6.7014806315E−10 |
| A13 | −8.0440796859E−13 | −9.3124295402E−12 | 2.5515056963E−11 | −8.9952144636E−12 |
| A14 | 7.3249723522E−14 | 1.0829478982E−12 | −3.2657419156E−12 | −5.2377492275E−12 |
| A15 | −3.3288366369E−15 | −6.1297632512E−14 | 2.0202265296E−13 | 5.0111520318E−13 |
| A16 | 6.2477955488E−17 | 1.3964547180E−15 | −5.0526760803E−15 | −1.5071597855E−14 |

### Example 11

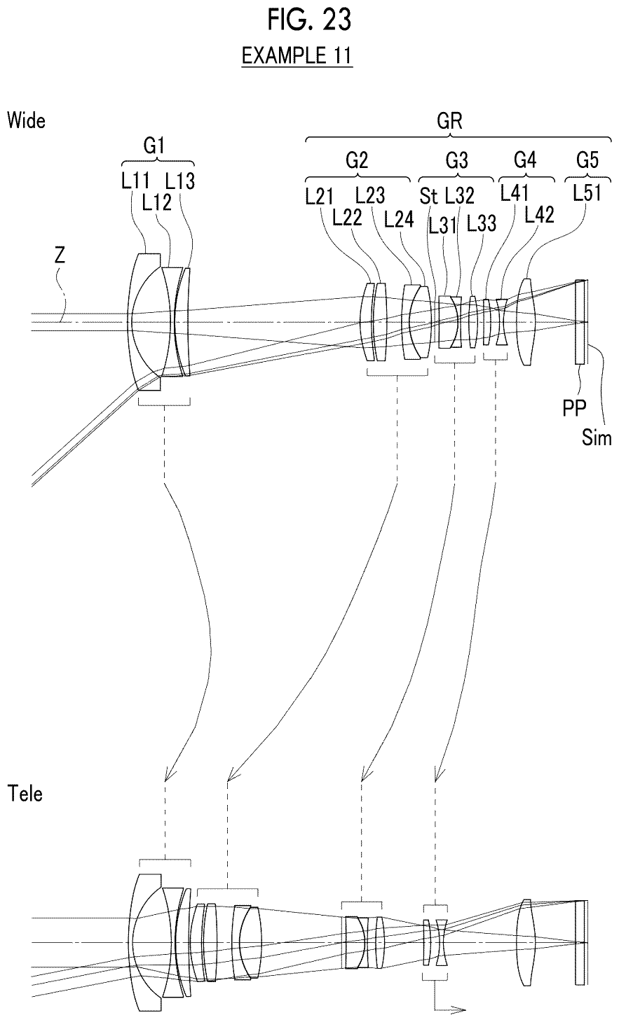

FIG. 23 illustrates a configuration and a moving path of a zoom lens of Example 11. The zoom lens of Example 11 consists of, in order from the object side to the image side, the first lens group G1 having a negative refractive power, the second lens group G2 having a positive refractive power, the third lens group G3 having a positive refractive power, the fourth lens group G4 having a negative refractive power, and the fifth lens group G5 having a positive refractive power. The subsequent group GR consists of the second lens group G2, the third lens group G3, the fourth lens group G4, and the fifth lens group G5. During zooming from to the image plane Sim.

The focus group consists of the fourth lens group G4, and the focus group moves to the image side during focusing from the infinite distance object to the nearest object.

The first lens group G1 consists of, in order from the object side to the image side, three lenses including the lenses L11 to L13. The second lens group G2 consists of, in order from the object side to the image side, four lenses including the lenses L21 to L24. The third lens group G3 consists of, in order from the object side to the image side, the aperture stop St and three lenses including the lenses L31 to L33. The fourth lens group G4 consists of, in order from the object side to the image side, two lenses including the lenses L41 and L42. The fifth lens group G5 consists of one lens that is the lens L51.

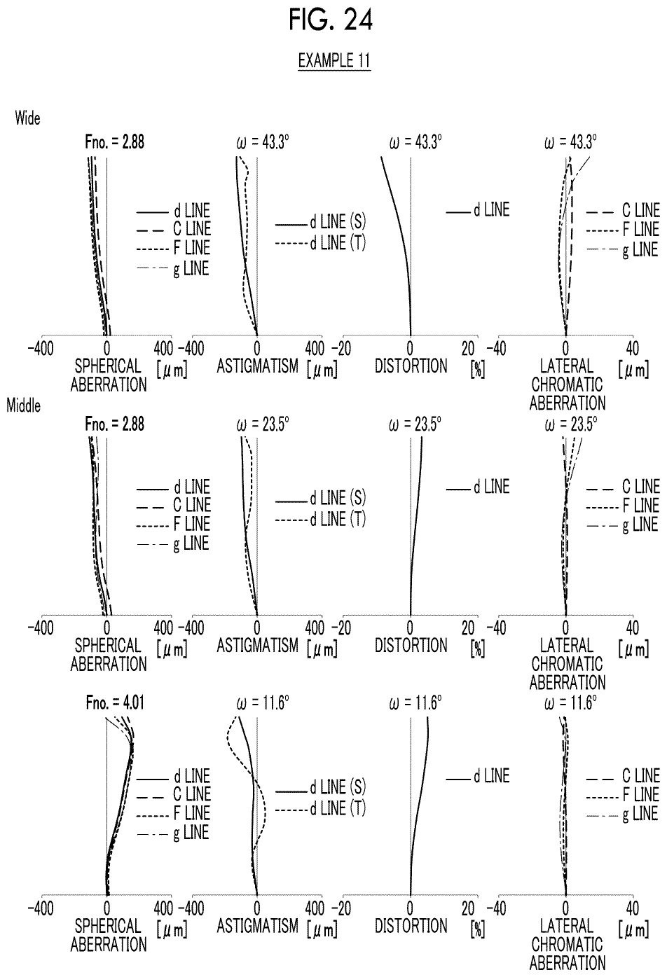

For the zoom lens of Example 11, Table 31 shows basic lens data, Table 32 shows specifications and a variable surface spacing, Table 33 shows aspherical coefficients, and FIG. 24 illustrates each aberration diagram.

TABLE 31
Example 11

| Sn | R | D | Nd | νd | θgF | ED | SG |
|---|---|---|---|---|---|---|---|
| *1 | 74.1335 | 1.3500 | 1.80139 | 45.45 | 0.55814 | 45.989 | 4.840 |
| *2 | 22.4124 | 12.4424 | | | | 37.027 | |
| 3 | −61.1004 | 1.2009 | 1.55397 | 71.76 | 0.53931 | 36.688 | 3.660 |
| 4 | 61.3891 | 0.2010 | | | | 36.028 | |
| 5 | 49.8249 | 4.1855 | 1.92119 | 23.96 | 0.62025 | 36.200 | 3.840 |
| 6 | 238.1927 | DD[6] | | | | 35.916 | |
| *7 | 35.5105 | 3.6385 | 1.77250 | 49.46 | 0.55399 | 26.000 | 4.830 |
| *8 | 79.5093 | 0.6184 | | | | 25.947 | |
| 9 | 66.4074 | 4.3505 | 1.51742 | 52.43 | 0.55649 | 26.079 | 2.460 |
| 10 | −155.5420 | 4.7423 | | | | 25.972 | |
| 11 | 79.1359 | 2.4713 | 1.80000 | 29.84 | 0.60178 | 25.017 | 3.680 |
| 12 | 21.6607 | 7.1066 | 1.52841 | 76.45 | 0.53954 | 23.873 | 3.760 |
| 13 | −58.9525 | DD[13] | | | | 23.784 | |
| 14 (St) | ∞ | 1.5000 | | | | 17.952 | |
| 15 | −292.0870 | 6.0403 | 1.49700 | 81.61 | 0.53887 | 17.505 | 3.700 |
| 16 | −16.0405 | 0.8000 | 1.72047 | 34.71 | 0.58350 | 16.802 | 3.190 |
| 17 | 122.1986 | 2.6779 | | | | 16.872 | |
| 18 | 70.3242 | 2.8154 | 1.91082 | 35.25 | 0.58224 | 17.267 | 4.970 |
| 19 | −42.9711 | DD[19] | | | | 17.200 | |
| 20 | −349.7099 | 2.2263 | 1.94595 | 17.98 | 0.65460 | 15.222 | 3.510 |
| 21 | −40.1093 | 2.8378 | | | | 15.000 | |
| *22 | −38.1846 | 1.2434 | 1.68948 | 31.02 | 0.59874 | 14.726 | 2.880 |
| *23 | 18.4341 | DD[23] | | | | 15.353 | |
| *24 | 111.1338 | 6.0552 | 1.49710 | 81.56 | 0.53848 | 27.000 | 3.640 |
| *25 | −30.5093 | 12.8796 | | | | 27.220 | |
| 26 | ∞ | 2.8500 | 1.51680 | 64.20 | 0.53430 | 28.197 | 2.520 |
| 27 | ∞ | 1.1106 | | | | 28.325 | |

TABLE 32
Example 11

| | Wide | Middle | Tele |
|---|---|---|---|
| Zr | 1.00 | 1.92 | 4.00 |
| f | 16.49 | 31.68 | 65.97 |
| Bf | 15.87 | 15.87 | 15.87 |
| Fno. | 2.88 | 2.88 | 4.01 |
| 2ω [°] | 86.6 | 47.0 | 23.2 |
| DD[6] | 55.1296 | 22.4692 | 0.5006 |
| DD[13] | 0.9998 | 10.3396 | 25.4443 |
| DD[19] | 2.0000 | 3.7338 | 12.6001 |
| DD[23] | 4.2086 | 11.2910 | 23.5528 |

TABLE 33
Example 11

| Sn | 1 | 2 | 7 | 8 |
|---|---|---|---|---|
| KA | 1.0000000000E+00 | 1.0000000000E+00 | 1.0000000000E+00 | 1.0000000000E+00 |
| A3 | 0.0000000000E+00 | 0.0000000000E+00 | 0.0000000000E+00 | 0.0000000000E+00 |
| A4 | −9.9617595455E−06 | −9.7281203022E−06 | −7.0255200761E−06 | −3.6497423248E−06 |
| A5 | −9.2584245523E−08 | −1.8518604167E−06 | 3.0531975117E−07 | 7.1881236615E−07 |
| A6 | 7.8390870641E−08 | 3.4374191720E−07 | 5.9469410345E−08 | 2.7404369370E−09 |
| A7 | −8.9587991128E−09 | −3.4509674978E−08 | −1.3505311262E−08 | −1.2763631543E−08 |
| A8 | 9.6300207573E−10 | 2.7741925185E−09 | 6.4658495012E−10 | 1.5797051849E−09 |
| A9 | −6.2935950932E−11 | −1.5640617421E−10 | 2.5838102033E−11 | −1.7793069520E−10 |
| A10 | 1.7847025358E−12 | 2.6857333607E−12 | −6.4693114083E−12 | 1.9138687662E−11 |
| A11 | 2.4557642249E−14 | 3.5664825340E−13 | 5.7224670639E−13 | −1.1198072879E−12 |
| A12 | −3.0555470665E−15 | −2.4015584869E−14 | −1.7058384318E−14 | −2.7051957489E−14 |
| A13 | 4.0085612238E−17 | 6.6700369396E−17 | −1.9550262641E−15 | 9.5323154758E−15 |
| A14 | 2.4791174954E−18 | 4.3722896414E−17 | 2.2151107677E−16 | −6.9679618175E−16 |
| A15 | −9.5050627239E−20 | −1.6748789324E−18 | −8.9500151548E−18 | 2.3814833414E−17 |
| A16 | 1.0032279156E−21 | 2.0360559355E−20 | 1.3590001470E−19 | −3.2794813075E−19 |
| Sn | 22 | 23 | 24 | 25 |
| KA | 1.0000000000E+00 | 1.0000000000E+00 | 1.0000000000E+00 | 1.0000000000E+00 |
| A3 | 0.0000000000E+00 | 0.0000000000E+00 | 0.0000000000E+00 | 0.0000000000E+00 |
| A4 | −4.6409225759E−04 | −5.3707043823E−04 | 7.7891036771E−05 | 8.8770221452E−05 |
| A5 | 3.6866594532E−05 | 6.9870165972E−05 | −7.1179957507E−06 | −2.6289164380E−06 |
| A6 | 1.0074897252E−05 | 1.0051563178E−06 | 1.9735858437E−07 | −2.2928094287E−07 |
| A7 | −1.6273252569E−06 | 4.0722548197E−07 | 1.9051758095E−08 | 1.1316837633E−08 |
| A8 | 6.0512111045E−08 | −4.0209773748E−07 | −1.5091520615E−09 | −2.7053441076E−10 |
| A9 | −9.0457798934E−09 | 6.8480257769E−08 | 2.2920710812E−11 | 4.8213206373E−10 |
| A10 | 3.5597363065E−09 | −3.8802654699E−09 | 1.2382580673E−11 | −1.0030966602E−10 |
| A11 | −6.3769824144E−10 | 3.2087813982E−10 | −1.9286874103E−12 | 1.0300809266E−11 |
| A12 | 8.4549253530E−11 | −2.5024208123E−10 | 1.0731594599E−13 | −5.4899189464E−13 |
| A13 | −9.2350502695E−12 | 6.4034689347E−11 | 6.7825972762E−16 | 6.3644879876E−15 |
| A14 | 7.3739444520E−13 | −7.6392992957E−12 | −3.8465174785E−16 | 9.0533432157E−16 |
| A15 | −3.6200433149E−14 | 4.5449255146E−13 | 1.8189969674E−17 | −4.8760625832E−17 |
| A16 | 7.9781138153E−16 | −1.0969892905E−14 | −2.8928102508E−19 | 7.9330619616E−19 |

### Example 12

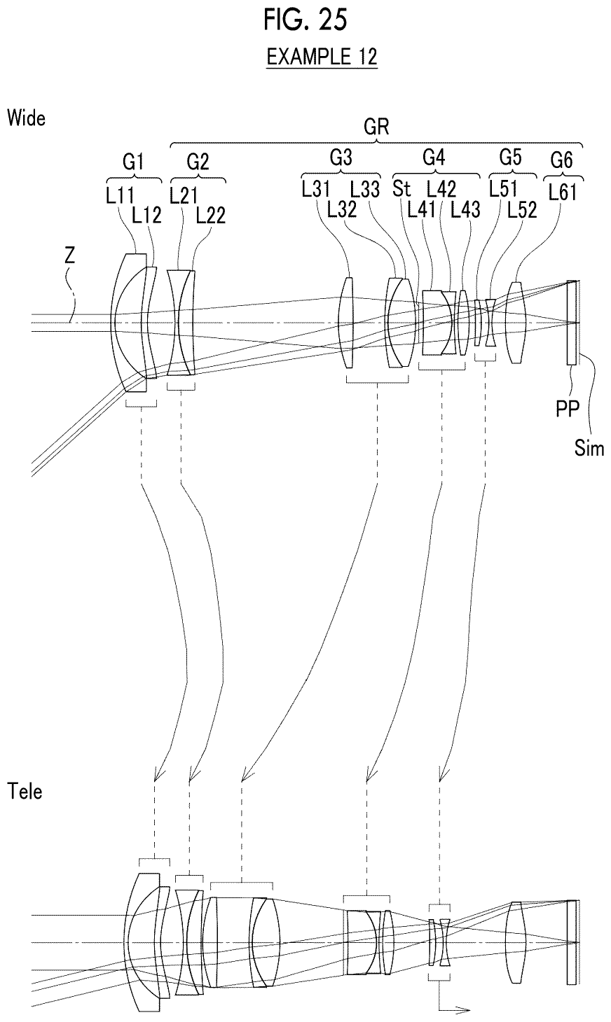

FIG. 25 illustrates a configuration and a moving path of a zoom lens of Example 12. The zoom lens of Example 12 consists of, in order from the object side to the image side, the first lens group G1 having a negative refractive power, the second lens group G2 having a negative refractive power, the third lens group G3 having a positive refractive power, the fourth lens group G4 having a positive refractive power, the fifth lens group G5 having a negative refractive power, and the sixth lens group G6 having a positive refractive power. The subsequent group GR consists of the second lens group G2, the third lens group G3, the fourth lens group G4, the fifth lens group G5, and the sixth lens group G6. During zooming from the wide angle end to the telephoto end, the first lens group G1, the second lens group G2, the third lens group G3, the fourth lens group G4, and the fifth lens group G5 move along the optical axis Z by changing spacings with respect to adjacent lens groups, and the sixth lens group G6 is fixed with respect to the image plane Sim.

The focus group consists of the fifth lens group G5, and the focus group moves to the image side during focusing from the infinite distance object to the nearest object.

The first lens group G1 consists of, in order from the object side to the image side, two lenses including the lenses L11 and L12. The second lens group G2 consists of, in order from the object side to the image side, two lenses including the lenses L21 and L22. The third lens group G3 consists of, in order from the object side to the image side, three lenses including the lenses L31 to L33. The fourth lens group G4 consists of, in order from the object side to the image side, the aperture stop St and three lenses including the lenses L41 to L43. The fifth lens group G5 consists of, in order from the object side to the image side, two lenses including the lenses L51 and L52. The sixth lens group G6 consists of one lens that is the lens L61.

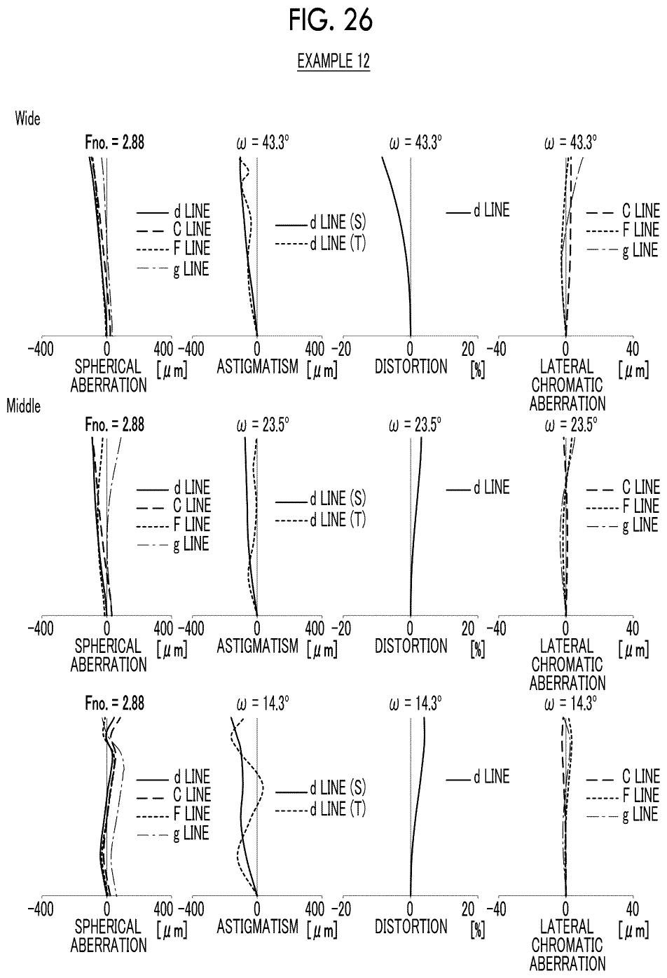

For the zoom lens of Example 12, Table 34 shows basic lens data, Table 35 shows specifications and a variable surface spacing, Table 36 shows aspherical coefficients, and FIG. 26 illustrates each aberration diagram.

TABLE 34
Example 12

| Sn | R | D | Nd | νd | θgF | ED | SG |
|---|---|---|---|---|---|---|---|
| 1 | 57.2824 | 1.3500 | 1.85026 | 32.27 | 0.59299 | 46.529 | 4.360 |
| 2 | 22.5543 | 8.4338 | | | | 37.633 | |
| *3 | 50.3879 | 2.0002 | 1.49710 | 81.56 | 0.53848 | 37.605 | 3.640 |
| *4 | 32.3426 | DD[4] | | | | 36.620 | |
| 5 | −63.0524 | 1.1092 | 1.48749 | 70.44 | 0.53062 | 35.338 | 2.450 |
| 6 | 41.5164 | 4.6300 | 1.92119 | 23.96 | 0.62025 | 34.954 | 3.840 |
| 7 | 221.9927 | DD[7] | | | | 34.600 | |
| *8 | 44.1459 | 4.7421 | 1.77377 | 47.17 | 0.55574 | 30.300 | 4.620 |
| *9 | −260.6536 | 10.1775 | | | | 30.323 | |
| 10 | 78.5095 | 0.9999 | 1.80518 | 25.42 | 0.61616 | 30.077 | 3.370 |
| 11 | 25.6794 | 8.9001 | 1.53775 | 74.70 | 0.53936 | 29.316 | 3.640 |
| 12 | −47.5253 | DD[12] | | | | 29.361 | |
| 13 (St) | ∞ | 1.5009 | | | | 21.983 | |
| 14 | −216.6118 | 9.1516 | 1.49700 | 81.61 | 0.53887 | 21.580 | 3.700 |
| 15 | −17.5080 | 0.8002 | 1.72047 | 34.71 | 0.58350 | 20.503 | 3.190 |
| 16 | 102.0648 | 1.1712 | | | | 20.902 | |
| 17 | 66.2893 | 3.6049 | 1.90525 | 35.04 | 0.58486 | 21.354 | 4.830 |
| 18 | −44.9451 | DD[18] | | | | 21.353 | |
| 19 | −139.5377 | 1.8818 | 1.94595 | 17.98 | 0.65460 | 15.442 | 3.510 |
| 20 | −38.7363 | 2.4217 | | | | 15.200 | |
| *21 | −31.8393 | 1.0002 | 1.68948 | 31.02 | 0.59874 | 15.093 | 2.880 |
| *22 | 24.2614 | DD[22] | | | | 15.689 | |
| *23 | 78.6536 | 6.6065 | 1.49710 | 81.56 | 0.53848 | 27.000 | 3.640 |
| *24 | −31.3513 | 13.2386 | | | | 27.287 | |
| 25 | ∞ | 2.8500 | 1.51680 | 64.20 | 0.53430 | 28.233 | 2.520 |
| 26 | ∞ | 1.1085 | | | | 28.364 | |

TABLE 35
Example 12

| | Wide | Middle | Tele |
|---|---|---|---|
| Zr | 1.00 | 1.92 | 3.24 |
| f | 16.48 | 31.67 | 53.41 |
| Bf | 16.22 | 16.22 | 16.22 |
| Fno. | 2.88 | 2.88 | 2.88 |
| 2ω [°] | 86.6 | 47.0 | 28.6 |
| DD[4] | 8.8545 | 7.8019 | 7.2878 |
| DD[7] | 46.5832 | 14.8442 | 0.5000 |
| DD[12] | 0.9991 | 9.9713 | 20.2186 |
| DD[18] | 2.0005 | 5.7734 | 11.5198 |
| DD[22] | 4.3476 | 9.8586 | 19.0563 |

TABLE 36
Example 12

| Sn | 3 | 4 | 8 | 9 |
|---|---|---|---|---|
| KA | 1.0000000000E+00 | 1.0000000000E+00 | 1.0000000000E+00 | 1.0000000000E+00 |
| A3 | 0.0000000000E+00 | 0.0000000000E+00 | 0.0000000000E+00 | 0.0000000000E+00 |
| A4 | −2.1184200135E−05 | −3.0376522816E−05 | −5.2820942514E−06 | −1.1324196204E−06 |
| A5 | −9.1367523584E−07 | −4.4744739138E−07 | 4.4868520577E−07 | 6.6339898693E−07 |
| A6 | 1.4357683308E−07 | 3.7876050086E−08 | 2.6360901361E−08 | −1.2506132226E−08 |
| A7 | −1.0766047425E−08 | 4.7971803025E−09 | −5.6015386603E−09 | −3.0364674670E−09 |
| A8 | 1.0684643076E−09 | −7.6584435333E−10 | −6.2964112286E−11 | −8.0859371752E−12 |
| A9 | −1.0411063124E−10 | 7.5389655705E−11 | 4.6961929180E−11 | 3.3649393392E−11 |
| A10 | 8.4113502165E−12 | −3.8724433447E−12 | −2.0997451871E−12 | −2.6565572244E−12 |
| A11 | −4.8544703116E−13 | 5.4107614930E−15 | −4.9090266117E−14 | 1.5289409789E−13 |
| A12 | 1.8866205736E−14 | 1.1400508801E−14 | 5.0626047934E−15 | −1.1651723855E−14 |
| A13 | −5.0762261545E−16 | −7.4234128315E−16 | 1.4250807213E−16 | 7.7551429859E−16 |
| A14 | 9.3129913927E−18 | 2.2994927018E−17 | −2.9239342347E−17 | −3.5862769429E−17 |
| A15 | −1.1191710110E−19 | −3.5680743077E−19 | 1.2170610650E−18 | 9.5906670888E−19 |
| A16 | 7.1626838065E−22 | 2.1377896170E−21 | −1.7423703823E−20 | −1.1052180357E−20 |
| Sn | 21 | 22 | 23 | 24 |
| KA | 1.0000000000E+00 | 1.0000000000E+00 | 1.0000000000E+00 | 1.0000000000E+00 |
| A3 | 0.0000000000E+00 | 0.0000000000E+00 | 0.0000000000E+00 | 0.0000000000E+00 |
| A4 | −2.0408780827E−04 | −2.2290278146E−04 | 6.0294351704E−05 | 6.5954574217E−05 |
| A5 | 2.9589542807E−05 | 3.9889125464E−05 | −4.4172717757E−06 | −8.6992303259E−07 |
| A6 | 5.5487091975E−07 | −1.3615193892E−06 | 2.3973018504E−08 | −6.1419894185E−07 |
| A7 | 4.7095446604E−08 | 4.7950769626E−07 | 1.9836889985E−08 | 1.6304323191E−07 |
| A8 | −1.4477884336E−07 | −4.1433203483E−07 | −6.3651226841E−10 | −2.8135615276E−08 |
| A9 | 2.6729113594E−08 | 1.4100852856E−07 | −2.0165058208E−11 | 3.0626075000E−09 |
| A10 | −8.6267004252E−10 | −2.8589447515E−08 | 4.3120208401E−13 | −2.1595265089E−10 |
| A11 | −3.1702728772E−10 | 3.4796294398E−09 | 2.8094039001E−13 | 1.6183338942E−11 |
| A12 | 2.6163054015E−11 | −1.8250911296E−10 | −5.7024358355E−14 | −1.9625487520E−12 |
| A13 | 5.7580312262E−12 | −1.1627458825E−11 | 5.8183083542E−15 | 1.9889637551E−13 |
| A14 | −1.2531467451E−12 | 2.5784463129E−12 | −3.3302926528E−16 | −1.1972064071E−14 |
| A15 | 9.2704512146E−14 | −1.6520385490E−13 | 1.0260811603E−17 | 3.8350987035E−16 |
| A16 | −2.5236860532E−15 | 3.9205016552E−15 | −1.3317257269E−19 | −5.0959841337E−18 |

### Example 13

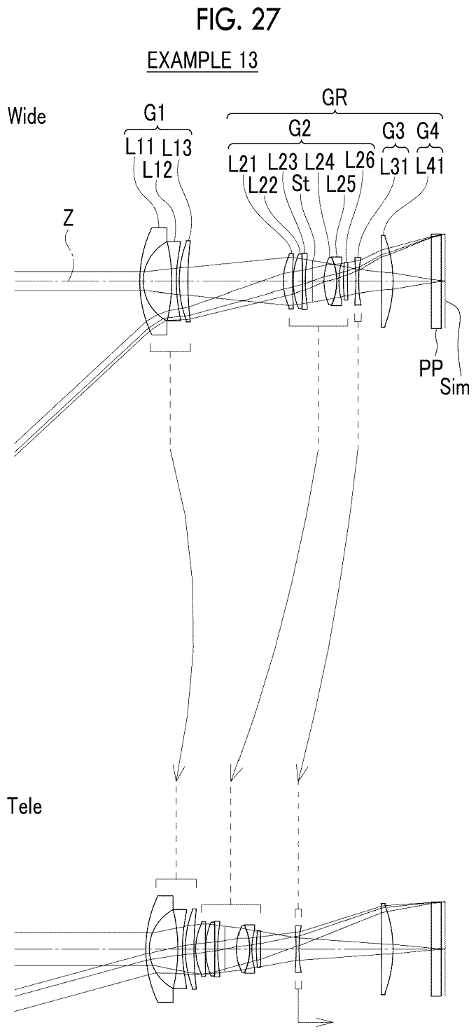

FIG. 27 illustrates a configuration and a moving path of a zoom lens of Example 13. The zoom lens of Example 13 consists of, in order from the object side to the image side, the first lens group G1 having a negative refractive power, the second lens group G2 having a positive refractive power, the third lens group G3 having a negative refractive power, and the fourth lens group G4 having a positive refractive power. The subsequent group GR consists of the second lens group G2, the third lens group G3, and the fourth lens group G4. During zooming from the wide angle end to the telephoto end, the first lens group G1, the second lens group G2, and the third lens group G3 move along the optical axis Z by changing spacings with respect to adjacent lens groups, and the fourth lens group G4 is fixed with respect to the image plane Sim.

The focus group consists of the third lens group G3, and the focus group moves to the image side during focusing from the infinite distance object to the nearest object.

The first lens group G1 consists of, in order from the object side to the image side, three lenses including the lenses L11 to L13. The second lens group G2 consists of the aperture stop St and six lenses including lenses L21 to L26. The third lens group G3 consists of one lens that is the lens L31. The fourth lens group G4 consists of one lens that is the lens L41.

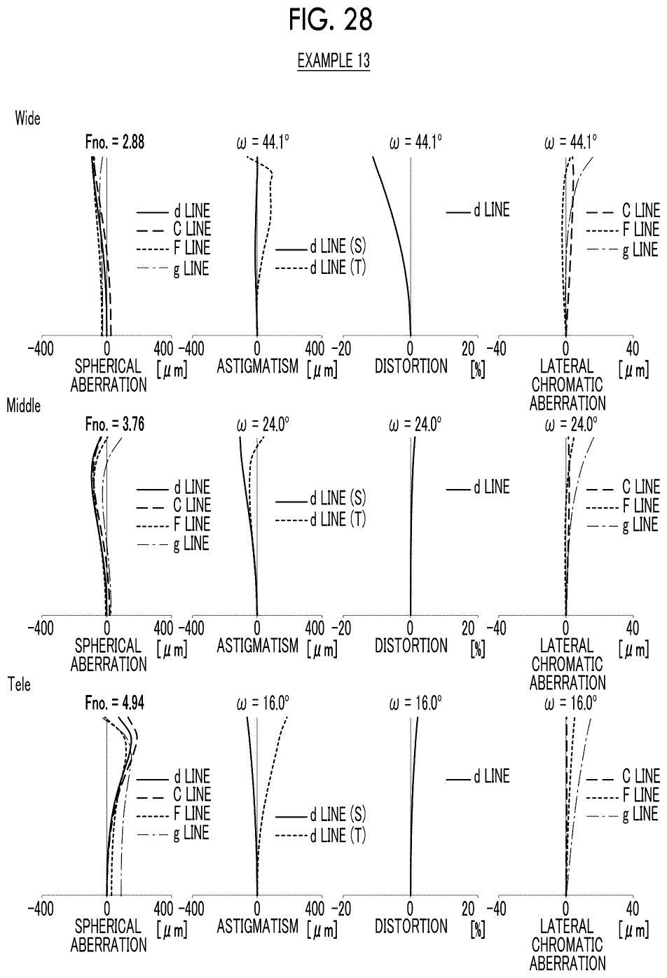

For the zoom lens of Example 13, Table 37 shows basic lens data, Table 38 shows specifications and a variable surface spacing, Table 39 shows aspherical coefficients, and FIG. 28 illustrates each aberration diagram.

TABLE 37
Example 13

| Sn | R | D | Nd | νd | θgF | ED | SG |
|---|---|---|---|---|---|---|---|
| 1 | 38.8652 | 1.0000 | 1.80420 | 46.50 | 0.55727 | 29.585 | 4.400 |
| 2 | 13.7071 | 8.1875 | | | | 23.339 | |
| *3 | −50.4909 | 1.3002 | 1.49710 | 81.56 | 0.53848 | 23.196 | 3.640 |
| *4 | 47.3989 | 0.8458 | | | | 22.927 | |
| 5 | 34.2385 | 2.4861 | 2.00100 | 29.13 | 0.59952 | 22.897 | 5.120 |
| 6 | 107.0749 | DD[6] | | | | 22.614 | |
| 7 | 18.0001 | 2.7297 | 1.49700 | 81.61 | 0.53887 | 15.144 | 3.700 |
| 8 | 209.4027 | 0.1302 | | | | 15.041 | |
| 9 | 21.8096 | 2.6596 | 1.49700 | 81.61 | 0.53887 | 14.918 | 3.700 |
| 10 | −236.6385 | 0.8101 | 1.56732 | 42.84 | 0.57436 | 14.557 | 2.530 |
| 11 | 48.3335 | 2.0351 | | | | 14.170 | |
| 12 (St) | ∞ | 3.3415 | | | | 13.784 | |
| 13 | 18.3311 | 3.6675 | 1.55032 | 75.50 | 0.54001 | 12.647 | 4.090 |
| 14 | −17.5274 | 0.5999 | 1.58144 | 40.89 | 0.57680 | 12.027 | 2.590 |
| 15 | 21.2788 | 1.2818 | | | | 11.084 | |
| *16 | 38.1862 | 1.1865 | 1.77288 | 49.52 | 0.55481 | 10.828 | 4.930 |
| *17 | 116.2065 | DD[17] | | | | 11.070 | |
| *18 | −45.4047 | 0.8001 | 1.77288 | 49.52 | 0.55481 | 13.644 | 4.930 |
| *19 | 57.2450 | DD[19] | | | | 14.044 | |
| 20 | −778.7128 | 3.2673 | 1.73400 | 51.05 | 0.55010 | 25.699 | 4.060 |
| 21 | −38.7256 | 10.9905 | | | | 26.118 | |
| 22 | ∞ | 2.8500 | 1.51680 | 64.20 | 0.53430 | 27.996 | 2.520 |
| 23 | ∞ | 1.1146 | | | | 28.262 | |

TABLE 38
Example 13

| | Wide | Middle | Tele |
|---|---|---|---|
| Zr | 1.00 | 1.91 | 2.94 |
| f | 16.49 | 31.51 | 48.53 |
| Bf | 13.98 | 13.98 | 13.98 |
| Fno. | 2.88 | 3.76 | 4.94 |
| 2ω [°] | 88.2 | 48.0 | 32.0 |
| DD[6] | 27.2120 | 8.0843 | 0.4771 |
| DD[17] | 2.4145 | 6.3926 | 10.2612 |
| DD[19] | 6.5817 | 15.0508 | 23.7355 |

TABLE 39
Example 13

| Sn | 3 | 4 | 16 | 17 |
|---|---|---|---|---|
| KA | 1.0000000000E+00 | 1.0000000000E+00 | 1.0000000000E+00 | 1.0000000000E+00 |
| A4 | 1.0512078879E−05 | −6.8994922482E−07 | −9.4576327689E−05 | −2.1312388961E−05 |
| A6 | −4.9614016459E−08 | −5.6426698952E−08 | −7.3757105614E−07 | −3.9237661164E−07 |
| A8 | 2.2612692961E−10 | −1.7931257445E−10 | −1.6214801990E−08 | −1.2890969890E−08 |
| A10 | −2.0853086811E−12 | −1.4872316253E−12 | 2.5777479113E−10 | 2.8365762164E−10 |
| Sn | 18 | 19 | | |
| KA | 1.0000000000E+00 | 1.0000000000E+00 | | |
| A4 | 1.5760191708E−04 | 1.8613488924E−04 | | |
| A6 | −3.0524822706E−06 | −3.1760240286E−06 | | |
| A8 | 4.2021122638E−08 | 4.1015720099E−08 | | |
| A10 | −1.6472332481E−10 | −1.8499609542E−10 | | |

### Example 14

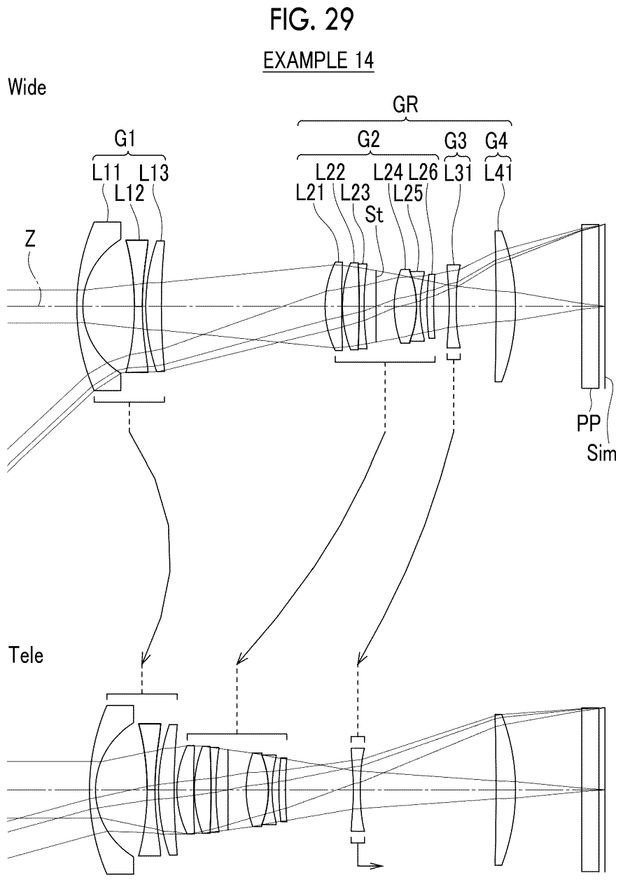

FIG. 29 illustrates a configuration and a moving path of a zoom lens of Example 14. The zoom lens of Example 14 consists of, in order from the object side to the image side, the first lens group G1 having a negative refractive power, the second lens group G2 having a positive refractive power, the third lens group G3 having a negative refractive power, and the fourth lens group G4 having a positive refractive power. The subsequent group GR consists of the second lens group G2, the third lens group G3, and the fourth lens group G4. During zooming from the wide angle end to the telephoto end, the first lens group G1, the second lens group G2, and the third lens group G3 move along the optical axis Z by changing spacings with respect to adjacent lens groups, and the fourth lens group G4 is fixed with respect to the image plane Sim. The focus group consists of the third lens group G3, and the focus group moves to the image side during focusing from the infinite distance object to the nearest object.

The first lens group G1 consists of, in order from the object side to the image side, three lenses including the lenses L11 to L13. The second lens group G2 consists of the aperture stop St and six lenses including the lenses L21 to L26. The third lens group G3 consists of one lens that is the lens L31. The fourth lens group G4 consists of one lens that is the lens L41.

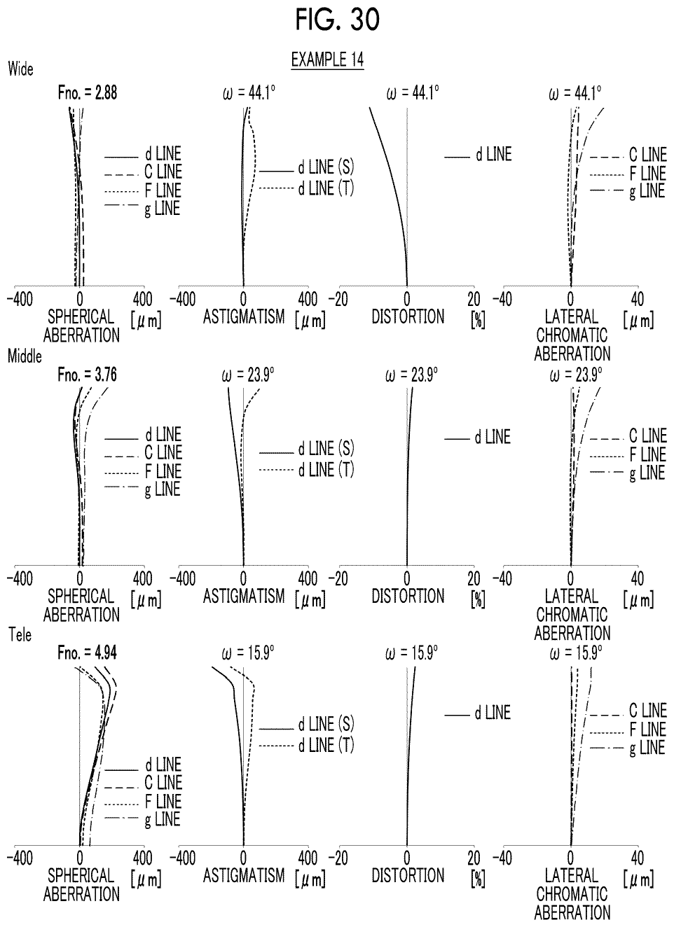

For the zoom lens of Example 14, Table 40 shows basic lens data, Table 41 shows specifications and a variable surface spacing, Table 42 shows aspherical coefficients, and FIG. 30 illustrates each aberration diagram.

TABLE 40
Example 14

| Sn | R | D | Nd | νd | θgF | ED | SG |
|---|---|---|---|---|---|---|---|
| 1 | 38.1700 | 1.0000 | 1.83481 | 42.72 | 0.56477 | 29.098 | 4.570 |
| 2 | 13.1570 | 8.5608 | | | | 23.126 | |
| *3 | −47.6220 | 1.3003 | 1.49710 | 81.56 | 0.53848 | 22.799 | 3.640 |
| *4 | 51.5677 | 0.5908 | | | | 22.572 | |
| 5 | 36.2334 | 2.5729 | 2.05090 | 26.94 | 0.60519 | 22.542 | 5.270 |
| 6 | 118.7423 | DD[6] | | | | 22.229 | |
| 7 | 18.0000 | 2.7577 | 1.49700 | 81.61 | 0.53887 | 15.263 | 3.700 |
| 8 | 206.6777 | 0.1337 | | | | 15.157 | |
| 9 | 21.5915 | 2.7621 | 1.49700 | 81.61 | 0.53887 | 15.037 | 3.700 |
| 10 | −162.3215 | 0.8102 | 1.54814 | 45.82 | 0.57004 | 14.671 | 2.540 |
| 11 | 52.1854 | 1.9904 | | | | 14.260 | |
| 12 (St) | ∞ | 3.0222 | | | | 13.837 | |
| 13 | 18.9347 | 3.6886 | 1.55032 | 75.50 | 0.54001 | 12.682 | 4.090 |
| 14 | −16.9770 | 0.6000 | 1.59551 | 39.22 | 0.58042 | 12.041 | 2.620 |
| 15 | 23.5847 | 1.1297 | | | | 11.118 | |
| *16 | 41.4700 | 1.1176 | 1.77400 | 49.59 | 0.55480 | 10.854 | 4.930 |
| *17 | 101.2537 | DD[17] | | | | 11.019 | |
| *18 | −40.5051 | 1.1560 | 1.77400 | 49.59 | 0.55480 | 13.841 | 4.930 |
| *19 | 66.3377 | DD[19] | | | | 14.319 | |
| 20 | −500.4725 | 3.2335 | 1.77250 | 49.62 | 0.55038 | 25.578 | 4.280 |
| 21 | −38.0008 | 10.9718 | | | | 26.014 | |
| 22 | ∞ | 2.8500 | 1.51680 | 64.20 | 0.53430 | 27.981 | 2.520 |
| 23 | ∞ | 1.0132 | | | | 28.259 | |

TABLE 41
Example 14

| | Wide | Middle | Tele |
|---|---|---|---|
| Zr | 1.00 | 1.91 | 2.94 |
| f | 16.50 | 31.53 | 48.55 |
| Bf | 13.86 | 13.86 | 13.86 |
| Fno. | 2.88 | 3.76 | 4.94 |
| 2ω [°] | 88.2 | 47.8 | 31.8 |
| DD[6] | 27.0503 | 8.0678 | 0.4809 |
| DD[17] | 2.5767 | 6.8722 | 11.1504 |
| DD[19] | 6.6113 | 14.5578 | 22.5018 |

TABLE 42
Example 14

| Sn | 3 | 4 | 16 | 17 |
|---|---|---|---|---|
| KA | 1.0000000000E+00 | 1.0000000000E+00 | 1.0000000000E+00 | 1.0000000000E+00 |
| A4 | −3.6969493468E−06 | −1.5121593555E−05 | −3.3761623510E−05 | 5.1232832602E−05 |
| A6 | 9.7959073992E−08 | 9.6141245544E−08 | −2.8277502129E−07 | −7.5604536950E−08 |
| A8 | −6.8472411221E−10 | −1.0758344346E−09 | 1.8015417407E−08 | 2.9350135208E−08 |
| A10 | 3.6628835883E−13 | 1.0008754405E−12 | −2.4243176858E−10 | −3.2435115907E−10 |
| Sn | 18 | 19 | | |
| KA | 1.0000000000E+00 | 1.0000000000E+00 | | |
| A4 | 1.5528727739E−04 | 1.8009598403E−04 | | |
| A6 | −2.4152324055E−06 | −2.5132062258E−06 | | |
| A8 | 3.9095412837E−08 | 3.4813311150E−08 | | |
| A10 | −2.5020206866E−10 | −2.1890370144E−10 | | |

### Example 15

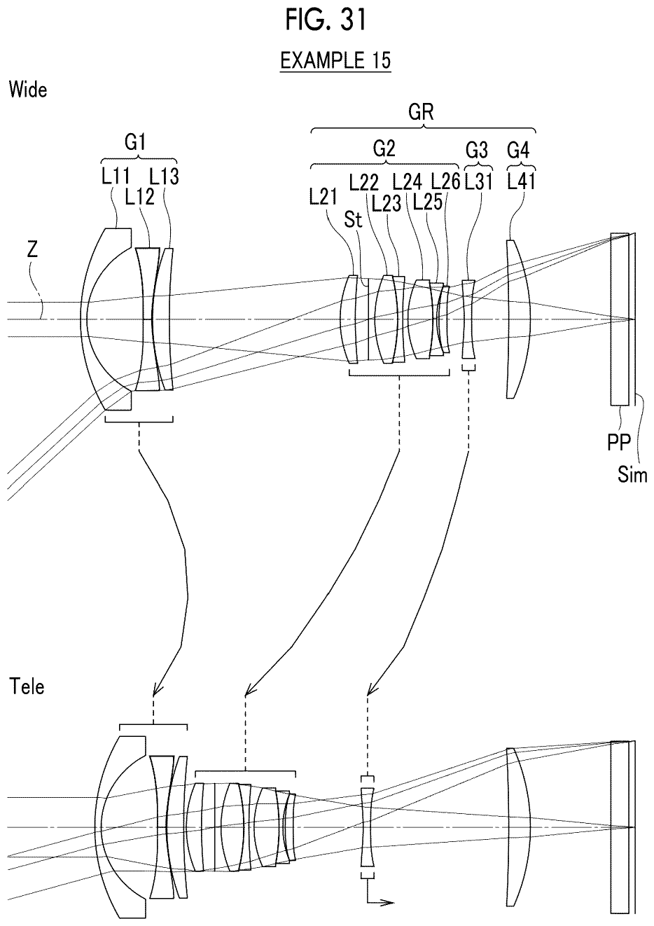

FIG. 31 illustrates a configuration and a moving path of a zoom lens of Example 15. The zoom lens of Example 15 consists of, in order from the object side to the image side, the first lens group G1 having a negative refractive power, the second lens group G2 having a positive refractive power, the third lens group G3 having a negative refractive power, and the fourth lens group G4 having a positive refractive power. The subsequent group GR consists of the second lens group G2, the third lens group G3, and the fourth lens group G4. During zooming from the wide angle end to the telephoto end, the first lens group G1, the second lens group G2, and the third lens group G3 move along the optical axis Z by changing spacings with respect to adjacent lens groups, and the fourth lens group G4 is fixed with respect to the image plane Sim. The focus group consists of the third lens group G3, and the focus group moves to the image side during focusing from the infinite distance object to the nearest object.

The first lens group G1 consists of, in order from the object side to the image side, three lenses including the lenses L11 to L13. The second lens group G2 consists of the aperture stop St and six lenses including the lenses L21 to L26. The third lens group G3 consists of one lens that is the lens L31. The fourth lens group G4 consists of one lens that is the lens L41.

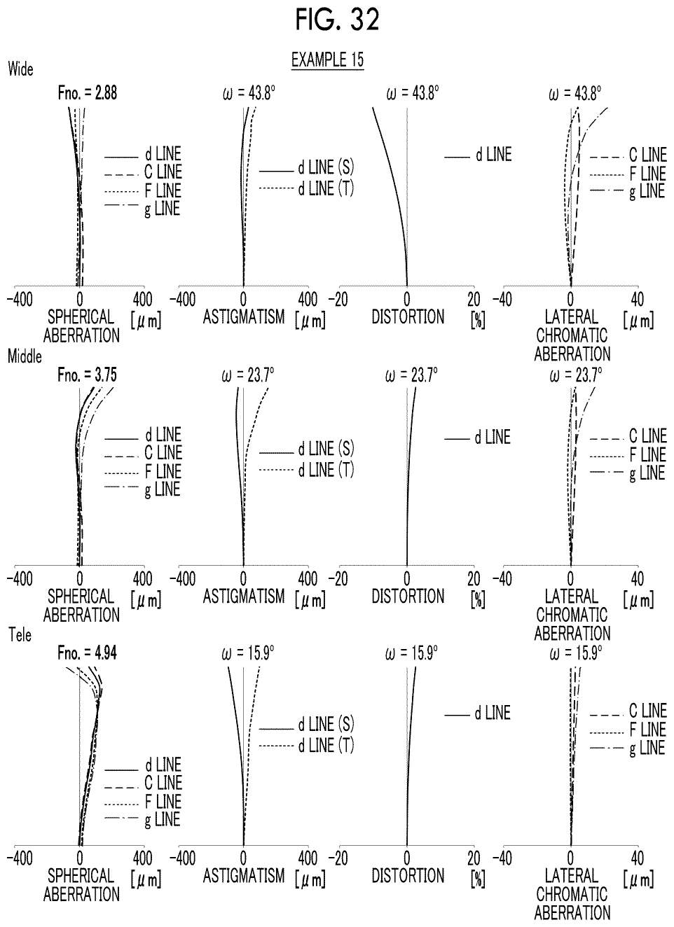

For the zoom lens of Example 15, Table 43 shows basic lens data, Table 44 shows specifications and a variable surface spacing, Table 45 shows aspherical coefficients, and FIG. 32 illustrates each aberration diagram.

TABLE 43
Example 15

| Sn | R | D | Nd | νd | θgF | ED | SG |
|---|---|---|---|---|---|---|---|
| 1 | 30.3762 | 1.0000 | 1.87070 | 40.73 | 0.56825 | 29.827 | 4.840 |
| 2 | 13.4392 | 8.8997 | | | | 23.620 | |
| *3 | 1147.0813 | 1.3564 | 1.49710 | 81.56 | 0.53848 | 23.377 | 3.640 |
| *4 | 23.7952 | 0.1200 | | | | 23.286 | |
| 5 | 35.0875 | 2.6490 | 2.00069 | 25.46 | 0.61364 | 23.261 | 4.730 |
| 6 | 115.2400 | DD[6] | | | | 22.946 | |
| 7 | 18.9639 | 2.3985 | 1.49700 | 81.61 | 0.53887 | 14.481 | 3.700 |
| 8 | 76.3584 | 2.0746 | | | | 14.396 | |
| 9 (St) | ∞ | 1.0000 | | | | 14.397 | |
| 10 | 19.2520 | 3.6026 | 1.55032 | 75.50 | 0.54001 | 14.468 | 4.090 |
| 11 | −30.9153 | 0.8002 | 1.51742 | 52.15 | 0.55896 | 14.105 | 2.430 |
| 12 | 74.1706 | 0.8144 | | | | 13.565 | |
| 13 | 16.1585 | 3.9478 | 1.55032 | 75.50 | 0.54001 | 12.952 | 4.090 |
| 14 | −34.0719 | 0.6001 | 1.67300 | 38.26 | 0.57580 | 11.893 | 3.010 |
| 15 | 14.6477 | 0.3625 | | | | 10.930 | |
| *16 | 28.9884 | 1.2619 | 1.80337 | 45.49 | 0.55928 | 10.928 | 4.890 |
| *17 | 107.3529 | DD[17] | | | | 10.519 | |
| *18 | −33.7971 | 1.1605 | 1.77400 | 49.59 | 0.55480 | 12.559 | 4.930 |
| *19 | 92.6500 | DD[19] | | | | 12.826 | |
| 20 | −248.6833 | 3.4244 | 1.72916 | 54.67 | 0.54534 | 25.490 | 4.050 |
| 21 | −33.1152 | 12.6900 | | | | 25.962 | |
| 22 | ∞ | 2.8500 | 1.51680 | 64.20 | 0.53430 | 28.020 | 2.520 |
| 23 | ∞ | 1.0094 | | | | 28.272 | |

TABLE 44
Example 15

| | Wide | Middle | Tele |
|---|---|---|---|
| Zr | 1.00 | 1.91 | 2.94 |
| f | 16.49 | 31.52 | 48.54 |
| Bf | 15.58 | 15.58 | 15.58 |
| Fno. | 2.88 | 3.75 | 4.94 |
| 2ω [°] | 87.6 | 47.4 | 31.8 |
| DD[6] | 26.8760 | 7.6081 | 0.4236 |
| DD[17] | 2.7199 | 7.2373 | 10.9618 |
| DD[19] | 5.8706 | 12.9179 | 21.8201 |

TABLE 45
Example 15

| Sn | 3 | 4 | 16 | 17 |
|---|---|---|---|---|
| KA | 1.0000000000E+00 | 1.0000000000E+00 | 1.0000000000E+00 | 1.0000000000E+00 |
| A4 | −2.3349529394E−04 | −2.6038910229E−04 | 6.5287009428E−05 | 1.4601429713E−04 |
| A6 | 4.2109219450E−06 | 4.3804297135E−06 | 1.1755572214E−05 | 1.3606368827E−05 |
| A8 | −6.7327881763E−08 | −7.2779436473E−08 | −1.4075230256E−06 | −1.5462201702E−06 |
| A10 | 8.7088047535E−10 | 9.7369730652E−10 | 1.4392573399E−07 | 1.5286213896E−07 |
| A12 | −8.3936947038E−12 | −9.7803011728E−12 | −9.1623263097E−09 | −9.1527106353E−09 |
| A14 | 5.5769226056E−14 | 6.7911919545E−14 | 3.7260217194E−10 | 3.4231435233E−10 |
| A16 | −2.3728490294E−16 | −3.0289150942E−16 | −9.4247026843E−12 | −7.7800676492E−12 |
| A18 | 5.7382463071E−19 | 7.7173794854E−19 | 1.3549610527E−13 | 9.8522008003E−14 |
| A20 | −5.9446039052E−22 | −8.4671400705E−22 | −8.4669295541E−16 | −5.3365255465E−16 |
| Sn | 18 | 19 | | |
| KA | 1.0000000000E+00 | 1.0000000000E+00 | | |
| A4 | 2.7894680874E−04 | 3.0509002416E−04 | | |
| A6 | 1.9585183861E−06 | 5.3765586938E−07 | | |
| A8 | −1.1922372037E−06 | −8.8586829508E−07 | | |
| A10 | 1.2061182483E−07 | 8.3973004766E−08 | | |
| A12 | −6.7611989404E−09 | −4.3488042766E−09 | | |
| A14 | 2.2670354917E−10 | 1.3459555434E−10 | | |
| A16 | −4.4861657177E−12 | −2.4601497986E−12 | | |
| A18 | 4.8104897144E−14 | 2.4366878968E−14 | | |
| A20 | −2.1449650034E−16 | −1.0028120719E−16 | | |

### Example 16

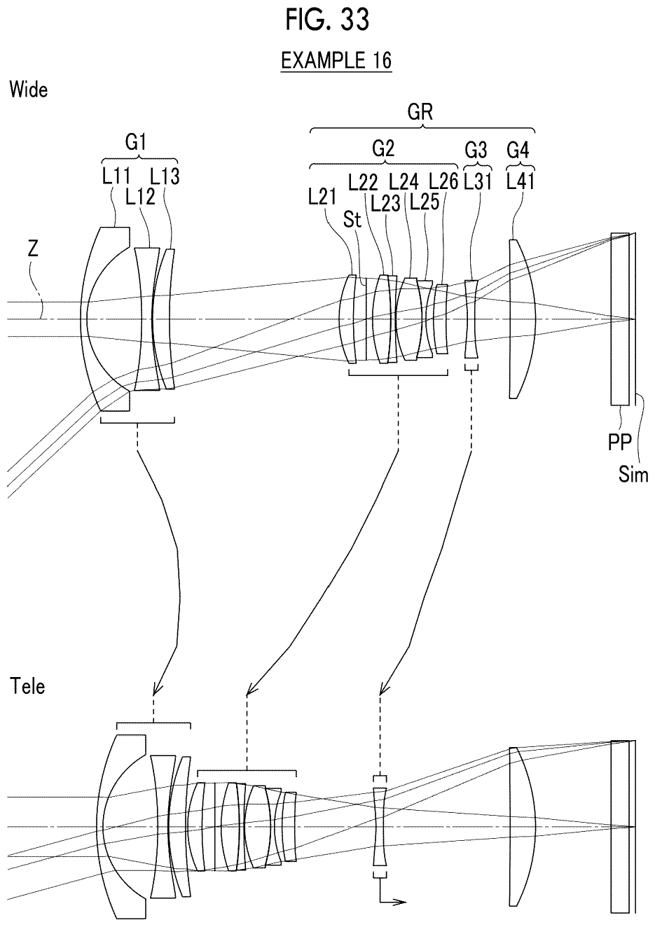

FIG. 33 illustrates a configuration and a moving path of a zoom lens of Example 16. The zoom lens of Example 16 consists of, in order from the object side to the image side, the first lens group G1 having a negative refractive power, the second lens group G2 having a positive refractive power, the third lens group G3 having a negative refractive power, and the fourth lens group G4 having a positive refractive power. The subsequent group GR consists of the second lens group G2, the third lens group G3, and the fourth lens group G4. During zooming from the wide angle end to the telephoto end, the first lens group G1, the second lens group G2, and the third lens group G3 move along the optical axis Z by changing spacings with respect to adjacent lens groups, and the fourth lens group G4 is fixed with respect to the image plane Sim. The focus group consists of the third lens group G3, and the focus group moves to the image side during focusing from the infinite distance object to the nearest object.

The first lens group G1 consists of, in order from the object side to the image side, three lenses including the lenses L11 to L13. The second lens group G2 consists of the aperture stop St and six lenses including the lenses L21 to L26. The third lens group G3 consists of one lens that is the lens L31. The fourth lens group G4 consists of one lens that is the lens L41.

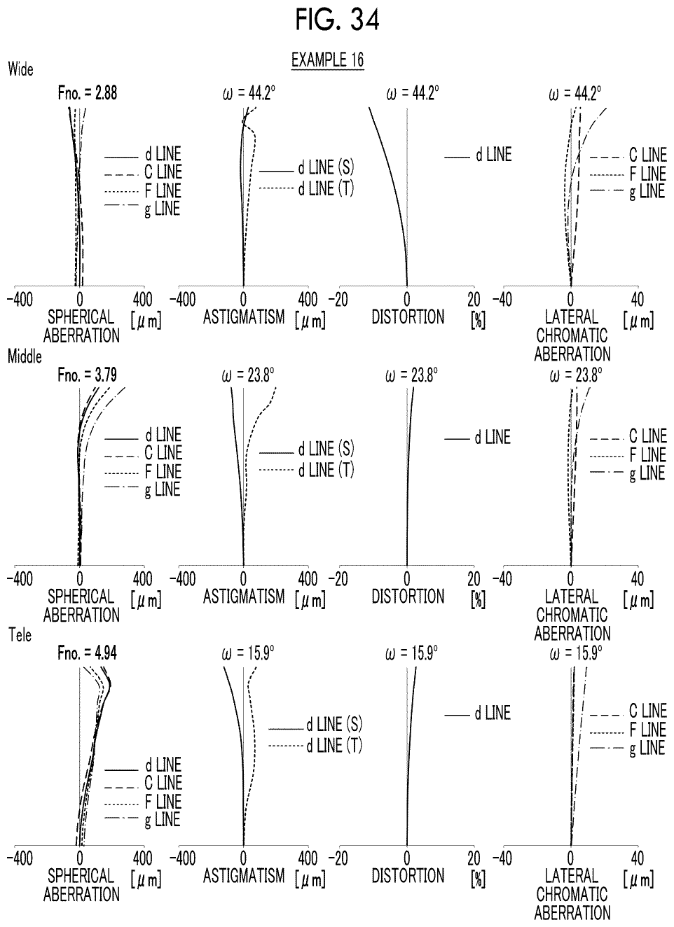

For the zoom lens of Example 16, Table 46 shows basic lens data, Table 47 shows specifications and a variable surface spacing, Table 48 shows aspherical coefficients, and FIG. 34 illustrates each aberration diagram.

TABLE 46
Example 16

| Sn | R | D | Nd | νd | θgF | ED | SG |
|---|---|---|---|---|---|---|---|
| 1 | 37.4233 | 1.0000 | 1.77535 | 50.31 | 0.55042 | 30.158 | 4.350 |
| 2 | 13.7828 | 8.6595 | | | | 23.717 | |
| *3 | −70.2026 | 1.6002 | 1.58313 | 59.46 | 0.54056 | 23.386 | 3.010 |
| *4 | 42.5822 | 0.1201 | | | | 22.990 | |
| 5 | 31.3942 | 2.6537 | 2.05091 | 26.95 | 0.60473 | 22.986 | 5.270 |
| 6 | 81.0448 | DD[6] | | | | 22.614 | |
| 7 | 17.7377 | 2.2567 | 1.49700 | 81.61 | 0.53887 | 14.503 | 3.700 |
| 8 | 57.3270 | 2.0158 | | | | 14.406 | |
| 9 (St) | ∞ | 1.0000 | | | | 14.411 | |
| 10 | 22.6785 | 2.8818 | 1.59282 | 68.62 | 0.54414 | 14.493 | 4.130 |
| 11 | −54.8197 | 0.7100 | 1.54814 | 45.82 | 0.56889 | 14.217 | 2.580 |
| 12 | 89.3038 | 0.1200 | | | | 13.872 | |
| 13 | 16.8525 | 4.1033 | 1.59282 | 68.62 | 0.54414 | 13.512 | 4.130 |
| 14 | −23.9764 | 0.6001 | 1.65410 | 39.54 | 0.57251 | 12.593 | 3.010 |
| 15 | 16.1533 | 1.2160 | | | | 11.485 | |
| *16 | 34.9309 | 1.9998 | 1.58313 | 59.46 | 0.54056 | 11.330 | 3.010 |
| *17 | 299.9766 | DD[17] | | | | 10.813 | |
| *18 | −26.7737 | 1.1708 | 1.72903 | 54.04 | 0.54474 | 12.551 | 4.280 |
| *19 | 228.9390 | DD[19] | | | | 12.781 | |
| 20 | −787.5447 | 4.0045 | 1.60738 | 56.71 | 0.54817 | 25.555 | 3.530 |
| 21 | −29.8498 | 11.9222 | | | | 26.045 | |
| 22 | ∞ | 2.8500 | 1.51680 | 64.20 | 0.53430 | 28.029 | 2.520 |
| 23 | ∞ | 1.0137 | | | | 28.279 | |

TABLE 47
Example 16

| | Wide | Middle | Tele |
|---|---|---|---|
| Zr | 1.00 | 1.91 | 2.94 |
| f | 16.49 | 31.51 | 48.53 |
| Bf | 14.81 | 14.81 | 14.81 |
| Fno. | 2.88 | 3.79 | 4.94 |
| 2ω [°] | 88.4 | 47.6 | 31.8 |
| DD[6] | 26.6792 | 7.9314 | 0.3446 |
| DD[17] | 3.3445 | 7.9082 | 12.7100 |
| DD[19] | 5.5720 | 13.0405 | 20.0025 |

TABLE 48
Example 16

| Sn | 3 | 4 | 16 | 17 |
|---|---|---|---|---|
| KA | 1.0000000000E+00 | 1.0000000000E+00 | 1.0000000000E+00 | 1.0000000000E+00 |
| A4 | −2.7435444806E−05 | −3.4188297092E−05 | 7.8297772836E−06 | 1.1590003025E−04 |
| A6 | 5.3732031198E−07 | 5.1159109569E−07 | 5.5588227847E−06 | 6.4506434130E−06 |
| A8 | −1.3230543152E−08 | −1.3723308527E−08 | −6.9784682090E−07 | −6.7137865401E−07 |
| A10 | 3.1778485996E−10 | 3.3778885844E−10 | 6.7260274793E−08 | 5.5343028936E−08 |
| A12 | −5.3273428799E−12 | −5.7415996546E−12 | −4.0546645415E−09 | −2.4253492734E−09 |
| A14 | 5.5556306584E−14 | 6.0459202346E−14 | 1.5722513634E−10 | 4.9482121766E−11 |
| A16 | −3.4286631976E−16 | −3.7784062402E−16 | −3.8532810314E−12 | −3.7494398083E−14 |
| A18 | 1.1392219216E−18 | 1.2761878905E−18 | 5.4556497709E−14 | −1.4942730799E−14 |
| A20 | −1.5604500160E−21 | −1.7819300298E−21 | −3.3975007904E−16 | 1.7217652989E−16 |
| Sn | 18 | 19 | | |
| KA | 1.0000000000E+00 | 1.0000000000E+00 | | |
| A4 | 3.6700817025E−04 | 3.8646275442E−04 | | |
| A6 | −7.2883882378E−07 | −9.4734016566E−07 | | |
| A8 | −9.2852567785E−07 | −7.7159620334E−07 | | |
| A10 | 9.5833784425E−08 | 7.2217405070E−08 | | |
| A12 | −5.2316666742E−09 | −3.5786679995E−09 | | |
| A14 | 1.6776203905E−10 | 1.0449291643E−10 | | |
| A16 | −3.1431826614E−12 | −1.7852114718E−12 | | |
| A18 | 3.1779501586E−14 | 1.6446971062E−14 | | |
| A20 | −1.3376527302E−16 | −6.2914658659E−17 | | |

### Example 17

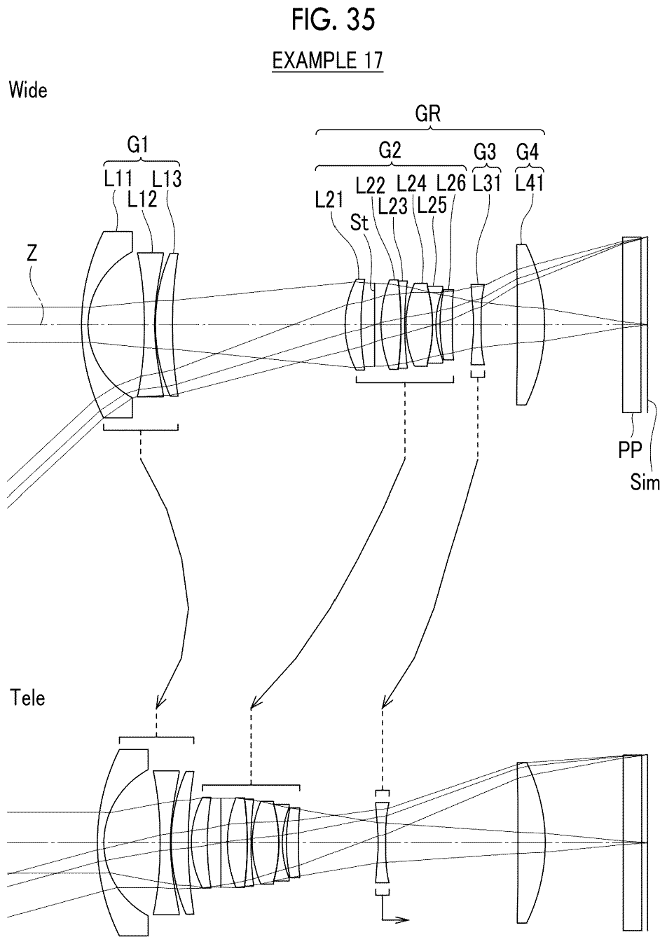

FIG. 35 illustrates a configuration and a moving path of a zoom lens of Example 17. The zoom lens of Example 17 consists of, in order from the object side to the image side, the first lens group G1 having a negative refractive power, the second lens group G2 having a positive refractive power, the third lens group G3 having a negative refractive power, and the fourth lens group G4 having a positive refractive power. The subsequent group GR consists of the second lens group G2, the third lens group G3, and the fourth lens group G4. During zooming from the wide angle end to the telephoto end, the first lens group G1, the second lens group G2, and the third lens group G3 move along the optical axis Z by changing spacings with respect to adjacent lens groups, and the fourth lens group G4 is fixed with respect to the image plane Sim. The focus group consists of the third lens group G3, and the focus group moves to the image side during focusing from the infinite distance object to the nearest object.

The first lens group G1 consists of, in order from the object side to the image side, three lenses including the lenses L11 to L13. The second lens group G2 consists of the aperture stop St and six lenses including the lenses L21 to L26. The third lens group G3 consists of one lens that is the lens L31. The fourth lens group G4 consists of one lens that is the lens L41.

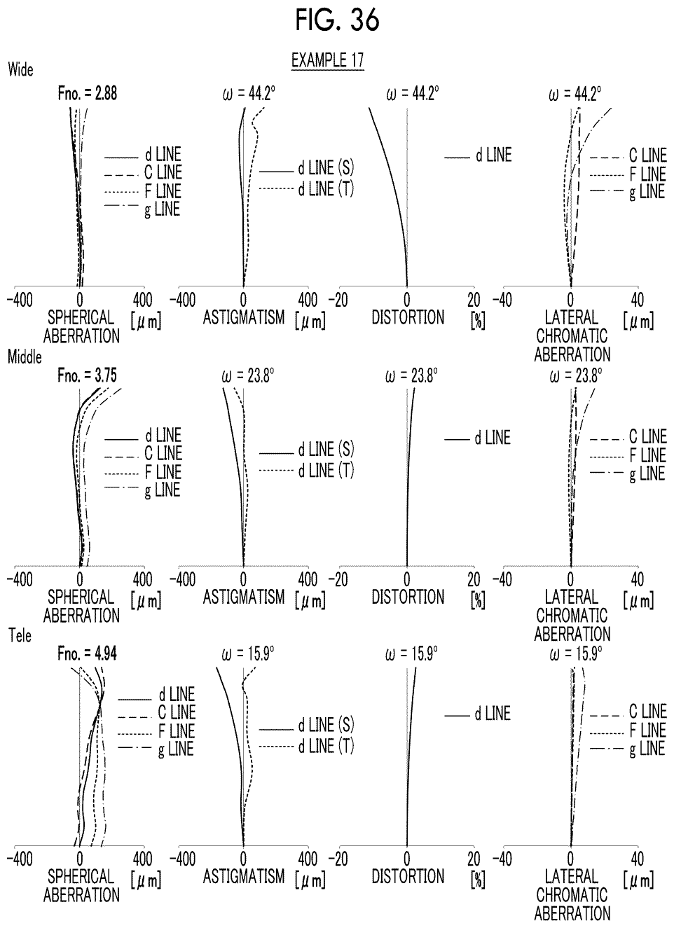

For the zoom lens of Example 17, Table 49 shows basic lens data, Table 50 shows specifications and a variable surface spacing, Table 51 shows aspherical coefficients, and FIG. 36 illustrates each aberration diagram.

TABLE 49
Example 17

| Sn | R | D | Nd | νd | θgF | ED | SG |
|---|---|---|---|---|---|---|---|
| 1 | 34.7628 | 1.0000 | 1.77250 | 49.60 | 0.55165 | 30.011 | 4.240 |
| 2 | 13.5266 | 8.7100 | | | | 23.546 | |
| *3 | −82.8134 | 1.6000 | 1.58510 | 58.74 | 0.54116 | 23.192 | 3.300 |
| *4 | 36.3271 | 0.1200 | | | | 22.740 | |
| 5 | 30.2168 | 2.6300 | 2.05091 | 26.95 | 0.60473 | 22.987 | 5.270 |
| 6 | 76.4413 | DD[6] | | | | 22.623 | |
| 7 | 16.3962 | 2.4600 | 1.49700 | 81.61 | 0.53887 | 14.628 | 3.700 |
| 8 | 46.5774 | 2.1100 | | | | 14.445 | |
| 9 (St) | ∞ | 1.0000 | | | | 14.360 | |
| 10 | 20.4640 | 3.0800 | 1.59283 | 68.63 | 0.54286 | 14.412 | 4.070 |
| 11 | −58.8570 | 0.5700 | 1.54814 | 45.82 | 0.56889 | 14.060 | 2.580 |
| 12 | 58.8570 | 0.2000 | | | | 13.675 | |
| 13 | 17.4835 | 4.1100 | 1.59283 | 68.63 | 0.54286 | 13.338 | 4.070 |
| 14 | −24.0337 | 0.5400 | 1.65411 | 39.68 | 0.57262 | 12.369 | 3.010 |
| 15 | 15.9153 | 0.6300 | | | | 11.301 | |
| *16 | 29.1113 | 1.8900 | 1.58510 | 58.74 | 0.54116 | 11.262 | 3.300 |
| *17 | 294.8208 | DD[17] | | | | 10.816 | |
| *18 | −27.2175 | 1.1700 | 1.76802 | 49.24 | 0.55164 | 12.645 | 4.560 |
| *19 | 241.5555 | DD[19] | | | | 12.921 | |
| 20 | −751.9980 | 4.2200 | 1.61773 | 49.81 | 0.55968 | 25.200 | 3.160 |
| 21 | −30.5006 | 12.0688 | | | | 25.835 | |
| 22 | ∞ | 2.8500 | 1.51680 | 64.20 | 0.53430 | 28.000 | 2.520 |
| 23 | ∞ | 1.0100 | | | | 28.272 | |

TABLE 50
Example 17

| | Wide | Middle | Tele |
|---|---|---|---|
| Zr | 1.00 | 1.91 | 2.94 |
| f | 16.49 | 31.51 | 48.57 |
| Bf | 14.96 | 14.92 | 14.86 |
| Fno. | 2.88 | 3.75 | 4.94 |
| 2ω [°] | 88.4 | 47.6 | 31.8 |
| DD[6] | 26.6200 | 7.7138 | 0.4879 |
| DD[17] | 3.2870 | 7.9979 | 12.2130 |
| DD[19] | 5.6000 | 12.4484 | 20.4650 |

TABLE 51
Example 17

| Sn | 3 | 4 | 16 | 17 |
|---|---|---|---|---|
| KA | 1.0000000000E+00 | 1.0000000000E+00 | 1.0000000000E+00 | 1.0000000000E+00 |
| A3 | 0.0000000000E+00 | 0.0000000000E+00 | 0.0000000000E+00 | 0.0000000000E+00 |
| A4 | −3.9924577224E−05 | −5.2717350356E−05 | −5.6037435788E−05 | 1.2569879863E−04 |
| A5 | −5.1852215278E−06 | −3.0603195913E−06 | 3.1167800426E−05 | −7.5279325899E−05 |
| A6 | 2.4805344695E−06 | 2.5910625117E−06 | −1.2244498970E−05 | 6.4157441890E−05 |
| A7 | −1.7539778327E−07 | −4.2935249742E−07 | 8.8195816761E−06 | −1.9839925072E−05 |
| A8 | −2.9581973849E−08 | 1.9557676761E−08 | −6.7867359661E−06 | 2.8564232827E−06 |
| A9 | 3.2235598271E−09 | 1.8271994016E−09 | 3.2546395675E−06 | −1.9471728126E−06 |
| A10 | 7.4991432654E−10 | 3.5397011065E−10 | −8.5662423567E−07 | 1.3130566099E−06 |
| A11 | −1.2215169948E−10 | −1.1609979679E−10 | 7.0195083659E−08 | −2.7080897841E−07 |
| A12 | −3.7721525292E−12 | 2.4551308416E−13 | 2.9312859944E−08 | −3.3138540630E−08 |
| A13 | 1.4800537658E−42 | 1.5549002771E−12 | −9.8979829383E−09 | 1.9982480626E−08 |
| A14 | −2.4569352907E−14 | −6.6712880356E−14 | 7.0957205291E−10 | −1.4609034040E−09 |
| A15 | −7.7693593692E−15 | −7.6946423481E−15 | 1.7513910904E−10 | −3.8665233524E−10 |
| A16 | 2.6871925618E−16 | 4.7486976265E−16 | −3.3067578340E−11 | 5.9181199574E−11 |
| A17 | 1.8920218202E−17 | 1.5719915775E−17 | 8.4621971776E−14 | 1.8030436086E−12 |
| A18 | −8.0215421148E−19 | −1.2042993579E−18 | 3.1936536227E−13 | −6.3938312332E−13 |
| A19 | −1.7580140587E−20 | −1.0128720673E−20 | −1.3737554812E−14 | 8.2530816674E−15 |
| A20 | 7.6944491746E−22 | 9.6075388810E−22 | −4.9418073255E−16 | 1.8462205892E−15 |
| Sn | 18 | 19 | | |
| KA | 1.0000000000E+00 | 1.0000000000E+00 | | |
| A3 | 0.0000000000E+00 | 0.0000000000E+00 | | |
| A4 | 2.2182976106E−04 | 2.1168787378E−04 | | |
| A5 | 1.5988017197E−04 | 1.9172323717E−04 | | |
| A6 | −4.0281193641E−05 | −5.4763367412E−05 | | |
| A7 | −1.2599590175E−05 | −1.0775863051E−05 | | |
| A8 | 6.0729275695E−06 | 7.0239831857E−06 | | |
| A9 | −7.5192822427E−08 | −4.0331436842E−07 | | |
| A10 | −3.2506466278E−07 | −3.3375296967E−07 | | |
| A11 | 4.1261623607E−08 | 5.5906836513E−08 | | |
| A12 | 7.5425197952E−09 | 6.6807831613E−09 | | |
| A13 | −1.9722081930E−09 | −2.1984273415E−09 | | |
| A14 | −1.9659215468E−11 | −4.5547438975E−12 | | |
| A15 | 4.2064233563E−11 | 4.2239233657E−11 | | |
| A16 | −2.2729807827E−12 | −2.0174335823E−12 | | |
| A17 | −4.3559581003E−13 | −4.0704851021E−13 | | |
| A18 | 3.9316231229E−14 | 3.0963800243E−14 | | |
| A19 | 1.7903786194E−15 | 1.5796411710E−15 | | |
| A20 | −2.0767406726E−16 | −1.4972112878E−16 | | |

### Example 18

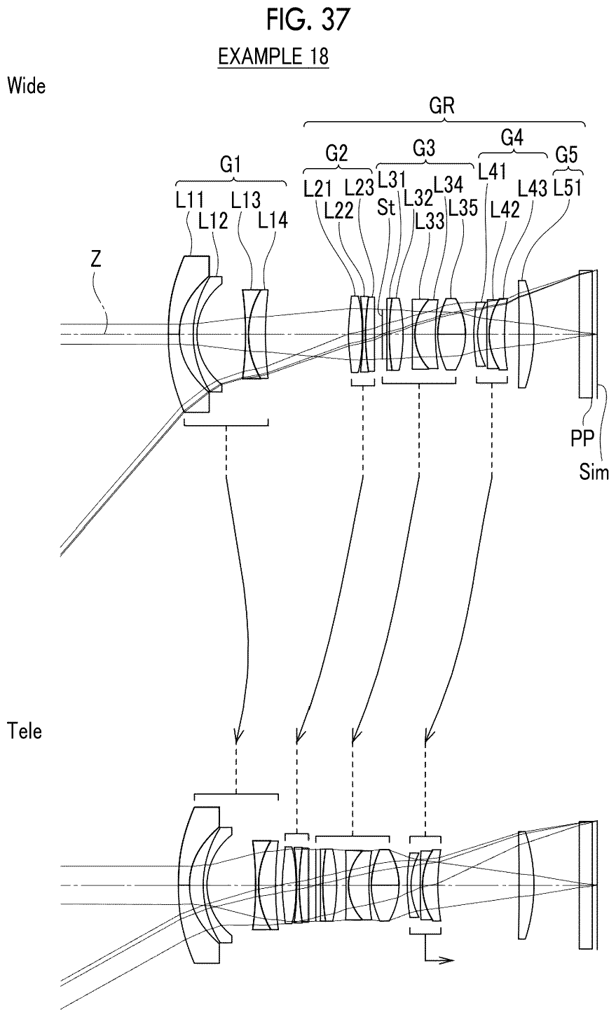

FIG. 37 illustrates a configuration and a moving path of a zoom lens of Example 18. The zoom lens of Example 18 consists of, in order from the object side to the image side, the first lens group G1 having a negative refractive power, the second lens group G2 having a positive refractive power, the third lens group G3 having a positive refractive power, the fourth lens group G4 having a negative refractive power, and the fifth lens group G5 having a positive refractive power. The subsequent group GR consists of the second lens group G2, the third lens group G3, the fourth lens group G4, and the fifth lens group G5. During zooming from the wide angle end to the telephoto end, the first lens group G1, the second lens group G2, the third lens group G3, and the fourth lens group G4 move along the optical axis Z by changing spacings with respect to adjacent lens groups, and the fifth lens group G5 is fixed with respect to the image plane Sim. The focus group consists of the fourth lens group G4, and the focus group moves to the image side during focusing from the infinite distance object to the nearest object.

The first lens group G1 consists of, in order from the object side to the image side, four lenses including the lenses L11 to L14. The second lens group G2 consists of, in order from the object side to the image side, three lenses including the lenses L21 to L23. The third lens group G3 consists of, in order from the object side to the image side, the aperture stop St and five lenses including lenses L31 to L35. The fourth lens group G4 consists of, in order from the object side to the image side, three lenses including the lenses L41 to L43. The fifth lens group G5 consists of one lens that is the lens L51.

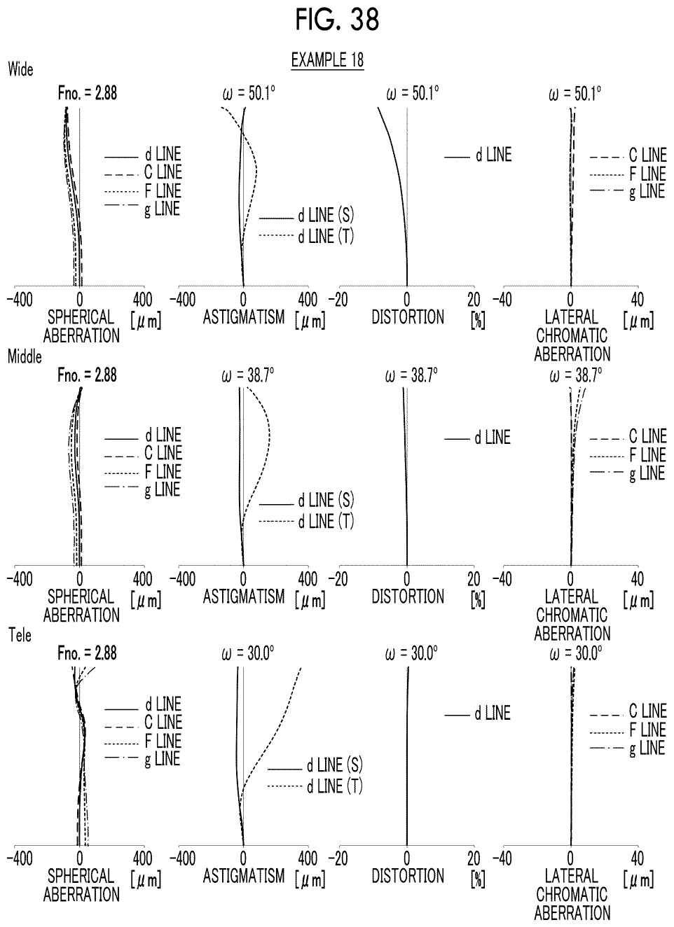

For the zoom lens of Example 18, Table 52 shows basic lens data, Table 53 shows specifications and a variable surface spacing, Table 54 shows aspherical coefficients, and FIG. 38 illustrates each aberration diagram.

TABLE 52
Example 18

| Sn | R | D | Nd | νd | θgF | ED | SG |
|---|---|---|---|---|---|---|---|
| *1 | 78.1195 | 2.4207 | 1.59319 | 67.90 | 0.54402 | 35.472 | 4.100 |
| *2 | 17.0643 | 3.0293 | | | | 26.514 | |
| 3 | 24.7411 | 0.8212 | 1.88300 | 40.80 | 0.56557 | 26.186 | 5.420 |
| 4 | 14.7059 | 10.6799 | | | | 22.860 | |
| 5 | −78.5968 | 0.6558 | 1.43744 | 94.44 | 0.53349 | 20.200 | 3.520 |
| 6 | 20.1971 | 3.7151 | 1.88300 | 40.76 | 0.56679 | 20.154 | 5.520 |
| 7 | 83.7799 | DD[7] | | | | 19.716 | |
| *8 | 39.7450 | 3.0244 | 1.90525 | 35.04 | 0.58486 | 17.400 | 4.830 |
| *9 | −57.3438 | 0.1498 | | | | 17.400 | |
| 10 | −65.6066 | 0.5577 | 1.64769 | 33.87 | 0.59124 | 17.165 | 2.780 |
| 11 | 55.2063 | 1.9917 | 1.52855 | 76.97 | 0.54015 | 16.872 | 3.855 |
| 12 | 6548.5015 | DD[12] | | | | 16.674 | |
| 13 (St) | ∞ | 0.9998 | | | | 16.337 | |
| 14 | −7038.8276 | 0.5436 | 1.61405 | 55.12 | 0.55186 | 16.324 | 3.580 |
| 15 | 54.7869 | 3.0150 | 1.49690 | 81.52 | 0.53599 | 16.320 | 3.640 |
| 16 | −39.3414 | 2.0952 | | | | 16.349 | |
| 17 | −288.1666 | 0.5186 | 1.65411 | 39.68 | 0.57262 | 15.823 | 3.010 |
| 18 | 11.5283 | 4.5098 | 1.49731 | 82.51 | 0.53861 | 15.499 | 3.860 |
| 19 | 53.9303 | 0.5134 | | | | 15.689 | |
| *20 | 16.4423 | 6.0793 | 1.49710 | 81.56 | 0.53848 | 16.200 | 3.640 |
| *21 | −14.7991 | DD[21] | | | | 16.200 | |
| *22 | 34.3725 | 0.8315 | 1.68948 | 31.02 | 0.59874 | 14.600 | 2.880 |
| *23 | 14.2554 | 2.0074 | | | | 14.522 | |
| 24 | 184.6966 | 0.5228 | 1.90200 | 25.26 | 0.61662 | 14.818 | 4.100 |
| 25 | 15.1694 | 3.3643 | 1.92286 | 18.90 | 0.65041 | 15.642 | 3.570 |
| 26 | 51.9007 | DD[26] | | | | 16.195 | |
| 27 | −921.0004 | 3.2845 | 1.49700 | 81.54 | 0.53748 | 23.829 | 3.620 |
| 28 | −40.4013 | 9.9772 | | | | 24.400 | |
| 29 | ∞ | 2.8500 | 1.51680 | 64.20 | 0.53430 | 28.693 | 2.520 |
| 30 | ∞ | 1.1000 | | | | 29.400 | |

TABLE 53
Example 18

| | Wide | Middle | Tele |
|---|---|---|---|
| Zr | 1.00 | 1.38 | 1.88 |
| f | 13.39 | 18.53 | 25.22 |
| Bf | 12.96 | 12.96 | 12.96 |
| Fno. | 2.88 | 2.88 | 2.88 |
| 2ω [°] | 100.2 | 77.4 | 60.0 |
| DD[7] | 18.1081 | 7.5851 | 1.4820 |
| DD[12] | 1.6890 | 1.9913 | 1.5049 |
| DD[21] | 1.7799 | 2.0870 | 1.7441 |
| DD[26] | 3.2403 | 8.6551 | 17.8642 |

TABLE 54
Example 18

| Sn | 1 | 2 | 8 | 9 |
|---|---|---|---|---|
| KA | 1.0000000000E+00 | 1.0000000000E+00 | 1.0000000000E+00 | 1.0000000000E+00 |
| A3 | 0.0000000000E+00 | 0.0000000000E+00 | 0.0000000000E+00 | 0.0000000000E+00 |
| A4 | 7.7173673393E−05 | 7.3112377090E−05 | −6.4383218485E−05 | −5.5828281806E−05 |
| A5 | −4.2527159688E−06 | −3.5335353654E−06 | 3.8815403762E−06 | 4.1002955424E−06 |
| A6 | −1.5184304505E−07 | −1.8362609466E−07 | 1.3203719348E−07 | 6.5834608190E−08 |
| A7 | 2.3959823461E−08 | 1.9164224744E−08 | −9.6251172178E−08 | −8.1172353097E−08 |
| A8 | −1.4070286965E−09 | −6.9191439987E−10 | −4.9191649304E−09 | 1.9655777023E−09 |
| A9 | 5.2192086284E−11 | −1.0049395611E−10 | 2.1136581919E−09 | −4.3437910151E−10 |
| A10 | −6.5419155284E−14 | 1.0518848118E−11 | −1.3082666019E−10 | 3.8076708999E−10 |
| A11 | 1.3668479966E−13 | −4.9844742274E−13 | 9.1112496087E−14 | −6.8055243893E−11 |
| A12 | −4.7889191333E−14 | −1.2578787322E−14 | −8.9318359069E−13 | 4.1224462110E−12 |
| A13 | 4.7311491447E−15 | 4.4469565151E−15 | 3.1615406273E−13 | 2.7165535226E−13 |
| A14 | −2.2870564604E−16 | −3.2664911249E−16 | −3.8584369830E−14 | −6.2355049694E−14 |
| A15 | 5.6444096112E−18 | 1.1161708863E−17 | 2.1755302516E−15 | 3.9833942460E−15 |
| A16 | −5.7215974425E−20 | −1.5306666273E−19 | −4.8277895496E−17 | −9.2429034356E−17 |
| Sn | 20 | 21 | 22 | 23 |
| KA | 1.0000000000E+00 | 1.0000000000E+00 | 1.0000000000E+00 | 1.0000000000E+00 |
| A3 | 0.0000000000E+00 | 0.0000000000E+00 | 0.0000000000E+00 | 0.0000000000E+00 |
| A4 | −7.4368436274E−05 | 7.4833766292E−05 | −1.5722270310E−04 | −1.9406919744E−04 |
| A5 | 2.9867657849E−06 | 6.9275803040E−06 | 2.9641272463E−07 | 4.5446963058E−08 |
| A6 | 3.2550376067E−07 | −1.2318088299E−06 | 2.3976581245E−06 | 3.7763350561E−06 |
| A7 | −1.8474405829E−07 | −4.7450562047E−07 | 2.7558434227E−08 | −2.5068167355E−07 |
| A8 | 3.5137360205E−09 | 1.5738602945E−07 | −3.8217673921E−08 | 6.0549932009E−08 |
| A9 | 2.7380994523E−09 | −1.5637833273E−08 | 9.4306241959E−09 | −2.5733200089E−08 |
| A10 | −6.2778863210E−12 | −1.4413538835E−09 | −2.4505743008E−09 | 4.5201619799E−09 |
| A11 | −5.3264957729E−11 | 6.4142535730E−10 | 3.8374634196E−10 | −1.9214838369E−10 |
| A12 | 4.6032329750E−12 | −7.3116070713E−11 | −2.8690323044E−11 | −8.6944633697E−11 |
| A13 | 1.8713082737E−13 | 1.0546976054E−12 | −5.9334806606E−13 | 2.1025185043E−11 |
| A14 | −6.6784941929E−14 | 5.0122469410E−13 | 3.1352498484E−13 | −2.2459012163E−12 |
| A15 | 4.9249185876E−15 | −4.4774734676E−14 | −2.4612526741E−14 | 1.2301958151E−13 |
| A16 | −1.2725380398E−16 | 1.2402625375E−15 | 6.7561798505E−16 | −2.8049779122E−15 |

### Example 19

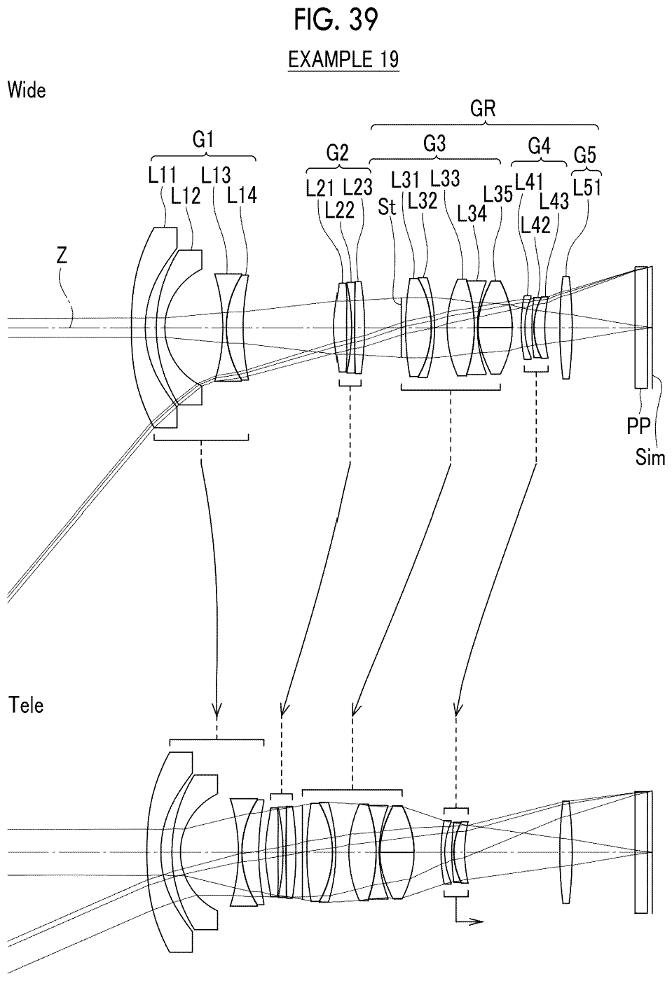

FIG. 39 illustrates a configuration and a moving path of a zoom lens of Example 19. The zoom lens of Example 19 consists of, in order from the object side to the image side, the first lens group G1 having a negative refractive power, the second lens group G2 having a positive refractive power, the third lens group G3 having a positive refractive power, the fourth lens group G4 having a negative refractive power, and the fifth lens group G5 having a positive refractive power. The subsequent group GR consists of the second lens group G2, the third lens group G3, the fourth lens group G4, and the fifth lens group G5. During zooming from to the image plane Sim.

The focus group consists of the fourth lens group G4, and the focus group moves to the image side during focusing from the infinite distance object to the nearest object.

The first lens group G1 consists of, in order from the object side to the image side, four lenses including the lenses L11 to L14. The second lens group G2 consists of, in order from the object side to the image side, three lenses including the lenses L21 to L23. The third lens group G3 consists of, in order from the object side to the image side, the aperture stop St and five lenses including the lenses L31 to L35. The fourth lens group G4 consists of, in order from the object side to the image side, three lenses including the lenses L41 to L43. The fifth lens group G5 consists of one lens that is the lens L51.

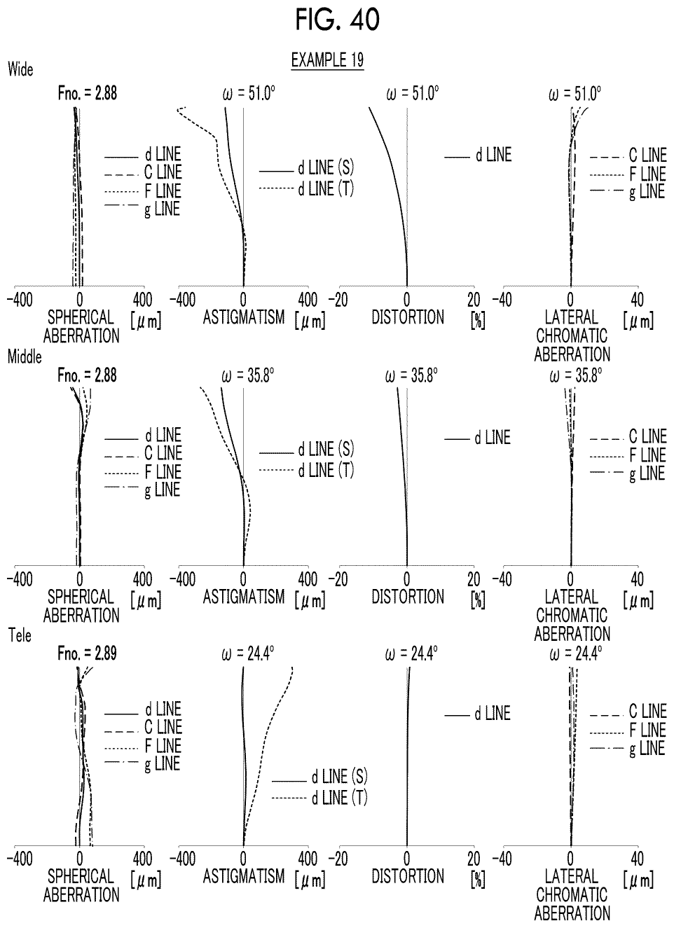

For the zoom lens of Example 19, Table 55 shows basic lens data, Table 56 shows specifications and a variable surface spacing, Table 57 shows aspherical coefficients, and FIG. 40 illustrates each aberration diagram.

TABLE 55
Example 19

| Sn | R | D | Nd | νd | θgF | ED | SG |
|---|---|---|---|---|---|---|---|
| *1 | 102.4841 | 3.2122 | 1.51633 | 64.06 | 0.53345 | 47.744 | 2.380 |
| *2 | 27.1902 | 2.5481 | | | | 37.859 | |
| 3 | 35.2828 | 1.9656 | 1.71300 | 53.94 | 0.54424 | 36.887 | 3.810 |
| 4 | 15.6713 | 13.3768 | | | | 27.918 | |
| 5 | −44.6411 | 0.8130 | 1.49700 | 81.61 | 0.53894 | 25.600 | 3.900 |
| 6 | 23.8830 | 3.8673 | 1.95000 | 29.37 | 0.60018 | 24.984 | 4.790 |
| 7 | 62.7729 | DD[7] | | | | 24.445 | |
| *8 | 32.7542 | 2.8655 | 1.74950 | 35.33 | 0.58189 | 21.200 | 3.290 |
| *9 | 160.3926 | 1.1676 | | | | 21.200 | |
| 10 | −51.7804 | 0.6861 | 1.80906 | 25.27 | 0.61209 | 21.205 | 5.200 |
| 11 | 510.1161 | 2.2875 | 1.49700 | 81.64 | 0.53714 | 21.582 | 3.650 |
| 12 | −74.8604 | DD[12] | | | | 21.919 | |
| 13 (St) | ∞ | 0.9998 | | | | 22.437 | |
| 14 | 68.3551 | 5.9304 | 1.62604 | 39.07 | 0.58113 | 23.209 | 2.960 |
| 15 | −24.1651 | 0.7511 | 1.80501 | 39.59 | 0.57129 | 23.396 | 4.130 |
| 16 | −42.6858 | 2.9061 | | | | 23.801 | |
| 17 | 28.6751 | 6.2713 | 1.49700 | 81.35 | 0.53698 | 23.064 | 3.600 |
| 18 | −35.8451 | 0.7088 | 1.85026 | 32.30 | 0.59311 | 22.360 | 4.220 |
| 19 | 30.4054 | 0.1498 | | | | 21.724 | |
| *20 | 18.0338 | 7.8855 | 1.49710 | 81.56 | 0.53848 | 22.200 | 3.640 |
| *21 | −21.5341 | DD[21] | | | | 22.149 | |
| *22 | 39.8936 | 0.8590 | 1.68948 | 31.02 | 0.59874 | 15.146 | 2.880 |
| *23 | 18.1992 | 1.6225 | | | | 14.244 | |
| 24 | 52.7268 | 0.4855 | 1.91650 | 31.60 | 0.59117 | 14.000 | 4.740 |
| 25 | 15.9194 | 2.4855 | 1.94595 | 17.99 | 0.65565 | 14.348 | 3.530 |
| 26 | 34.4288 | DD[26] | | | | 14.630 | |
| 27 | 101.4093 | 2.8555 | 1.48071 | 85.29 | 0.53623 | 24.081 | 3.680 |
| 28 | −106.5896 | 14.5177 | | | | 24.400 | |
| 29 | ∞ | 2.8500 | 1.51680 | 64.20 | 0.53430 | 28.788 | 2.520 |
| 30 | ∞ | 1.1000 | | | | 29.321 | |

TABLE 56
Example 19

| | Wide | Middle | Tele |
|---|---|---|---|
| Zr | 1.00 | 1.56 | 2.39 |
| f | 13.39 | 20.94 | 32.01 |
| Bf | 17.50 | 17.50 | 17.50 |
| Fno. | 2.88 | 2.88 | 2.89 |
| 2ω [°] | 102.0 | 71.6 | 48.8 |
| DD[7] | 20.8527 | 9.9962 | 1.5729 |
| DD[12] | 8.4631 | 4.5312 | 1.4999 |
| DD[21] | 1.9578 | 2.6030 | 6.1042 |
| DD[26] | 3.5427 | 14.1294 | 22.0369 |

TABLE 57
Example 19

| Sn | 1 | 2 | 8 | 9 |
|---|---|---|---|---|
| KA | 1.0000000000E+00 | 1.0000000000E+00 | 1.0000000000E+00 | 1.0000000000E+00 |
| A3 | 0.0000000000E+00 | 0.0000000000E+00 | 0.0000000000E+00 | 0.0000000000E+00 |
| A4 | 2.1707459232E−05 | 1.0420575566E−05 | −4.4547432216E−05 | −4.6482167411E−05 |
| A5 | −1.0204491957E−06 | 1.6773487620E−07 | 1.6116631947E−06 | 2.8470827712E−06 |
| A6 | 2.9354767758E−08 | −1.8965312510E−07 | 1.6308971343E−07 | 4.4511675909E−08 |
| A7 | 4.0921746595E−10 | 1.8547196613E−08 | −4.6443906734E−08 | −7.0332371955E−08 |
| A8 | −7.6805335722E−11 | −2.3596619054E−10 | −6.9235746593E−09 | 2.3519657790E−09 |
| A9 | 1.3565502126E−12 | −7.6029390175E−11 | 1.5836637705E−09 | 4.7477301779E−10 |
| A10 | 1.6052927877E−14 | 6.2043474786E−12 | −5.2808769963E−11 | −8.1862361948E−12 |
| A11 | −1.4394461024E−15 | −2.8010762828E−13 | −8.3476532246E−12 | −4.9778556365E−12 |
| A12 | 1.3908232072E−16 | 2.9076237508E−15 | 8.5906320464E−13 | 4.1707833494E−13 |
| A13 | −6.4155099154E−18 | 6.0203365993E−16 | −2.8858857310E−15 | −4.8240561806E−15 |
| A14 | 1.7046762550E−19 | −3.8265821043E−17 | −4.7191754150E−15 | −1.5925375288E−15 |
| A15 | −2.5062709623E−21 | 9.8537430217E−19 | 3.1215297077E−16 | 1.0883940614E−16 |
| A16 | 1.5878096443E−23 | −9.8126660570E−21 | −6.6065310649E−18 | −2.3005626750E−18 |
| Sn | 20 | 21 | 22 | 23 |
| KA | 1.0000000000E+00 | 1.0000000000E+00 | 1.0000000000E+00 | 1.0000000000E+00 |
| A3 | 0.0000000000E+00 | 0.0000000000E+00 | 0.0000000000E+00 | 0.0000000000E+00 |
| A4 | −4.6776004037E−05 | 2.8752871069E−05 | −1.3721230588E−05 | −5.6304704116E−06 |
| A5 | 2.5463140798E−07 | 2.5093345624E−06 | 2.1885969577E−06 | −3.4191647773E−06 |
| A6 | 4.2998306820E−08 | −6.9261149649E−07 | −1.8828358738E−07 | 7.6988467590E−07 |
| A7 | −2.8594971640E−08 | 2.6764332687E−08 | −4.8728489479E−08 | −2.7000125679E−08 |
| A8 | −2.2743316903E−10 | 2.9623953001E−09 | 1.9753033352E−08 | 5.1038631149E−09 |
| A9 | 4.4310246321E−10 | −9.0930268459E−11 | −2.4471681635E−09 | −1.6494894218E−09 |
| A10 | −1.3571630147E−11 | −1.4291809544E−11 | 1.0481452490E−10 | 1.1922344504E−10 |
| A11 | −2.3573875241E−12 | −2.8769901722E−13 | 2.2996873343E−11 | 2.0031940381E−11 |
| A12 | 5.1888754664E−14 | 1.9857346006E−13 | −4.2885733421E−12 | −5.5895679827E−12 |
| A13 | 2.6429828875E−14 | −1.9894110211E−14 | 3.1538157147E−14 | 5.0346844292E−13 |
| A14 | −3.1251231638E−15 | 9.7144641592E−16 | 4.8865122783E−14 | −1.0114002623E−14 |
| A15 | 1.4657237226E−16 | −2.3111118674E−17 | −4.6360533756E−15 | −1.2106118755E−15 |
| A16 | −2.6152653924E−18 | 1.9325430167E−19 | 1.3904927793E−16 | 6.1201252811E−17 |

Tables 58 to 65 show the corresponding values of Conditional Expressions (1) to (53) of the zoom lenses of Examples 1 to 19. While a corresponding value of a conditional expression may have a plurality of values, Tables 58 to 65 representatively show only one value. Preferable ranges of the conditional expressions may be set using the corresponding values of the examples shown in Tables 58 to 65 as the upper limits and the lower limits of the conditional expressions.

TABLE 58

| Expression | | | | | | |
|---|---|---|---|---|---|---|
| Number | | Example 1 | Example 2 | Example 3 | Example 4 | Example 5 |
| (1) | ft/fw | 3.2400 | 3.2400 | 3.2400 | 3.2400 | 3.2400 |
| (2) | Bfw/(fw × tan ωw) | 0.9642 | 1.0059 | 1.0749 | 1.2656 | 1.2649 |
| (3) | (−ΔP)/fw | 2.4103 | 2.5122 | 2.6512 | 2.6106 | 2.3025 |
| (4) | (−fN)/fw | 1.7163 | 1.7811 | 4.6464 | 2.8879 | 2.0634 |
| (5) | Fnot | 2.8867 | 2.8866 | 2.8785 | 2.8802 | 2.8800 |
| (6) | Fnot/Fnow | 0.9999 | 0.9994 | 0.9978 | 1.0001 | 0.9993 |
| (7) | fP/fw | 2.1958 | 2.2191 | 1.9910 | 2.8295 | 1.5978 |
| (8) | ωw | 43.3119 | 43.0696 | 44.1062 | 43.1485 | 43.0924 |
| (9) | fw/fM | 0.2221 | 0.2400 | −0.0887 | 0.0197 | 0.0515 |
| (10) | NMp | 1.91082 | 1.91082 | 2.00000 | 1.92286 | 1.92286 |
| (11) | νMp | 35.25 | 35.25 | 17.79 | 18.90 | 18.90 |
| (12) | (−f1)/fw | 2.0050 | 2.0253 | 2.0211 | 1.4369 | 1.4538 |
| (13) | DG1/(fw × tan ωw) | 1.4034 | 1.5504 | 1.5273 | 1.1639 | 1.1601 |
| (14) | DGP/(fw × tan ωw) | 1.7204 | 1.5890 | 1.6855 | 0.3763 | 1.9062 |
| (15) | Denw/fw | 1.7422 | 1.7277 | 1.8103 | 1.4748 | 1.4867 |
| (16) | G1ave | 3.7767 | 3.1050 | 3.8156 | 3.5933 | 3.4500 |
| (17) | GPave | 3.7125 | 3.1050 | 3.0214 | 3.7000 | 3.5480 |
| (18) | Gfave × DGfoc/\|ffoc\| | 0.7163 | 0.6472 | 0.0475 | 0.1040 | 0.1423 |
| (19) | (−f1)/fP | 0.9131 | 0.9127 | 1.0151 | 0.5078 | 0.9098 |
| (20) | (−f1)/fM | 0.4453 | 0.4861 | −0.1793 | 0.0283 | 0.0748 |
| (21) | fP/fM | 0.4876 | 0.5326 | −0.1766 | 0.0557 | 0.0822 |
| (22) | (−ffoc)/(fw × tan ωw) | 1.8205 | 1.9054 | 4.7937 | 3.0808 | 2.2056 |
| (23) | (1/Rc1f − 1/Rc1r)/(1/Ry1f − 1/Ry1r) | 1.2466 | 2.3842 | 2.0543 | 1.3064 | 1.2991 |
| (24) | (1/RcPf − 1/RyPf) × NP × fP | 0.6517 | 0.8193 | 0.2226 | 0.0000 | 0.9605 |
| (25) | (1/RcNf − 1/RcNr)/(1/RyNf − 1/RyNr) | 0.9958 | 0.9837 | 0.9594 | 0.9582 | 1.0076 |
| (26) | (1/RcEf − 1/RcEr)/(1/RyEf − 1/RyEr) | 1.1658 | 1.1778 | — | — | — |

TABLE 59

| Expression | | | | | | |
|---|---|---|---|---|---|---|
| Number | | Example 1 | Example 2 | Example 3 | Example 4 | Example 5 |
| (27) | ν1n | 81.56 | 70.44 | — | 63.85 | 67.02 |
| (28) | θgF1n − (0.6438 − 0.001682 × ν1n) | 0.0319 | 0.0053 | — | 0.0054 | 0.0048 |
| (29) | νPn | 74.70 | 74.70 | 95.10 | — | 81.61 |
| (30) | θgFPn − (0.6438 − 0.001682 × νPn) | 0.0212 | 0.0212 | 0.0498 | — | 0.0323 |
| (31) | νNn | — | — | 81.56 | — | — |
| (32) | θgFNn − (0.6438 − 0.001682 × νNn) | — | — | 0.0319 | — | — |
| (33) | νMn | 90.19 | 81.61 | 81.61 | 81.61 | 81.61 |
| (34) | θgFMn − (0.6438 − 0.001682 × νMn) | 0.0431 | 0.0323 | 0.0323 | 0.0323 | 0.0323 |
| (35) | νEp | 81.56 | 81.56 | — | — | — |
| (36) | θgFEp − (0.6438 − 0.001682 × νEp) | 0.0319 | 0.0319 | — | — | — |
| (37) | N1p | 1.92286 | 1.92119 | 1.95489 | 1.94595 | 1.98613 |
| (38) | ν1p | 20.88 | 23.96 | 23.02 | 17.98 | 16.48 |
| (39) | DSInw/TLw | 0.0440 | 0.0554 | 0.0168 | 0.0195 | 0.0182 |
| (40) | DSOnw/TLw | 0.0676 | 0.0678 | 0.5568 | 0.5399 | 0.5525 |
| (41) | DSIcew/TLw | 0.0440 | 0.0554 | 0.0229 | 0.0269 | 0.0248 |
| (42) | DSOcew/TLw | 0.0676 | 0.0678 | 0.0323 | 0.0656 | 0.0581 |
| (43) | ΔN/ΔP | 0.2602 | 0.2968 | 0.3417 | 0.3319 | 0.3359 |
| (44) | Dexw/(fw × tan ωw) | 3.0427 | 3.1618 | 2.6895 | 3.5171 | 3.4454 |
| (45) | Fnot × DGP/ft | 1.4450 | 1.3234 | 1.4515 | 0.3136 | 1.5851 |
| (46) | Fnot × (DGP + DGM)/ft | 2.0633 | 1.9534 | 1.9383 | 1.0582 | 2.3096 |
| (47) | TLt/ft | 2.5584 | 2.6099 | 2.7053 | 2.7094 | 2.5457 |
| (48) | fw/fE | 0.4005 | 0.3844 | 0.2770 | 0.3076 | 0.3517 |
| (49) | \|(1 − βfw²) × βfRw²\| | 1.3282 | 1.3090 | 0.5506 | 0.9377 | 1.3308 |
| (50) | \|(1 − βft²) × βfRt²\| | 1.9475 | 2.0356 | 0.7548 | 1.3709 | 1.8917 |
| (51) | (−BRw) × (fw × tan ωw) | 0.0626 | 0.0530 | 0.2252 | 0.1077 | 0.0981 |
| (52) | (−BRt) × (ft × tan ωt) | 0.0231 | 0.0265 | 0.0866 | 0.0482 | 0.0481 |
| (53) | Nobn | 1.85883 | 1.85883 | 1.74694 | 1.69680 | 1.69680 |

TABLE 60

| Expression | | Example | Example | Example | Example | Example |
|---|---|---|---|---|---|---|
| Number | | 6 | 7 | 8 | 9 | 10 |
| (1) | ft/fw | 3.2373 | 3.2400 | 3.2400 | 3.2400 | 2.2000 |
| (2) | Bfw/(fw × tan ωw) | 1.4787 | 1.2595 | 1.2114 | 0.9998 | 1.2560 |
| (3) | (−ΔP)/fw | 2.4342 | 1.7952 | 2.6968 | 2.5137 | 0.9582 |
| (4) | (−fN)/fw | 2.6814 | 3.2832 | 2.5631 | 1.8032 | 3.2572 |
| (5) | Fnot | 2.8945 | 2.8871 | 2.8797 | 2.8897 | 2.8767 |
| (6) | Fnot/Fnow | 1.0010 | 0.9982 | 1.0005 | 0.9994 | 0.9979 |
| (7) | fP/fw | 2.1953 | 1.6201 | 2.5648 | 2.2489 | 1.3287 |
| (8) | ωw | 43.3676 | 43.5821 | 43.1621 | 42.9475 | 43.5624 |
| (9) | fw/fM | 0.2012 | 0.1387 | 0.0387 | 0.2521 | 0.1567 |
| (10) | NMp | 1.92286 | 1.92286 | 1.92286 | 1.91082 | 1.92286 |
| (11) | νMp | 20.88 | 18.90 | 18.90 | 35.25 | 18.90 |
| (12) | (−f1)/fw | 2.0242 | 1.5267 | 1.3959 | 2.0529 | 1.2796 |
| (13) | DG1/(fw × tan ωw) | 1.9366 | 1.1073 | 1.1861 | 1.2857 | 1.0026 |
| (14) | DGP/(fw × tan ωw) | 2.0992 | 1.9041 | 0.4631 | 1.7049 | 1.5552 |
| (15) | Denw/fw | 1.9413 | 1.5523 | 1.5662 | 1.6318 | 1.2949 |
| (16) | G1ave | 3.4333 | 3.7700 | 3.7867 | 3.9967 | 3.4133 |
| (17) | GPave | 3.4580 | 3.3300 | 4.1800 | 4.1000 | 3.1980 |
| (18) | Gfave × DGfoc/\|ffoc\| | 0.1188 | 0.8833 | 0.0766 | 0.6117 | 0.6467 |
| (19) | (−f1)/fP | 0.9221 | 0.9424 | 0.5442 | 0.9128 | 0.9630 |
| (20) | (−f1)/fM | 0.4072 | 0.2117 | 0.0541 | 0.5174 | 0.2004 |
| (21) | fP/fM | 0.4416 | 0.2247 | 0.0993 | 0.5668 | 0.2081 |
| (22) | (−ffoc)/(fw × tan ωw) | 2.8387 | 3.4498 | 2.7331 | 1.9373 | 3.4249 |
| (23) | (1/Rc1f − 1/Rc1r)/(1/Ry1f − 1/Ry1r) | 1.2761 | 1.2844 | 1.2542 | 1.1571 | 1.3123 |
| (24) | (1/RcPf − 1/RyPf) × NP × fP | 0.8183 | 1.2282 | 0.0629 | 0.7436 | 1.1585 |
| (25) | (1/RcNf − 1/RcNr)/(1/RyNf − 1/RyNr) | 0.9690 | 1.3192 | 0.9770 | 0.9910 | 0.8765 |
| (26) | (1/RcEf − 1/RcEr)/(1/RyEf − 1/RyEr) | 0.9051 | — | — | 1.2039 | — |

TABLE 61

| Expression | | Example | Example | Example | Example | Example |
|---|---|---|---|---|---|---|
| Number | | 6 | 7 | 8 | 9 | 10 |
| (27) | ν1n | — | 63.85 | 63.85 | 76.45 | 67.02 |
| (28) | θgF1n − (0.6438 − 0.001682 × ν1n) | — | 0.0054 | 0.0054 | 0.0243 | 0.0048 |
| (29) | νPn | 81.61 | 81.61 | — | 74.70 | 81.61 |
| (30) | θgFPn − (0.6438 − 0.001682 × νPn) | 0.0323 | 0.0323 | — | 0.0212 | 0.0323 |
| (31) | νNn | — | — | — | — | — |
| (32) | θgFNn − (0.6438 − 0.001682 × νNn) | — | — | — | — | — |
| (33) | νMn | 81.61 | 81.61 | 81.61 | 81.61 | 81.61 |
| (34) | θgFMn − (0.6438 − 0.001682 × νMn) | 0.0323 | 0.0323 | 0.0323 | 0.0323 | 0.0323 |
| (35) | νEp | — | — | — | 81.56 | — |
| (36) | θgFEp − (0.6438 − 0.001682 × νEp) | — | — | — | 0.0319 | — |
| (37) | N1p | 1.92286 | 1.94595 | 1.89286 | 1.92119 | 1.94595 |
| (38) | ν1p | 20.88 | 17.98 | 20.36 | 23.96 | 17.98 |
| (39) | DSInw/TLw | 0.0104 | 0.0171 | 0.0177 | 0.0661 | 0.0219 |
| (40) | DSOnw/TLw | 0.0597 | 0.5770 | 0.5648 | 0.0685 | 0.5192 |
| (41) | DSIcew/TLw | 0.0153 | 0.0240 | 0.0248 | 0.0661 | 0.0308 |
| (42) | DSOcew/TLw | 0.0659 | 0.0527 | 0.1750 | 0.0685 | 0.0683 |
| (43) | ΔN/ΔP | 0.3038 | 0.2878 | 0.2942 | 0.3163 | 0.1306 |
| (44) | Dexw/(fw × tan ωw) | 3.1953 | 2.6309 | 3.1828 | 3.0271 | 2.5256 |
| (45) | Fnot × DGP/ft | 1.7729 | 1.6148 | 0.3860 | 1.4154 | 1.9339 |
| (46) | Fnot × (DGP + DGM)/ft | 2.4163 | 2.2573 | 1.0214 | 2.1614 | 2.8000 |
| (47) | TLt/ft | 2.8747 | 2.3796 | 2.5774 | 2.5673 | 2.8262 |
| (48) | fw/fE | 0.2633 | − | 0.3542 | 0.3640 | — |
| (49) | \|(1 − βfw²) × βfRw²\| | 1.1692 | 1.4862 | 0.9671 | 1.3095 | 1.3779 |
| (50) | \|(1 − βft²) × βfRt²\| | 1.7367 | 2.0072 | 1.3703 | 2.1150 | 1.4979 |
| (51) | (−BRw) × (fw × tan ωw) | 0.1108 | 0.0726 | 0.1434 | 0.0510 | 0.0692 |
| (52) | (−BRt) × (ft × tan ωt) | 0.1240 | 0.0369 | 0.0545 | 0.0270 | 0.0219 |
| (53) | Nobn | 1.58913 | 1.77250 | 1.72916 | 1.83441 | 1.62041 |

TABLE 62

| Expression | | Example | Example | Example | Example | Example |
|---|---|---|---|---|---|---|
| Number | | 11 | 12 | 13 | 14 | 15 |
| (1) | ft/fw | 4.0000 | 3.2400 | 2.9430 | 2.9430 | 2.9430 |
| (2) | Bfw/(fw × tan ωw) | 1.0199 | 1.0458 | 0.8744 | 0.8674 | 0.9850 |
| (3) | (−ΔP)/fw | 3.2976 | 2.6357 | 1.5161 | 1.4830 | 1.4668 |
| (4) | (−fN)/fw | 1.9387 | 1.9893 | 1.9800 | 1.9604 | 1.9321 |
| (5) | Fnot | 4.0177 | 2.8868 | 4.9401 | 4.9372 | 4.9407 |
| (6) | Fnot/Fnow | 1.3912 | 0.9998 | 1.7092 | 1.7096 | 1.7095 |
| (7) | fP/fw | 2.2346 | 2.2197 | 1.2644 | 1.2580 | 1.2105 |
| (8) | ωw | 43.3308 | 43.2665 | 44.1230 | 44.0960 | 43.7996 |
| (9) | fw/fM | 0.2499 | 0.2187 | — | — | — |
| (10) | NMp | 1.91082 | 1.90525 | — | — | — |
| (11) | νMp | 35.25 | 35.04 | — | — | — |
| (12) | (−f1)/fw | 2.0862 | 2.0806 | 1.6538 | 1.6377 | 1.6795 |
| (13) | DG1/(fw × tan ωw) | 1.2455 | 0.7595 | 0.8641 | 0.8774 | 0.8868 |
| (14) | DGP/(fw × tan ωw) | 1.4735 | 1.5996 | 1.1531 | 1.1269 | 1.0662 |
| (15) | Denw/fw | 1.6900 | 1.7168 | 1.0736 | 1.0673 | 1.0866 |
| (16) | G1ave | 4.1133 | 4.0000 | 4.3867 | 4.4933 | 4.4033 |
| (17) | GPave | 4.2925 | 3.4833 | 3.8483 | 3.9033 | 3.9050 |
| (18) | Gfave × DGfoc/\|ffoc\| | 0.6302 | 0.5167 | 0.1208 | 0.1762 | 0.1795 |
| (19) | (−f1)/fP | 0.9336 | 0.9374 | 1.3080 | 1.3018 | 1.3875 |
| (20) | (−f1)/fM | 0.5214 | 0.4550 | — | — | — |
| (21) | fP/fM | 0.5585 | 0.4854 | — | — | — |
| (22) | (−ffoc)/(fw × tan ωw) | 2.0551 | 2.1135 | 2.0415 | 2.0232 | 2.0148 |
| (23) | (1/Rc1f − 1/Rc1r)/(1/Ry1f − 1/Ry1r) | 1.1296 | 4.4110 | 1.3825 | 1.3443 | 1.5083 |
| (24) | (1/RcPf − 1/RyPf) × NP × fP | 0.3499 | 0.1006 | 0.5916 | 0.1293 | −1.0514 |
| (25) | (1/RcNf − 1/RcNr)/(1/RyNf − 1/RyNr) | 1.0048 | 0.9795 | 0.9473 | 0.9658 | 0.9593 |
| (26) | (1/RcEf − 1/RcEr)/(1/RyEf − 1/RyEr) | 1.2606 | 1.2004 | — | — | — |

TABLE 63

| Expression | | Example | Example | Example | Example | Example |
|---|---|---|---|---|---|---|
| Number | | 11 | 12 | 13 | 14 | 15 |
| (27) | ν1n | 71.76 | 81.56 | 81.56 | 81.56 | 81.56 |
| (28) | θgF1n − (0.6438 − 0.001682 × ν1n) | 0.0162 | 0.0319 | 0.0319 | 0.0319 | 0.0319 |
| (29) | νPn | 76.45 | 74.70 | 81.61 | 81.61 | 81.61 |
| (30) | θgFPn − (0.6438 − 0.001682 × νPn) | 0.0243 | 0.0212 | 0.0323 | 0.0323 | 0.0323 |
| (31) | νNn | — | — | — | — | — |
| (32) | θgFNn − (0.6438 − 0.001682 × νNn) | — | — | — | — | — |
| (33) | νMn | 81.61 | 81.61 | — | — | — |
| (34) | θgFMn − (0.6438 − 0.001682 × νMn) | 0.0323 | 0.0323 | — | — | — |
| (35) | νEp | 81.56 | 81.56 | — | — | — |
| (36) | θgFEp − (0.6438 − 0.001682 × νEp) | 0.0319 | 0.0319 | — | — | — |
| (37) | N1p | 1.92119 | — | 2.00100 | 2.05090 | 2.00069 |
| (38) | ν1p | 23.96 | — | 29.13 | 26.94 | 25.46 |
| (39) | DSInw/TLw | 0.0514 | 0.0713 | 0.0810 | 0.0776 | 0.0532 |
| (40) | DSOnw/TLw | 0.0553 | 0.0662 | 0.0235 | 0.0230 | 0.3943 |
| (41) | DSIcew/TLw | 0.0514 | 0.0713 | 0.0810 | 0.0776 | 0.0532 |
| (42) | DSOcew/TLw | 0.0553 | 0.0662 | 0.0329 | 0.0324 | 0.5245 |
| (43) | ΔN/ΔP | 0.3557 | 0.3385 | 0.6861 | 0.6495 | 0.6593 |
| (44) | Dexw/(fw × tan ωw) | 3.0321 | 3.3017 | 2.3787 | 2.3865 | 2.5124 |
| (45) | Fnot × DGP/ft | 1.3962 | 1.3415 | 1.8772 | 1.8317 | 1.7164 |
| (46) | Fnot × (DGP + DGM)/ft | 2.1473 | 2.1376 | — | — | — |
| (47) | TLt/ft | 2.2201 | 2.7203 | 1.7470 | 1.7389 | 1.7359 |
| (48) | fw/fE | 0.3377 | 0.3583 | 0.2976 | 03108 | 0.3169 |
| (49) | \|(1 − βfw²) × βfRw²\| | 1.2444 | 1.2414 | 1.3344 | 1.3314 | 1.3967 |
| (50) | \|(1 − βft²) × βfRt²\| | 2.4317 | 2.0270 | 2.5738 | 2.4638 | 2.4955 |
| (51) | (−BRw) × (fw × tan ωw) | 0.0441 | 0.0629 | 0.1310 | 0.1385 | 0.1356 |
| (52) | (−BRt) × (ft × tan ωt) | 0.0307 | 0.0335 | 0.0425 | 0.0424 | 0.0500 |
| (53) | Nobn | 1.80139 | 1.85026 | 1.80420 | 1.83481 | 1.87071 |

TABLE 64

| Expression | | | | | |
|---|---|---|---|---|---|
| Number | | Example 16 | Example 17 | Example 18 | Example 19 |
| (1) | ft/fw | 2.9430 | 2.9455 | 1.8835 | 2.3906 |
| (2) | Bfw/(fw × tan ωw) | 0.9254 | 0.9343 | 0.8081 | 1.0600 |
| (3) | (−ΔP)/fw | 1.4430 | 1.4365 | 1.0923 | 1.6910 |
| (4) | (−fN)/fw | 1.9899 | 1.9278 | 1.8371 | 2.5971 |
| (5) | Fnot | 4.9357 | 4.9379 | 2.8840 | 2.8862 |
| (6) | Fnot/Fnow | 1.7080 | 1.7107 | 0.9988 | 1.0002 |
| (7) | fP/fw | 1.2299 | 1.2093 | −1.8371 | 1.7814 |
| (8) | ωw | 44.1515 | 44.1540 | 50.1357 | 50.9552 |
| (9) | fw/fM | — | — | — | — |
| (10) | NMp | — | — | — | — |
| (11) | νMp | — | — | — | — |
| (12) | (−f1)/fw | 1.6544 | 1.6450 | 1.7348 | 1.4574 |
| (13) | DG1/(fw × tan ωw) | 0.8766 | 0.8782 | 1.3294 | 1.5613 |
| (14) | DGP/(fw × tan ωw) | 1.0558 | 1.0362 | 0.4194 | 1.4899 |
| (15) | Denw/fw | 1.0725 | 1.0840 | 1.2669 | 1.6220 |
| (16) | G1ave | 4.2100 | 4.0700 | 4.6400 | 3.7200 |
| (17 | GPave | 3.8400 | 3.7600 | 4.3467 | 3.6340 |
| (18) | Gfave × DGfoc/\|ffoc\| | 0.1527 | 0.1678 | 0.9613 | 0.5826 |
| (19) | (−f1)/fP | 1.3451 | 1.3602 | −0.9443 | 0.8181 |
| (20) | (−f1)/fM | — | — | — | — |
| (21) | fP/fM | — | — | — | — |
| (22) | (−ffoc)/(fw × tan ωw) | 2.0498 | 1.9856 | 1.5341 | 2.1065 |
| (23) | (1/Rc1f − 1/Rc1r)/(1/Ry1f − 1/Ry1r) | 1.2426 | 1.2481 | 1.3477 | 2.3303 |
| (24) | (1/RcPf − 1/RyPf) × NP × fP | −0.3256 | −0.1214 | −0.3907 | 0.6406 |
| (25) | (1/RcNf − 1/RcNr)/(1/RyNf − | 0.9322 | 0.9341 | 0.9851 | 0.9911 |
| | 1/RyNr) | | | | |
| (26) | (1/RcEf − 1/RcEr)/(1/RyEf − 1/RyEr) | — | — | — | — |

TABLE 65

| Expression | | Example | Example | Example | Example |
|---|---|---|---|---|---|
| Number | | 16 | 17 | 18 | 19 |
| (27) | ν1n | — | — | 67.90 | 81.61 |
| (28) | θgF1n − (0.6438 − 0.001682 × ν1n) | — | — | 0.0144 | 0.0324 |
| (29) | νPn | 81.61 | 81.61 | — | 81.35 |
| (30) | θgFPn − (0.6438 − 0.001682 × νPn) | 0.0323 | 0.0323 | — | 0.0300 |
| (31 | νNn | — | — | — | — |
| (32) | θgFNn − (0.6438 − 0.001682 × νNn) | — | — | — | — |
| (33) | νMn | — | — | — | — |
| (34) | θgFMn − (0.6438 − 0.001682 × νMn) | — | — | — | — |
| (35) | νEp | — | — | 81.54 | 85.29 |
| (36) | θgFEp − (0.6438 − 0.001682 × νEp) | — | — | 0.0308 | 0.0359 |
| (37) | N1p | 2.05091 | 2.05091 | 1.88300 | 1.95000 |
| (38) | ν1p | 26.95 | 26.95 | 40.76 | 29.37 |
| (39) | DSInw/TLw | 0.0449 | 0.0472 | 0.0107 | 0.0582 |
| (40) | DSOnw/TLw | 0.3898 | 0.3923 | 0.0395 | 0.0903 |
| (41) | DSIcew/TLw | 0.0449 | 0.0472 | 0.0166 | 0.0582 |
| (42) | DSOcew/TLw | 0.5199 | 0.5231 | 0.0394 | 0.0902 |
| (43) | ΔN/ΔP | 0.6064 | 0.6232 | 1.0000 | 0.8169 |
| (44) | Dexw/(fw × tan ωw) | 2.5727 | 2.5329 | 2.6734 | 2.8879 |
| (45) | Fnot × DGP/ft | 1.7190 | 1.6866 | 0.7690 | 2.2177 |
| (46) | Fnot × (DGP + DGM)/ft | — | — | — | — |
| (47) | TLt/ft | 1.7304 | 1.7307 | 3.6032 | 3.6050 |
| (48) | fw/fE | 0.3235 | 0.3211 | 0.1577 | 0.1233 |
| (49) | \|(1 − βfw²) × βfRw²\| | 1.3157 | 1.3910 | 1.9632 | 1.5308 |
| (50) | \|(1 − βft²) × βfRt²\| | 2.2578 | 2.4150 | 3.8708 | 3.0403 |
| (51) | (−BRw) × (fw × tan ωw) | 0.1266 | 0.1320 | −0.0443 | −0.0273 |
| (52) | (−BRt) × (ft × tan ωt) | 0.0423 | 0.0447 | 0.0013 | 0.0043 |
| (53) | Nobn | 1.77535 | 1.77250 | 1.88300 | 1.71300 |

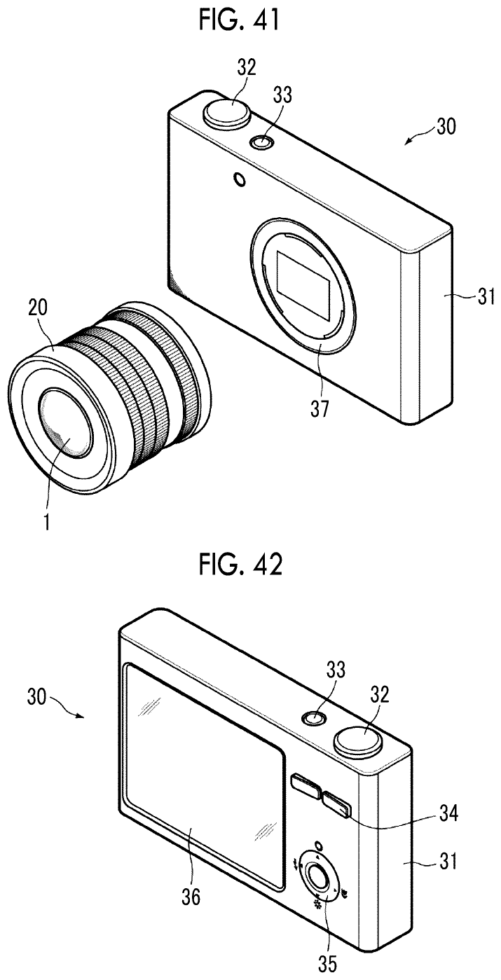

Next, an imaging apparatus according to the embodiment of the present disclosure will be described. FIGS. 41 and 42 illustrate external views of a camera 30 that is the imaging apparatus according to one embodiment of the present disclosure. FIG. 41 illustrates a perspective view of the camera 30 seen from its front surface side, and FIG. 42 illustrates a perspective view of the camera 30 seen from its rear surface side. The camera 30 is a so-called mirrorless type digital camera on which an interchangeable lens 20 can be attachably and detachably mounted. The interchangeable lens 20 is configured to include a zoom lens 1 according to one embodiment of the present disclosure, accommodated in a lens barrel.

The camera 30 comprises a camera body 31, and a shutter button 32 and a power button 33 are provided on an upper surface of the camera body 31. An operator 34, an operator 35, and a display unit 36 are provided on a rear surface of the camera body 31.

The display unit 36 can display a captured image and an image within an angle of view before capturing.

An imaging opening on which light from an imaging target is incident is provided in a center portion of a front surface of the camera body 31, and a mount 37 is provided at a position corresponding to the imaging opening. The interchangeable lens 20 is mounted on the camera body 31 through the mount 37.

The camera body 31 is provided with an imaging element such as a charge coupled device (CCD) or a complementary metal oxide semiconductor (CMOS) that outputs an imaging signal corresponding to a subject image formed by the interchangeable lens 20, a signal processing circuit that generates an image by processing the imaging signal output from the imaging element, a recording medium for recording the generated image, and the like. In the camera 30, a static image or a video can be captured by pressing the shutter button 32, and image data obtained by this capturing is recorded on the recording medium.

While the disclosed technology has been described above using the embodiment and the examples, the disclosed technology is not limited to the embodiment and the examples and can be subjected to various modifications. For example, the curvature radius, the surface spacing, the refractive index, the Abbe number, and the aspherical coefficients of each lens are not limited to the values shown in each example and may have other values.

The imaging apparatus according to the embodiment of the present disclosure is also not limited to the examples and can have various aspects of, for example, a camera of a type other than a mirrorless type, a film camera, a video camera, and a security camera.

The following appendices are further disclosed with respect to the embodiment and the examples described above.

### APPENDIX 1

A zoom lens consisting of, in order from an object side to an image side, a first lens group having a negative refractive power, and a subsequent group, in which the subsequent group includes at least three lens groups, one of the at least three lens groups is a P lens group having a positive refractive power, during zooming, a spacing between the first lens group and the subsequent group changes, and all spacings between adjacent lens groups in the subsequent group change, and in a case where a focal length of an entire system in a state where an infinite distance object is in focus at a wide angle end is denoted by fw, a focal length of the entire system in a state where the infinite distance object is in focus at a telephoto end is denoted by ft, a back focus of the entire system as an air conversion distance in the state where the infinite distance object is in focus at the wide angle end is denoted by Bfw, and a maximum half angle of view in the state where the infinite distance object is in focus at the wide angle end is denoted by ww, Conditional Expressions (1) and (2) are satisfied, which are represented by

$$1.5 < ft / fw < 6 \qquad ( 1 )$$

$$and$$

$$0.4 < Bfw / ( fw \times tan ω w ) < 2. \qquad ( 2 )$$

### APPENDIX 2

The zoom lens according to Appendix 1, in which the P lens group has a largest moving amount to the object side during zooming from the wide angle end to the telephoto end among the lens groups in the subsequent group.

### APPENDIX 3

The zoom lens according to Appendix 2, in which, in a case where a moving amount of the P lens group during zooming from the wide angle end to the telephoto end is denoted by ΔP, and a sign of the moving amount during zooming is negative for movement to the object side and is positive for movement to the image side, Conditional Expression (3) is satisfied, which is represented by

$$0.9 < ( - Δ P ) / fw < 6. \qquad ( 3 )$$

### APPENDIX 4

The zoom lens according to Appendix 2, in which an N lens group having a negative refractive power is disposed on the image side with respect to the P lens group.

### APPENDIX 5

The zoom lens according to Appendix 4, in which a final lens group positioned closest to the image side in the zoom lens is disposed on the image side with respect to the N lens group.

### APPENDIX 6

The zoom lens according to Appendix 4 or 5, in which at least a part of the N lens group is a focus group that moves along an optical axis during focusing.

### APPENDIX 7

The zoom lens according to any one of Appendices 4 to 6, in which, in a case where a focal length of the N lens group is denoted by fN, Conditional Expression (4) is satisfied, which is represented by

$$0.5 < ( - fN ) / fw < 7. \qquad ( 4 )$$

### APPENDIX 8

The zoom lens according to any one of Appendices 1 to 7, in which, in a case where an open F-number in the state where the infinite distance object is in focus at the telephoto end is denoted by Fnot, Conditional Expression (5) is satisfied, which is represented by

$$1. 2 < Fnot < 5.8 . \qquad ( 5 )$$

### APPENDIX 9

The zoom lens according to any one of Appendices 1 to 8, in which, in a case where an open F-number in the state where the infinite distance object is in focus at the telephoto end is denoted by Fnot, and an open F-number in the state where the infinite distance object is in focus at the wide angle end is denoted by Fnow, Conditional Expression (6) is satisfied, which is represented by

$$0.95 < Fn ot / Fnow < 1.8 . \qquad ( 6 )$$

### APPENDIX 10

The zoom lens according to any one of Appendices 2 to 7, in which, in a case where a focal length of the P lens group is denoted by fP, Conditional Expression (7) is satisfied, which is represented by

$$0.5 < fP / fw < 6. \qquad ( 7 )$$

### APPENDIX 11

The zoom lens according to any one of Appendices 1 to 10, in which Conditional Expression (8) is satisfied, which is represented by

$$35 < ω w < 54. \qquad ( 8 )$$

### APPENDIX 12

The zoom lens according to Appendix 5, in which the final lens group has a positive refractive power.

### APPENDIX 13

The zoom lens according to any one of Appendices 4 to 7, in which an M lens group is disposed between the P lens group and the N lens group.

### APPENDIX 14

The zoom lens according to any one of Appendices 1 to 13, in which the P lens group has a largest moving amount to the object side during zooming from the wide angle end to the telephoto end among the lens groups in the subsequent group, an N lens group having a negative refractive power is disposed on the image side with respect to the P lens group, an M lens group is disposed between the P lens group and the N lens group, and in a case where a moving amount of the P lens group during zooming from the wide angle end to the telephoto end is denoted by ΔP, and a sign of the moving amount during zooming is negative for movement to the object side and is positive for movement to the image side, Conditional Expression (3) is satisfied, which is represented by

$$0.9 < ( - Δ P ) / fw < 6. \qquad ( 3 )$$

### APPENDIX 15

The zoom lens according to Appendix 13 or 14, in which the M lens group has a positive refractive power.

### APPENDIX 16

The zoom lens according to any one of Appendices 13 to 15, in which, in a case where a focal length of the M lens group is denoted by fM, Conditional Expression (9) is satisfied, which is represented by

$$0.01 < fw / fM < 0.35 . \qquad ( 9 )$$

### APPENDIX 17

The zoom lens according to any one of Appendices 13 to 16, in which, in a case where a refractive index with respect to a d line for a positive lens closest to the image side among positive lenses in the M lens group is denoted by NMp, and an Abbe number based on the d line for the positive lens closest to the image side among the positive lenses in the M lens group is denoted by vMp, Conditional Expressions (10) and (11) are satisfied, which are represented by

$$1.73 < NMp < 2.5 and \qquad ( 10 )$$

$$10 < vMp < 50. \qquad ( 11 )$$

### APPENDIX 18

The zoom lens according to any one of Appendices 13 to 17, in which an aperture stop is disposed closest to the object side in the M lens group.

### APPENDIX 19

The zoom lens according to any one of Appendices 1 to 18, in which the first lens group includes a negative meniscus lens having a concave surface facing the image side, closest to the object side.

### APPENDIX 20

The zoom lens according to any one of Appendices 1 to 19, in which, in a case where a focal length of the first lens group is denoted by f1, Conditional Expression (12) is satisfied, which is represented by

$$1 < ( - f 1 ) / fw < 2.5 . \qquad ( 12 )$$

### APPENDIX 21

The zoom lens according to any one of Appendices 1 to 20, in which, in a case where a distance on an optical axis from a lens surface of the first lens group closest to the object side to a lens surface of the first lens group closest to the image side is denoted by DG1, Conditional Expression (13) is satisfied, which is represented by

$$0.71 < DG 1 / ( fw \times tan ω w ) < 2.5 . \qquad ( 13 )$$

### APPENDIX 22

The zoom lens according to any one of Appendices 2 to 7, in which, in a case where a distance on an optical axis from a lens surface of the P lens group closest to the object side to a lens surface of the P lens group closest to the image side is denoted by DGP, Conditional Expression (14) is satisfied, which is represented by

$$0.35 < DGP / ( fw \times tan ω w ) < 2.5 . \qquad ( 14 )$$

### APPENDIX 23

The zoom lens according to any one of Appendices 1 to 22, in which, in a case where a distance on an optical axis from a lens surface of the first lens group closest to the object side to a paraxial entrance pupil position in the state where the infinite distance object is in focus at the wide angle end is denoted by Denw, Conditional Expression (15) is satisfied, which is represented by

$$1 < Denw / fw < 2.2 . \qquad ( 15 )$$

### APPENDIX 24

The zoom lens according to any one of Appendices 1 to 23, in which, in a case where an average specific gravity of all lenses of the first lens group is denoted by G1ave, Conditional Expression (16) is satisfied, which is represented by

$$1 < G 1 ave < 5. \qquad ( 16 )$$

### APPENDIX 25

The zoom lens according to any one of Appendices 2 to 7, in which, in a case where an average specific gravity of all lenses of the P lens group is denoted by GPave, Conditional Expression (17) is satisfied, which is represented by

$$1 < GPave < 5. \qquad ( 17 )$$

### APPENDIX 26

The zoom lens according to Appendix 6, in which, in a case where an average specific gravity of all lenses of the focus group is denoted by Gfave, a distance on the optical axis from a lens surface of the focus group closest to the object side to a lens surface of the focus group closest to the image side is denoted by DGfoc, and a focal length of the focus group is denoted by ffoc, Conditional Expression (18) is satisfied, which is represented by

$$0.03 < Gfave \times DGfoc / \vert ffoc \vert < 0.9 . \qquad ( 18 )$$

### APPENDIX 27

The zoom lens according to any one of Appendices 2 to 7, in which, in a case where a focal length of the first lens group is denoted by f1, and a focal length of the P lens group is denoted by fP, Conditional Expression (19) is satisfied, which is represented by

$$0.3 < ( - f 1 ) / fP < 1.5 . \qquad ( 19 )$$

### APPENDIX 28

The zoom lens according to any one of Appendices 13 to 18, in which, in a case where a focal length of the first lens group is denoted by f1, and a focal length of the M lens group is denoted by fM, Conditional Expression (20) is satisfied, which is represented by

$$0 < ( - f 1 ) / fM < 0.7 . \qquad ( 20 )$$

### APPENDIX 29

The zoom lens according to any one of Appendices 13 to 18, in which, in a case where a focal length of the P lens group is denoted by fP, and a focal length of the M lens group is denoted by fM, Conditional Expression (21) is satisfied, which is represented by

$$0 < fP / fM < 2. \qquad ( 21 )$$

### APPENDIX 30

The zoom lens according to Appendix 6, in which, in a case where a focal length of the focus group is denoted by ffoc, Conditional Expression (22) is satisfied, which is represented by

$$1.2 < ( - ffoc ) / ( fw \times tan ω w ) < 5.5 . \qquad ( 22 )$$

### APPENDIX 31

The zoom lens according to any one of Appendices 1 to 30, in which the first lens group includes at least one aspherical lens, and in a case where a paraxial curvature radius of a surface, on the object side, of the aspherical lens of the first lens group is denoted by Rolf, a paraxial curvature radius of a surface, on the image side, of the aspherical lens of the first lens group is denoted by Rc1r, a curvature radius of the surface, on the object side, of the aspherical lens of the first lens group at a position of a maximum effective diameter is denoted by Ry1f, and a curvature radius of the surface, on the image side, of the aspherical lens of the first lens group at a position of a maximum effective diameter is denoted by Ry1r, Conditional Expression (23) is satisfied, which is represented by

$$1.05 < ( 1 / Rc 1 f - 1 / Rc 1 r ) / ( 1 / Ry 1 f - 1 / Ry 1 r ) < 8. \qquad ( 23 )$$

### APPENDIX 32

The zoom lens according to any one of Appendices 2 to 7, in which the P lens group includes at least one aspherical lens, and in a case where a paraxial curvature radius of a surface, on the object side, of the aspherical lens of the P lens group is denoted by RcPf, a curvature radius of the surface, on the object side, of the aspherical lens of the P lens group at a position of a maximum effective diameter is denoted by RyPf, a refractive index with respect to a d line for the aspherical lens of the P lens group is denoted by NP, and a focal length of the P lens group is denoted by fP, Conditional Expression (24) is satisfied, which is represented by

$$0.01 < ( 1 / RcPf - 1 / RyPf ) \times NP \times fP < 5. \qquad ( 24 )$$

### APPENDIX 33

The zoom lens according to any one of Appendices 4 to 7, in which the N lens group includes at least one aspherical lens, and in a case where a paraxial curvature radius of a surface, on the object side, of the aspherical lens of the N lens group is denoted by RcNf, a paraxial curvature radius of a surface, on the image side, of the aspherical lens of the N lens group is denoted by RcNr, a curvature radius of the surface, on the object side, of the aspherical lens of the N lens group at a position of a maximum effective diameter is denoted by RyNf, and a curvature radius of the surface, on the image side, of the aspherical lens of the N lens group at a position of a maximum effective diameter is RyNr, Conditional Expression (25) is satisfied, which is represented by

$$0.7 < ( 1 / RcNf - 1 / RcNr ) / ( 1 / RyNf - 1 / RyNr ) < 0.996 . \qquad ( 25 )$$

### APPENDIX 34

The zoom lens according to Appendix 5, in which the final lens group includes at least one aspherical lens, and in a case where a paraxial curvature radius of a surface, on the object side, of the aspherical lens of the final lens group is denoted by RcEf, a paraxial curvature radius of a surface, on the image side, of the aspherical lens of the final lens group is denoted by RcEr, a curvature radius of the surface, on the object side, of the aspherical lens of the final lens group at a position of a maximum effective diameter is denoted by RyEf, and a curvature radius of the surface, on the image side, of the aspherical lens of the final lens group at a position of a maximum effective diameter is denoted by RyEr, Conditional Expression (26) is satisfied, which is represented by

$$1. 01 < ( 1 / RcEf - 1 / RcEr ) / ( 1 / RyEf - 1 / RyEr ) < 2. \qquad ( 26 )$$

### APPENDIX 35

The zoom lens according to any one of Appendices 1 to 34, in which the first lens group includes at least one negative lens, and in a case where an Abbe number based on a d line for the negative lens of the first lens group is denoted by ν1n, and a partial dispersion ratio between a g line and an F line for the negative lens of the first lens group is denoted by θgF1n, Conditional Expressions (27) and (28) are satisfied, which are represented by

$$55 < v 1 n < 110 and \qquad ( 27 )$$

$$0.003 < θ gF 1 n - ( 0.6438 - 0.001682 \times v 1 n ) < 0.05 . \qquad ( 28 )$$

### APPENDIX 36

The zoom lens according to any one of Appendices 2 to 7, in which the P lens group includes at least one negative lens, and in a case where an Abbe number based on a d line for the negative lens of the P lens group is denoted by νPn, and a partial dispersion ratio between a g line and an F line for the negative lens of the P lens group is denoted by θgFPn, Conditional Expressions (29) and (30) are satisfied, which are represented by

$$55 < vPn < 110 and \qquad ( 29 )$$

$$0.003 < θ gFPn - ( 0.6438 - 0.001682 \times v P n ) < 0 \text{.05} . \qquad ( 30 )$$

### APPENDIX 37

The zoom lens according to any one of Appendices 4 to 7, in which the N lens group includes at least one negative lens, and in a case where an Abbe number based on a d line for the negative lens of the N lens group is denoted by νNn, and a partial dispersion ratio between a g line and an F line for the negative lens of the N lens group is denoted by θgFNn, Conditional Expressions (31) and (32) are satisfied, which are represented by

$$55 < vNn < 110 and \qquad ( 31 )$$

$$0.003 < θ gFNn - ( 0.6438 - 0.001682 \times vNn ) < 0 \text{.05} . \qquad ( 32 )$$

### APPENDIX 38

The zoom lens according to any one of Appendices 13 to 18, in which the M lens group includes at least one negative lens, and in a case where an Abbe number based on a d line for the negative lens of the M lens group is denoted by νMn, and a partial dispersion ratio between a g line and an F line for the negative lens of the M lens group is denoted by θgFMn, Conditional Expressions (33) and (34) are satisfied, which are represented by

$$55 < vMn < 110 and \qquad ( 33 )$$

$$0.003 < θ gFMn - ( 0.6438 - 0.001682 \times vMn ) < 0 \text{.06} . \qquad ( 34 )$$

### APPENDIX 39

The zoom lens according to Appendix 5, in which the final lens group includes at least one positive lens, and in a case where an Abbe number based on a d line for the positive lens of the final lens group is denoted by νEp, and a partial dispersion ratio between a g line and an F line for the positive lens of the final lens group is denoted by θgFEp, Conditional Expressions (35) and (36) are satisfied, which are represented by

$$55 < vEp < 110 and \qquad ( 35 )$$

$$0.003 < θ gFEp - ( 0.6438 - 0.001682 \times vEp ) < 0 \text{.05} . \qquad ( 36 )$$

### APPENDIX 40

The zoom lens according to any one of Appendices 1 to 39, in which the first lens group includes at least one positive lens, and in a case where a refractive index with respect to a d line for the positive lens of the first lens group is denoted by N1p, and an Abbe number based on the d line for the positive lens of the first lens group is denoted by ν1p, Conditional Expressions (37) and (38) are satisfied, which are represented by

$$1.8 < N 1 p < 2.3 and \qquad ( 37 )$$

$$10 < v 1 p < 45. \qquad ( 38 )$$

### APPENDIX 41

The zoom lens according to Appendix 5, in which the final lens group is fixed with respect to an image plane during zooming.

### APPENDIX 42

The zoom lens according to Appendix 19, in which the first lens group includes a biconcave lens disposed on the image side with respect to the negative meniscus lens, and a positive lens disposed on the image side with respect to the biconcave lens.

### APPENDIX 43

The zoom lens according to any one of Appendices 1 to 42, in which the first lens group at the telephoto end is positioned on the image side with respect to the first lens group at the wide angle end.

### APPENDIX 44

The zoom lens according to any one of Appendices 1 to 42, in which the first lens group at the telephoto end is positioned on the object side with respect to the first lens group at the wide angle end.

### APPENDIX 45

The zoom lens according to any one of Appendices 1 to 44, in which the subsequent group includes an aperture stop, at least one negative lens having a concave surface facing the object side is disposed on the image side with respect to the aperture stop, and in a case where a distance on an optical axis between the aperture stop and the negative lens having the concave surface facing the object side in the state where the infinite distance object is in focus at the wide angle end is denoted by DSInw, and a sum of a distance on the optical axis from a lens surface of the first lens group closest to the object side to a lens surface of the subsequent group closest to the image side and the back focus of the entire system as the air conversion distance in the state where the infinite distance object is in focus at the wide angle end is denoted by TLw, Conditional Expression (39) is satisfied, which is represented by

$$0.001 < DSInw / TLw < 0 \text{.12} . \qquad ( 39 )$$

### APPENDIX 46

The zoom lens according to any one of Appendices 1 to 45, in which the subsequent group includes an aperture stop, at least one negative lens having a concave surface facing the image side is disposed on the object side with respect to the aperture stop, and in a case where a distance on an optical axis between the aperture stop and the negative lens having the concave surface facing the image side in the state where the infinite distance object is in focus at the wide angle end is denoted by DSOnw, and a sum of a distance on the optical axis from a lens surface of the first lens group closest to the object side to a lens surface of the subsequent group closest to the image side and the back focus of the entire system as the air conversion distance in the state where the infinite distance object is in focus at the wide angle end is denoted by TLw, Conditional Expression (40) is satisfied, which is represented by

$$0.001 < D S Onw / TLw < 0 \text{.18} . \qquad ( 40 )$$

### APPENDIX 47

The zoom lens according to any one of Appendices 1 to 46, in which the subsequent group includes an aperture stop, at least one cemented lens is disposed on the image side with respect to the aperture stop, and in a case where a distance on an optical axis between the aperture stop and a bonding surface of the cemented lens on the image side with respect to the aperture stop in the state where the infinite distance object is in focus at the wide angle end is denoted by DSIcew, and a sum of a distance on the optical axis from a lens surface of the first lens group closest to the object side to a lens surface of the subsequent group closest to the image side and the back focus of the entire system as the air conversion distance in the state where the infinite distance object is in focus at the wide angle end is denoted by TLw, Conditional Expression (41) is satisfied, which is represented by

$$0.001 < DSIcew / TLw < 0 \text{.12} . \qquad ( 41 )$$

### APPENDIX 48

The zoom lens according to any one of Appendices 1 to 47, in which the subsequent group includes an aperture stop, at least one cemented lens is disposed on the object side with respect to the aperture stop, and in a case where a distance on an optical axis between the aperture stop and a bonding surface of the cemented lens on the object side with respect to the aperture stop in the state where the infinite distance object is in focus at the wide angle end is denoted by DSOcew, and a sum of a distance on the optical axis from a lens surface of the first lens group closest to the object side to a lens surface of the subsequent group closest to the image side and the back focus of the entire system as the air conversion distance in the state where the infinite distance object is in focus at the wide angle end is denoted by TLw, Conditional Expression (42) is satisfied, which is represented by

$$0.001 < D S O cew / TLw < 0 \text{.18} . \qquad ( 42 )$$

### APPENDIX 49

The zoom lens according to any one of Appendices 4 to 7, in which, in a case where a moving amount of the N lens group during zooming from the wide angle end to the telephoto end is denoted by ΔN, a moving amount of the P lens group during zooming from the wide angle end to the telephoto end is denoted by ΔP, and a sign of the moving amount during zooming is negative for movement to the object side and is positive for movement to the image side, Conditional Expression (43) is satisfied, which is represented by

$$0.1 < Δ N / Δ P < 0 \text{.75} . \qquad ( 43 )$$

### APPENDIX 50

The zoom lens according to any one of Appendices 1 to 49, in which, in a case where a sum of a distance on an optical axis from a paraxial exit pupil position to a lens surface of the subsequent group closest to the image side and the back focus of the entire system as the air conversion distance in the state where the infinite distance object is in focus at the wide angle end is denoted by Dexw, Conditional Expression (44) is satisfied, which is represented by

$$1.5 < Dexw / ( fw \times tan ω w ) < 5. \qquad ( 44 )$$

### APPENDIX 51

The zoom lens according to any one of Appendices 2 to 7, in which, in a case where an open F-number in the state where the infinite distance object is in focus at the telephoto end is denoted by Fnot, and a distance on an optical axis from a lens surface of the P lens group closest to the object side to a lens surface of the P lens group closest to the image side is denoted by DGP, Conditional Expression (45) is satisfied, which is represented by

$$0.4 < F not \times DGP / ft < 4. \qquad ( 45 )$$

### APPENDIX 52

The zoom lens according to any one of Appendices 13 to 18, in which, in a case where an open F-number in the state where the infinite distance object is in focus at the telephoto end is denoted by Fnot, a distance on an optical axis from a lens surface of the P lens group closest to the object side to a lens surface of the P lens group closest to the image side is denoted by DGP, and a distance on the optical axis from a lens surface of the M lens group closest to the object side to a lens surface of the M lens group closest to the image side is denoted by DGM, Conditional Expression (46) is satisfied, which is represented by

$$0.4 < F not \times ( DGP + DGM ) / ft < 4. \qquad ( 46 )$$

### APPENDIX 53

The zoom lens according to any one of Appendices 1 to 52, in which one lens group is provided between the first lens group and the P lens group.

### APPENDIX 54

The zoom lens according to any one of Appendices 1 to 53, in which, in a case where a sum of a distance on an optical axis from a lens surface of the first lens group closest to the object side to a lens surface of the subsequent group closest to the image side and the back focus of the entire system as the air conversion distance in the state where the infinite distance object is in focus at the telephoto end is denoted by TLt, Conditional Expression (47) is satisfied, which is represented by

$$1.2 < TLt / ft < 5. \qquad ( 47 )$$

### APPENDIX 55

The zoom lens according to Appendix 12, in which, in a case where a focal length of the final lens group is denoted by fE, Conditional Expression (48) is satisfied, which is represented by

$$0.1 < fw / fE < 0.7 . \qquad ( 48 )$$

### APPENDIX 56

The zoom lens according to Appendix 6, in which, in a case where a lateral magnification of the focus group in the state where the infinite distance object is in focus at the wide angle end is denoted by βfw, and a combined lateral magnification of all lenses on the image side with respect to the focus group in the state where the infinite distance object is in focus at the wide angle end is denoted by βfRw, Conditional Expression (49) is satisfied, which is represented by

$$0.3 < \vert ( 1 - β {fw}^{2} ) \times β {fRw}^{2} \vert < 3. \qquad ( 49 )$$

### APPENDIX 57

The zoom lens according to Appendix 6, in which, in a case where a lateral magnification of the focus group in the state where the infinite distance object is in focus at the telephoto end is denoted by βft, and a combined lateral magnification of all lenses on the image side with respect to the focus group in the state where the infinite distance object is in focus at the telephoto end is denoted by βfRt, Conditional Expression (50) is satisfied, which is represented by

$$0.5 < \vert ( 1 - β {ft}^{2} ) \times β {fRt}^{2} \vert < 4. \qquad ( 50 )$$

### APPENDIX 58

The zoom lens according to Appendix 6 or 56, in which, in a case where a lateral magnification of the focus group in the state where the infinite distance object is in focus at the wide angle end is denoted by βfw, a combined lateral magnification of all lenses on the image side with respect to the focus group in the state where the infinite distance object is in focus at the wide angle end is denoted by βfRw, a focal length of the focus group is denoted by ffoc, a combined focal length of all lenses on the image side with respect to the focus group in the state where the infinite distance object is in focus at the wide angle end is denoted by ffRw, a sum of a distance on an optical axis from a paraxial exit pupil position to a lens surface of the subsequent group closest to the image side and the back focus of the entire system as the air conversion distance in the state where the infinite distance object is in focus at the wide angle end is denoted by Dexw, and

$$\begin{matrix}γ w = ( 1 - β {fw}^{2} ) \times β {fRw}^{2} and \\ BRw = \{ β fw / ( ffoc \times γ w ) - 1 / ( β fRw \times ffRw ) - ( 1 / Dexw ) \}\end{matrix}$$

are established, Conditional Expression (51) is satisfied, which is represented by

$$0 < ( - BRw ) \times ( fw \times tan ω w ) < 0.7 . \qquad ( 51 )$$

### APPENDIX 59

The zoom lens according to Appendix 6 or 57, in which, in a case where a lateral magnification of the focus group in the state where the infinite distance object is in focus at the telephoto end is denoted by βft, a combined lateral magnification of all lenses on the image side with respect to the focus group in the state where the infinite distance object is in focus at the telephoto end is denoted by βfRt, a focal length of the focus group is denoted by ffoc, a combined focal length of all lenses on the image side with respect to the focus group in the state where the infinite distance object is in focus at the telephoto end is denoted by ffRt, a sum of a distance on an optical axis from a paraxial exit pupil position to a lens surface of the subsequent group closest to the image side and the back focus of the entire system as the air conversion distance in the state where the infinite distance object is in focus at the telephoto end is denoted by Dext, the maximum half angle of view in the state where the infinite distance object is in focus at the telephoto end is denoted by ωt, and

$$\begin{matrix}γ w = ( 1 - β {ft}^{2} ) \times β {fRt}^{2} and \\ BRt = \{ β ft / ( ffoc \times γ t ) - 1 / ( β fRt \times ffRt ) - ( 1 / Dext ) \}\end{matrix}$$

are established, Conditional Expression (52) is satisfied, which is represented by

$$0 < ( - BRt ) \times ( ft \times tan ω t ) < 0.5 . \qquad ( 52 )$$

### APPENDIX 60

The zoom lens according to any one of Appendices 1 to 59, comprising an aperture stop, in which at least three lenses are provided between the first lens group and the aperture stop.

### APPENDIX 61

The zoom lens according to any one of Appendices 1 to 60, comprising an aperture stop, in which at least three positive lenses are provided between the first lens group and the aperture stop.

### APPENDIX 62

The zoom lens according to any one of Appendices 4 to 7, comprising an aperture stop, in which at least three lenses are provided between the aperture stop and the N lens group.

### APPENDIX 63

The zoom lens according to any one of Appendices 4 to 7, comprising an aperture stop, in which at least two positive lenses are provided between the aperture stop and the N lens group.

### APPENDIX 64

The zoom lens according to Appendix 6, in which the number of lenses included in the focus group is two or less.

### APPENDIX 65

The zoom lens according to Appendix 5, in which the number of lenses included in the final lens group is two or less.

### APPENDIX 66

The zoom lens according to any one of Appendices 1 to 65, in which a lens surface of the first lens group closest to the image side is a concave surface.

### APPENDIX 67

The zoom lens according to any one of Appendices 1 to 66, in which the number of moving paths different from each other among moving paths of each lens group that moves during zooming from the wide angle end to the telephoto end is five.

### APPENDIX 68

The zoom lens according to any one of Appendices 1 to 66, in which the number of moving paths different from each other among moving paths of each lens group that moves during zooming from the wide angle end to the telephoto end is four.

### APPENDIX 69

The zoom lens according to any one of Appendices 1 to 66, in which the number of moving paths different from each other among moving paths of each lens group that moves during zooming from the wide angle end to the telephoto end is three.

### APPENDIX 70

The zoom lens according to any one of Appendices 1 to 69, in which at least one of a lens closest to the object side in the zoom lens or a second lens from the object side in the zoom lens is a negative lens, and in a case where a refractive index with respect to a d line for the negative lens of at least one of the lens closest to the object side in the zoom lens or the second lens from the object side in the zoom lens is denoted by Nobn, Conditional Expression (53) is satisfied, which is represented by

$$1.7 < Nobn < 2.2 . \qquad ( 53 )$$

### APPENDIX 71

The zoom lens according to Appendix 70, in which the lens closest to the object side in the zoom lens is a negative lens and satisfies the Conditional Expression (53).

### APPENDIX 72

An imaging apparatus comprising the zoom lens according to any one of Appendices 1 to 71.

All documents, patent applications, and technical standards described in the present specification are incorporated in the present specification by reference to the same extent as in a case where individual documents, patent applications, and technical standards are specifically and individually indicated to be incorporated by reference.

What is claimed is:

1. A zoom lens consisting of, in order from an object side to an image side, a first lens group having a negative refractive power, and a subsequent group,
wherein the subsequent group includes at least three lens groups,
one of the at least three lens groups is a P lens group having a positive refractive power,
during zooming, a spacing between the first lens group and the subsequent group changes, and all spacings between adjacent lens groups in the subsequent group change, and
in a case where a focal length of the zoom lens in a state where an infinite distance object is in focus at a wide angle end is denoted by fw,
a focal length of the zoom lens in a state where the infinite distance object is in focus at a telephoto end is denoted by ft,
a back focus of the zoom lens as an air conversion distance in the state where the infinite distance object is in focus at the wide angle end is denoted by Bfw, and
a maximum half angle of view in the state where the infinite distance object is in focus at the wide angle end is denoted by ωw,
Conditional Expressions (1) and (2) are satisfied, which are represented by
$$1.5 < ft / fw < 6 and \qquad ( 1 )$$
$$0.4 < Bfw / ( fw \times tan ω w ) < 2. \qquad ( 2 )$$

2. The zoom lens according to claim 1,
wherein the P lens group has a largest moving amount to the object side during zooming from the wide angle end to the telephoto end among the lens groups in the subsequent group.

3. The zoom lens according to claim 2,
wherein, in a case where a moving amount of the P lens group during zooming from the wide angle end to the telephoto end is denoted by ΔP, and
a sign of the moving amount during zooming is negative for movement to the object side and is positive for movement to the image side,
Conditional Expression (3) is satisfied, which is represented by
$$0.9 < ( - Δ P ) / fw - 6. \qquad ( 3 )$$

4. The zoom lens according to claim 2,
wherein an N lens group having a negative refractive power is disposed on the image side with respect to the P lens group.

5. The zoom lens according to claim 4,
wherein a final lens group positioned closest to the image side in the zoom lens is disposed on the image side with respect to the N lens group.

6. The zoom lens according to claim 4,
wherein at least a part of the N lens group is a focus group that moves along an optical axis during focusing.

7. The zoom lens according to claim 4,
wherein, in a case where a focal length of the N lens group is denoted by fN,
Conditional Expression (4) is satisfied, which is represented by
$$0.5 < ( - fN ) / fw < 7. \qquad ( 4 )$$

8. The zoom lens according to claim 1,
wherein, in a case where an open F-number in the state where the infinite distance object is in focus at the telephoto end is denoted by Fnot,
Conditional Expression (5) is satisfied, which is represented by
$$1.2 < F not < 5.8 . \qquad ( 5 )$$

9. The zoom lens according to claim 1,
wherein, in a case where an open F-number in the state where the infinite distance object is in focus at the telephoto end is denoted by Fnot, and
an open F-number in the state where the infinite distance object is in focus at the wide angle end is denoted by Fnow,
Conditional Expression (6) is satisfied, which is represented by
$$0.95 < F not / F now < 1.8 . \qquad ( 6 )$$

10. The zoom lens according to claim 2,
wherein, in a case where a focal length of the P lens group is denoted by fP,
Conditional Expression (7) is satisfied, which is represented by
$$0.5 < fP / fw < 6. \qquad ( 7 )$$

11. The zoom lens according to claim 1,
wherein Conditional Expression (8) is satisfied, which is represented by
$$35 < ω w < 54. \qquad ( 8 )$$

12. The zoom lens according to claim 5,
wherein the final lens group has a positive refractive power.

13. The zoom lens according to claim 4,
wherein an M lens group is disposed between the P lens group and the N lens group.

14. The zoom lens according to claim 1,
wherein the P lens group has a largest moving amount to the object side during zooming from the wide angle end to the telephoto end among the lens groups in the subsequent group,
an N lens group having a negative refractive power is disposed on the image side with respect to the P lens group,
an M lens group is disposed between the P lens group and the N lens group, and
in a case where a moving amount of the P lens group during zooming from the wide angle end to the telephoto end is denoted by ΔP, and
a sign of the moving amount during zooming is negative for movement to the object side and is positive for movement to the image side,
Conditional Expression (3) is satisfied, which is represented by
$$0.9 < ( - Δ P ) / fw < 6. \qquad ( 3 )$$

15. The zoom lens according to claim 13,
wherein the M lens group has a positive refractive power.

16. The zoom lens according to claim 13,
wherein, in a case where a focal length of the M lens group is denoted by fM,
Conditional Expression (9) is satisfied, which is represented by
$$0.01 < fw / fM < 0.35 . \qquad ( 9 )$$

17. The zoom lens according to claim 13,
wherein, in a case where a refractive index with respect to a d line for a positive lens closest to the image side among positive lenses in the M lens group is denoted by NMp, and
an Abbe number based on the d line for the positive lens closest to the image side among the positive lenses in the M lens group is denoted by vMp,
Conditional Expressions (10) and (11) are satisfied, which are represented by
$$1.73 < NMp < 2.5 and \qquad ( 10 )$$
$$10 < vMp < 50. \qquad ( 11 )$$

18. The zoom lens according to claim 13,
wherein an aperture stop is disposed closest to the object side in the M lens group.

19. The zoom lens according to claim 1,
wherein the first lens group includes a negative meniscus lens having a concave surface facing the image side, closest to the object side.

20. The zoom lens according to claim 1,
wherein, in a case where a focal length of the first lens group is denoted by f1,
Conditional Expression (12) is satisfied, which is represented by
$$1 < ( - f 1 ) / fw < 2.5 . \qquad ( 12 )$$

21. The zoom lens according to claim 1,
wherein, in a case where a distance on an optical axis from a lens surface of the first lens group closest to the object side to a lens surface of the first lens group closest to the image side is denoted by DG1,
Conditional Expression (13) is satisfied, which is represented by
$$0.71 < DG 1 / ( fw \times tan ω w ) < 2.5 . \qquad ( 13 )$$

22. The zoom lens according to claim 2,
wherein, in a case where a distance on an optical axis from a lens surface of the P lens group closest to the object side to a lens surface of the P lens group closest to the image side is denoted by DGP,
Conditional Expression (14) is satisfied, which is represented by
$$0.35 < DGP / ( fw \times tan ω w ) < 2.5 . \qquad ( 14 )$$

23. The zoom lens according to claim 1,
wherein, in a case where a distance on an optical axis from a lens surface of the first lens group closest to the object side to a paraxial entrance pupil position in the state where the infinite distance object is in focus at the wide angle end is denoted by Denw,
Conditional Expression (15) is satisfied, which is represented by
$$1 < Denw / fw < 2.2 . \qquad ( 15 )$$

24. The zoom lens according to claim 2,
wherein, in a case where a focal length of the first lens group is denoted by f1, and
a focal length of the P lens group is denoted by fP,
Conditional Expression (19) is satisfied, which is represented by
$$0.3 < ( - f 1 ) / fP < 1.5 . \qquad ( 19 )$$

25. The zoom lens according to claim 13,
wherein, in a case where a focal length of the first lens group is denoted by f1, and
a focal length of the M lens group is denoted by fM,
Conditional Expression (20) is satisfied, which is represented by
$$0 < ( - f 1 ) / fM < 0.7 . \qquad ( 20 )$$

26. The zoom lens according to claim 13,
wherein, in a case where a focal length of the P lens group is denoted by fP, and
a focal length of the M lens group is denoted by fM,
Conditional Expression (21) is satisfied, which is represented by
$$0 < fP / fM < 2. \qquad ( 21 )$$

27. The zoom lens according to claim 6,
wherein, in a case where a focal length of the focus group is denoted by ffoc,
Conditional Expression (22) is satisfied, which is represented by
$$1.2 < ( - ffoc ) / ( fw \times tan ω w ) < 5.5 . \qquad ( 22 )$$

28. The zoom lens according to claim 1,
wherein the first lens group includes at least one positive lens, and
in a case where a refractive index with respect to a d line for the positive lens of the first lens group is denoted by N1p, and
an Abbe number based on the d line for the positive lens of the first lens group is denoted by ν1p,
Conditional Expressions (37) and (38) are satisfied, which are represented by
$$1.8 < N 1 p < 2.3 and \qquad ( 37 )$$
$$10 < v 1 p < 45. \qquad ( 38 )$$

29. The zoom lens according to claim 5,
wherein the final lens group is fixed with respect to an image plane during zooming.

30. The zoom lens according to claim 19,
wherein the first lens group includes a biconcave lens disposed on the image side with respect to the negative meniscus lens, and a positive lens disposed on the image side with respect to the biconcave lens.

31. The zoom lens according to claim 1,
wherein the first lens group at the telephoto end is positioned on the image side with respect to the first lens group at the wide angle end.

32. The zoom lens according to claim 1,
wherein the first lens group at the telephoto end is positioned on the object side with respect to the first lens group at the wide angle end.

33. The zoom lens according to claim 1,
wherein one lens group is provided between the first lens group and the P lens group.

34. The zoom lens according to claim 1,
wherein a lens surface of the first lens group closest to the image side is a concave surface.

35. An imaging apparatus comprising:
the zoom lens according to claim 1.
